(19) United States
(12) Patent Application Publication
(10) Pub. No.: US 2023/0110221 A1
(43) Pub. Date: Apr. 13, 2023

(54) SAKE REPLICAS PRODUCED FROM INDIVIDUAL COMPONENTS

(71) Applicant: Ava Food Labs, Inc., San Francisco, CA (US)

(72) Inventors: Joshua Canaria Decolongon, San Francisco, CA (US); Mardonn Carl Chua, San Francisco, CA (US); Ethan Charles Beswick, San Francisco, CA (US); Joshua Lundquist, Dublin, CA (US); Jillian Angela Jastrzembski, San Francisco, CA (US); Leslie P. Silva, Emeryville, CA (US)

(21) Appl. No.: 17/617,181

(22) PCT Filed: Jun. 12, 2020
(86) PCT No.: PCT/US2020/037525

§ 371 Date: Dec. 7, 2021

Related U.S. Application Data
(60) Provisional application No. 62/861,146, filed on Jun. 13, 2019.

(51) Int. Cl. C12G 3/06

(52) U.S. Cl. CPC C12G 3/06

(57) ABSTRACT

Materials and methods for producing sake replicas from individual components are provided herein.

### CROSS-REFERENCE TO RELATED APPLICATIONS

This application is a claims priority to U.S. Provisional Application Ser. No. 62/861,146, filed on Jun. 13, 2019, incorporated by reference herein in its entirety.

### TECHNICAL FIELD

This document relates to materials and methods for producing sakes from individual components.

### BACKGROUND

Traditional methods for producing alcoholic beverages are often lengthy and costly, involving the harvesting of fastidious crops, followed by processing, fermenting, and aging steps. Each component of the traditional process has an inherent variability and risk, including climate, crop disease, and contamination, which can render such methods and their resulting products inconsistent. The use of traditional sake production methods requires difficult controls for variability, often involving adulteration of the final product with ingredients to mask imperfections.

### SUMMARY

This document is based, at least in part, on the discovery that compounds that contribute to the flavor and aroma of various alcoholic beverages (e.g., sakes) can be identified and combined to yield alcoholic beverage replicas that have the taste, aroma, and other characteristics of traditionally generated alcoholic beverages. Because each ingredient is added individually, the methods disclosed herein can reduce many of the risks and variability associated with traditional production of alcoholic beverages. In some cases, one or more ingredients (e.g., at least 50%, 60%, 70%, 80%, 90%, 95%, 99%, or 100% of the ingredients) can be highly defined (e.g., by lot analysis). In some cases, one or more ingredients (e.g., at least 50%, 60%, 70%, 80%, 90%, 95%, 99%, or 100% of the ingredients) can be highly pure (e.g., at least 90%, 95%, 96%, 97%, 98%, 99%, 99.5%, or 99.9% pure). The methods also can provide infinite reproducibility of a recipe, which is not possible with traditional production methods. Further, the methods described herein allow for unique flexibility in optimization of the flavors, aromas, and textures of sakes, and greatly reduce or even eliminate the possibility that the resulting sakes will contain detrimental or undesired components. Moreover, the methods disclosed herein differ from currently existing methods in that they are rapid, reproducible, and cost-effective.

There are several types of traditional sakes. Junmai is a sake that is made from rice only, with no addition of distilled alcohol. Honjozo is a sake to which a small amount of distilled alcohol is added. Ginjo is a sake made from highly milled rice, with additional alcohol added. Junmai Ginjo is a sake made from highly milled rice, without additional alcohol added. Daiginjo is a sake made from even more highly milled rice than Ginjo, with additional alcohol. Junmai Daiginjo is its counterpart without additional alcohol added. Nama-zake is a sake that has not been pasteurized. Nigorizake is a sake that is unfiltered.

Traditional sakes can be further categorized. Seishu is the legal name for sake, differentiating it from other alcoholic beverages. Futsuu-shu is any sake that is not junmai, honjozo, ginjo-shu or daiginjo; this loosely translates to “value-sake.” Jizake is a somewhat vague term that usually means sake made in smaller breweries located in distant areas, or sake that is not mass-produced (ie “craft sake”).

In some embodiments, sake replicas as described herein can be replicas of any of these types of sakes. In some embodiments, sake replicas described herein can be a replica of a blend of two or more types of sakes.

Traditional sakes are complex mixtures on a chemical level. In some aspects, this document provides sake replicas that are less complex than a traditional sake. It was surprising that the replicas disclosed herein do not need to have the complexity of a traditional sake in order to be perceived as such. It was also surprising that some compounds, which by themselves have an unpleasant taste and/or smell, can enhance the taste and/or smell of the sake replicas disclosed herein. It was further surprising that the exclusion of some compounds found in all tested traditional sakes was not detrimental to the sake replicas described herein. Similarly, it was surprising that some compounds that were not found in any tested traditional sake could be beneficial to the sake replicas described herein. It was also surprising that sake replicas described herein containing some compounds in amounts greater than the highest measured amount in any tested traditional alcoholic beverage or lower than the lowest measured amount in any tested traditional sake were superior to replicas that contained the same compounds in amounts within the measured range of traditional sake. Therefore, in another aspect, this document provides sake replicas that are not mere replicas of existing products, but instead provide a similar sensory experience with a different chemical composition.

In one aspect, this document features a sake replica that includes ethanol, water, and one or more additional volatile organic compounds (VOCs), where the one or more additional VOCs include at least one VOC that is not present in a corresponding traditional sake. In some cases, the one or more additional VOCs do not include at least one VOC that is present in a corresponding traditional sake. This document also features a sake replica that includes ethanol, water, and one or more additional VOCs, where the one or more additional VOCs do not include at least one VOC that is present in a corresponding traditional sake.

The one or more additional VOCs can include one or more, two or more, three or more, four or more, five or more, six or more, or all seven of butyl formate, ethyl octanoate, ethyl propionate, ethyl-2-methylbutyrate, isoamyl acetate, isoamyl alcohol, and isobutanol. In some cases, the one or more additional VOCs include no more than six, no more than five, or no more than four of butyl formate, ethyl octanoate, ethyl propionate, ethyl-2-methylbutyrate, isoamyl acetate, isoamyl alcohol, and isobutanol.

The sake replica can further include one or more non-volatile compounds, where the one or more non-volatile compounds include at least one compound that is not present in a corresponding traditional sake. The sake replica can further include one or more non-volatile compounds, where the one or more non-volatile compounds do not include at least one non-volatile compound that is present in a corresponding traditional sake.

The one or more additional VOCs can include an ester, an alcohol, an aldehyde, a ketone, or an aldehyde and a ketone, optionally, an acid, optionally, a terpene, an isoprenoid, or a terpene and an isoprenoid, optionally, a phenol, optionally, a lactone; optionally, an amine, a pyrazine, or an amine and a pyrazine, optionally, a thiol, a thiazole, a sulfide, or any combination thereof, optionally, an ether, optionally, an acetal; and optionally, a furan.

The sake replica can further include one or more non-volatile compounds. The one or more non-volatile compounds can have less than 90%, less than 80%, less than 70%, less than 60%, less than 50%, less than 40% identity, less than 30% identity, or less than 25% identity to the non-volatile compounds in a corresponding traditional sake.

The one or more additional VOCs can have less than 90%, less than 80%, less than 70%, less than 60%, less than 50%, less than 40% identity, less than 30% identity, less than 25% identity, less than 20% identity, or less than 15% identity to the VOCs in a single corresponding traditional sake.

In one aspect, this document features a sake replica that includes ethanol, water, and one or more additional volatile organic compounds (VOCs), where the one or more additional VOCs include at least one VOC that is not present in a corresponding traditional sake. In some cases, the one or more additional VOCs do not include at least one VOC that is present in a corresponding traditional sake. This document also features a sake replica that includes ethanol, water, and one or more additional VOCs, where the one or more additional VOCs do not include at least one VOC that is present in a corresponding traditional sake. In some cases, the one or more additional VOCs include at least one VOC that is not present in a corresponding traditional sake.

In another aspect, this document features a sake replica that includes ethanol, water, and one or more non-volatile compounds, where the one or more non-volatile compounds include at least one non-volatile compound that is not present in a corresponding traditional sake. In some cases, the one or more non-volatile compounds do not include at least one non-volatile compound that is present in a corresponding traditional sake. This document also features a sake replica that includes ethanol, water, and one or more non-volatile compounds, where the one or more non-volatile compounds do not include at least one non-volatile compound that is present in a corresponding traditional sake. In some cases, the one or more non-volatile compounds include at least one non-volatile compound that is not present in a corresponding traditional sake. Implementations can include one or more of the following features. An additional VOC that is not present in a corresponding traditional sake can be a compound selected from the group consisting of 1,4-cineole, 1-decanol, 2,4,6-trimethylphenol, 2-acetyl-1-methylpyrrole, 2-ethyl-3(5 or 6)-dimethylpyrazine, 2-ethyl-3-methylpyrazine, 2-isopropyl-4-methyl thiazole, 2-methoxy-3-(1-methylpropyl) pyrazine, 2-methoxy-4-methylphenol, 2-methoxy-4-propylphenol, 2-methylbutyl acetate, 2-methylbutyl isovalerate, 2-nonanol, 3-carene, 3-methylthio hexyl acetate, 3-phenylpropanal, 4,5,6,7-tetrahydro-3,6-dimethylbenzofuran, 4-carvomenthenol, 4-mercapto-4-methyl-2-pentanone, 5-methyl-2-phenyl-2-hexenal, acetoin, a-ionone, allyl heptanoate, alpha-pinene, amyl alcohol, amyl butyrate, anisyl acetate, anisyl butyrate, b-caryophellene, benzyl acetate, benzyl benzoate, benzyl butyrate, benzyl formate, benzyl propionate, beta-ionone, butyl butyryllactate, butyl formate, carvacrol, cinnamaldehyde, cis-3-hexenyl acetate, cis-3-hexenyl butyrate, cis-3-hexenyl valerate, cis-5-octen-1-ol, cis-6-nonen-1-ol, citral, citronellal, cuminaldehyde, D-carvone, decanal, d-fenchone, ethyl 2-trans-4-cis-decadienoate, ethyl cinnamate, ethyl myristate, ethyl undecanoate, eucalyptol, eugenol, furfuryl thioacetate, gamma-decalactone, gamma-terpinene, gamma-undecalactone, gamma-valerolactone, geranyl acetone, hexadecanol, hexyl 3-methylbutanoate, hexyl isobutyrate, 3-isobutyl-2-methoxypyrazine, isoamyl cinnamate, isoamyl isobutyrate, isoamyl isovalerate, isoamyl phenylacetate, isobutyl isobutyrate, isoeugenol, L-carvone, linalool, linalool oxide, linalyl acetate, L-menthyl acetate, maltol, massoia lactone, methyl anthranilate, methyl benzoate, methyl cinnamate, methyl cyclopentenolone, methyl decanoate, methyl octanoate, methyl salicylate, myrcene, nerolidol, omega-pentadecalactone, p,a-dimethylstyrene, p-cymene, perillaldehyde, phenethyl 2-methylbutyrate, phenethyl butyrate, phenethyl octanoate, phenethyl tiglate, phenylacetaldehyde dimethyl acetal, salicylaldehyde, tetrahydrolinalool, thymol, trans-2-hexen-1-al, valencene, valeraldehyde, vanillyl butyl ether, and whiskey lactone. An additional VOC that is present in a corresponding traditional sake can be a compound selected from the group consisting of 1-octanol, 2,3-pentadione, 2-heptanone, 2-nonanone, 5-methyl furfural, benzaldehyde, benzyl alcohol, butyl acetate, butyraldehyde, citronellol, diethyl succinate, ethyl isobutyrate, ethyl lactate, ethyl propionate, ethyl trans-2-butenoate, ethyl(methylthio) acetate, gamma-heptalactone, gamma-hexalactone, gamma-octalactone, hexanol, isoamyl hexanoate, isobutyl acetate, isobutyraldehyde, isobutyric acid, isovaleric acid, methionyl acetate, methyl acetate, nonanoic acid, phenylacetaldehyde, propionaldehyde, propionic acid, propyl acetate, and propyl butyrate. A non-volatile compound that is not present in a corresponding traditional sake can be a compound selected from the group consisting of 2,3,5-trimethylpyrazine, 2,3-dimethylpyrazine, aspartic acid, caffeic acid, camphoric acid, catechin, cinnamic acid, cysteine, cystine, ellagic acid, epicatechin, epicatechin gallate, gallic acid, hesperetin, methyl gallate, methyl-2-pyrrolyl ketone, inositol, propyl gallate, pyridine, quercetin, resveratrol, sinapinic acid, sorbic acid, syringaldehyde, and tryptamine. A non-volatile compound that is present in a corresponding traditional sake can be a compound selected from the group consisting of 2,3,5,6-tetramethylpyrazine, 2-furoic acid, 2-isopropylmalic acid, 3,4-dihydroxybenzoic acid, 4-guanidinobutyric acid, asparagine, beta-alanine, carnitine, fucose, gamma-aminobutyric acid (GABA), galactose, glucosamine, glutamine, glycine, guanine, histidine, lactic acid, leucine, mannitol, mannose, methionine, ornithine, proline, pyridoxine, pyruvic acid, quinic acid, rhamnose, salicylic acid, serine, tryptophan, tyrosine, valine, and xylose.

Implementations can further have one or more of the following features. The one or more additional VOCs can include an ester, an alcohol, an aldehyde, a ketone, or an aldehyde and a ketone, optionally, an acid, optionally, a terpene, an isoprenoid, or a terpene and an isoprenoid, optionally, a phenol, optionally, a lactone, optionally, an amine, a pyrazine, or an amine and a pyrazine, optionally, a thiol, a thiazole, a sulfide, or any combination thereof, optionally, an ether, optionally, an acetal, and optionally, a furan. The one or more additional VOCs can include one or more esters. The one or more esters can be selected from the group consisting of 2-methylbutyl acetate, 2-methylbutyl isovalerate, 3-heptyl acetate, 3-methylthio hexyl acetate, allyl heptanoate, allyl hexanoate, amyl butyrate, anisyl acetate, anisyl butyrate, benzyl acetate, benzyl benzoate, benzyl butyrate, benzyl formate, benzyl propionate, butyl acetate, butyl butyryllactate, butyl formate, cis-3-hexenyl acetate, cis-3-hexenyl butyrate, cis-3-hexenyl caproate, cis-3-hexenyl valerate, diethyl malate, diethyl succinate, ethyl 2-methylbutyrate, ethyl 2-trans-4-cis-decadienoate, ethyl 3-hydroxyhexanoate, ethyl acetate, ethyl acetoacetate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl phenylacetate, ethyl propionate, ethyl salicylate, ethyl trans-2-butenoate, ethyl undecanoate, ethyl valerate, ethyl(methylthio) acetate, ethyl-trans-3-hexenoate, geranyl butyrate, geranyl propionate, heptyl acetate, hexyl 3-methylbutanoate, hexyl acetate, hexyl butyrate, hexyl formate, hexyl isobutyrate, hexyl propionate, isoamyl acetate, isoamyl cinnamate, isoamyl hexanoate, isoamyl isobutyrate, isoamyl isovalerate, isoamyl octanoate, isoamyl phenylacetate, isobutyl acetate, isobutyl butyrate, isobutyl isobutyrate, isobutyl propionate, linalyl acetate, methionyl acetate (3-methylthio-propylacetate), methionyl butyrate, methyl acetate, methyl anthranilate, methyl benzoate, methyl cinnamate, methyl decanoate, methyl hexanoate, methyl laurate, methyl octanoate, methyl salicylate, phenethyl 2-methylbutyrate, phenethyl acetate, phenethyl butyrate, phenethyl formate, phenethyl octanoate, phenethyl propionate, phenethyl tiglate, propyl acetate, propyl butyrate, propyl isovalerate, and mixtures thereof. The one or more esters can be selected from the group consisting of butyl acetate, diethyl malate, diethyl succinate, ethyl 2-methylbutyrate, ethyl 3-hydroxyhexanoate, ethyl acetate, ethyl benzoate, ethyl butanoate, ethyl decanoate, ethyl heptanoate, ethyl hexanoate, ethyl isobutyrate, ethyl isovalerate, ethyl lactate, ethyl laurate, ethyl levulinate, ethyl nonanoate, ethyl octanoate, ethyl phenylacetate, ethyl propionate, ethyl salicylate, ethyl trans-2-butenoate, ethyl valerate, ethyl(methylthio) acetate, ethyl-trans-3-hexenoate, heptyl acetate, hexyl acetate, isoamyl acetate, isoamyl hexanoate, isoamyl octanoate, isobutyl acetate, isobutyl propionate, methionyl acetate, methyl acetate, methyl hexanoate, methyl laurate, phenethyl acetate, phenethyl formate, phenethyl propionate, propyl acetate, propyl butyrate, propyl isovalerate, and mixtures thereof. The one or more esters can be selected from the group consisting of ethyl acetate, ethyl butanoate, ethyl hexanoate, ethyl octanoate, isoamyl acetate, and phenethyl acetate. The one or more esters can be present in a total amount of about 6 mg/L to about 95 mg/L. The one or more esters can be present in an amount of at least about 41 mg/L. About 2% to about 40% by mass of the one or more additional VOCs can be the one or more esters. The one or more additional VOCs can include one or more acids. The one or more acids can be selected from the group consisting of isobutyric acid, isovaleric acid, nonanoic acid, propionic acid, and mixtures thereof. The one or more acids can be present in a total amount of about 0.9 mg/L to about 3 mg/L. About 0.3% to about 2% of the one or more additional VOCs can be the one or more acids. The one or more additional VOCs can include one or more alcohols. The one or more alcohols can be selected from the group consisting of 1-decanol, 1-octanol, 1-octen-3-ol, 2-heptanol, 2-methyl-1-butanol, 2-nonanol, 2-phenylethanol, amyl alcohol, anisyl alcohol, benzyl alcohol, butyl alcohol, cis-5-octen-1-ol, cis-6-nonen-1-ol, DL-3-methyl-2-butanol, hexadecanol, hexanol, isoamyl alcohol, isobutyl alcohol, propanol, and mixtures thereof. The one or more alcohols can be selected from the group consisting of 1-octanol, 1-octen-3-ol, 2-heptanol, 2-methyl-1-butanol, 2-phenylethanol, benzyl alcohol, butyl alcohol, DL-3-methyl-2-butanol, hexanol, isoamyl alcohol, isobutyl alcohol, propanol, and mixtures thereof. The one or more alcohols can be selected from the group consisting of 2-methyl-1-butanol, 2-phenylethanol, butyl alcohol, isoamyl alcohol, isobutyl alcohol, propanol, and mixtures thereof. The one or more alcohols can be present in a total amount of about 100 mg/L to about 350 mg/L. About 40% to about 95% of the one or more additional VOCs can be the one or more alcohols. The one or more additional VOCs can include one or more aldehydes or ketones. The one or more aldehydes or ketones can be selected from the group consisting of 3-ethyl-2-hydroxy-2-cyclopenten-1-one, 2,3-hexanedione, 2,3-pentadione, 2-acetyl-1-methylpyrrole, 2-heptanone, 2-methoxycinnamaldehyde, 2-methylbutyraldehyde, 2-nonanone, 2-octanone, 2-undecanone, 3-phenylpropanal, 5-ethyl-3-hydroxy-4-methyl-2(5H)-furanone, 5-methyl furfural, 5-methyl-2-phenyl-2-hexenal, 6-methyl-5-hepten-2-one, acetaldehyde, acetoin, acetophenone, benzaldehyde, butyraldehyde, cinnamaldehyde, cuminaldehyde, decanal, furfural, isobutyraldehyde, isovaleraldehyde, lauric aldehyde, maltol, methyl cyclopentenolone, methyl β-naphthyl ketone, methyl-2-pyrrolyl ketone, nonanal, octanal, p-anisaldehyde, phenylacetaldehyde, propionaldehyde, salicylaldehyde, trans-2-hexen-1-al, valeraldehyde, and mixtures thereof the one or more aldehydes or ketones can be selected from the group consisting of 2,3-pentadione, 2-heptanone, 2-methylbutyraldehyde, 2-nonanone, 2-undecanone, 5-ethyl-3-hydroxy-4-methyl-2(5H)-furanone, 5-methyl furfural, 6-methyl-5-hepten-2-one, acetaldehyde, acetophenone, benzaldehyde, butyraldehyde, furfural, isobutyraldehyde, isovaleraldehyde, methyl β-naphthyl ketone, methyl-2-pyrrolyl ketone, nonanal, octanal, p-anisaldehyde, phenylacetaldehyde, propionaldehyde, and mixtures thereof. The one or more aldehydes or ketones can be selected from the group consisting of acetaldehyde, furfural, and mixtures thereof. The one or more aldehydes or ketones can be present in a total amount of about 0.09 mg/L to about 40 mg/L. The one or more aldehydes or ketones can be present in a total amount of at least about 1.2 mg/L. About 0.03% to about 16% by mass of the one or more additional VOCs can be the one or more aldehydes or ketones. At least about 0.9% by mass of the one or more additional VOCs can be the one or more aldehydes or ketones. The one or more additional VOCs can include one or more terpenes or isoprenoids. The one or more terpenes or isoprenoids can be selected from the group consisting of (1R)-(-)-myrtenal, 1,4-cineole, 3-carene, 4,5,6,7-tetrahydro-3,6-dimethylbenzofuran, 4-carvomenthenol, 4-ethyl guaiacol, a-ionone, alpha-pinene, a-terpineol, b-caryophellene, beta-damascenone, beta-ionone, beta-pinene, carvacrol, cis-rose-oxide, citral, citronellal, citronellol, D-camphor, D-carvone, d-fenchone, eucalyptol, gamma-terpinene, geraniol, geranyl acetone, L-carvone, limonene, linalool, linalool oxide, L-menthyl acetate, myrcene, nerolidol, p,a-dimethylstyrene, p-cymene, perillaldehyde, terpinolene, tetrahydrolinalool, thymol, valencene, and mixtures thereof. The one or more terpenes or isoprenoids can be selected from the group consisting of (1R)-(-)-myrtenal, 4-ethyl guaiacol, a-terpineol, beta-damascenone, beta-pinene, cis-rose-oxide, citronellol, D-camphor, geraniol, limonene, and mixtures thereof. The one or more terpenes or isoprenoids can be present in a total amount of about 0.001 mg/L to about 0.045 mg/L. About 0.0003% to about 0.035% by mass of the one or more additional VOCs can be the one or more terpenes or isoprenoids. The one or more additional VOCs can include one or more phenols. The one or more phenols can be selected from the group consisting of 2,4,6-trimethylphenol, 2-methoxy-4-methylphenol, 2-methoxy-4-propylphenol, 4-ethyl phenol, eugenol, guaiacol, isoeugenol, p-cresol, and mixtures thereof. The one or more phenols can be selected from the group consisting of 4-ethyl phenol, guaiacol, p-cresol, and mixtures thereof. The one or more phenols can be present in a total amount of about 0.0002 mg/L to about 0.009 mg/L. About 0.00009% to about 0.006% by mass of the one or more additional VOCs can be the one or more phenols. The one or more additional VOCs can include one or more lactones. The one or more lactones can be selected from the group consisting of delta-decalactone, delta-dodecalactone, dihydrocoumarin, gamma-decalactone, gamma-dodecalactone, gamma-heptalactone, gamma-hexalactone, gamma-nonalactone, gamma-octalactone, gamma-undecalactone, gamma-valerolactone, massoia lactone, omega-pentadecalactone, whiskey lactone, and mixtures thereof. The one or more lactones can be selected from the group consisting of delta-decalactone, delta-dodecalactone, gamma-dodecalactone, gamma-heptalactone, gamma-hexalactone, gamma-nonalactone, gamma-octalactone, and mixtures thereof. The one or more lactones can be present in a total amount of about 0.0025 mg/L to about 0.2 mg/L. About 0.0009% to about 0.12% by mass of the one or more additional VOCs can be the one or more lactones. The one or more additional VOCs can include one or more amines or pyrazines. The one or more amines or pyrazines can be selected from the group consisting of 2-ethyl-3(5 or 6)-dimethylpyrazine, 2-ethyl-3-methylpyrazine, 2-methoxy-3-(1-methylpropyl) pyrazine, 3-Isobutyl-2-methoxypyrazine, indole, and mixtures thereof. The one or more amines or pyrazines can include indole. The one or more amines or pyrazines can be present in a total amount of about 0.0001 mg/L to about 0.0003 mg/L. About 0.00004% to about 0.0002% by mass of the one or more additional VOCs can be the one or more amines or pyrazines. The one or more additional VOCs can include one or more thiols, thiazoles, or sulfides. The one or more thiols, thiazoles, or sulfides can be selected from the group consisting of 1-para-menthene-8-thiol, 2-isopropyl-4-methyl thiazole, 4-mercapto-4-methyl-2-pentanone, furfuryl thioacetate, and mixtures thereof. The one or more thiols, thiazoles, or sulfides can include 1-para-menthene-8-thiol. The one or more thiols, thiazoles, or sulfides can be present in a total amount of about 0.0000003 mg/L to about 0.0000015 mg/L. About 0.00000008% to about 0.000001% by mass of the one or more additional VOCs can be the one or more thiols, thiazoles, or sulfides. The one or more additional VOCs can include one or more ethers. The one or more ethers can include vanillyl ethyl ether, vanillyl butyl ether, or a combination thereof. The one or more ethers can include vanillyl ethyl ether. The one or more ethers can be present in a total amount of about 0.001 to about 0.003 mg/L. About 0.0004% to about 0.002% by mass of the one or more additional VOCs can be the one or more ethers. The one or more additional VOCs can include one or more acetals. The one or more acetals can be selected from the group consisting of 2-isobutyl-4-methyl-1,3-dioxolane, benzaldehyde glyceryl acetal, phenylacetaldehyde dimethyl acetal, and mixtures thereof. The one or more acetals can include 2-isobutyl-4-methyl-1,3-dioxolane. The one or more acetals can be present in a total amount of about 0.001 mg/L to about 0.003 mg/L. About 0.0004% to about 0.002% by mass of the one or more additional VOCs can be the one or more acetals. The one or more additional VOCs can include one or more furans. The one or more furans can include 2-pentyl furan. The one or more furans can be present in a total amount of about 0.0006 mg/L to about 0.0012 mg/L. About 0.0002% to about 0.0008% by mass of the one or more additional VOCs can be the one or more furans.

Implementations can further include one or more of the following features. The one or more additional VOCs can include at least 5 compounds selected from the group consisting of (1R)-(-)-myrtenal, 3-ethyl-2-hydroxy-2-cyclopenten-1-one, 1,4-cineole, 1-decanol, 1-octanol, 1-octen-3-ol, 1-para-menthene-8-thiol, 2,3-hexanedione, 2,3-pentadione, 2,4,6-trimethylphenol, 2-acetyl-1-methylpyrrole, 2-ethyl-3(5 or 6)-dimethylpyrazine, 2-ethyl-3-methylpyrazine, 2-heptanol, 2-heptanone, 2-isobutyl-4-methyl-1,3-dioxolane, 2-isopropyl-4-methyl thiazole, 2-methoxy-3-(1-methylpropyl) pyrazine, 2-methoxy-4-methylphenol, 2-methoxy-4-propylphenol, 2-methoxycinnamaldehyde, 2-methyl-1-butanol, 2-methylbutyl acetate, 2-methylbutyl isovalerate, 2-methylbutyraldehyde, 2-nonanol, 2-nonanone, 2-octanone, 2-pentylfuran, 2-phenylethanol, 2-undecanone, 3-carene, 3-heptyl acetate, 3-methylthio hexyl acetate, 3-phenylpropanal, 4,5,6,7-tetrahydro-3,6-dimethylbenzofuran, 4-carvomenthenol, 4-ethyl guaiacol, 4-ethyl phenol, 4-mercapto-4-methyl-2-pentanone, 5-ethyl-3-hydroxy-4-methyl-2(5H)-furanone, 5-methyl furfural, 5-methyl-2-phenyl-2-hexenal, 6-methyl-5-hepten-2-one, acetaldehyde, acetoin, acetophenone, a-ionone, allyl heptanoate, allyl hexanoate, alpha-pinene, amyl alcohol, amyl butyrate, anisyl acetate, anisyl alcohol, anisyl butyrate, a-terpineol, b-caryophellene, benzaldehyde, benzaldehyde glyceryl acetal, benzyl acetate, benzyl alcohol, benzyl benzoate, benzyl butyrate, benzyl formate, benzyl propionate, beta-damascenone, beta-ionone, beta-pinene, butyl acetate, butyl alcohol, butyl butyryllactate, butyl formate, butyraldehyde, carvacrol, cinnamaldehyde, cis-3-hexenyl acetate, cis-3-hexenyl butyrate, cis-3-hexenyl caproate, cis-3-hexenyl valerate, cis-5-octen-1-ol, cis-6-nonen-1-ol, cis-rose-oxide, citral, citronellal, citronellol, cuminaldehyde, D-camphor, D-carvone, decanal, delta-decalactone, delta-dodecalactone, d-fenchone, diethyl malate, diethyl succinate, dihydrocoumarin, DL-3-methyl-2-butanol, ethyl 2-methylbutyrate, ethyl 2-trans-4-cis-decadienoate, ethyl 3-hydroxyhexanoate, ethyl acetate, ethyl acetoacetate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl phenylacetate, ethyl propionate, ethyl salicylate, ethyl trans-2-butenoate, ethyl undecanoate, ethyl valerate, ethyl(methylthio) acetate, ethyl-trans-3-hexenoate, eucalyptol, eugenol, furfural, furfuryl thioacetate, gamma-decalactone, gamma-dodecalactone, gamma-heptalactone, gamma-hexalactone, gamma-nonalactone, gamma-octalactone, gamma-terpinene, gamma-undecalactone, gamma-valerolactone, geraniol, geranyl acetone, geranyl butyrate, geranyl propionate, guaiacol, heptyl acetate, hexadecanol, hexanol, hexyl 3-methylbutanoate, hexyl acetate, hexyl butyrate, hexyl formate, hexyl isobutyrate, hexyl propionate, 3-isobutyl-2-methoxypyrazine, indole, isoamyl acetate, isoamyl alcohol, isoamyl cinnamate, isoamyl hexanoate, isoamyl isobutyrate, isoamyl isovalerate, isoamyl octanoate, isoamyl phenylacetate, isobutyl acetate, isobutyl alcohol, isobutyl butyrate, isobutyl isobutyrate, isobutyl propionate, isobutyraldehyde, isobutyric acid, isoeugenol, isovaleraldehyde, isovaleric acid, lauric aldehyde, L-carvone, limonene, linalool, linalool oxide, linalyl acetate, L-menthyl acetate, maltol, massoia lactone, methionyl acetate, methionyl butyrate, methyl acetate, methyl anthranilate, methyl benzoate, methyl cinnamate, methyl cyclopentenolone, methyl decanoate, methyl hexanoate, methyl laurate, methyl octanoate, methyl salicylate, methyl β-naphthyl ketone, methyl-2-pyrrolyl ketone, myrcene, nerolidol, nonanal, nonanoic acid, octanal, omega-pentadecalactone, p,a-dimethyl styrene, p-anisaldehyde, p-cresol, p-cymene, perillaldehyde, phenethyl 2-methylbutyrate, phenethyl acetate, phenethyl butyrate, phenethyl formate, phenethyl octanoate, phenethyl propionate, phenethyl tiglate, phenylacetaldehyde, phenylacetaldehyde dimethyl acetal, propanol, propionaldehyde, propionic acid, propyl acetate, propyl butyrate, propyl isovalerate, salicylaldehyde, terpinolene, tetrahydrolinalool, thymol, trans-2-hexen-1-al, valencene, valeraldehyde, vanillyl butyl ether, vanillyl ethyl ether, and whiskey lactone. The one or more additional VOCs can include at least 3 compounds selected from the group consisting of (1R)-(-)-myrtenal, 1-octanol, 1-octen-3-ol, 1-para-menthene-8-thiol, 2,3-pentadione, 2-heptanol, 2-heptanone, 2-isobutyl-4-methyl-1,3-dioxolane, 2-methyl-1-butanol, 2-methylbutyraldehyde, 2-nonanone, 2-pentylfuran, 2-phenylethanol, 2-undecanone, 4-ethyl guaiacol, 4-ethyl phenol, 5-ethyl-3-hydroxy-4-methyl-2(5H)-furanone, 5-methyl furfural, 6-methyl-5-hepten-2-one, acetaldehyde, acetophenone, a-terpineol, benzaldehyde, benzyl alcohol, beta-damascenone, beta-pinene, butyl acetate, butyl alcohol, butyraldehyde, cis-rose-oxide, citronellol, D-camphor, delta-decalactone, delta-dodecalactone, diethyl malate, diethyl succinate, DL-3-methyl-2-butanol, ethyl 2-methylbutyrate, ethyl 3-hydroxyhexanoate, ethyl acetate, ethyl benzoate, Ethyl butanoate, ethyl decanoate, ethyl heptanoate, ethyl hexanoate, ethyl isobutyrate, ethyl isovalerate, ethyl lactate, ethyl laurate, ethyl levulinate, ethyl nonanoate, ethyl octanoate, ethyl phenylacetate, ethyl propionate, ethyl salicylate, ethyl trans-2-butenoate, ethyl valerate, ethyl(methylthio) acetate, ethyl-trans-3-hexenoate, furfural, gamma-dodecalactone, gamma-heptalactone, gamma-hexalactone, gamma-nonalactone, gamma-octalactone, geraniol, guaiacol, heptyl acetate, hexanol, hexyl acetate, indole, isoamyl acetate, isoamyl alcohol, isoamyl hexanoate, isoamyl octanoate, isobutyl acetate, isobutyl alcohol, isobutyl propionate, isobutyraldehyde, isobutyric acid, isovaleraldehyde, isovaleric acid, limonene, methionyl acetate, methyl acetate, methyl hexanoate, methyl laurate, methyl β-naphthyl ketone, methyl-2-pyrrolyl ketone, nonanal, nonanoic acid, octanal, p-anisaldehyde, p-cresol, phenethyl acetate, phenethyl formate, phenethyl propionate, phenylacetaldehyde, propanol, propionaldehyde, propionic acid, propyl acetate, propyl butyrate, propyl isovalerate, and vanillyl ethyl ether. The one or more additional VOCs can include at least 3 compounds selected from the group consisting of 1-octanol, 2,3-pentadione, 2-heptanone, 2-methyl-1-butanol, 2-nonanone, 2-phenylethanol, 5-methyl furfural, acetaldehyde, benzaldehyde, benzyl alcohol, butyl acetate, butyl alcohol, butyraldehyde, citronellol, diethyl succinate, ethyl acetate, ethyl butanoate, ethyl hexanoate, ethyl isobutyrate, ethyl lactate, ethyl octanoate, ethyl propionate, ethyl trans-2-butenoate, ethyl(methylthio) acetate, furfural, gamma-heptalactone, gamma-hexalactone, gamma-octalactone, hexanol, isoamyl acetate, isoamyl alcohol, isoamyl hexanoate, isobutyl acetate, isobutyl alcohol, isobutyraldehyde, isobutyric acid, isovaleric acid, methionyl acetate, methyl acetate, nonanoic acid, phenethyl acetate, phenylacetaldehyde, propanol, propionaldehyde, propionic acid, propyl acetate, propyl butyrate. The one or more additional VOCs can include at least 3 compounds selected from the group consisting of 2-methyl-1-butanol, 2-phenylethanol, acetaldehyde, butyl alcohol, ethyl acetate, ethyl butanoate, ethyl hexanoate, ethyl octanoate, furfural, isoamyl acetate, isoamyl alcohol, isobutyl alcohol, phenethyl acetate, and propanol.

Implementations can further include one or more of the following features. The sake replica can include 2-phenylethanol in an amount of less than about 28 mg/L. The sake replica can include propanol in an amount of less than about 39 mg/L. The sake replica can include ethyl butanoate in an amount of at least about 0.17 mg/L. The sake replica can include ethyl octanoate in an amount of at least about 3.4 mg/L. The sake replica can include furfural in an amount of at least about 0.45 mg/L. Less than about 15.5% by mass of the one or more additional VOCs can be 2-phenylethanol. Less than about 22.5% by mass of the one or more additional VOCs can be propanol. At least about 0.12% by mass of the one or more additional VOCs can be ethyl butanoate. At least about 0.31% by mass of the one or more additional VOCs can be furfural.

Implementations can further include one or more of the following features. The one or more additional VOCs can include one or more of butyl formate, ethyl octanoate, ethyl propionate, ethyl-2-methylbutyrate, isoamyl acetate, isoamyl alcohol, and isobutanol. The one or more additional VOCs can include two or more of butyl formate, ethyl octanoate, ethyl propionate, ethyl-2-methylbutyrate, isoamyl acetate, isoamyl alcohol, and isobutanol. The one or more additional VOCs can include three or more of butyl formate, ethyl octanoate, ethyl propionate, ethyl-2-methylbutyrate, isoamyl acetate, isoamyl alcohol, and isobutanol. The one or more additional VOCs can include four or more of butyl formate, ethyl octanoate, ethyl propionate, ethyl-2-methylbutyrate, isoamyl acetate, isoamyl alcohol, and isobutanol. The one or more additional VOCs can include five or more of butyl formate, ethyl octanoate, ethyl propionate, ethyl-2-methylbutyrate, isoamyl acetate, isoamyl alcohol, and isobutanol. The one or more additional VOCs can include six or more of butyl formate, ethyl octanoate, ethyl propionate, ethyl-2-methylbutyrate, isoamyl acetate, isoamyl alcohol, and isobutanol. The one or more additional VOCs can include butyl formate, ethyl octanoate, ethyl propionate, ethyl-2-methylbutyrate, isoamyl acetate, isoamyl alcohol, and isobutanol. The one or more additional VOCs can include no more than 6 of butyl formate, ethyl octanoate, ethyl propionate, ethyl-2-methylbutyrate, isoamyl acetate, isoamyl alcohol, and isobutanol. The one or more additional VOCs can include no more than 5 of butyl formate, ethyl octanoate, ethyl propionate, ethyl-2-methylbutyrate, isoamyl acetate, isoamyl alcohol, and isobutanol. The one or more additional VOCs can include no more than 4 of butyl formate, ethyl octanoate, ethyl propionate, ethyl-2-methylbutyrate, isoamyl acetate, isoamyl alcohol, and isobutanol.

Implementations can further include one or more of the following features. The additional VOCs can have less than 90% identity to the VOCs in a single reference sake. The additional VOCs can have less than 70% identity to the VOCs in a single reference sake. The additional VOCs can have less than 50% identity to the VOCs in a single reference sake. The additional VOCs can have less than 30% identity to the VOCs in a single reference sake. The additional VOCs can have less than 20% identity to the VOCs in a single reference sake. The sake replica can include at least 7 additional VOCs and wherein no more than 6 of the additional VOCs can be found in a single reference sake. The sake replica can include at least 8 additional VOCs and wherein no more than 7 of the additional VOCs can be found in a single reference sake. The sake replica can include at least 9 additional VOCs and wherein no more than 8 of the additional VOCs can be found in a single reference sake. The sake replica can include at least 10 additional VOCs and wherein no more than 9 of the additional VOCs can be found in a single reference sake. The sake replica can include one or more additional VOCs that can be not present in a corresponding traditional sake.

Implementations can further include one or more of the following features. The one or more non-volatile compounds can include a sugar, a sugar alcohol, or a combination thereof, an amino acid, an amino acid derivative, or a combination thereof, a pH-modifying salt, an organic acid, optionally, a nucleobase, a nucleotide, or a combination thereof, optionally, a nitrogen-containing heterocycle, and optionally, a phenolic compound. The one or more non-volatile compounds can include a sugar, a sugar alcohol, or a combination thereof. The sugar, sugar alcohol, or combination thereof can be selected from the group consisting of arabitol, fructose, fucose, galactose, glucosamine, glucose, mannitol, mannose, inositol, rhamnose, ribose, sorbitol, xylose, and mixtures thereof. The sugar, sugar alcohol, or combination thereof can be selected from the group consisting of fructose, glucose, sorbitol, fucose, galactose, glucosamine, mannitol, mannose, rhamnose, xylose, arabitol, ribose, and mixtures thereof. The sugar, sugar alcohol, or combination thereof can be selected from the group consisting of fructose, glucose, sorbitol, and mixtures thereof. The one or more non-volatile compounds can include an amino acid, amino acid derivative, or combination thereof. The amino acid, amino acid derivative, or combination thereof can be selected from the group consisting of alanine, arginine, asparagine, aspartic acid, beta-alanine, betaine, carnitine, carnosine, citrulline, cysteine, cystine, GABA, glutamic acid, glutamine, glycine, histidine, homoserine, isoleucine, kynurenic acid, leucine, lysine, methionine, ornithine, phenylalanine, proline, serine, threonine, trans-4-hydroxyproline, tryptamine, tryptophan, tyramine, tyrosine, valine, and mixtures thereof. The amino acid, amino acid derivative, or combination thereof can be selected from the group consisting of arginine, glutamic acid, isoleucine, lysine, phenylalanine, threonine, alanine, asparagine, beta-alanine, carnitine, GABA, glutamine, glycine, histidine, leucine, methionine, ornithine, proline, serine, tryptophan, tyrosine, valine, betaine, carnosine, citrulline, homoserine, trans-4-hydroxyproline, tyramine, kynurenic acid, and mixtures thereof. The amino acid, amino acid derivative, or combination thereof can be selected from the group consisting of alanine, arginine, glutamic acid, isoleucine, lysine, phenylalanine, threonine, and mixtures thereof. The one or more non-volatile compounds can include a pH-modifying salt. The pH-modifying can include potassium hydroxide (KOH). The one or more non-volatile compounds can include an organic acid. The organic acid can be selected from the group consisting of 2-furoic acid, 2-isopropylmalic acid, 4-guanidinobutyric acid, adipic acid, camphoric acid, cinnamic acid, citric acid, D-glucuronic acid, fumaric acid, lactic acid, malic acid, pantothenic acid, pyruvic acid, quinic acid, sorbic acid, succinic acid, tartaric acid, and mixtures thereof. The organic acid can be selected from the group consisting of citric acid, D-glucuronic acid, fumaric acid, malic acid, succinic acid, tartaric acid, cinnamic acid, pantothenic acid, 2-furoic acid, 2-isopropylmalic acid, 4-guanidinobutyric acid, lactic acid, pyruvic acid, quinic acid, adipic acid, and mixtures thereof. The organic acid can be selected from the group consisting of cinnamic acid, citric acid, D-glucuronic acid, fumaric acid, malic acid, succinic acid, tartaric acid, and mixtures thereof. The one or more non-volatile compounds can include a nucleobase, nucleotide, or a combination thereof. The nucleobase, nucleotide, or combination thereof can be selected from the group consisting of adenine, cytidine, cytosine, guanine, uracil, and mixtures thereof. The one or more non-volatile compounds can include a nitrogen-containing heterocycle. The nitrogen-containing heterocycle can be selected from the group consisting of 2,3,5,6-tetramethylpyrazine, 2,3,5-trimethylpyrazine, 2,3-dimethylpyrazine, methyl-2-pyrrolyl ketone, pipecolinic acid, piperine, pyridine, pyridoxine, and mixtures thereof. The nitrogen-containing heterocycle can be selected from the group consisting of 2,3,5,6-tetramethylpyrazine, pyridoxine, pipecolinic acid, piperine, and mixtures thereof. The one or more non-volatile compounds can include a phenolic compound. The phenolic compound can be selected from the group consisting of 3,4-dihydroxybenzoic acid, acetovanillone, caffeic acid, catechin, coumaric acid, ellagic acid, epicatechin, epicatechin gallate, gallic acid, hesperetin, methyl gallate, polydatin, propyl gallate, quercetin, resveratrol, rutin, salicylic acid, sinapinic acid, syringaldehyde, syringic acid, trans-ferulic acid, vanillic acid, vanillin, and mixtures thereof. The phenolic compound can be selected from the group consisting of salicylic acid, vanillin, 3,4-dihydroxybenzoic acid, trans-ferulic acid, coumaric acid, vanillic acid, rutin, acetovanillone, polydatin, syringic acid, and mixtures thereof.

Implementations can further include one or more of the following features. The one or more non-volatile compounds can include at least 5 compounds selected from the group consisting of 2,3,5,6-tetramethylpyrazine, 2,3,5-trimethylpyrazine, 2,3-dimethylpyrazine, 2-furoic acid, 2-isopropylmalic acid, 3,4-dihydroxybenzoic acid, 4-guanidinobutyric acid, acetovanillone, adenine, adipic acid, alanine, arabitol, arginine, asparagine, aspartic acid, beta-alanine, betaine, caffeic acid, camphoric acid, carnitine, carnosine, catechin, choline, choline bitartrate, cinnamic acid, citric acid, citrulline, coumaric acid, cysteine, cystine, cytidine, cytosine, D-glucuronic acid, ellagic acid, epicatechin, epicatechin gallate, fructose, fucose, fumaric acid, GABA, galactose, gallic acid, glucosamine, glucose, glutamic acid, glutamine, glycine, guanine, hesperetin, histidine, homoserine, isoleucine, KOH, kynurenic acid, lactic acid, leucine, lysine, malic acid, mannitol, mannose, methionine, methyl Gallate, methyl-2-pyrrolyl ketone, inositol, ornithine, pantothenic acid, phenylalanine, pipecolinic acid, piperine, polydatin, proline, propyl gallate, pyridine, pyridoxine, pyruvic acid, quercetin, quinic acid, resveratrol, rhamnose, ribose, rutin, salicylic acid, serine, sinapinic acid, sorbic acid, sorbitol, succinic acid, syringaldehyde, syringic acid, tartaric acid, threonine, trans-4-hydroxyproline, trans-ferulic acid, tryptamine, tryptophan, tyramine, tyrosine, uracil, valine, vanillic acid, vanillin, and xylose. The one or more non-volatile compounds can include at least 5 compounds selected from the group consisting of 2,3,5,6-tetramethylpyrazine, 2-furoic acid, 2-isopropylmalic acid, 3,4-dihydroxybenzoic acid, 4-guanidinobutyric acid, acetovanillone, adenine, adipic acid, alanine, arabitol, arginine, asparagine, beta-alanine, betaine, carnitine, carnosine, choline, choline bitartrate, cinnamic acid, citric acid, citrulline, coumaric acid, cytidine, cytosine, D-glucuronic acid, fructose, fucose, fumaric acid, GABA, galactose, glucosamine, glucose, glutamic acid, glutamine, glycine, guanine, histidine, homoserine, isoleucine, KOH, kynurenic acid, lactic acid, leucine, lysine, malic acid, mannitol, mannose, methionine, ornithine, pantothenic acid, phenylalanine, pipecolinic acid, piperine, polydatin, proline, pyridoxine, pyruvic acid, quinic acid, rhamnose, ribose, rutin, salicylic acid, serine, sorbitol, succinic acid, syringic acid, tartaric acid, threonine, trans-4-hydroxyproline, trans-ferulic acid, tryptophan, tyramine, tyrosine, uracil, valine, vanillic acid, vanillin, and xylose. The one or more non-volatile compounds can include at least 5 compounds selected from the group consisting of 2,3,5,6-tetramethylpyrazine, 4-guanidinobutyric acid, alanine, arginine, choline bitartrate, cinnamic acid, citric acid, D-glucuronic acid, fructose, fumaric acid, glucose, glutamic acid, guanine, isoleucine, KOH, lysine, malic acid, phenylalanine, pyridoxine, salicylic acid, sorbitol, succinic acid, tartaric acid, and threonine. The one or more non-volatile compounds can include at least 5 compounds selected from the group consisting of alanine, arginine, choline bitartrate, cinnamic acid, citric acid, D-glucuronic acid, fructose, fumaric acid, glucose, glutamic acid, isoleucine, KOH, lysine, malic acid, phenylalanine, sorbitol, succinic acid, tartaric acid, threonine.

Implementations can further include one or more of the following features. The sake replica can include less than about 1.4 mg/L of fumaric acid. The sake replica can include at least about 38 mg/L of phenylalanine. The sake replica can include at least about 25 mg/L of fructose. The one or more non-volatile compounds can have less than 90% identity to the non-volatile compounds in a single reference sake. The one or more non-volatile compounds can have less than 70% identity to the non-volatile compounds in a single reference sake. The one or more non-volatile compounds can have less than 50% identity to the non-volatile compounds in a single reference sake. The one or more non-volatile compounds can have less than 30% identity to the non-volatile compounds in a single reference sake. The sake replica can include at least 16 additional non-volatile compounds and wherein no more than 15 of the additional non-volatile compounds can be found in a single reference sake. The sake replica can include at least 18 additional non-volatile compounds and wherein no more than 15 of the additional non-volatile compounds can be found in a single reference sake. The sake replica can include at least 20 additional non-volatile compounds and wherein no more than 15 of the additional non-volatile compounds can be found in a single reference sake.

Implmementations can further include the following feature. The sake replica can lack one or more of Escherichia coli, Salmonella sp., Brettanomyces sp., Lactobacillales, Saccharomyces sp., Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, Verticillium psalliotae, mold, mildew, rot, insects, insect eggs, insect filth, rodent filth, mammalian excreta, insect lecithins, hydrogen sulfide, hydrogen disulfide, 2,4,6-trichloranisole, 2,4,6,-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, and dichloromethane.

In another aspect, provided herein is a sake replica including ethanol, water, and one or more additional VOCs, wherein the additional VOCs include 2-methyl-1-butanol, 2-phenylethanol, acetaldehyde, butyl alcohol, ethyl acetate, ethyl butanoate, ethyl hexanoate, ethyl octanoate, furfural, isoamyl acetate, isoamyl alcohol, isobutyl alcohol, phenethyl acetate, and propanol. In some embodiments, the sake replica can further include one or more non-volatile compounds, wherein the non-volatile compounds include alanine, arginine, choline bitartrate, cinnamic acid, citric acid, D-glucuronic acid, fructose, fumaric acid, glucose, glutamic acid, isoleucine, KOH, lysine, malic acid, phenylalanine, sorbitol, succinic acid, tartaric acid, and threonine.

In another aspect, provided herein is a sake replica including ethanol, water, and one or more non-volatile compounds, wherein the non-volatile compounds include alanine, arginine, choline bitartrate, cinnamic acid, citric acid, D-glucuronic acid, fructose, fumaric acid, glucose, glutamic acid, isoleucine, KOH, lysine, malic acid, phenylalanine, sorbitol, succinic acid, tartaric acid, and threonine. In some embodiments, the sake replica can further include one or more additional VOCs, wherein the additional VOCs include 2-methyl-1-butanol, 2-phenylethanol, acetaldehyde, butyl alcohol, ethyl acetate, ethyl butanoate, ethyl hexanoate, ethyl octanoate, furfural, isoamyl acetate, isoamyl alcohol, isobutyl alcohol, phenethyl acetate, and propanol.

In another aspect, provided herein is a method of making a sake replica, the method including combining ingredients including water, ethanol, five or more additional VOCs, wherein at least five of the five or more additional VOCs can be provided as separate ingredients, and five or more non-volatile compounds, wherein at least five of the five or more non-volatile compounds can be provided as separate ingredients.

Implementations can include one or more of the following features. The method can include using 10 or more additional VOCs, wherein at least 10 of the 10 or more additional VOCs can be provided as separate ingredients. The method can include using 10 or more non-volatile compounds, wherein at least 10 of the 10 or more non-volatile compounds can be provided as separate ingredients. The additional VOCs can include one or more VOCs that are not present in a corresponding traditional sake. The one or more VOCs that are not present in a corresponding traditional sake can be selected from the group consisting of 1,4-cineole, 1-decanol, 2,4,6-trimethylphenol, 2-acetyl-1-methylpyrrole, 2-ethyl-3(5 or 6)-dimethylpyrazine , 2-ethyl-3-methylpyrazine, 2-isopropyl-4-methyl thiazole, 2-methoxy-3-(1-methylpropyl) pyrazine, 2-methoxy-4-methylphenol, 2-methoxy-4-propylphenol, 2-methylbutyl acetate, 2-methylbutyl isovalerate, 2-nonanol, 3-carene, 3-methylthio hexyl acetate, 3-phenylpropanal, 4,5,6,7-tetrahydro-3,6-dimethylbenzofuran, 4-carvomenthenol, 4-mercapto-4-methyl-2-pentanone, 5-methyl-2-phenyl-2-hexenal, acetoin, a-ionone, allyl heptanoate, alpha-pinene, amyl alcohol, amyl butyrate, anisyl acetate, anisyl butyrate, b-caryophellene, benzyl acetate, benzyl benzoate, benzyl butyrate, benzyl formate, benzyl propionate, beta-ionone, butyl butyryllactate, butyl formate, carvacrol, cinnamaldehyde, cis-3-hexenyl acetate, cis-3-hexenyl butyrate, cis-3-hexenyl valerate, cis-5-octen-1-ol, cis-6-nonen-1-ol, citral, citronellal, cuminaldehyde, D-carvone, decanal, d-fenchone, ethyl 2-trans-4-cis-decadienoate, ethyl cinnamate, ethyl myristate, ethyl undecanoate, eucalyptol, eugenol, furfuryl thioacetate, gamma-decalactone, gamma-terpinene, gamma-undecalactone, gamma-valerolactone, geranyl acetone, hexadecanol, hexyl 3-methylbutanoate, hexyl isobutyrate, 3-isobutyl-2-methoxypyrazine, isoamyl cinnamate, isoamyl isobutyrate, isoamyl isovalerate, isoamyl phenylacetate, isobutyl isobutyrate, isoeugenol, L-carvone, linalool, linalool oxide, linalyl acetate, L-menthyl acetate, maltol, massoia lactone, methyl anthranilate, methyl benzoate, methyl cinnamate, methyl cyclopentenolone, methyl decanoate, methyl octanoate, methyl salicylate, myrcene, nerolidol, omega-pentadecalactone, p,a-dimethylstyrene, p-cymene, perillaldehyde, phenethyl 2-methylbutyrate, phenethyl butyrate, phenethyl octanoate, phenethyl tiglate, phenylacetaldehyde dimethyl acetal, salicylaldehyde, tetrahydrolinalool, thymol, trans-2-hexen-1-al, valencene, valeraldehyde, vanillyl butyl ether, and whiskey lactone. The additional VOCs can not include one or more VOCs that is present in a corresponding traditional sake. The one or more VOCs that is present in a corresponding traditional sake can be selected from the group consisting of 1-octanol, 2,3-pentadione, 2-heptanone, 2-nonanone, 5-methyl furfural, benzaldehyde, benzyl alcohol, butyl acetate, butyraldehyde, citronellol, diethyl succinate, ethyl isobutyrate, ethyl lactate, ethyl propionate, ethyl trans-2-butenoate, ethyl(methylthio) acetate, gamma-heptalactone, gamma-hexalactone, gamma-octalactone, hexanol, isoamyl hexanoate, isobutyl acetate, isobutyraldehyde, isobutyric acid, isovaleric acid, methionyl acetate, methyl acetate, nonanoic acid, phenylacetaldehyde, propionaldehyde, propionic acid, propyl acetate, and propyl butyrate. The non-volatile compounds can include one or more non-volatile compounds that can be not present in a corresponding traditional sake. The one or more non-volatile compounds that is not present in a corresponding traditional sake can be selected from the group consisting of 2,3,5-trimethylpyrazine, 2,3-dimethylpyrazine, aspartic acid, caffeic acid, camphoric acid, catechin, cinnamic acid, cysteine, cystine, ellagic acid, epicatechin, epicatechin gallate, gallic acid, hesperetin, methyl gallate, methyl-2-pyrrolyl ketone, inositol, propyl gallate, pyridine, quercetin, resveratrol, sinapinic acid, sorbic acid, syringaldehyde, and tryptamine. The non-volatile compounds can not include one or more non-volatile compounds that is present in a corresponding traditional sake. The one or more non-volatile compounds that is present in a corresponding traditional sake can be selected from the group consisting of 2,3,5,6-tetramethylpyrazine, 2-furoic acid, 2-isopropylmalic acid, 3,4-dihydroxybenzoic acid, 4-guanidinobutyric acid, asparagine, beta-alanine, carnitine, fucose, GABA, galactose, glucosamine, glutamine, glycine, guanine, histidine, lactic acid, leucine, mannitol, mannose, methionine, ornithine, proline, pyridoxine, pyruvic acid, quinic acid, rhamnose, salicylic acid, serine, tryptophan, tyrosine, valine, and xylose. The additional VOCs can include 2-methyl-1-butanol, 2-phenylethanol, acetaldehyde, butyl alcohol, ethyl acetate, ethyl butanoate, ethyl hexanoate, ethyl octanoate, furfural, isoamyl acetate, isoamyl alcohol, isobutyl alcohol, phenethyl acetate, and propanol. The non-volatile compounds can include alanine, arginine, choline bitartrate, cinnamic acid, citric acid, D-glucuronic acid, fructose, fumaric acid, glucose, glutamic acid, isoleucine, KOH, lysine, malic acid, phenylalanine, sorbitol, succinic acid, tartaric acid, and threonine.

In another aspect, provided herein is a sake replica produced by the any of the methods provided herein. In some embodiments, a sake replica can be any of the sake replicas provided herein.

In another aspect, provided herein is a method of sake replica concentrate, the method including combining ethanol, water, and one or more additional VOCs, wherein at least one of the one or more additional VOCs can be present in a concentration of at least about 2-fold the concentration of the same VOC in a corresponding traditional sake.

Implementations can include one or more of the following features. The method can include using 5 or more additional VOCs, wherein at least 5 of the 5 or more additional VOCs can be provided as separate ingredients. The method can include using 10 or more additional VOCs, wherein at least 10 of the 10 or more additional VOCs can be provided as separate ingredients. The additional VOCs can include one or more VOCs that is not present in a corresponding traditional sake. The one or more VOCs that is not present in a corresponding traditional sake can be selected from the group consisting of 1,4-cineole, 1-decanol, 2,4,6-trimethylphenol, 2-acetyl-1-methylpyrrole, 2-ethyl-3(5 or 6)-dimethylpyrazine , 2-ethyl-3-methylpyrazine, 2-isopropyl-4-methyl thiazole, 2-methoxy-3 -(1-methylpropyl) pyrazine, 2-methoxy-4-methylphenol, 2-methoxy-4-propylphenol, 2-methylbutyl acetate, 2-methylbutyl isovalerate, 2-nonanol, 3-carene, 3-methylthio hexyl acetate, 3 -phenylpropanal, 4,5,6,7-tetrahydro-3,6-dimethylbenzofuran, 4-carvomenthenol, 4-mercapto-4-methyl-2-pentanone, 5-methyl-2-phenyl-2-hexenal, acetoin, a-ionone, allyl heptanoate, alpha-pinene, amyl alcohol, amyl butyrate, anisyl acetate, anisyl butyrate, b-caryophellene, benzyl acetate, benzyl benzoate, benzyl butyrate, benzyl formate, benzyl propionate, beta-ionone, butyl butyryllactate, butyl formate, carvacrol, cinnamaldehyde, cis-3-hexenyl acetate, cis-3-hexenyl butyrate, cis-3-hexenyl valerate, cis-5-octen-1-ol, cis-6-nonen-1-ol, citral, citronellal, cuminaldehyde, D-carvone, decanal, d-fenchone, ethyl 2-trans-4-cis-decadienoate, ethyl cinnamate, ethyl myristate, ethyl undecanoate, eucalyptol, eugenol, furfuryl thioacetate, gamma-decalactone, gamma-terpinene, gamma-undecalactone, gamma-valerolactone, geranyl acetone, hexadecanol, hexyl 3-methylbutanoate, hexyl isobutyrate, 3-isobutyl-2-methoxypyrazine, isoamyl cinnamate, isoamyl isobutyrate, isoamyl isovalerate, isoamyl phenylacetate, isobutyl isobutyrate, isoeugenol, L-carvone, linalool, linalool oxide, linalyl acetate, L-menthyl acetate, maltol, massoia lactone, methyl anthranilate, methyl benzoate, methyl cinnamate, methyl cyclopentenolone, methyl decanoate, methyl octanoate, methyl salicylate, myrcene, nerolidol, omega-pentadecalactone, p,a-dimethylstyrene, p-cymene, perillaldehyde, phenethyl 2-methylbutyrate, phenethyl butyrate, phenethyl octanoate, phenethyl tiglate, phenylacetaldehyde dimethyl acetal, salicylaldehyde, tetrahydrolinalool, thymol, trans-2-hexen-1-al, valencene, valeraldehyde, vanillyl butyl ether, and whiskey lactone. The additional VOCs can not include one or more VOCs that is present in a corresponding traditional sake. The one or more VOCs that is present in a corresponding traditional sake can be selected from the group consisting of 1-octanol, 2,3-pentadione, 2-heptanone, 2-nonanone, 5-methyl furfural, benzaldehyde, benzyl alcohol, butyl acetate, butyraldehyde, citronellol, diethyl succinate, ethyl isobutyrate, ethyl lactate, ethyl propionate, ethyl trans-2-butenoate, ethyl(methylthio) acetate, gamma-heptalactone, gamma-hexalactone, gamma-octalactone, hexanol, isoamyl hexanoate, isobutyl acetate, isobutyraldehyde, isobutyric acid, isovaleric acid, methionyl acetate, methyl acetate, nonanoic acid, phenylacetaldehyde, propionaldehyde, propionic acid, propyl acetate, and propyl butyrate. The additional VOCs can include 2-methyl-1-butanol, 2-phenylethanol, acetaldehyde, butyl alcohol, ethyl acetate, ethyl butanoate, ethyl hexanoate, ethyl octanoate, furfural, isoamyl acetate, isoamyl alcohol, isobutyl alcohol, phenethyl acetate, and propanol. The method can further include using one or more non-volatile compounds. The method can include using 5 or more non-volatile compounds, wherein at least 5 of the 5 or more non-volatile compounds can be provided as separate ingredients. The method can include using 10 or more non-volatile compounds, wherein at least 10 of the 10 or more non-volatile compounds can be provided as separate ingredients. The non-volatile compounds can include one or more non-volatile compounds that is not present in a corresponding traditional sake. The one or more non-volatile compounds that is not present in a corresponding traditional sake can be selected from the group consisting of 2,3,5-trimethylpyrazine, 2,3-dimethylpyrazine, aspartic acid, caffeic acid, camphoric acid, catechin, cinnamic acid, cysteine, cystine, ellagic acid, epicatechin, epicatechin gallate, gallic acid, hesperetin, methyl gallate, methyl-2-pyrrolyl ketone, inositol, propyl gallate, pyridine, quercetin, resveratrol, sinapinic acid, sorbic acid, syringaldehyde, and tryptamine. The non-volatile compounds can not include one or more non-volatile compounds that is present in a corresponding traditional sake. The one or more non-volatile compounds that is present in a corresponding traditional sake can be selected from the group consisting of 2,3,5,6-tetramethylpyrazine, 2-furoic acid, 2-isopropylmalic acid, 3,4-dihydroxybenzoic acid, 4-guanidinobutyric acid, asparagine, beta-alanine, carnitine, fucose, GABA, galactose, glucosamine, glutamine, glycine, guanine, histidine, lactic acid, leucine, mannitol, mannose, methionine, ornithine, proline, pyridoxine, pyruvic acid, quinic acid, rhamnose, salicylic acid, serine, tryptophan, tyrosine, valine, and xylose. The non-volatile compounds include alanine, arginine, choline bitartrate, cinnamic acid, citric acid, D-glucuronic acid, fructose, fumaric acid, glucose, glutamic acid, isoleucine, KOH, lysine, malic acid, phenylalanine, sorbitol, succinic acid, tartaric acid, and threonine.

In another aspect, also provided herein is a sake replica concentrate produced by any of the methods provided herein. In some embodiments, the sake replica concentrate, when diluted, can be any of the sake replicas provided herein.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the description below. Other features, objects, and advantages of the invention will be apparent from the description and from the claims.

### DETAILED DESCRIPTION

This document provides sake replicas, as well as methods for making alcoholic beverage replicas by combining water and ethanol with individual VOCs and non-volatile organic compounds. The sake replicas described herein have characteristics—including taste, aroma, mouthfeel, and appearance—of traditionally generated sakes, and are meant to be consumed and enjoyed in the same manner as traditional sakes.

As used herein, the terms “traditional” and “reference” sakes refer to sakes produced through standard fermentation that include the fermentation of rice plant matter. “Traditionally-produced” sakes are sakes that are generated using standard processes.

In some embodiments, a sake replica can consist of the ingredients included in a particular list, or can have a VOC content (or non-volatile compound content) that consists of the VOCs or non-volatile compounds included in a particular list. Further, a sake replica can consist essentially of the ingredients included in a particular list, or can have a VOC content (or non-volatile compound content) that consists essentially of the VOCs or non-volatile compounds that are included in a particular list. By “consisting essentially of” is meant that a sake replica contains specified ingredients/VOCs/non-volatile compounds, and can contain additional ingredients/VOCs/non-volatile compounds that do not materially affect the basic and novel characteristics of the sake replica.

In general, the sake replicas include the following components, or classes of components:

a) a source of water, either pure or with mineral content present to improve flavor;

b) a source of distilled ethanol with a concentration between about 20% and 100% weight by volume;

c) one or more VOCs; and

d) one or more non-volatile compounds.

Water is the main component of the replicas, acting as a solvent for all the other ingredients. The ethanol component provides the alcoholic content to the replicas. The VOCs can provide both aroma and flavor to the sake, including fruity, floral, earthy, herbaceous, oak, yeast, spice, and/or mineral aromas and flavors. The non-volatile components can provide acidity and much of the flavor, aftertaste, and mouthfeel perception of the replicas.

In some embodiments, a sake replica can include water, ethanol, and (a) one or more additional VOCs (i.e., VOCs in addition to ethanol), where the one or more additional VOCs are not present in a corresponding reference sake (also sometimes herein called a corresponding traditional sake); (b) one or more additional VOCs, where the one or more additional VOCs do not include one or more VOCs that are present in a corresponding reference sake; (c) one or more non-volatile compounds, where the one or more non-volatile compounds are not present in a corresponding reference sake; (d) one or more non-volatile compounds, where the one or more non-volatile compounds do not include one or more non-volatile compounds that are present in a corresponding reference sake; or (e) any combination of (a), (b), (c), and (d) [(a) and (b); (a) and (c); (a) and (d); (b) and (c); (b) and (d); (c) and (d); (a), (b), and (c); (a), (b), and (d); (a), (c), and (d); (b), (c), and (d); or (a), (b), (c), and (d)].

As used herein, a “corresponding reference sake” can be a single type, a single brand, or a single bottle of traditionally-produced sake that a sake replica as described herein is intended to replicate. In some cases, a single type, single brand, or single bottle of traditionally-produced sake can be a blend of two or more (e.g., two, three, four, or more than four) sakes. For example, if the sake replica is meant to be the same as a Junmai-shu sake, then a Junmai-shu sake would be a corresponding reference sake.

In general, the sake replicas provided herein can have an ethanol content of about 10% to about 25% (v/v) (e.g., about 10% to about 15%, about 15% to about 20%, about 20% to about 25%, about 12% to about 20%, about 14% to about 18%, about 15% to about 23%, about 16% to about 22%, about 17% to about 21%, or about 18% to about 20% (v/v)).

It is to be noted, however, that the ethanol component can be omitted in order to generate a “non-alcoholic” version of a sake replica. In such ethanol-free embodiments, the amounts of the other components may be changed, and the ethanol may be replaced at least in part by water.

The additional VOCs present in a sake replica can include compounds that fall into several categories, including esters, acids, alcohols, aldehydes/ketones, terpenes/isoprenoids, phenols, lactones, amines/pyrazines, thiols/thiazoles/sulfides, ethers, acetals, and furans. In some embodiments, for example, a sake replica can include an ester and an alcohol (in addition to ethanol). In some embodiments, for example, a sake replica can contain VOCs that include an ester, an alcohol, and an aldehyde, a ketone, or both. It will be appreciated that any and all stereoisomers can be used when no stereochemistry is specified.

Esters, including ethyl, methyl, and acetate esters, can contribute fruity and floral characteristics to a sake. Esters that may be used in a sake replica include, without limitation, one or more of, 2-methylbutyl acetate, 2-methylbutyl isovalerate, 3-heptyl acetate, 3-methylthio hexyl acetate, allyl heptanoate, allyl hexanoate, amyl butyrate, anisyl acetate, anisyl butyrate, benzyl acetate, benzyl benzoate, benzyl butyrate, benzyl formate, benzyl propionate, butyl acetate, butyl butyryllactate, butyl formate, cis-3-hexenyl acetate, cis-3-hexenyl butyrate, cis-3-hexenyl caproate, cis-3-hexenyl valerate, diethyl malate, diethyl succinate, ethyl 2-methylbutyrate, ethyl 2-trans-4-cis-decadienoate, ethyl 3-hydroxyhexanoate, ethyl acetate, ethyl acetoacetate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl phenylacetate, ethyl propionate, ethyl salicylate, ethyl trans-2-butenoate, ethyl undecanoate, ethyl valerate, ethyl(methylthio) acetate, ethyl-trans-3-hexenoate, geranyl butyrate, geranyl propionate, heptyl acetate, hexyl 3-methylbutanoate, hexyl acetate, hexyl butyrate, hexyl formate, hexyl isobutyrate, hexyl propionate, isoamyl acetate, isoamyl cinnamate, isoamyl hexanoate, isoamyl isobutyrate, isoamyl isovalerate, isoamyl octanoate, isoamyl phenylacetate, isobutyl acetate, isobutyl butyrate, isobutyl isobutyrate, isobutyl propionate, linalyl acetate, methionyl acetate (3-methylthio-propylacetate), methionyl butyrate, methyl acetate, methyl anthranilate, methyl benzoate, methyl cinnamate, methyl decanoate, methyl hexanoate, methyl laurate, methyl octanoate, methyl salicylate, phenethyl 2-methylbutyrate, phenethyl acetate, phenethyl butyrate, phenethyl formate, phenethyl octanoate, phenethyl propionate, phenethyl tiglate, propyl acetate, propyl butyrate, propyl isovalerate, and mixtures thereof. Any appropriate number of esters can be used (for example, 1 to 100, 1 to 50, 1 to 25, 1 to 10, 1 to 5, 5 to 100, 5 to 50, 5 to 25, 5 to 10, 10 to 100, 10 to 50, 10 to 25, 25 to 50, or 25 to 100 esters). Esters can make up any suitable portion of the additional VOCs. In some embodiments, the one or more esters can be present in a total amount of about 6 mg/L to about 95 mg/L (e.g., about 6 to about 10 mg/L, about 10 to about 20 mg/L, about 20 to about 30 mg/L, about 30 to about 40 mg/L, about 40 to about 50 mg/L, about 50 to about 60 mg/L, about 60 to about 70 mg/L, about 70 to about 80 mg/L, about 80 to about 90 mg/L, about 80 to about 95 mg/L, about 40 to about 95 mg/L, about 50 to about 95 mg/L, about 60 to about 80 mg/L, or about 70 to about 95 mg/L). In some embodiments, the one or more esters can be present in an amount of at least about 41 mg/L (e.g., at least about 42 mg/L, 43 mg/L, 44 mg/L, 45 mg/L, 50 mg/L, 55 mg/L, 60 mg/L, 65 mg/L, 70 mg/L, 75 mg/L, 80 mg/L, 85 mg/L, or 90 mg/L). In some embodiments, about 2% to about 40% by mass (e.g., about 2% to about 10%, about 10% to about 20%, about 20% to about 30%, about 30% to about 40%, about 10% to about 30%, or about 20% to about 40% by mass) of the one or more additional VOCs can be the one or more esters.

In some embodiments, a sake replica can include at least one ester (e.g., at least 2, at least 5, at least 10, at least 20, at least 30, 1 to 5, 1 to 10, 1 to 25, 5 to 10, 5 to 25, or 10 to 25 esters) selected from the group consisting of butyl acetate, diethyl malate, diethyl succinate, ethyl 2-methylbutyrate, ethyl 3-hydroxyhexanoate, ethyl acetate, ethyl benzoate, ethyl butanoate, ethyl decanoate, ethyl heptanoate, ethyl hexanoate, ethyl isobutyrate, ethyl isovalerate, ethyl lactate, ethyl laurate, ethyl levulinate, ethyl nonanoate, ethyl octanoate, ethyl phenylacetate, ethyl propionate, ethyl salicylate, ethyl trans-2-butenoate, ethyl valerate, ethyl(methylthio) acetate, ethyl-trans-3-hexenoate, heptyl acetate, hexyl acetate, isoamyl acetate, isoamyl hexanoate, isoamyl octanoate, isobutyl acetate, isobutyl propionate, methionyl acetate, methyl acetate, methyl hexanoate, methyl laurate, phenethyl acetate, phenethyl formate, phenethyl propionate, propyl acetate, propyl butyrate, propyl isovalerate, and mixtures thereof.

In some embodiments, a sake replica can include at least one ester (e.g., at least 2, at least 3, at least 4, at least 5, or 1, 2, 3, 4, 5, or 6 esters) selected from the group consisting of ethyl acetate, ethyl butanoate, ethyl hexanoate, ethyl octanoate, isoamyl acetate, and phenethyl acetate.

Acids may contribute to “sour” or “fermented” aromas or flavors, which can be important to the general character of a sake. Acids that may be included in a sake replica include, without limitation, isobutyric acid, isovaleric acid, nonanoic acid, propionic acid, and mixtures thereof. Any appropriate number of acids can be used (for example, 1 to 25, 1 to 10, 1 to 5, 5 to 25, 5 to 10, or 10 to 25 acids). Acids can make up any suitable portion of the additional VOCs. In some embodiments, the one or more acids can be present in a total amount of about 0.9 mg/L to about 3 mg/L (e.g., about 0.9 to about 1 mg/L, about 1 to about 3 mg/L, about 1 to about 2 mg/L, or about 2 to about 3 mg/L). In some embodiments, about 0.3% to about 2% by mass (e.g., about 0.3% to about 0.5%, about 0.3% to about 1%, about 0.5% to about 1%, or about 1% to about 2%) of the one or more additional VOCs can be the one or more acids. In some embodiments, the one or more additional VOCs can include no acids.

Higher alcohols (e.g., alcohols that are not ethanol) can provide various flavor and/or aroma components to sakes, including banana, spice, grassiness, and oxidized characteristics. Higher alcohols also can be important for adding roundness to the general aroma of a sake, as well as some weight on the palate. Higher alcohols that can be present in The sake replicas provided herein include, without limitation, 1-decanol, 1-octanol, 1-octen-3-ol, 2-heptanol, 2-methyl-1-butanol, 2-nonanol, 2-phenylethanol, amyl alcohol, anisyl alcohol, benzyl alcohol, butyl alcohol, cis-5-octen-1-ol, cis-6-nonen-1-ol, DL-3-methyl-2-butanol, hexadecanol, hexanol, isoamyl alcohol, isobutyl alcohol, propanol, and mixtures thereof. Any appropriate number of alcohols can be used (for example, 1 to 25, 1 to 10, 1 to 5, 5 to 25, 5 to 10, or 10 to 25 alcohols). Alcohols can make up any suitable portion of the additional VOCs. In some embodiments, the one or more alcohols can be present in a total amount of about 100 mg/L to about 350 mg/L (e.g., about 100 to about 150 mg/L, about 150 to about 200 mg/L, about 200 to about 250 mg/L, about 250 to about 300 mg/L, about 300 to about 350 mg/L, about 100 to about 200 mg/L, about 200 to about 300 mg/L, about 150 to about 250 mg/L, or about 250 to about 350 mg/L). In some embodiments, about 40% to about 95% by mass (e.g., about 40% to about 50%, about 50% to about 60%, about 60% to about 70%, about 70% to about 80%, about 80% to about 95%, about 80% to about 90%, about 40% to about 60%, about 60% to about 80%, about 50% to about 70%, about 70% to about 90%, or about 70% to about 95% by mass) of the one or more additional VOCs can be the one or more alcohols.

In some embodiments, a sake replica can include at least one alcohol (e.g., at least 2, at least 5, at least 10, 1 to 5, or 1 to 10 alcohols) selected from the group consisting of 1-octanol, 1-octen-3-ol, 2-heptanol, 2-methyl-1-butanol, 2-phenylethanol, benzyl alcohol, butyl alcohol, DL-3-methyl-2-butanol, hexanol, isoamyl alcohol, isobutyl alcohol, propanol, and mixtures thereof.

In some embodiments, a sake replica can include at least one alcohol (e.g., at least 2, at least 3, at least 5, 1 to 5, or 1 to 6 alcohols) selected from the group consisting of 2-methyl-1-butanol, 2-phenylethanol, butyl alcohol, isoamyl alcohol, isobutyl alcohol, propanol, and mixtures thereof.

Aldehydes and ketones can provide flavors and/or aromas that are important to the general character of sakes. For example, acetaldehyde is a by-product of alcoholic fermentation that gives a vinous and oxidized aroma, diacetyl is a by-product of malolactic fermentation that provides a buttery flavor, and sotolon can provide a maple-like scent. Non-limiting examples of aldehydes/ketones that may be used in the sake replicas provided herein include 3-ethyl-2-hydroxy-2-cyclopenten-1-one, 2,3-hexanedione, 2,3-pentadione, 2-acetyl-1-methylpyrrole, 2-heptanone, 2-methoxycinnamaldehyde, 2-methylbutyraldehyde, 2-nonanone, 2-octanone, 2-undecanone, 3-phenylpropanal, 5-ethyl-3-hydroxy-4-methyl-2(5H)-furanone, 5-methyl furfural, 5-methyl-2-phenyl-2-hexenal, 6-methyl-5-hepten-2-one, acetaldehyde, acetoin, acetophenone, benzaldehyde, butyraldehyde, cinnamaldehyde, cuminaldehyde, decanal, furfural, isobutyraldehyde, isovaleraldehyde, lauric aldehyde, maltol, methyl cyclopentenolone, methyl β-naphthyl ketone, methyl-2-pyrrolyl ketone, nonanal, octanal, p-anisaldehyde, phenylacetaldehyde, propionaldehyde, salicylaldehyde, trans-2-hexen-1-al, valeraldehyde, and mixtures thereof. Any appropriate number of aldehydes and/or ketones can be used (e.g., 1 to 50, 1 to 25, 1 to 10, 1 to 5, 5 to 50, 5 to 25, 5 to 10, 10 to 50, 10 to 25, or 25 to 50 aldehydes and/or ketones). Aldehydes and/or ketones can make up any suitable portion of the additional VOCs. In some embodiments, the one or more aldehydes and/or ketones can be present in a total amount of about 0.09 mg/L to about 40 mg/L (e.g., about 0.09 to about 0.1 mg/L, about 0.09 to about 0.5 mg/L, about 0.1 to about 0.5 mg/L, about 0.5 to about 1 mg/L, about 1 to about 5 mg/L, about 5 to about 10 mg/L, about 10 to about 20 mg/L, about 20 to about 30 mg/L, about 30 to about 40 mg/L, about 10 to about 30 mg/L, or about 20 to about 40 mg/L). In some embodiments, the one or more aldehydes or ketones can be present in a total amount of at least about 1.2 mg/L (e.g., at least about 1.3 mg/L, 1.4 mg/L, 1.5 mg/L, 2 mg/L, 3 mg/L, 4 mg/L, 5 mg/L, 10 mg/L, 15 mg/L, 20 mg/L, 25 mg/L, 30 mg/L, or 35 mg/L). In some embodiments, about 0.03% to about 16% by mass (e.g., about 0.03% to about 0.05%, about 0.03% to about 0.1%, about 0.05% to about 0.1%, about 0.1% to about 0.5%, about 0.5% to about 1%, about 1% to about 5%, about 5% to about 10%, about 10% to about 15%, about 1% to about 10%, about 1% to about 15%, or about 10% to about 15% by mass) of the one or more additional VOCs can be the one or more aldehydes or ketones. In some embodiments, at least about 0.9% by mass (e.g., at least about 1%, 2%, 3%, 4%, 5%, 6%, 7%, 8%, 9%, 10%, 11%, 12%, 13%, 14%, or 15%) of the one or more additional VOCs can be the one or more aldehydes or ketones.

In some embodiments, a sake replica can include at least one aldehyde or ketone (e.g., at least 2, at least 5, at least 10, at least 15, 1 to 5, or 5 to 10 aldehydes and/or ketones) selected from the group consisting of the group consisting of 2,3-pentadione, 2-heptanone, 2-methylbutyraldehyde, 2-nonanone, 2-undecanone, 5-ethyl-3-hydroxy-4-methyl-2(5H)-furanone, 5-methyl furfural, 6-methyl-5-hepten-2-one, acetaldehyde, acetophenone, benzaldehyde, butyraldehyde, furfural, isobutyraldehyde, isovaleraldehyde, methyl β-naphthyl ketone, methyl-2-pyrrolyl ketone, nonanal, octanal, p-anisaldehyde, phenylacetaldehyde, propionaldehyde, and mixtures thereof.

In some embodiments, a sake replica can include at least one aldehyde or ketone (e.g., 1 or 2 aldehydes and/or ketones) selected from the group consisting of acetaldehyde, furfural, and mixtures thereof.

Terpenes and isoprenoids can contribute floral and green characteristics to a sake. For example, limonene can contribute citrus flavors. Terpenes and isoprenoids that can be included in The sake replicas provided herein include, without limitation, (1R)-(-)-myrtenal, 1,4-cineole, 3-carene, 4,5,6,7-tetrahydro-3,6-dimethylbenzofuran, 4-carvomenthenol, 4-ethyl guaiacol, a-ionone (also called alpha-ionone), alpha-pinene (also called a-pinene), a-terpineol (also called alpha-terpineol), b-caryophellene, beta-damascenone, beta-ionone, beta-pinene, carvacrol, cis-rose-oxide (also called (-)cis-rose oxide), citral, citronellal, citronellol, D-camphor, D-carvone, d-fenchone, eucalyptol, gamma-terpinene, geraniol, geranyl acetone (also called 6,10-dimethyl-5,9-undecadien-2-one), L-carvone, limonene, linalool, linalool oxide, L-menthyl acetate, myrcene, nerolidol, p,a-dimethyl styrene, p-cymene, perillaldehyde, terpinolene, tetrahydrolinalool, thymol, valencene, and mixtures thereof. Any appropriate number of terpenes and/or isoprenoids can be used (for example, 1 to 40, 1 to 25, 1 to 10, 1 to 5, 5 to 40, 5 to 25, 5 to 10, 10 to 40, 10 to 25, or 25 to 40 terpenes and/or isoprenoids). Terpenes and/or isoprenoids can make up any suitable portion of the additional VOCs. In some embodiments, the one or more terpenes and/or isoprenoids can be present in a total amount of about 0.001 mg/L to about 0.045 mg/L (e.g., about 0.001 to about 0.005 mg/L, about 0.005 to about 0.01 mg/L, about 0.01 to about 0.045 mg/L, about 0.01 to about 0.02 mg/L, about 0.02 to about 0.03 mg/L, about 0.03 to about 0.04 mg/L, or about 0.030 to about 0.045 mg/L). In some embodiments, about 0.0003% to about 0.035% by mass (e.g., about 0.0003% to about 0.0005%, about 0.0003% to about 0.001%, about 0.0005% to about 0.001%, about 0.001% to about 0.005%, about 0.005% to about 0.01%, about 0.01% to about 0.035%, about 0.01% to about 0.02%, about 0.02% to about 0.03%, or about 0.020% to about 0.035% by mass) of the one or more additional VOCs can be the one or more terpenes or isoprenoids. In some embodiments, the one or more additional VOCs can include no terpenes or isoprenoids.

In some embodiments, a sake replica can include at least one terpene or isoprenoid (e.g., at least 2, at least 5, 1 to 10, or 1 to 5 terpenes and/or isoprenoids) selected from the group consisting of (1R)-(-)-myrtenal, 4-ethyl guaiacol, a-terpineol, beta-damascenone, beta-pinene, cis-rose-oxide, citronellol, D-camphor, geraniol, limonene, and mixtures thereof.

Phenols can contribute smoky or earthy characteristics to a sake. Examples of phenols that can be used in the sake replicas described herein include, without limitation, 2,4,6-trimethylphenol, 2-methoxy-4-methylphenol, 2-methoxy-4-propylphenol, 4-ethyl phenol, eugenol, guaiacol, isoeugenol, p-cresol, and mixtures thereof. Any appropriate number of phenols can be used (for example, 1 to 10, 1 to 8, 1 to 5, 2 to 10, 2 to 8, 2 to 5, 3 to 5, 3 to 8, or 3 to 10 phenols). Phenols can make up any suitable portion of the additional VOCs. In some embodiments, the one or more phenols can be present in a total amount of about 0.0002 mg/L to about 0.009 mg/L (e.g., about 0.0002 to about 0.0005 mg/L, about 0.0005 to about 0.001 mg/L, about 0.001 to about 0.005 mg/L, about 0.001 to about 0.009 mg/L, or about 0.005 to about 0.009 mg/L). In some embodiments, about 0.00009% to about 0.006% by mass (e.g., about 0.00009% to about 0.0001%, about 0.00009% to about 0.0005%, about 0.0001% to about 0.0005%, about 0.0005% to about 0.001%, about 0.001% to about 0.005%, or about 0.001% to about 0.006% by mass) of the one or more additional VOCs can be the one or more phenols. In some embodiments, the one or more additional VOCs can include no phenols.

In some embodiments, a sake replica can include at least one phenol (e.g., 1, 2, or 3 phenols) selected from the group consisting of 4-ethyl phenol, guaiacol, p-cresol, and mixtures thereof.

Lactones can also contribute to the characteristics of a sake. Non-limiting examples of lactones that can be included in the sake replicas provided herein include delta-decalactone, delta-dodecalactone, dihydrocoumarin, gamma-decalactone, gamma-dodecalactone, gamma-heptalactone, gamma-hexalactone, gamma-nonalactone, gamma-octalactone, gamma-undecalactone, gamma-valerolactone, massoia lactone, omega-pentadecalactone, whiskey lactone (also called cis-whiskey lactone), and mixtures thereof. Any appropriate number of lactones can be used (for example, 1 to 10, 1 to 8, 1 to 5, 2 to 10, 2 to 8, 2 to 5, 3 to 5, 3 to 8, or 3 to 10 lactones). Lactones can make up any suitable portion of the additional VOCs. In some embodiments, the one or more lactones can be present in a total amount of about 0.0025 mg/L to about 0.2 mg/L (e.g., about 0.0025 to about 0.005 mg/L, about 0.005 to about 0.01 mg/L, about 0.01 to about 0.05 mg/L, about 0.05 to about 0.1 mg/L, or about 0.1 to about 0.2 mg/L). In some embodiments, about 0.0009% to about 0.12% by mass (e.g., about 0.0009% to about 0.005%, about 0.0009% to about 0.001%, about 0.001% to about 0.005%, about 0.005% to about 0.01%, about 0.01% to about 0.05%, about 0.05% to about 0.1%, or about 0.05% to about 0.12% by mass) of the one or more additional VOCs can be the one or more lactones. In some embodiments, the one or more additional VOCs can include no lactones.

In some embodiments, a sake replica can include at least one lactone (e.g., at least 2, at least 3, at least 4, at least 5, at least 6, 1 to 3, or 1 to 6 lactones) selected from the group consisting of delta-decalactone, delta-dodecalactone, gamma-dodecalactone, gamma-heptalactone, gamma-hexalactone, gamma-nonalactone, gamma-octalactone, and mixtures thereof.

Amines and pyrazines can contribute unique characteristics to sakes. Examples of amines and pyrazines that can be used in a sake replica as provided herein include, without limitation, 2-ethyl-3(5 or 6)-dimethylpyrazine, 2-ethyl-3-methylpyrazine, 2-methoxy-3-(1-methylpropyl) pyrazine, 3-isobutyl-2-methoxypyrazine, indole, and mixtures thereof. In some embodiments, a sake replica can include indole. Any appropriate number of amines and/or pyrazines can be used (e.g., 1 to 10, 1 to 8, 1 to 5, 2 to 10, 2 to 8, 2 to 5, 3 to 5, 3 to 8, or 3 to 10 amines and/or pyrazines). Amines and/or pyrazines can make up any suitable portion of the additional VOCs. In some embodiments, the one or more amines and/or pyrazines can be present in a total amount of about 0.0001 mg/L to about 0.0003 mg/L (e.g., about 0.0001 to about 0.0002 mg/L or about 0.0002 to about 0.0003 mg/L). In some embodiments, about 0.00004% to about 0.0002% by mass (e.g., about 0.00004% to about 0.00005%, about 0.00004% to about 0.0001%, about 0.00005% to about 0.0001%, or about 0.0001% to about 0.0002% by mass) of the one or more additional VOCs can be the one or more amines or pyrazines. In some embodiments, the one or more additional VOCs can include no amines or pyrazines.

Like amines and pyrazines, thiols, thiazoles, and/or sulfides can contribute to the signature flavors of sakes. Examples of thiols that may be included in the sake replicas provided herein are, without limitation, 1-para-menthene-8-thiol, 2-isopropyl-4-methyl thiazole, 4-mercapto-4-methyl-2-pentanone, furfuryl thioacetate, and mixtures thereof. In some embodiments, a sake replica can include 1-para-menthene-8-thiol. Any appropriate number of thiols, thiazoles, and/or sulfides can be used (e.g., 1 to 10, 1 to 8, 1 to 5, 2 to 10, 2 to 8, 2 to 5, 3 to 5, 3 to 8, or 3 to 10 thiols, thiazoles, and/or sulfides). Thiols, thiazoles, or sulfides can make up any suitable portion of the additional VOCs. In some embodiments, the one or more thiols, thiazoles, or sulfides can be present in a total amount of about 0.0000003 mg/L to about 0.0000015 mg/L (e.g., 0.0000003 to about 0.0000005 mg/L, about 0.0000005 to about 0.000001 mg/L, or about 0.0000003 to about 0.0000015 mg/L). In some embodiments, about 0.00000008% to about 0.000001% by mass (e.g., about 0.00000008% to about 0.0000001%, about 0.0000001% to about 0.0000005%, or about 0.0000005% to about 0.000001% by mass) of the one or more additional VOCs can be the one or more thiols, thiazoles, or sulfides. In some embodiments, the one or more additional VOCs can include no thiols, thiazoles, or sulfides.

Ethers can also contribute to the flavors of sake replicas. Examples of ethers that may be included in the sake replicas provided herein are, without limitation, vanillyl ethyl ether, vanillyl butyl ether. In some embodiments, a sake replica can include vanillyl ethyl ether. Any appropriate number of ethers can be used (for example, 1, 2, 1 to 10, 1 to 8, 1 to 5, 2 to 10, 2 to 8, 2 to 5, 3 to 5, 3 to 8, or 3 to 10 ethers). Ethers can make up any suitable portion of the additional VOCs. In some embodiments, the one or more ethers can be present in a total amount of about 0.001 to about 0.003 mg/L (e.g., about 0.001 to about 0.002 mg/L or about 0.002 to about 0.003 mg/L). In some embodiments, about 0.0004% to about 0.002% by mass (e.g., about 0.0004% to about 0.001%, about 0.0005% to about 0.001%, or about 0.001% to about 0.002% by mass) of the one or more additional VOCs can be the one or more ethers. In some embodiments, the one or more additional VOCs can include no ethers.

Acetals can also contribute to the flavors of sake replicas. Examples of acetals that may be included in the sake replicas provided herein are, without limitation, 2-isobutyl-4-methyl-1,3-dioxolane, benzaldehyde glyceryl acetal, phenylacetaldehyde dimethyl acetal, and mixtures thereof. In some embodiments, a sake replica can include 2-isobutyl-4-methyl-1,3-dioxolane. Any appropriate number of acetals can be used (for example, 1 to 10, 1 to 8, 1 to 5, 2 to 10, 2 to 8, 2 to 5, 3 to 5, 3 to 8, or 3 to 10 acetals). Acetals can make up any suitable portion of the additional VOCs. In some embodiments, the one or more acetals can be present in a total amount of about 0.001 mg/L to about 0.003 mg/L (e.g., about 0.001 to about 0.002 mg/L or about 0.002 to about 0.003 mg/L). In some embodiments, about 0.0004% to about 0.002% by mass (e.g., about 0.0004% to about 0.001%, about 0.0005% to about 0.001%, or about 0.001% to about 0.002% by mass) of the one or more additional VOCs can be the one or more acetals. In some embodiments, the one or more additional VOCs can include no acetals.

Furans can also contribute to the flavors of sake replica. A non-limiting example of a furan that may be included in the sake replicas provided herein is 2-pentyl furan. In some embodiments, a sake replica can include 2-pentyl furan. Any appropriate number of furans can be used (for example, 1 to 10, 1 to 8, 1 to 5, 2 to 10, 2 to 8, 2 to 5, 3 to 5, 3 to 8, or 3 to 10 furans). Furans can make up any suitable portion of the additional VOCs. In some embodiments, the one or more furans can be present in a total amount of about 0.0006 mg/L to about 0.0012 mg/L (e.g., about 0.0006 to about 0.001 mg/L). In some embodiments, about 0.0002% to about 0.0008% by mass (e.g., about 0.0002% to about 0.0004%, about 0.0004% to about 0.0006%, or about 0.0006% to about 0.0008% by mass) of the one or more additional VOCs can be the one or more furans. In some embodiments, the one or more additional VOCs can include no furans.

In some embodiments, a sake replica can include one or more (e.g., one, two, three, four, five, six, or all seven) VOCs selected from the group consisting of butyl formate, ethyl octanoate, ethyl propionate, ethyl-2-methylbutyrate, isoamyl acetate, isoamyl alcohol, and isobutanol.

For example, in some cases, a sake replica can include two compounds selected from the group consisting of butyl formate, ethyl octanoate, ethyl propionate, ethyl-2-methylbutyrate, isoamyl acetate, isoamyl alcohol, and isobutanol, where the two compounds are butyl formate and ethyl octanoate; butyl formate and ethyl propionate; butyl formate and ethyl-2-methylbutyrate; butyl formate and isoamyl acetate; butyl formate and isoamyl alcohol; butyl formate and isobutanol; ethyl octanoate and ethyl propionate; ethyl octanoate and ethyl-2-methylbutyrate; ethyl octanoate and isoamyl acetate; ethyl octanoate and isoamyl alcohol; ethyl octanoate and isobutanol; ethyl propionate and ethyl-2-methylbutyrate; ethyl propionate and isoamyl acetate; ethyl propionate and isoamyl alcohol; ethyl propionate and isobutanol; ethyl-2-methylbutyrate and isoamyl acetate; ethyl-2-methylbutyrate and isoamyl alcohol; ethyl-2-methylbutyrate and isobutanol; isoamyl acetate and isoamyl alcohol; isoamyl acetate and isobutanol; or isoamyl alcohol and isobutanol.

In some cases, a sake replica can include three compounds selected from the group consisting of butyl formate, ethyl octanoate, ethyl propionate, ethyl-2-methylbutyrate, isoamyl acetate, isoamyl alcohol, and isobutanol. The three compounds can be butyl formate, ethyl octanoate, and ethyl propionate; butyl formate, ethyl octanoate, and ethyl-2-methylbutyrate; butyl formate, ethyl octanoate, and isoamyl acetate; butyl formate, ethyl octanoate, and isoamyl alcohol; butyl formate, ethyl octanoate, and isobutanol; butyl formate, ethyl propionate, and ethyl-2-methylbutyrate; butyl formate, ethyl propionate, and isoamyl acetate; butyl formate, ethyl propionate, and isoamyl alcohol; butyl formate, ethyl propionate, and isobutanol; butyl formate, ethyl-2-methylbutyrate, and isoamyl acetate; butyl formate, ethyl-2-methylbutyrate, and isoamyl alcohol; butyl formate, ethyl-2-methylbutyrate, and isobutanol; butyl formate, isoamyl acetate, and isoamyl alcohol; butyl formate, isoamyl acetate, and isobutanol; butyl formate, isoamyl alcohol, and isobutanol; ethyl octanoate, ethyl propionate, and ethyl-2-methylbutyrate; ethyl octanoate, ethyl propionate, and isoamyl acetate; ethyl octanoate, ethyl propionate, and isoamyl alcohol; ethyl octanoate, ethyl propionate, and isobutanol; ethyl octanoate, ethyl-2-methylbutyrate, and isoamyl acetate; ethyl octanoate, ethyl-2-methylbutyrate, and isoamyl alcohol; ethyl octanoate, ethyl-2-methylbutyrate, and isobutanol; ethyl octanoate, isoamyl acetate, and isoamyl alcohol; ethyl octanoate, isoamyl acetate, and isobutanol; ethyl octanoate, isoamyl alcohol, and isobutanol; ethyl propionate, ethyl-2-methylbutyrate, and isoamyl acetate; ethyl propionate, ethyl-2-methylbutyrate, and isoamyl alcohol; ethyl propionate, ethyl-2-methylbutyrate, and isobutanol; ethyl propionate, isoamyl acetate, and isoamyl alcohol; ethyl propionate, isoamyl acetate, and isobutanol; ethyl propionate, isoamyl alcohol, and isobutanol; ethyl-2-methylbutyrate, isoamyl acetate, and isoamyl alcohol; ethyl-2-methylbutyrate, isoamyl acetate, and isobutanol; ethyl-2-methylbutyrate, isoamyl alcohol, and isobutanol; or isoamyl acetate, isoamyl alcohol, and isobutanol.

In some cases, a sake replica can include four compounds selected from the group consisting of butyl formate, ethyl octanoate, ethyl propionate, ethyl-2-methylbutyrate, isoamyl acetate, isoamyl alcohol, and isobutanol. The four compounds can be butyl formate, ethyl octanoate, ethyl propionate, and ethyl-2-methylbutyrate; butyl formate, ethyl octanoate, ethyl propionate, and isoamyl acetate; butyl formate, ethyl octanoate, ethyl propionate, and isoamyl alcohol; butyl formate, ethyl octanoate, ethyl propionate, and isobutanol; butyl formate, ethyl octanoate, ethyl-2-methylbutyrate, and isoamyl acetate; butyl formate, ethyl octanoate, ethyl-2-methylbutyrate, and isoamyl alcohol; butyl formate, ethyl octanoate, ethyl-2-methylbutyrate, and isobutanol; butyl formate, ethyl octanoate, isoamyl acetate, and isoamyl alcohol; butyl formate, ethyl octanoate, isoamyl acetate, and isobutanol; butyl formate, ethyl octanoate, isoamyl alcohol, and isobutanol; butyl formate, ethyl propionate, ethyl-2-methylbutyrate, and isoamyl acetate; butyl formate, ethyl propionate, ethyl-2-methylbutyrate, and isoamyl alcohol; butyl formate, ethyl propionate, ethyl-2-methylbutyrate, and isobutanol; butyl formate, ethyl propionate, isoamyl acetate, and isoamyl alcohol; butyl formate, ethyl propionate, isoamyl acetate, and isobutanol; butyl formate, ethyl propionate, isoamyl alcohol, and isobutanol; butyl formate, ethyl-2-methylbutyrate, isoamyl acetate, and isoamyl alcohol; butyl formate, ethyl-2-methylbutyrate, isoamyl acetate, and isobutanol; butyl formate, ethyl-2-methylbutyrate, isoamyl alcohol, and isobutanol; butyl formate, isoamyl acetate, isoamyl alcohol, and isobutanol; ethyl octanoate, ethyl propionate, ethyl-2-methylbutyrate, and isoamyl acetate; ethyl octanoate, ethyl propionate, ethyl-2-methylbutyrate, and isoamyl alcohol; ethyl octanoate, ethyl propionate, ethyl-2-methylbutyrate, and isobutanol; ethyl octanoate, ethyl propionate, isoamyl acetate, and isoamyl alcohol; ethyl octanoate, ethyl propionate, isoamyl acetate, and isobutanol; ethyl octanoate, ethyl propionate, isoamyl alcohol, and isobutanol; ethyl octanoate, ethyl-2-methylbutyrate, isoamyl acetate, and isoamyl alcohol; ethyl octanoate, ethyl-2-methylbutyrate, isoamyl acetate, and isobutanol; ethyl octanoate, ethyl-2-methylbutyrate, isoamyl alcohol, and isobutanol; ethyl octanoate, isoamyl acetate, isoamyl alcohol, and isobutanol; ethyl propionate, ethyl-2-methylbutyrate, isoamyl acetate, and isoamyl alcohol; ethyl propionate, ethyl-2-methylbutyrate, isoamyl acetate, and isobutanol; ethyl propionate, ethyl-2-methylbutyrate, isoamyl alcohol, and isobutanol; ethyl propionate, isoamyl acetate, isoamyl alcohol, and isobutanol; or ethyl-2-methylbutyrate, isoamyl acetate, isoamyl alcohol, and isobutanol.

In some cases, a sake replica can include five compounds selected from the group consisting of butyl formate, ethyl octanoate, ethyl propionate, ethyl-2-methylbutyrate, isoamyl acetate, isoamyl alcohol, and isobutanol. The five compounds can be butyl formate, ethyl octanoate, ethyl propionate, ethyl-2-methylbutyrate, and isoamyl acetate; butyl formate, ethyl octanoate, ethyl propionate, ethyl-2-methylbutyrate, and isoamyl alcohol; butyl formate, ethyl octanoate, ethyl propionate, ethyl-2-methylbutyrate, and isobutanol; butyl formate, ethyl octanoate, ethyl propionate, isoamyl acetate, and isoamyl alcohol; butyl formate, ethyl octanoate, ethyl propionate, isoamyl acetate, and isobutanol; butyl formate, ethyl octanoate, ethyl propionate, isoamyl alcohol, and isobutanol; butyl formate, ethyl octanoate, ethyl-2-methylbutyrate, isoamyl acetate, and isoamyl alcohol; butyl formate, ethyl octanoate, ethyl-2-methylbutyrate, isoamyl acetate, and isobutanol; butyl formate, ethyl octanoate, ethyl-2-methylbutyrate, isoamyl alcohol, and isobutanol; butyl formate, ethyl octanoate, isoamyl acetate, isoamyl alcohol, and isobutanol; butyl formate, ethyl propionate, ethyl-2-methylbutyrate, isoamyl acetate, and isoamyl alcohol; butyl formate, ethyl propionate, ethyl-2-methylbutyrate, isoamyl acetate, and isobutanol; butyl formate, ethyl propionate, ethyl-2-methylbutyrate, isoamyl alcohol, and isobutanol; butyl formate, ethyl propionate, isoamyl acetate, isoamyl alcohol, and isobutanol; butyl formate, ethyl-2-methylbutyrate, isoamyl acetate, isoamyl alcohol, and isobutanol; ethyl octanoate, ethyl propionate, ethyl-2-methylbutyrate, isoamyl acetate, and isoamyl alcohol; ethyl octanoate, ethyl propionate, ethyl-2-methylbutyrate, isoamyl acetate, and isobutanol; ethyl octanoate, ethyl propionate, ethyl-2-methylbutyrate, isoamyl alcohol, and isobutanol; ethyl octanoate, ethyl propionate, isoamyl acetate, isoamyl alcohol, and isobutanol; ethyl octanoate, ethyl-2-methylbutyrate, isoamyl acetate, isoamyl alcohol, and isobutanol; or ethyl propionate, ethyl-2-methylbutyrate, isoamyl acetate, isoamyl alcohol, and isobutanol.

In some cases, a sake replica can include six compounds selected from the group consisting of butyl formate, ethyl octanoate, ethyl propionate, ethyl-2-methylbutyrate, isoamyl acetate, isoamyl alcohol, and isobutanol. The six compounds can be butyl formate, ethyl octanoate, ethyl propionate, ethyl-2-methylbutyrate, isoamyl acetate, and isoamyl alcohol; butyl formate, ethyl octanoate, ethyl propionate, ethyl-2-methylbutyrate, isoamyl acetate, and isobutanol; butyl formate, ethyl octanoate, ethyl propionate, ethyl-2-methylbutyrate, isoamyl alcohol, and isobutanol; butyl formate, ethyl octanoate, ethyl propionate, isoamyl acetate, isoamyl alcohol, and isobutanol; butyl formate, ethyl octanoate, ethyl-2-methylbutyrate, isoamyl acetate, isoamyl alcohol, and isobutanol; butyl formate, ethyl propionate, ethyl-2-methylbutyrate, isoamyl acetate, isoamyl alcohol, and isobutanol; or ethyl octanoate, ethyl propionate, ethyl-2-methylbutyrate, isoamyl acetate, isoamyl alcohol, and isobutanol.

In some embodiments, a sake replica as provided herein can include no more than six (e.g., six, five, four, three, two, one, or none), no more than five (e.g., five, four, three, two, one, or none), or no more than four (e.g., four, three, two, one, or none) of the VOCs in the group consisting of butyl formate, ethyl octanoate, ethyl propionate, ethyl-2-methylbutyrate, isoamyl acetate, isoamyl alcohol, and isobutanol.

In some embodiments, the sake replicas provided herein can include one or more (e.g., one, two, three, four, five, six, seven eight, nine, ten, or more than ten) VOCs that are not present in a corresponding traditional sake.

The presence, absence, and/or amount of VOCs and non-volatile compounds in traditional sakes and in sake replicas is assessed using gas chromatography/mass spectrometry (GC-MS) and liquid chromatography/mass spectrometry (LC-MS) methods as described herein. A volatile or non-volatile compound that is “not present” in a reference sake is one that is not detected in the reference sake using the methods set forth in Example 1. Limits of detection for various VOCs are disclosed in TABLES 1A, 1B, 1C, and 1D herein, and limits of detection for various non-volatile compounds are disclosed in TABLES 8A and 8B herein.

In some embodiments, the additional VOCs can include one or more VOCs that are not present in a corresponding traditional sake. Non-limiting examples of such compounds can include 1,4-cineole, 1-decanol, 2,4,6-trimethylphenol, 2-acetyl-1-methylpyrrole, 2-ethyl-3(5 or 6)-dimethylpyrazine , 2-ethyl-3-methylpyrazine, 2-isopropyl-4-methyl thiazole, 2-methoxy-3-(1-methylpropyl) pyrazine, 2-methoxy-4-methylphenol, 2-methoxy-4-propylphenol, 2-methylbutyl acetate, 2-methylbutyl isovalerate, 2-nonanol, 3-carene, 3-methylthio hexyl acetate, 3-phenylpropanal, 4,5,6,7-tetrahydro-3,6-dimethylbenzofuran, 4-carvomenthenol, 4-mercapto-4-methyl-2-pentanone, 5-methyl-2-phenyl-2-hexenal, acetoin, a-ionone, allyl heptanoate, alpha-pinene, amyl alcohol, amyl butyrate, anisyl acetate, anisyl butyrate, b-caryophellene, benzyl acetate, benzyl benzoate, benzyl butyrate, benzyl formate, benzyl propionate, beta-ionone, butyl butyryllactate, butyl formate, carvacrol, cinnamaldehyde, cis-3-hexenyl acetate, cis-3-hexenyl butyrate, cis-3-hexenyl valerate, cis-5-octen-1-ol, cis-6-nonen-1-ol, citral, citronellal, cuminaldehyde, D-carvone, decanal, d-fenchone, ethyl 2-trans-4-cis-decadienoate, ethyl cinnamate, ethyl myristate, ethyl undecanoate, eucalyptol, eugenol, furfuryl thioacetate, gamma-decalactone, gamma-terpinene, gamma-undecalactone, gamma-valerolactone, geranyl acetone, hexadecanol, hexyl 3-methylbutanoate, hexyl isobutyrate, 3-isobutyl-2-methoxypyrazine, isoamyl cinnamate, isoamyl isobutyrate, isoamyl isovalerate, isoamyl phenylacetate, isobutyl isobutyrate, isoeugenol, L-carvone, linalool, linalool oxide, linalyl acetate, L-menthyl acetate, maltol, massoia lactone, methyl anthranilate, methyl benzoate, methyl cinnamate, methyl cyclopentenolone, methyl decanoate, methyl octanoate, methyl salicylate, myrcene, nerolidol, omega-pentadecalactone, p,a-dimethylstyrene, p-cymene, perillaldehyde, phenethyl 2-methylbutyrate, phenethyl butyrate, phenethyl octanoate, phenethyl tiglate, phenylacetaldehyde dimethyl acetal, salicylaldehyde, tetrahydrolinalool, thymol, trans-2-hexen-1-al, valencene, valeraldehyde, vanillyl butyl ether, and whiskey lactone. In some embodiments, a sake replica can include at least one (e.g., at least 1, at least 2, at least 3, at least 4, at least 5, at least 10, at least 15, at least 20, at least 30, at least 40, at least 50, at least 60, at least 70, at least 80, 1 to 80, 1 to 70, 1 to 60, 1 to 50, 1 to 40, 1 to 30, 1 to 20, 1 to 10, 1 to 5, 1 to 4, 1 to 3, 1 to 2, 2 to 80, 2 to 70, 2 to 60, 2 to 50, 2 to 40, 2 to 30, 2 to 20, 2 to 10, 2 to 5, 2 to 4, 2 to 3, 3 to 80, 3 to 70, 3 to 60, 3 to 50, 3 to 40, 3 to 30, 3 to 20, 3 to 10, 3 to 5, 3 to 4, 4 to 80, 4 to 70, 4 to 60, 4 to 50, 4 to 40, 4 to 30, 4 to 20, 4 to 10, 4 to 5, 5 to 80, 5 to 70, 5 to 60, 5 to 50, 5 to 40, 5 to 30, 5 to 20, 5 to 10, 10 to 80, 10 to 70, 10 to 60, 10 to 50, 10 to 40, 10 to 30, or 10 to 20) compounds selected from the group consisting of 1,4-cineole, 1-decanol, 2,4,6-trimethylphenol, 2-acetyl-1-methylpyrrole, 2-ethyl-3(5 or 6)-dimethylpyrazine , 2-ethyl-3-methylpyrazine, 2-isopropyl-4-methyl thiazole, 2-methoxy-3-(1-methylpropyl) pyrazine, 2-methoxy-4-methylphenol, 2-methoxy-4-propylphenol, 2-methylbutyl acetate, 2-methylbutyl isovalerate, 2-nonanol, 3-carene, 3-methylthio hexyl acetate, 3-phenylpropanal, 4,5,6,7-tetrahydro-3,6-dimethylbenzofuran, 4-carvomenthenol, 4-mercapto-4-methyl-2-pentanone, 5-methyl-2-phenyl-2-hexenal, acetoin, a-ionone, allyl heptanoate, alpha-pinene, amyl alcohol, amyl butyrate, anisyl acetate, anisyl butyrate, b-caryophellene, benzyl acetate, benzyl benzoate, benzyl butyrate, benzyl formate, benzyl propionate, beta-ionone, butyl butyryllactate, butyl formate, carvacrol, cinnamaldehyde, cis-3-hexenyl acetate, cis-3-hexenyl butyrate, cis-3-hexenyl valerate, cis-5-octen-1-ol, cis-6-nonen-1-ol, citral, citronellal, cuminaldehyde, D-carvone, decanal, d-fenchone, ethyl 2-trans-4-cis-decadienoate, ethyl cinnamate, ethyl myristate, ethyl undecanoate, eucalyptol, eugenol, furfuryl thioacetate, gamma-decalactone, gamma-terpinene, gamma-undecalactone, gamma-valerolactone, geranyl acetone, hexadecanol, hexyl 3-methylbutanoate, hexyl isobutyrate, 3-isobutyl-2-methoxypyrazine, isoamyl cinnamate, isoamyl isobutyrate, isoamyl isovalerate, isoamyl phenylacetate, isobutyl isobutyrate, isoeugenol, L-carvone, linalool, linalool oxide, linalyl acetate, L-menthyl acetate, maltol, massoia lactone, methyl anthranilate, methyl benzoate, methyl cinnamate, methyl cyclopentenolone, methyl decanoate, methyl octanoate, methyl salicylate, myrcene, nerolidol, omega-pentadecalactone, p,a-dimethylstyrene, p-cymene, perillaldehyde, phenethyl 2-methylbutyrate, phenethyl butyrate, phenethyl octanoate, phenethyl tiglate, phenylacetaldehyde dimethyl acetal, salicylaldehyde, tetrahydrolinalool, thymol, trans-2-hexen-1-al, valencene, valeraldehyde, vanillyl butyl ether, and whiskey lactone. It is surprising that the sake replicas described herein include one or more compounds not found in any tested traditional sake, as it would be expected that to create a sake replica, one would only think to use compounds found in one or more traditional sakes. By way of example only, p,a-dimethylstyrene, on its own, gives off a plastic character. However, in low concentrations in a sake replica (e.g., any of the sake replicas provided herein), it can provide an attractive citrus character.

In some embodiments, the additional VOCs can exclude one or more VOCs that are present in a corresponding traditional sake. Non-limiting examples of such compounds include 1-octanol, 2,3-pentadione, 2-heptanone, 2-nonanone, 5-methyl furfural, benzaldehyde, benzyl alcohol, butyl acetate, butyraldehyde, citronellol, diethyl succinate, ethyl isobutyrate, ethyl lactate, ethyl propionate, ethyl trans-2-butenoate, ethyl(methylthio) acetate, gamma-heptalactone, gamma-hexalactone, gamma-octalactone, hexanol, isoamyl hexanoate, isobutyl acetate, isobutyraldehyde, isobutyric acid, isovaleric acid, methionyl acetate, methyl acetate, nonanoic acid, phenylacetaldehyde, propionaldehyde, propionic acid, propyl acetate, and propyl butyrate. In some embodiments, a sake replica can include at least one (e.g., at least 1, at least 2, at least 3, at least 5, at least 10, at least 15, at least 20, at least 25, 1 to 5, 1 to 10, 1 to 15, 1 to 20, 1 to 30, 5 to 10, 5 to 15, 5 to 20, 5 to 25, 5 to 30, 10 to 15, 10 to 20, 10 to 25, or 10 to 30) compounds selected from the group consisting of 1-octanol, 2,3-pentadione, 2-heptanone, 2-nonanone, 5-methyl furfural, benzaldehyde, benzyl alcohol, butyl acetate, butyraldehyde, citronellol, diethyl succinate, ethyl isobutyrate, ethyl lactate, ethyl propionate, ethyl trans-2-butenoate, ethyl(methylthio) acetate, gamma-heptalactone, gamma-hexalactone, gamma-octalactone, hexanol, isoamyl hexanoate, isobutyl acetate, isobutyraldehyde, isobutyric acid, isovaleric acid, methionyl acetate, methyl acetate, nonanoic acid, phenylacetaldehyde, propionaldehyde, propionic acid, propyl acetate, and propyl butyrate. It is surprising that the sake replicas described herein lack one or more compounds found in every tested traditional sake, as it would be expected that to create a sake replica, one would believe that compounds present in every tested traditional sake to be important to sake flavor.

A sake replica can include any appropriate number of additional VOCs. For example, a sake replica can include 1 to 100 (e.g., at least 5, at least 10, at least 20, at least 30, at least 40, at least 50, 1 to 90, 1 to 80, 1 to 70, 1 to 60, 1 to 50, 1 to 40, 1 to 30, 1 to 20, 1 to 10, 1 to 5, 5 to 100, 5 to 90, 5 to 80, 5 to 70, 5 to 60, 5 to 40, 5 to 30, 5 to 20, 5 to 10, 10 to 100, 10 to 90, 10 to 90, 10 to 70, 10 to 60, 10 to 50, 10 to 40, 10 to 30, 10 to 20, 20 to 100, 20 to 90, 20 to 80, 20 to 70, 20 to 60, 20 to 50, 20 to 40, 20 to 30, 30 to 100, 30 to 90,30 to 80,30 to 70,30 to 60,30 to 50, 30 to 40, 40 to 100, 40 to 90, 40 to 80, 40 to 70, 40 to 60, 40 to 50, 50 to 100, 50 to 90, 50 to 80, 50 to 70, or 50 to 60) additional VOCs. For example, in some embodiments, a sake replica can include 1 to 100 (e.g., at least 5, at least 10, at least 20, at least 30, at least 40, at least 50, 1 to 90, 1 to 80, 1 to 70, 1 to 60, 1 to 50, 1 to 40, 1 to 30, 1 to 20, 1 to 10, 1 to 5, 5 to 100, 5 to 90, 5 to 80, 5 to 70, 5 to 60, 5 to 40, 5 to 30, 5 to 20, 5 to 10, 10 to 100, 10 to 90, 10 to 90, 10 to 70, 10 to 60, 10 to 50, 10 to 40, 10 to 30, 10 to 20, 20 to 100, 20 to 90, 20 to 80, 20 to 70, 20 to 60,20 to 50,20 to 40,20 to 30,30 to 100,30 to 90, 30 to 80, 30 to 70, 30 to 60, 30 to 50, 30 to 40, 40 to 100, 40 to 90, 40 to 80, 40 to 70, 40 to 60, 40 to 50, 50 to 100, 50 to 90, 50 to 80, 50 to 70, or 50 to 60) compounds selected from the group consisting of (1R)-(-)-myrtenal, 3-ethyl-2-hydroxy-2-cyclopenten-1-one, 1,4-cineole, 1-decanol, 1-octanol, 1-octen-3-ol, 1-para-menthene-8-thiol, 2,3-hexanedione, 2,3-pentadione, 2,4,6-trimethylphenol, 2-acetyl-1-methylpyrrole, 2-ethyl-3(5 or 6)-dimethylpyrazine, 2-ethyl-3-methylpyrazine, 2-heptanol, 2-heptanone, 2-isobutyl-4-methyl-1,3-dioxolane, 2-isopropyl-4-methyl thiazole, 2-methoxy-3-(1-methylpropyl) pyrazine, 2-methoxy-4-methylphenol, 2-methoxy-4-propylphenol, 2-methoxycinnamaldehyde, 2-methyl-1-butanol, 2-methylbutyl acetate, 2-methylbutyl isovalerate, 2-methylbutyraldehyde, 2-nonanol, 2-nonanone, 2-octanone, 2-pentylfuran, 2-phenylethanol, 2-undecanone, 3-carene, 3-heptyl acetate, 3-methylthio hexyl acetate, 3-phenylpropanal, 4,5,6,7-tetrahydro-3,6-dimethylbenzofuran, 4-carvomenthenol, 4-ethyl guaiacol, 4-ethyl phenol, 4-mercapto-4-methyl-2-pentanone, 5-ethyl-3-hydroxy-4-methyl-2(5H)-furanone, 5-methyl furfural, 5-methyl-2-phenyl-2-hexenal, 6-methyl-5-hepten-2-one, acetaldehyde, acetoin, acetophenone, a-ionone, ally! heptanoate, ally! hexanoate, alpha-pinene, amyl alcohol, amyl butyrate, anisyl acetate, anisyl alcohol, anisyl butyrate, a-terpineol, b-caryophellene, benzaldehyde, benzaldehyde glyceryl acetal, benzyl acetate, benzyl alcohol, benzyl benzoate, benzyl butyrate, benzyl formate, benzyl propionate, beta-damascenone, beta-ionone, beta-pinene, butyl acetate, butyl alcohol, butyl butyryllactate, butyl formate, butyraldehyde, carvacrol, cinnamaldehyde, cis-3-hexenyl acetate, cis-3-hexenyl butyrate, cis-3-hexenyl caproate, cis-3-hexenyl valerate, cis-5-octen-1-ol, cis-6-nonen-1-ol , cis-rose-oxide, citral, citronellal, citronellol, cuminaldehyde, D-camphor, D-carvone, decanal, delta-decalactone, delta-dodecalactone, d-fenchone, diethyl malate, diethyl succinate, dihydrocoumarin, DL-3-methyl-2-butanol, ethyl 2-methylbutyrate, ethyl 2-trans-4-cis-decadienoate, ethyl 3-hydroxyhexanoate, ethyl acetate, ethyl acetoacetate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl phenylacetate, ethyl propionate, ethyl salicylate, ethyl trans-2-butenoate, ethyl undecanoate, ethyl valerate, ethyl(methylthio) acetate, ethyl-trans-3-hexenoate, eucalyptol, eugenol, furfural, furfuryl thioacetate, gamma-decalactone, gamma-dodecalactone, gamma-heptalactone, gamma-hexalactone, gamma-nonalactone, gamma-octalactone, gamma-terpinene, gamma-undecalactone, gamma-valerolactone, geraniol, geranyl acetone, geranyl butyrate, geranyl propionate, guaiacol, heptyl acetate, hexadecanol, hexanol, hexyl 3-methylbutanoate, hexyl acetate, hexyl butyrate, hexyl formate, hexyl isobutyrate, hexyl propionate, 3-isobutyl-2-methoxypyrazine, indole, isoamyl acetate, isoamyl alcohol, isoamyl cinnamate, isoamyl hexanoate, isoamyl isobutyrate, isoamyl isovalerate, isoamyl octanoate, isoamyl phenylacetate, isobutyl acetate, isobutyl alcohol, isobutyl butyrate, isobutyl isobutyrate, isobutyl propionate, isobutyraldehyde, isobutyric acid, isoeugenol, isovaleraldehyde, isovaleric acid, lauric aldehyde, L-carvone, limonene, linalool, linalool oxide, linalyl acetate, L-menthyl acetate, maltol, massoia lactone, methionyl acetate, methionyl butyrate, methyl acetate, methyl anthranilate, methyl benzoate, methyl cinnamate, methyl cyclopentenolone, methyl decanoate, methyl hexanoate, methyl laurate, methyl octanoate, methyl salicylate, methyl β-naphthyl ketone, methyl-2-pyrrolyl ketone, myrcene, nerolidol, nonanal, nonanoic acid, octanal, omega-pentadecalactone, p,a-dimethyl styrene, p-anisaldehyde, p-cresol, p-cymene, perillaldehyde, phenethyl 2-methylbutyrate, phenethyl acetate, phenethyl butyrate, phenethyl formate, phenethyl octanoate, phenethyl propionate, phenethyl tiglate, phenylacetaldehyde, phenylacetaldehyde dimethyl acetal, propanol, propionaldehyde, propionic acid, propyl acetate, propyl butyrate, propyl isovalerate, salicylaldehyde, terpinolene, tetrahydrolinalool, thymol, trans-2-hexen-1-al, valencene, valeraldehyde, vanillyl butyl ether, vanillyl ethyl ether, and whiskey lactone. In some embodiments, a sake replica can include 1 to 100 (e.g., at least 3, at least 5, at least 10, at least 20, at least 30, at least 40, at least 50, 1 to 90, 1 to 80, 1 to 70, 1 to 60, 1 to 50, 1 to 40, 1 to 30, 1 to 20, 1 to 10, 1 to 5, 5 to 100, 5 to 90, 5 to 80, 5 to 70, 5 to 60, 5 to 40, 5 to 30, 5 to 20, 5 to 10, 10 to 100, 10 to 90, 10 to 90, 10 to 70, 10 to 60, 10 to 50, 10 to 40, 10 to 30, 10 to 20, 20 to 100, 20 to 90, 20 to 80, 20 to 70, 20 to 60, 20 to 50, 20 to 40, 20 to 30, 30 to 100, 30 to 90, 30 to 80, 30 to 70, 30 to 60, 30 to 50, 30 to 40, 40 to 100, 40 to 90, 40 to 80, 40 to 70, 40 to 60, 40 to 50, 50 to 100, 50 to 90, 50 to 80, 50 to 70, or 50 to 60) compounds selected from the group consisting of (1R)-(-)-myrtenal, 1-octanol, 1-octen-3-ol, 1-para-menthene-8-thiol, 2,3-pentadione, 2-heptanol, 2-heptanone, 2-isobutyl-4-methyl-1,3-dioxolane, 2-methyl-1-butanol, 2-methylbutyraldehyde, 2-nonanone, 2-pentylfuran, 2-phenylethanol, 2-undecanone, 4-ethyl guaiacol, 4-ethyl phenol, 5-ethyl-3-hydroxy-4-methyl-2(5H)-furanone, 5-methyl furfural, 6-methyl-5-hepten-2-one, acetaldehyde, acetophenone, a-terpineol, benzaldehyde, benzyl alcohol, beta-damascenone, beta-pinene, butyl acetate, butyl alcohol, butyraldehyde, cis-rose-oxide, citronellol, D-camphor, delta-decalactone, delta-dodecalactone, diethyl malate, diethyl succinate, DL-3-methyl-2-butanol, ethyl 2-methylbutyrate, ethyl 3-hydroxyhexanoate, ethyl acetate, ethyl benzoate, ethyl butanoate, ethyl decanoate, ethyl heptanoate, ethyl hexanoate, ethyl isobutyrate, ethyl isovalerate, ethyl lactate, ethyl laurate, ethyl levulinate, ethyl nonanoate, ethyl octanoate, ethyl phenylacetate, ethyl propionate, ethyl salicylate, ethyl trans-2-butenoate, ethyl valerate, ethyl(methylthio) acetate, ethyl-trans-3-hexenoate, furfural, gamma-dodecalactone, gamma-heptalactone, gamma-hexalactone, gamma-nonalactone, gamma-octalactone, geraniol, guaiacol, heptyl acetate, hexanol, hexyl acetate, indole, isoamyl acetate, isoamyl alcohol, isoamyl hexanoate, isoamyl octanoate, isobutyl acetate, isobutyl alcohol, isobutyl propionate, isobutyraldehyde, isobutyric acid, isovaleraldehyde, isovaleric acid, limonene, methionyl acetate, methyl acetate, methyl hexanoate, methyl laurate, methyl β-naphthyl ketone, methyl-2-pyrrolyl ketone, nonanal, nonanoic acid, octanal, p-anisaldehyde, p-cresol, phenethyl acetate, phenethyl formate, phenethyl propionate, phenylacetaldehyde, propanol, propionaldehyde, propionic acid, propyl acetate, propyl butyrate, propyl isovalerate, and vanillyl ethyl ether. In some embodiments, a sake replica can include 1 to 45 (e.g., at least 3, at least 5, at least 10, 1 to 5, 1 to 10, 1 to 20, 1 to 30, 1 to 40, 5 to 10, 5 to 20, 5 to 30, 5 to 40, 5 to 45, 10 to 20, 10 to 30, 10 to 40, 10 to 45, 20 to 30, 20 to 40, 20 to 45, 30 to 40, or 30 to 45) compounds selected from the group consisting of 1-octanol, 2,3-pentadione, 2-heptanone, 2-methyl-1-butanol, 2-nonanone, 2-phenylethanol, 5-methyl furfural, acetaldehyde, benzaldehyde, benzyl alcohol, butyl acetate, butyl alcohol, butyraldehyde, citronellol, diethyl succinate, ethyl acetate, ethyl butanoate, ethyl hexanoate, ethyl isobutyrate, ethyl lactate, ethyl octanoate, ethyl propionate, ethyl trans-2-butenoate, ethyl(methylthio) acetate, furfural, gamma-heptalactone, gamma-hexalactone, gamma-octalactone, hexanol, isoamyl acetate, isoamyl alcohol, isoamyl hexanoate, isobutyl acetate, isobutyl alcohol, isobutyraldehyde, isobutyric acid, isovaleric acid, methionyl acetate, methyl acetate, nonanoic acid, phenethyl acetate, phenylacetaldehyde, propanol, propionaldehyde, propionic acid, propyl acetate, propyl butyrate. In some embodiments, a sake replica can include 1 to 14 (e.g., at least 3, at least 5, at least 8, 1 to 5, 1 to 8, 1 to 10, 5 to 8, 5 to 10, 5 to 14, or 10 to 14) compounds selected from the group consisting of 2-methyl-1-butanol, 2-phenylethanol, acetaldehyde, butyl alcohol, ethyl acetate, ethyl butanoate, ethyl hexanoate, ethyl octanoate, furfural, isoamyl acetate, isoamyl alcohol, isobutyl alcohol, phenethyl acetate, and propanol. In some embodiments, a sake replica can include 2-methyl-1-butanol, 2-phenylethanol, acetaldehyde, butyl alcohol, ethyl acetate, ethyl butanoate, ethyl hexanoate, ethyl octanoate, furfural, isoamyl acetate, isoamyl alcohol, isobutyl alcohol, phenethyl acetate, and propanol. A sake can include VOCs in any appropriate amount. For example, in some embodiments, the additional VOCs can be present in a total amount of about 100 mg/L to about 700 mg/L (e.g., about 100 to about 300 mg/L, about 300 to about 500 mg/L, about 500 to about 700 mg/L, about 100 to about 200 mg/L, about 200 to about 300 mg/L, about 200 to about 400 mg/L, or about 400 to about 600 mg/L).

In some cases, the number of additional VOCs in a sake replica can be fewer than the number of additional VOCs in a single corresponding reference sake. Further, in some embodiments, the sake replicas provided herein can lack one or more (e.g., one, two, three, four, five, ten, 15, 20, or more than 20) VOCs that are present in a corresponding traditional sake. In some cases, the overall population of additional (non-ethanol) VOCs in a sake replica can have less than 95% identity to the VOCs in a corresponding reference sake (e.g., in a single type of traditionally made sake corresponding to the replica). For example, the additional VOCs in a sake replica can have less than 90%, less than 80%, less than 70%, less than 60%, less than 50%, less than 40%, less than 30%, less than 25%, less than 20%, or less than 15% identity to the population of VOCs in a corresponding reference sake made by traditional methods. In some cases, a percent identity can be calculated by dividing the number of shared additional VOCs by the number of additional VOCs in the corresponding reference sake. Some sake replicas may contain at least 3 (e.g., at least 5, at least 10 at least 15, at least 20, at least 25, at least 30, at least 35, at least 40, at least 45, or at least 50) VOCs that are not found in a single reference sake. Moreover, some sake replicas may contain no more than 50 (e.g., no more than 45, 40, 35, 30, 25, 20, 15, or 10) VOCs that are present in a single reference sake. For example, in some embodiments, a sake replica can have at least n additional VOCs and wherein less than n (e.g., n−1, n−2, n−3, n−4, n−5, n−6, n−7, n−8, n−9, n−10, n−15, n−20, and the like, as applicable) of the additional VOCs are found in a single reference sake; in some embodiments, n can be equal to 5, 6, 7, 8, 9, 10, 11, 12, 13, 14, 15, 16, 17, 18, 19, 20, 25, 30, 35, 40, 45, 50, 55, 60, 65, 70, 75, 80, or 85.

As noted above, the amounts of VOCs in reference sakes are measured using the GC-MS methods described herein. In some embodiments, the amount of a particular VOC in a sake replica can be an amount, based on concentration or percent composition, that is within a range 30% higher and lower than a measured amount for that VOC in a corresponding reference sake. For example, a VOC can be present in a sake replica in an amount that is 70 to 90%, 80 to 100%, 90 to 110%, 100 to 120%, 110 to 130%, 70 to 100%, 80 to 110%, 90 to 120%, or 100 to 130% of an amount measured for that VOC in a corresponding reference sake.

In some embodiments, a percent composition of VOCs can be calculated by dividing the measured amount of a VOC of interest (e.g., in mg/L) by the total measured amount of VOCs (e.g., in mg/L). In some embodiments, the total measured amount of VOCs is based on the VOCs in TABLES 1A-1D. In some embodiments, the total measured amount of VOCs is based on the total measured amount of (1R)-(-)-myrtenal, 1,4-cineole, 1-decanol, 1-octanol, 1-octen-3-ol, 1-para-menthene-8-thiol, 2,3-hexanedione, 2,3-pentadione, 2,4,6-trimethylphenol, 2-acetyl-1-methylpyrrole, 2-ethyl-3(5 or 6)-dimethylpyrazine, 2-ethyl-3-methylpyrazine, 2-heptanol, 2-heptanone, 2-isobutyl-4-methyl-1,3-dioxolane, 2-isopropyl-4-methyl thiazole, 2-methoxy-3-(1-methylpropyl) pyrazine, 2-methoxy-4-methylphenol, 2-methoxy-4-propylphenol, 2-methoxycinnamaldehyde, 2-methyl-1-butanol, 2-methylbutyl acetate, 2-methylbutyl isovalerate, 2-methylbutyraldehyde, 2-nonanol, 2-nonanone, 2-octanone, 2-pentylfuran, 2-phenylethanol, 2-undecanone, 3-carene, 3-heptyl acetate, 3-methylthio hexyl acetate, 3-phenylpropanal, 4,5,6,7-tetrahydro-3,6-dimethylbenzofuran, 4-carvomenthenol, 4-ethyl guaiacol, 4-ethyl phenol, 4-mercapto-4-methyl-2-pentanone, 5-ethyl-3-hydroxy-4-methyl-2(5H)-furanone, 5-methyl furfural, 5-methyl-2-phenyl-2-hexenal, 6-methyl-5-hepten-2-one, acetaldehyde, acetoin, acetophenone, a-ionone, allyl heptanoate, allyl hexanoate, alpha-pinene, amyl alcohol, amyl butyrate, anisyl acetate, anisyl alcohol, anisyl butyrate, a-terpineol, b-caryophellene, benzaldehyde, benzaldehyde glyceryl acetal, benzyl acetate, benzyl alcohol, benzyl benzoate, benzyl butyrate, benzyl formate, benzyl propionate, beta-damascenone, beta-ionone, beta-pinene, butyl acetate, butyl alcohol, butyl butyryllactate, butyl formate, butyraldehyde, carvacrol, cinnamaldehyde, cis-3-hexenyl acetate, cis-3-hexenyl butyrate, cis-3-hexenyl caproate, cis-3-hexenyl valerate, cis-5-octen-1-ol, cis-6-nonen-1-ol, cis-rose-oxide, citral, citronellal, citronellol, cuminaldehyde, D-camphor, D-carvone, decanal, delta-decalactone, delta-dodecalactone, d-fenchone, diethyl malate, diethyl succinate, dihydrocoumarin, DL-3-methyl-2-butanol, ethyl 2-methylbutyrate, ethyl 2-trans-4-cis-decadienoate, ethyl 3-hydroxyhexanoate, ethyl acetate, ethyl acetoacetate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl phenylacetate, ethyl propionate, ethyl salicylate, ethyl trans-2-butenoate, ethyl undecanoate, ethyl valerate, ethyl(methylthio) acetate, ethyl-trans-3-hexenoate, eucalyptol, eugenol, furfural, furfuryl thioacetate, gamma-decalactone, gamma-dodecalactone, gamma-heptalactone, gamma-hexalactone, gamma-nonalactone, gamma-octalactone, gamma-terpinene, gamma-undecalactone, gamma-valerolactone, geraniol, geranyl acetone, geranyl butyrate, geranyl propionate, guaiacol, heptyl acetate, hexadecanol, hexanol, hexyl 3-methylbutanoate, hexyl acetate, hexyl butyrate, hexyl formate, hexyl isobutyrate, hexyl propionate, 3-isobutyl-2-methoxypyrazine, indole, isoamyl acetate, isoamyl alcohol, isoamyl cinnamate, isoamyl hexanoate, isoamyl isobutyrate, isoamyl isovalerate, isoamyl octanoate, isoamyl phenylacetate, isobutyl acetate, isobutyl alcohol, isobutyl butyrate, isobutyl isobutyrate, isobutyl propionate, isobutyraldehyde, isobutyric acid, isoeugenol, isovaleraldehyde, isovaleric acid, lauric aldehyde, L-carvone, limonene, linalool, linalool oxide, linalyl acetate, L-menthyl acetate, maltol, massoia lactone, methionyl acetate, methionyl butyrate, methyl acetate, methyl anthranilate, methyl benzoate, methyl cinnamate, methyl cyclopentenolone, methyl decanoate, methyl hexanoate, methyl laurate, methyl octanoate, methyl salicylate, methyl β-naphthyl ketone, methyl-2-pyrrolyl ketone, myrcene, nerolidol, nonanal, nonanoic acid, octanal, omega-pentadecalactone, p,a-dimethylstyrene, p-anisaldehyde, p-cresol, p-cymene, perillaldehyde, phenethyl 2-methylbutyrate, phenethyl acetate, phenethyl butyrate, phenethyl formate, phenethyl octanoate, phenethyl propionate, phenethyl tiglate, phenylacetaldehyde, phenylacetaldehyde dimethyl acetal, propanol, propionaldehyde, propionic acid, propyl acetate, propyl butyrate, propyl isovalerate, salicylaldehyde, terpinolene, tetrahydrolinalool, thymol, trans-2-hexen-1-al, valencene, valeraldehyde, vanillyl butyl ether, vanillyl ethyl ether, and whiskey lactone. In some embodiments, the total measured amount of VOCs is based on the total measured amount of (1R)-(-)-myrtenal, 3-ethyl-2-hydroxy-2-cyclopenten-1-one, 1,4-cineole, 1-decanol, 1-octanol, 1-octen-3-ol, 1-para-menthene-8-thiol, 2,3-pentadione, 2,4,6-trimethylphenol (mesitol), 2-acetyl-1-methylpyrrole, 2-ethyl-3(5 or 6)-dimethylpyrazine , 2-ethyl-3-methylpyrazine, 2-heptanol, 2-heptanone, 2-isobutyl-4-methyl-1,3-dioxolane, 2-isopropyl-4-methyl thiazole, 2-methoxy-3-(1-methylpropyl) pyrazine, 2-methoxy methylphenol (creosol), 2-methoxy-4-propylphenol, 2-methyl-1-butanol, 2-methylbutyl acetate, 2-methylbutyl isovalerate, 2-methylbutyraldehyde, 2-nonanol, 2-nonanone, 2-pentylfuran, 2-phenylethanol, 2-undecanone, 3-carene, 3-methylthio hexyl acetate, 3-phenylpropanal, 4,5,6,7-tetrahydro-3,6-dimethylbenzofuran, 4-carvomenthenol (terpinen-4-ol), 4-ethyl guaiacol, 4-ethyl phenol, 4-mercapto-4-methyl-2-pentanone, 5-methyl furfural, 5-methyl-2-phenyl-2-hexenal, 6-methyl-5-hepten-2-one, acetaldehyde, acetoin, acetophenone, a-ionone, allyl heptanoate, alpha-pinene, amyl alcohol, amyl butyrate, anisyl acetate, anisyl butyrate, a-terpineol, b-caryophellene, benzaldehyde, benzyl acetate, benzyl alcohol, benzyl benzoate, benzyl butyrate, benzyl formate, benzyl propionate, beta-damascenone, beta-ionone, beta-pinene, butyl acetate, butyl alcohol, butyl butyryllactate, butyl formate, butyraldehyde, carvacrol, cinnamaldehyde, cis-3-hexenyl acetate, cis-3-hexenyl butyrate, cis-3-hexenyl valerate, cis-5-octen-1-ol, cis-6-nonen-1-ol, cis-rose-oxide, citral, citronellal, citronellol, cuminaldehyde, D-camphor, D-carvone, decanal, delta-decalactone, delta-dodecalactone, d-fenchone, diethyl malate, diethyl succinate, DL-3-methyl-2-butanol, ethyl 2-methylbutyrate, ethyl 2-trans-4-cis-decadienoate, ethyl 3-hydroxyhexanoate, ethyl acetate, ethyl benzoate, Ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl phenylacetate, ethyl propionate, ethyl salicylate, ethyl trans-2-butenoate, ethyl undecanoate, ethyl valerate, ethyl(methylthio) acetate, ethyl-trans-3-hexenoate, eucalyptol, eugenol, furfural, furfuryl thioacetate, gamma-decalactone, gamma-dodecalactone, gamma-heptalactone, gamma-hexalactone, gamma-nonalactone, gamma-octalactone, gamma-terpinene, gamma-undecalactone, gamma-valerolactone, geraniol, geranyl acetone (6,10-dimethyl-5,9-undecadien-2-one), guaiacol, heptyl acetate, hexadecanol, hexanol, hexyl 3-methylbutanoate, hexyl acetate, hexyl isobutyrate, IBMP (3-isobutyl-2-methoxypyrazine), indole, isoamyl acetate, isoamyl alcohol, isoamyl cinnamate, isoamyl hexanoate, isoamyl isobutyrate, isoamyl isovalerate, isoamyl octanoate, isoamyl phenylacetate, isobutyl acetate, isobutyl alcohol, isobutyl isobutyrate, isobutyl propionate, isobutyraldehyde, isobutyric acid, isoeugenol, isovaleraldehyde, isovaleric acid, L-carvone, limonene, linalool, linalool oxide, linalyl acetate, L-menthyl acetate, maltol, massoia lactone, methionyl acetate (3-methylthio-propylacetate), methyl acetate, methyl anthranilate, methyl benzoate, methyl cinnamate, methyl cyclopentenolone, methyl decanoate, methyl hexanoate, methyl laurate, methyl octanoate, methyl salicylate, methyl β-naphthyl ketone, methyl-2-pyrrolyl ketone, myrcene, nerolidol, nonanal, nonanoic acid, octanal, omega-pentadecalactone, p,a-dimethyl styrene, p-anisaldehyde, p-cresol, p-cymene, perillaldehyde, phenethyl 2-methylbutyrate, phenethyl acetate, phenethyl butyrate, phenethyl formate, phenethyl octanoate, phenethyl propionate, phenethyl tiglate, phenylacetaldehyde, phenylacetaldehyde dimethyl acetal, propanol, propionaldehyde, propionic acid, propyl acetate, propyl butyrate, propyl isovalerate, salicylaldehyde, tetrahydrolinalool, thymol, trans-2-hexen-1-al, valencene, valeraldehyde, vanillyl butyl ether, vanillyl ethyl ether, whiskey lactone. In some embodiments, the total measured amount of VOCs is based on the total measured amount of (1R)-(-)-myrtenal, 3-Ethyl-2-hydroxy-2-cyclopenten-1-one, 1,4-cineole, 1-decanol, 1-octanol, 1-octen-3-ol, 1-para-menthene-8-thiol, 2,3-pentadione, 2,4,6-trimethylphenol (mesitol), 2-acetyl-1-methylpyrrole, 2-ethyl-3(5 or 6)-dimethylpyrazine, 2-ethyl-3-methylpyrazine, 2-heptanol, 2-heptanone, 2-isobutyl-4-methyl-1,3-dioxolane, 2-isopropyl-4-methyl thiazole, 2-methoxy-3-(1-methylpropyl) pyrazine, 2-methoxy-4-methylphenol (creosol), 2-methoxy-4-propylphenol, 2-methylbutyl acetate, 2-methylbutyl isovalerate, 2-methylbutyraldehyde, 2-nonanol, 2-nonanone, 2-pentylfuran, 2-phenylethanol, 2-undecanone, 3-carene, 3-methylthio hexyl acetate, 3-phenylpropanal, 4,5,6,7-tetrahydro-3,6-dimethylbenzofuran, 4-carvomenthenol (terpinen-4-ol), 4-ethyl guaiacol, 4-ethyl pPhenol, 4-mercapto-4-methyl-2-pentanone, 5-methyl furfural, 5-methyl-2-phenyl-2-hexenal, 6-methyl-5-hepten-2-one, acetoin, acetophenone, a-ionone, allyl heptanoate, alpha-pinene, amyl alcohol, amyl butyrate, anisyl acetate, anisyl butyrate, a-terpineol, b-caryophellene, benzaldehyde, benzyl acetate, benzyl alcohol, benzyl benzoate, benzyl butyrate, benzyl formate, benzyl propionate, beta-damascenone, beta-ionone, beta-pinene, butyl acetate, butyl alcohol, butyl butyryllactate, butyl formate, butyraldehyde, carvacrol, cinnamaldehyde, cis-3-hexenyl acetate, cis-3-hexenyl butyrate, cis-3-hexenyl valerate, cis-5-octen-1-ol, cis-6-nonen-1-ol, cis-rose-oxide, citral, citronellal, citronellol, cuminaldehyde, D-camphor, D-carvone, decanal, delta-decalactone, delta-dodecalactone, d-fenchone, diethyl malate, diethyl succinate, DL-3-methyl-2-butanol, ethyl 2-methylbutyrate, ethyl 2-trans-4-cis-decadienoate, ethyl 3-hydroxyhexanoate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl phenylacetate, ethyl propionate, ethyl salicylate, ethyl trans-2-butenoate, ethyl undecanoate, ethyl valerate, ethyl(methylthio) acetate, ethyl-trans-3-hexenoate, eucalyptol, eugenol, furfural, furfuryl thioacetate, gamma-decalactone, gamma-dodecalactone, gamma-heptalactone, gamma-hexalactone, gamma-nonalactone, gamma-octalactone, gamma-terpinene, gamma-undecalactone, gamma-valerolactone, geraniol, geranyl acetone (6,10-dimethyl-5,9-undecadien-2-one), guaiacol, heptyl acetate, hexadecanol, hexanol, hexyl 3-methylbutanoate, hexyl acetate, hexyl isobutyrate, IBMP (3-isobutyl-2-methoxypyrazine), indole, isoamyl acetate, isoamyl cinnamate, isoamyl hexanoate, isoamyl isobutyrate, isoamyl isovalerate, isoamyl octanoate, isoamyl phenylacetate, isobutyl acetate, isobutyl isobutyrate, isobutyl propionate, isobutyraldehyde, isobutyric acid, isoeugenol, isovaleraldehyde, isovaleric acid, L-carvone, limonene, linalool, linalool oxide, linalyl acetate, L-menthyl acetate, maltol, massoia lactone, methionyl acetate (3-methylthio-propylacetate), methyl acetate, Methyl anthranilate, methyl benzoate, methyl cinnamate, methyl cyclopentenolone, methyl decanoate, methyl hexanoate, methyl laurate, methyl octanoate, methyl salicylate, methyl 3-naphthyl ketone, methyl-2-pyrrolyl ketone, myrcene, nerolidol, nonanal, nonanoic acid, octanal, omega-pentadecalactone, p,a-dimethyl styrene, p-anisaldehyde, p-cresol, p-cymene, perillaldehyde, phenethyl 2-methylbutyrate, phenethyl acetate, phenethyl butyrate, phenethyl formate, phenethyl octanoate, phenethyl propionate, phenethyl tiglate, phenylacetaldehyde, phenylacetaldehyde dimethyl acetal, propanol, propionaldehyde, propionic acid, propyl acetate, propyl butyrate, propyl isovalerate, salicylaldehyde, tetrahydrolinalool, thymol, trans-2-hexen-1-al, valencene, valeraldehyde, vanillyl butyl ether, vanillyl ethyl ether, and whiskey lactone.

In some cases, the total amount of VOCs in a sake replica can be less than the total amount of VOCs in a reference sake. For example, a sake replica can have a total VOC content (in mg/L) that is less than 95% (e.g., less than 90%, 85%, 80%, 70%, 60%, 50% or 40%) of the total VOC content (in mg/L) of a corresponding reference sake.

In some cases, the total amount of VOCs in a sake replica can be less than the total amount of VOCs in a corresponding reference sake. Further, the amount of any particular VOC in a sake replica may be different than the amount of that VOC in a corresponding reference sake. In some cases, the amount of a VOC in a sake replica can be 75% or less (e.g., 70% or less, 60% or less, 50% or less, 40% or less, 30% or less, 20% or less, or 10% or less), by concentration or percent mass, than the amount of the same VOC in a corresponding reference sake. In some cases, the amount of a VOC in a sake replica can be 125% or more (e.g., 150% or more, 200% or more, or 300% or more), by concentration or percent mass, than the amount of the same VOC in a corresponding reference sake.

It will be understood that when both a range (or subrange) and an “at least” or “less than” amount (or percent by mass) are disclosed, these together disclose all ranges that exist in the overlap of the range (or subrange) and one of the “at least” or “less than” values in any combination. By way of example only, ethyl butanoate can be present in an amount of about 0.001 mg/L to about 0.8 mg/L and the one or more additional VOCs can include ethyl butanoate in an amount of at least about 0.17 mg/L. Therefore, ethyl butanoate can be present in an amount of about 0.17 mg/L to about 0.8 mg/L (e.g., about 0.17 to about to about 0.2 mg/L, about 0.17 to about 0.4 mg/L, about 0.17 to about 0.6 mg/L, or about 0.17 to about 0.8 mg/L); ethyl butanoate can be present in an amount of about 0.2 mg/L to about 0.8 mg/L (e.g., about 0.2 to about 0.4 mg/L, about 0.2 to about 0.6 mg/L, or about 0.2 to about 0.8 mg/L); ethyl butanoate can be present in an amount of about 0.4 mg/L to about 0.8 mg/L (e.g., about 0.4 to about 0.6 mg/L, or about 0.4 to about 0.8 mg/L); or ethyl butanoate can be present in an amount of about 0.6 mg/L to about 0.8 mg/L.

Further, it will be understood that if both a range and an “at least” or “less than” value are described for a sake replica, the interpretation will be the largest overlap of those descriptions. For example, if a sake replica is described with both “ethyl butanoate can be present in an amount of about 0.001 mg/L to about 0.8 mg/L” and “the one or more additional VOCs include ethyl butanoate in an amount of at least about 0.17 mg/L”, the interpretation shall be that ethyl butanoate is present in an amount of about 0.17 mg/L to about 0.8 mg/L.

The one or more additional VOCs in a sake replica can include (1R)-(-)-myrtenal. In some embodiments, the (1R)-(-)-myrtenal can be present in an amount of about 0.002 mg/L to about 0.01 mg/L (e.g., about 0.002 to about 0.005 mg/L or about 0.005 to about 0.01 mg/L). In some embodiments, about 0.0007% to about 0.007% (e.g., about 0.0007% to about 0.001%, about 0.001% to about 0.005%, about 0.001% to about 0.007%, about 0.001% to about 0.003%, about 0.003% to about 0.005%, or about 0.005% to about 0.007%) by mass of the one or more additional VOCs can be (1R)-(-)-myrtenal. In some embodiments, the one or more additional VOCs can include no (1R)-(-)-myrtenal.

The one or more additional VOCs in a sake replica can include 1-octanol. In some embodiments, the 1-octanol can be present in an amount of about 0.0001 mg/L to about 0.01 mg/L (e.g., about 0.0001 to about 0.0005 mg/L, about 0.0005 to about 0.001 mg/L, about 0.001 to about 0.005 mg/L, or about 0.005 to about 0.01 mg/L). In some embodiments, about 0.00005% to about 0.007% (e.g., about 0.00005% to about 0.0001% to about 0.0001% to about 0.0005%, about 0.0005% to about 0.001%, about 0.001% to about 0.005%, about 0.001% to about 0.007%, about 0.001% to about 0.003%, about 0.003% to about 0.005%, or about 0.005% to about 0.007%) by mass of the one or more additional VOCs can be 1-octanol. In some embodiments, the one or more additional VOCs can include no 1-octanol.

The one or more additional VOCs in a sake replica can include 1-octen-3-ol. In some embodiments, the 1-octen-3-ol can be present in an amount of about 0.005 mg/L to about 0.03 mg/L (e.g., about 0.005 to about 0.01 mg/L, about 0.01 to about 0.03 mg/L, about 0.01 to about 0.02 mg/L, or about 0.02 to about 0.03 mg/L). In some embodiments, about 0.002% to about 0.02% (e.g., about 0.002% to about 0.005%, about 0.005% to about 0.01%, or about 0.01% to about 0.02%) by mass of the one or more additional VOCs can be 1-octen-3-ol. In some embodiments, the one or more additional VOCs can include no 1-octen-3-ol.

The one or more additional VOCs in a sake replica can include 1-para-menthene-8-thiol. In some embodiments, the 1-para-menthene-8-thiol can be present in an amount of about 0.0000001 mg/L to about 0.000002 mg/L (e.g., about 0.0000001 to about 0.0000005 mg/L, about 0.0000005 to about 0.000001 mg/L, or about 0.000001 to about 0.000002 mg/L). In some embodiments, about 0.00000003% to about 0.000001% (e.g., about 0.00000003% to about 0.00000005%, about 0.00000005% to about 0.0000001%, about 0.0000001% to about 0.0000005%, or about 0.0000005% to about 0.000001%) by mass of the one or more additional VOCs can be 1-para-menthene-8-thiol. In some embodiments, the one or more additional VOCs can include no 1-para-menthene-8-thiol.

The one or more additional VOCs in a sake replica can include 2,3-pentadione. In some embodiments, the 2,3-pentadione can be present in an amount of about 0.0003 mg/L to about 0.025 mg/L (e.g., about 0.0003 to about 0.0005 mg/L, about 0.0005 to about 0.001 mg/L, about 0.001 to about 0.005 mg/L, about 0.005 to about 0.01 mg/L, about 0.01 to about 0.2 mg/L, or about 0.010 to about 0.025 mg/L). In some embodiments, about 0.0001% to about 0.015% (e.g., about 0.0001% to about 0.0005%, about 0.0005% to about 0.001%, about 0.001% to about 0.005%, about 0.005% to about 0.01%, or about 0.005% to about 0.015%) by mass of the one or more additional VOCs can be 2,3-pentadione. In some embodiments, the one or more additional VOCs can include no 2,3-pentadione.

The one or more additional VOCs in a sake replica can include 2-heptanol. In some embodiments, the 2-heptanol can be present in an amount of about 0.0002 mg/L to about 0.002 mg/L (e.g., about 0.0002 to about 0.0005 mg/L, about 0.0005 to about 0.001 mg/L, or about 0.001 to about 0.002 mg/L). In some embodiments, about 0.00008% to about 0.0015% (e.g., about 0.00008% to about 0.0001%, about 0.00008% to about 0.0005%, about 0.0001% to about 0.0005%, about 0.0005% to about 0.001%, or about 0.0005% to about 0.0015%) by mass of the one or more additional VOCs can be 2-heptanol. In some embodiments, the one or more additional VOCs can include no 2-heptanol.

The one or more additional VOCs in a sake replica can include 2-heptanone. In some embodiments, the 2-heptanone can be present in an amount of about 0.00001 mg/L to about 0.006 mg/L (e.g., about 0.00001 to about 0.00005 mg/L, about 0.00005 to about 0.0001 mg/L, about 0.0001 to about 0.0005 mg/L, about 0.0005 to about 0.001 mg/L, about 0.001 to about 0.006 mg/L, or about 0.001 to about 0.005 mg/L). In some embodiments, about 0.000005% to about 0.004% (e.g., about 0.000005% to about 0.00001%, about 0.00001% to about 0.00005%, about 0.00005% to about 0.0001%, about 0.0001% to about 0.0005%, about 0.0005% to about 0.001%, or about 0.001% to about 0.004%) by mass of the one or more additional VOCs can be 2-heptanone. In some embodiments, the one or more additional VOCs can include no 2-heptanone.

The one or more additional VOCs in a sake replica can include 2-isobutyl-4-methyl-1,3-dioxolane. In some embodiments, the 2-isobutyl-4-methyl-1,3-dioxolane can be present in an amount of about 0.0005 mg/L to about 0.0025 mg/L (e.g., about 0.0005 to about 0.001 mg/L, about 0.001 to about 0.002 mg/L, or about 0.001 to about 0.0025 mg/L). In some embodiments, about 0.00015% to about 0.002% (e.g., about 0.00015% to about 0.0005%, about 0.0005% to about 0.001%, or about 0.001% to about 0.002%) by mass of the one or more additional VOCs can be 2-isobutyl-4-methyl-1,3-dioxolane. In some embodiments, the one or more additional VOCs can include no 2-isobutyl-4-methyl-1,3-dioxolane.

The one or more additional VOCs in a sake replica can include 2-methylbutyraldehyde. In some embodiments, the 2-methylbutyraldehyde can be present in an amount of about 0.0001 mg/L to about 0.04 mg/L (e.g., about 0.0001 to about 0.0005 mg/L, about 0.0005 to about 0.001 mg/L, about 0.001 to about 0.005 mg/L, about 0.005 to about 0.01 mg/L, about 0.01 to about 0.04 mg/L, about 0.01 to about 0.02 mg/L, or about 0.02 to about 0.04 mg/L). In some embodiments, about 0.00006% to about 0.03% (e.g., about 0.00006% to about 0.0001%, about 0.0001% to about 0.0005%, about 0.0005% to about 0.001%, about 0.001% to about 0.005%, about 0.005% to about 0.01%, or about 0.01% to about 0.03%) by mass of the one or more additional VOCs can be 2-methylbutyraldehyde. In some embodiments, the one or more additional VOCs can include no 2-methylbutyraldehyde.

The one or more additional VOCs in a sake replica can include 2-nonanone. In some embodiments, the 2-nonanone can be present in an amount of about 0.00001 mg/L to about 0.002 mg/L (e.g., about 0.00001 to about 0.00005 mg/L, about 0.00005 to about 0.0001 mg/L, about 0.0001 to about 0.0005 mg/L, about 0.0005 to about 0.001 mg/L, or about 0.001 to about 0.002 mg/L). In some embodiments, about 0.000003% to about 0.0015% (e.g., 0.000003% to about 0.000005%, about 0.000005% to about 0.00001%, about 0.00001% to about 0.00005%, about 0.00005% to about 0.0001%, or about 0.00005% to about 0.00015%) by mass of the one or more additional VOCs can be 2-nonanone. In some embodiments, the one or more additional VOCs can include no 2-nonanone.

The one or more additional VOCs in a sake replica can include 2-pentylfuran. In some embodiments, the 2-pentylfuran can be present in an amount of about 0.0002 mg/L to about 0.0015 mg/L (e.g., about 0.0002 to about 0.0005 mg/L, about 0.0005 to about 0.001 mg/L, or about 0.0005 to about 0.0015 mg/L). In some embodiments, about 0.00009% to about 0.0009% (e.g., about 0.00009% to about 0.0005%, about 0.0001% to about 0.0005%, about 0.0001% to about 0.0009%, or about 0.0005% to about 0.0009%) by mass of the one or more additional VOCs can be 2-pentylfuran. In some embodiments, the one or more additional VOCs can include no 2-pentylfuran.

The one or more additional VOCs in a sake replica can include 2-phenylethanol. In some embodiments, the 2-phenylethanol can be present in an amount of about 2 mg/L to about 170 mg/L (e.g., about 2 to about 5 mg/L, about 2 to about 10 mg/L, about 5 to about 10 mg/L, about 10 to about 20 mg/L, about 10 to about 50 mg/L, about 20 to about 50 mg/L, about 50 to about 100 mg/L, about 100 to about 150 mg/L, or about 100 to about 170 mg/L). In some embodiments, the 2-phenylethanol can be present in an amount of less than about 28 mg/L (e.g., less than about 27 mg/L, 26 mg/L, 25 mg/L, 24 mg/L, 23 mg/L, 22 mg/L, 20 mg/L, 18 mg/L, 16 mg/L, 14 mg/L, 12 mg/L, 10 mg/L, 8 mg/L, 6 mg/L, or 4 mg/L). In some embodiments, about 0.7% to about 95% (e.g., about 0.7% to about 1%, about 0.7% to about 5%, about 1% to about 5%, about 5% to about 10%, about 10% to about 25%, about 25% to about 50%, about 50% to about 75%, or about 75% to about 95%) by mass of the one or more additional VOCs can be 2-phenylethanol. In some embodiments, less than about 15.5% (e.g., less than about 15%, 14%, 13%, 12%, 11%, 10%, 9%, 8%, 7%, 6%, 5%, 4%, 3%, 2%, or 1%) by mass of the one or more additional VOCs can be 2-phenylethanol.

The one or more additional VOCs in a sake replica can include 2-undecanone. In some embodiments, the 2-undecanone can be present in an amount of about 0.000007 mg/L to about 0.00003 mg/L (e.g., about 0.000007 to about 0.00001 mg/L, about 0.00001 to about 0.00003 mg/L, about 0.00001 to about 0.00002 mg/L, or about 0.00002 to about 0.00003 mg/L). In some embodiments, about 0.000002% to about 0.00003% (e.g., 0.000002% to about 0.000005%, about 0.000005% to about 0.00001%, about 0.00001% to about 0.00003%, about 0.00001% to about 0.00002%, or about 0.00002% to about 0.00003%) by mass of the one or more additional VOCs can be 2-undecanone. In some embodiments, the one or more additional VOCs can include no 2-undecanone. The one or more additional VOCs in a sake replica can include 4-ethyl guaiacol.

In some embodiments, the 4-ethyl guaiacol can be present in an amount of about 0.002 mg/L to about 0.01 mg/L (e.g., about 0.002 to about 0.005 mg/L or about 0.005 to about 0.01 mg/L). In some embodiments, about 0.0007% to about 0.008% (e.g., about 0.0007% to about 0.001%, about 0.001% to about 0.008%, about 0.001% to about 0.005%, or about 0.005% to about 0.008%) by mass of the one or more additional VOCs can be 4-ethyl guaiacol. In some embodiments, the one or more additional VOCs can include no 4-ethyl guaiacol.

The one or more additional VOCs in a sake replica can include 4-ethyl phenol. In some embodiments, the 4-ethyl phenol can be present in an amount of about 0.001 mg/L to about 0.006 mg/L (e.g., about 0.001 to about 0.005 mg/L, about 0.001 to about 0.003 mg/L, about 0.003 to about 0.005 mg/L, about 0.002 to about 0.004 mg/L, or about 0.004 to about 0.006 mg/L). In some embodiments, about 0.0004% to about 0.005% (e.g., about 0.0004% to about 0.001%, about 0.0005% to about 0.001%, or about 0.001% to about 0.005%) by mass of the one or more additional VOCs can be 4-ethyl phenol. In some embodiments, the one or more additional VOCs can include no 4-ethyl phenol.

The one or more additional VOCs in a sake replica can include 5-methyl furfural. In some embodiments, the 5-methyl furfural can be present in an amount of about 0.000002 mg/L to about 0.0008 mg/L (e.g., about 0.000002 to about 0.000005 mg/L, about 0.000005 to about 0.00001 mg/L, about 0.00001 to about 0.00005 mg/L, about 0.00005 to about 0.0001 mg/L, about 0.0001 to about 0.0005 mg/L, about 0.0001 to about 0.0008 mg/L, or about 0.0001 to about 0.0008 mg/L). In some embodiments, about 0.000001% to about 0.0006% (e.g., about 0.000001% to about 0.000005%, about 0.000005% to about 0.00001%, about 0.00001% to about 0.00005%, about 0.00005% to about 0.0001%, about 0.0001% to about 0.0006%, or about 0.0001% to about 0.0006%) by mass of the one or more additional VOCs can be 5-methyl furfural. In some embodiments, the one or more additional VOCs can include no 5-methyl furfural.

The one or more additional VOCs in a sake replica can include 6-methyl-5-hepten-2-one. In some embodiments, the 6-methyl-5-hepten-2-one can be present in an amount of about 0.00008 mg/L to about 0.0004 mg/L (e.g., about 0.00008 to about 0.0001 mg/L, about 0.0001 to about 0.0004 mg/L, about 0.0001 to about 0.0003 mg/L, or about 0.0002 to about 0.0004 mg/L). In some embodiments, about 0.00003% to about 0.0003% (e.g., about 0.00003% to about 0.00005%, about 0.00005% to about 0.0001%, about 0.0001% to about 0.0003%, about 0.0001% to about 0.0002%, about 0.0002% to about 0.0003%) by mass of the one or more additional VOCs can be 6-methyl-5-hepten-2-one. In some embodiments, the one or more additional VOCs can include no 6-methyl-5-hepten-2-one.

The one or more additional VOCs in a sake replica can include acetophenone. In some embodiments, the acetophenone can be present in an amount of about 0.00004 mg/L to about 0.0002 mg/L (e.g., about 0.00004 to about 0.0001 mg/L, about 0.00005 to about 0.0001 mg/L, or about 0.0001 to about 0.0002 mg/L). In some embodiments, about 0.000015% to about 0.00015% (e.g., about 0.000015% to about 0.00005%, about 0.00005% to about 0.0001%, or about 0.00005% to about 0.00015%) by mass of the one or more additional VOCs can be acetophenone. In some embodiments, the one or more additional VOCs can include no acetophenone.

The one or more additional VOCs in a sake replica can include a-terpineol (also called alpha-terpineol). In some embodiments, the a-terpineol can be present in an amount of about 0.0001 mg/L to about 0.0007 mg/L (e.g., about 0.0001 to about 0.0005 mg/L, about 0.0001 to about 0.0003 mg/L, about 0.0003 to about 0.0005 mg/L, or about 0.0005 to about 0.0007 mg/L). In some embodiments, about 0.00005% to about 0.0005% (e.g., about 0.00005% to about 0.0001% to about 0.0001% to about 0.0005%) by mass of the one or more additional VOCs can be a-terpineol. In some embodiments, the one or more additional VOCs can include no a-terpineol.

The one or more additional VOCs in a sake replica can include benzaldehyde. In some embodiments, the benzaldehyde can be present in an amount of about 0.0003 mg/L to about 0.15 mg/L (e.g., about 0.0003 to about 0.001 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.05 to about 0.15 mg/L). In some embodiments, about 0.0001% to about 0.1% (e.g., about 0.0001% to about 0.0005%, about 0.0005% to about 0.001%, about 0.001% to about 0.005%, about 0.005% to about 0.01%, about 0.01% to about 0.05%, or about 0.05% to about 0.1%) by mass of the one or more additional VOCs can be benzaldehyde. In some embodiments, the one or more additional VOCs can include no benzaldehyde.

The one or more additional VOCs in a sake replica can include benzyl alcohol. In some embodiments, the benzyl alcohol can be present in an amount of about 0.001 mg/L to about 0.4 mg/L (e.g., about 0.001 to about 0.005 mg/L, about 0.005 to about 0.01 mg/L, about 0.01 to about 0.05 mg/L, about 0.05 to about 0.1 mg/L, about 0.1 to about 0.4 mg/L, about 0.1 to about 0.3 mg/L, or about 0.2 to about 0.4 mg/L). In some embodiments, about 0.0005% to about 0.3% (e.g., about 0.0005% to about 0.001%, about 0.001% to about 0.005%, about 0.005% to about 0.01%, about 0.01% to about 0.05%, about 0.05% to about 0.1%, about 0.1% to about 0.3%, about 0.1% to about 0.2%, or about 0.2% to about 0.3%) by mass of the one or more additional VOCs can be benzyl alcohol. In some embodiments, the one or more additional VOCs can include no benzyl alcohol.

The one or more additional VOCs in a sake replica can include beta-damascenone (also called damascenone). In some embodiments, the beta-damascenone can be present in an amount of about 0.0000002 mg/L to about 0.000001 mg/L (e.g., about 0.0000002 to about 0.0000005 mg/L or about 0.0000005 to about 0.000001 mg/L). In some embodiments, about 0.00000006% to about 0.0000007% (e.g., about 0.00000006% to about 0.0000001%, about 0.0000001% to about 0.0000005%, about 0.0000001% to about 0.0000003%, about 0.0000003% to about 0.0000005%, or about 0.0000005% to about 0.0000007%) by mass of the one or more additional VOCs can be beta-damascenone. In some embodiments, the one or more additional VOCs can include no beta-damascenone.

The one or more additional VOCs in a sake replica can include beta-pinene (also called b-pinene or (-)-beta-pinene). In some embodiments, the beta-pinene can be present in an amount of about 0.00006 mg/L to about 0.0003 mg/L (e.g., about 0.00006 to about 0.0001 mg/L, about 0.0001 to about 0.0003 mg/L, about 0.0001 to about 0.0002 mg/L, or about 0.0002 to about 0.0003 mg/L). In some embodiments, about 0.00002% to about 0.0002% (e.g., about 0.00002% to about 0.00005%, about 0.00005% to about 0.0001%, or about 0.0001% to about 0.0002%) by mass of the one or more additional VOCs can be beta-pinene. In some embodiments, the one or more additional VOCs can include no beta-pinene.

The one or more additional VOCs in a sake replica can include butyl acetate. In some embodiments, the butyl acetate can be present in an amount of about 0.00002 mg/L to about 0.005 mg/L (e.g., about 0.00002 to about 0.00005 mg/L, about 0.00005 to about 0.0001 mg/L, about 0.0001 to about 0.0005 mg/L, about 0.0005 to about 0.001 mg/L, or about 0.001 to about 0.0005 mg/L). In some embodiments, about 0.00001% to about 0.004% (e.g., about 0.00001% to about 0.00005%, about 0.00005% to about 0.0001%, about 0.0001% to about 0.0005%, about 0.0005% to about 0.001%, about 0.001% to about 0.004%, about 0.001% to about 0.003%, or about 0.002% to about 0.004%) by mass of the one or more additional VOCs can be butyl acetate. In some embodiments, the one or more additional VOCs can include no butyl acetate.

The one or more additional VOCs in a sake replica can include butyl alcohol (also called butanol). In some embodiments, the butyl alcohol can be present in an amount of about 0.6 mg/L to about 11 mg/L (e.g., about 0.6 to about 1 mg/L, about 1 to about 11 mg/L, about 1 to about 10 mg/L, about 1 to about 5 mg/L, about 5 to about 10 mg/L, about 5 to about 11 mg/L, about 1 to about 3 mg/L, about 3 to about 5 mg/L, about 3 to about 7 mg/L, about 5 to about 7 mg/L, about 7 to about 9 mg/L, about 9 to about 11 mg/L, about 2 to about 4 mg/L, about 4 to about 6 mg/L, about 6 to about 8 mg/L, or about 8 to about 10 mg/L). In some embodiments, about 0.2% to about 8% (e.g., about 0.2% to about 0.5%, about 0.5% to about 1%, about 0.2% to about 1%, about 1% to about 8%, about 1% to about 5%, about 1% to about 3%, about 3% to about 5%, about 5% to about 7%, about 2% to about 4%, about 4% to about 6%, or about 6% to about 8%) by mass of the one or more additional VOCs can be butyl alcohol. In some embodiments, the one or more additional VOCs can include no butyl alcohol.

The one or more additional VOCs in a sake replica can include butyraldehyde. In some embodiments, the butyraldehyde can be present in an amount of about 0.0001 mg/L to about 0.01 mg/L (e.g., about 0.0001 to about 0.0005 mg/L, about 0.0005 to about 0.001 mg/L, about 0.001 to about 0.005 mg/L, or about 0.005 to about 0.01 mg/L). In some embodiments, about 0.00005% to about 0.008% (e.g., about 0.00005% to about 0.0001%, about 0.0001% to about 0.0005%, about 0.0005% to about 0.001%, about 0.001% to about 0.008%, about 0.001% to about 0.005%, about 0.005% to about 0.008%, about 0.002% to about 0.004%, about 0.004% to about 0.006%, or about 0.006% to about 0.008%) by mass of the one or more additional VOCs can be butyraldehyde. In some embodiments, the one or more additional VOCs can include no butyraldehyde.

The one or more additional VOCs in a sake replica can include cis-rose-oxide (also called (-)cis-rose oxide). In some embodiments, the cis-rose-oxide can be present in an amount of about 0.000005 mg/L to about 0.00015 mg/L (e.g., about 0.000005 to about 0.00001 mg/L, about 0.00001 to about 0.00005 mg/L, about 0.00005 to about 0.0001 mg/L, or about 0.00005 to about 0.00015 mg/L). In some embodiments, about 0.000002% to about 0.0001% (e.g., about 0.000002% to about 0.000005%, about 0.000005% to about 0.00001%, about 0.00001% to about 0.00005%, or about 0.00005% to about 0.0001%) by mass of the one or more additional VOCs can be cis-rose-oxide. In some embodiments, the one or more additional VOCs can include no cis-rose-oxide.

The one or more additional VOCs in a sake replica can include citronellol. In some embodiments, the citronellol can be present in an amount of about 0.0003 mg/L to about 0.025 mg/L (e.g., about 0.00003 to about 0.0001 mg/L, about 0.00005 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.02 mg/L, or about 0.010 to about 0.025 mg/L). In some embodiments, about 0.0001% to about 0.02% (e.g., 0.0001% to about 0.0005%, about 0.0005% to about 0.001%, about 0.001% to about 0.005%, about 0.005% to about 0.01%, or about 0.01% to about 0.02%) by mass of the one or more additional VOCs can be citronellol. In some embodiments, the one or more additional VOCs can include no citronellol.

The one or more additional VOCs in a sake replica can include D-camphor. In some embodiments, the D-camphor can be present in an amount of about 0.00001 mg/L to about 0.00006 mg/L (e.g., about 0.00001 to about 0.00005 mg/L, about 0.00001 to about 0.00003 mg/L, about 0.00003 to about 0.00005 mg/L, about 0.00002 to about 0.00004 mg/L, or about 0.00004 to about 0.00006 mg/L). In some embodiments, about 0.000005% to about 0.00005% (e.g., about 0.000005% to about 0.00001% or about 0.00001% to about 0.00005%) by mass of the one or more additional VOCs can be D-camphor. In some embodiments, the one or more additional VOCs can include no D-camphor. The one or more additional VOCs in a sake replica can include delta-decalactone.

In some embodiments, the delta-decalactone can be present in an amount of about 0.002 mg/L to about 0.015 mg/L (e.g., about 0.002 to about 0.005 mg/L, about 0.005 to about 0.01 mg/L, or about 0.005 to about 0.015 mg/L). In some embodiments, about 0.0007% to about 0.01% (e.g., about 0.0007% to about 0.001%, about 0.001% to about 0.005%, or about 0.005% to about 0.01%) by mass of the one or more additional VOCs can be delta-decalactone. In some embodiments, the one or more additional VOCs can include no delta-decalactone.

The one or more additional VOCs in a sake replica can include delta-dodecalactone. In some embodiments, the delta-dodecalactone can be present in an amount of about 0.0003 mg/L to about 0.003 mg/L (e.g., about 0.0003 to about 0.001 mg/L, about 0.0005 to about 0.001 mg/L, about 0.001 to about 0.003 mg/L, about 0.001 to about 0.002 mg/L, or about 0.002 to about 0.003 mg/L). In some embodiments, about 0.0001% to about 0.002% (e.g., about 0.0001% to about 0.0005%, about 0.0005% to about 0.001%, or about 0.001% to about 0.002%) by mass of the one or more additional VOCs can be delta-dodecalactone. In some embodiments, the one or more additional VOCs can include no delta-dodecalactone.

The one or more additional VOCs in a sake replica can include diethyl malate. In some embodiments, the diethyl malate can be present in an amount of about 0.0002 mg/L to about 0.2 mg/L (e.g., about 0.0002 to about 0.0005 mg/L, about 0.0002 to about 0.001 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.2 mg/L). In some embodiments, about 0.00006% to about 0.15% (e.g., about 0.00006% to about 0.0001%, about 0.0001% to about 0.0005%, about 0.0005% to about 0.001%, about 0.001% to about 0.005%, about 0.005% to about 0.01%, about 0.01% to about 0.05%, about 0.05% to about 0.1%, or about 0.05% to about 0.15%) by mass of the one or more additional VOCs can be diethyl malate. In some embodiments, the one or more additional VOCs can include no diethyl malate.

The one or more additional VOCs in a sake replica can include diethyl succinate. In some embodiments, the diethyl succinate can be present in an amount of about 0.002 mg/L to about 3.5 mg/L (e.g., about 0.002 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1.0 to about 3.5 mg/L, about 1 to about 3 mg/L, about 1 to about 2 mg/L, about 2 to about 3 mg/L, or about 2.0 to about 3.5 mg/L). In some embodiments, about 0.0007% to about 2.4% (e.g., about 0.0007% to about 0.001%, about 0.001% to about 0.005%, about 0.005% to about 0.01%, about 0.01% to about 0.05%, about 0.05% to about 0.1%, about 0.1% to about 0.5%, about 0.5% to about 1%, about 1% to about 2%, or about 1.0% to about 2.4%) by mass of the one or more additional VOCs can be diethyl succinate. In some embodiments, the one or more additional VOCs can include no diethyl succinate.

The one or more additional VOCs in a sake replica can include DL-3-methyl-2-butanol. In some embodiments, the DL-3-methyl-2-butanol can be present in an amount of about 0.003 mg/L to about 0.02 mg/L (e.g., about 0.003 to about 0.005 mg/L, about 0.003 to about 0.01 mg/L, about 0.005 to about 0.01 mg/L, or about 0.01 to about 0.02 mg/L). In some embodiments, about 0.001% to about 0.015% (e.g., about 0.001% to about 0.005%, about 0.005% to about 0.01%, or about 0.005% to about 0.015%) by mass of the one or more additional VOCs can be DL-3-methyl-2-butanol. In some embodiments, the one or more additional VOCs can include no DL-3-methyl-2-butanol.

The one or more additional VOCs in a sake replica can include ethyl 2-methylbutyrate. In some embodiments, the ethyl 2-methylbutyrate can be present in an amount of about 0.0006 mg/L to about 0.003 mg/L (e.g., about 0.0006 to about 0.001 mg/L, about 0.001 to about 0.003 mg/L, about 0.001 to about 0.002 mg/L, or about 0.002 to about 0.003 mg/L). In some embodiments, about 0.0002% to about 0.002% (e.g., about 0.0002% to about 0.0005%, about 0.0005% to about 0.001%, or about 0.001% to about 0.002%) by mass of the one or more additional VOCs can be ethyl 2-methylbutyrate. In some embodiments, the one or more additional VOCs can include no ethyl 2-methylbutyrate.

The one or more additional VOCs in a sake replica can include ethyl 3-hydroxyhexanoate. In some embodiments, the ethyl 3-hydroxyhexanoate can be present in an amount of about 0.001 mg/L to about 0.01 mg/L (e.g., about 0.001 to about 0.005 mg/L or about 0.005 to about 0.01 mg/L). In some embodiments, about 0.0005% to about 0.008% (e.g., about 0.0005% to about 0.001%, about 0.001% to about 0.008%, about 0.001% to about 0.005%, about 0.002% to about 0.004%, about 0.004% to about 0.006%, or about 0.006% to about 0.008%) by mass of the one or more additional VOCs can be ethyl 3-hydroxyhexanoate. In some embodiments, the one or more additional VOCs can include no ethyl 3-hydroxyhexanoate.

The one or more additional VOCs in a sake replica can include ethyl benzoate. In some embodiments, the ethyl benzoate can be present in an amount of about 0.0006 mg/L to about 0.003 mg/L (e.g., about 0.0006 to about 0.001 mg/L, about 0.001 to about 0.003 mg/L, about 0.001 to about 0.002 mg/L, or about 0.002 to about 0.003 mg/L). In some embodiments, about 0.0002% to about 0.0025% (e.g., about 0.0002% to about 0.0005%, about 0.0005% to about 0.001%, about 0.001% to about 0.002%, or about 0.0010% to about 0.0025%) by mass of the one or more additional VOCs can be ethyl benzoate. In some embodiments, the one or more additional VOCs can include no ethyl benzoate.

The one or more additional VOCs in a sake replica can include ethyl butanoate (also called ethyl butyrate). In some embodiments, the ethyl butanoate can be present in an amount of about 0.001 mg/L to about 0.8 mg/L (e.g., about 0.001 to about 0.005 mg/L, about 0.005 to about 0.01 mg/L, about 0.01 to about 0.05 mg/L, about 0.05 to about 0.1 mg/L, about 0.1 to about 0.8 mg/L, about 0.1 to about 0.5 mg/L, about 0.2 to about 0.8 mg/L, about 0.2 to about 0.4 mg/L, about 0.4 to about 0.6, or about 0.6 to about 0.8 mg/L). In some embodiments, the ethyl butanoate can be present in an amount of at least about 0.17 mg/L (e.g., at least about 0.18 mg/L, 0.19 mg/L, 0.2 mg/L, 0.3 mg/L, 0.4 mg/L, 0.5 mg/L, 0.6 mg/L, or 0.7 mg/L). In some embodiments, about 0.0005% to about 0.3% (e.g., about 0.0005% to about 0.001%, about 0.001% to about 0.005%, about 0.005% to about 0.01%, about 0.01% to about 0.05%, about 0.05% to about 0.1%, about 0.1% to about 0.3%, about 0.1% to about 0.2%, about 0.15% to about 0.30%, or about 0.2% to about 0.3%) by mass of the one or more additional VOCs can be ethyl butanoate. In some embodiments, at least about 0.12% (e.g., at least about 0.13%, 0.14%, 0.15%, 0.16%, 0.17%, 0.18%, 0.19%, 0.20%, 0.22%, 0.24%, 0.26%, or 0.28%) by mass of the one or more additional VOCs can be ethyl butanoate.

The one or more additional VOCs in a sake replica can include ethyl decanoate. In some embodiments, the ethyl decanoate can be present in an amount of about 0.02 mg/L to about 0.2 mg/L (e.g., about 0.02 to about 0.05 mg/L, about 0.05 to about 0.1 mg/L, or about 0.1 to about 0.2 mg/L). In some embodiments, about 0.01% to about 0.15% (e.g., about 0.01% to about 0.05%, about 0.05% to about 0.1%, or about 0.05% to about 0.15%) by mass of the one or more additional VOCs can be ethyl decanoate. In some embodiments, the one or more additional VOCs can include no ethyl decanoate.

The one or more additional VOCs in a sake replica can include ethyl heptanoate. In some embodiments, the ethyl heptanoate can be present in an amount of about 0.0005 mg/L to about 0.003 mg/L (e.g., 0.0005 to about 0.001 mg/L, about 0.001 to about 0.003 mg/L, about 0.001 to about 0.002 mg/L, or about 0.002 to about 0.003 mg/L). In some embodiments, about 0.00015% to about 0.002% (e.g., about 0.00015% to about 0.0005%, about 0.0005% to about 0.001%, or about 0.001% to about 0.002%) by mass of the one or more additional VOCs can be ethyl heptanoate. In some embodiments, the one or more additional VOCs can include no ethyl heptanoate.

The one or more additional VOCs in a sake replica can include ethyl hexanoate. In some embodiments, the ethyl hexanoate can be present in an amount of about 0.0007 mg/L to about 24 mg/L (e.g., 0.0007 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 1 to about 10 mg/L, about 5 to about 10 mg/L, about 2 to about 4 mg/L, about 2 to about 5 mg/L, about 10 to about 15 mg/L, about 10 to about 20 mg/L, about 15 to about 20 mg/L, about 15 to about 24 mg/L, or about 20 to about 24 mg/L). In some embodiments, about 0.0002% to about 17% (e.g., about 0.0002% to about 0.0005%, about 0.0005% to about 0.001%, about 0.001% to about 0.005%, about 0.005% to about 0.01%, about 0.01% to about 0.05%, about 0.05% to about 0.1%, about 0.1% to about 0.5%, about 0.5% to about 1%, about 1% to about 2%, about 1% to about 5%, about 2% to about 4%, about 2% to about 5%, about 1% to about 10%, about 5% to about 10%, about 10% to about 15%, about 10% to about 17%, or about 15% to about 17%) by mass of the one or more additional VOCs can be ethyl hexanoate.

The one or more additional VOCs in a sake replica can include ethyl isobutyrate. In some embodiments, the ethyl isobutyrate can be present in an amount of about 0.0001 mg/L to about 0.02 mg/L (e.g., about 0.0001 to about 0.0005 mg/L, about 0.0005 to about 0.001 mg/L, about 0.001 to about 0.005 mg/L, about 0.005 to about 0.01 mg/L, or about 0.01 to about 0.02 mg/L). In some embodiments, about 0.00004% to about 0.015% (e.g., about 0.00004% to about 0.0001%, about 0.00005% to about 0.0001%, about 0.0001% to about 0.0005%, about 0.0005% to about 0.001%, about 0.001% to about 0.005%, about 0.005% to about 0.01%, or about 0.005% to about 0.015%) by mass of the one or more additional VOCs can be ethyl isobutyrate. In some embodiments, the one or more additional VOCs can include no ethyl isobutyrate.

The one or more additional VOCs in a sake replica can include ethyl isovalerate. In some embodiments, the ethyl isovalerate can be present in an amount of about 0.0002 mg/L to about 0.015 mg/L (e.g., about 0.0002 to about 0.0005 mg/L, about 0.0005 to about 0.001 mg/L, about 0.001 to about 0.005 mg/L, about 0.005 to about 0.01 mg/L, or about 0.005 to about 0.015 mg/L). In some embodiments, about 0.00008% to about 0.009% (e.g., about 0.00008% to about 0.0001%, about 0.0001% to about 0.0005%, about 0.0005% to about 0.001%, about 0.001% to about 0.009%, about 0.001% to about 0.005%, or about 0.005% to about 0.009%) by mass of the one or more additional VOCs can be ethyl isovalerate. In some embodiments, the one or more additional VOCs can include no ethyl isovalerate.

The one or more additional VOCs in a sake replica can include ethyl lactate. In some embodiments, the ethyl lactate can be present in an amount of about 0.03 mg/L to about 12 mg/L (e.g., about 0.03 to about 0.1 mg/L, about 0.05 to about 0.1 mg/L, about 0.1 to about 0.5 mg/L, about 0.5 to about 1 mg/L, about 1 to about 5 mg/L, about 1 to about 10 mg/L, about 1 to about 12 mg/L, about 5 to about 10 mg/L, or about 5 to about 12 mg/L). In some embodiments, about 0.01% to about 9% (e.g., about 0.01% to about 0.05%, about 0.05% to about 0.1%, about 0.1% to about 0.5%, about 0.5% to about 1%, about 1% to about 5%, about 1% to about 9%, or about 5% to about 9%) by mass of the one or more additional VOCs can be ethyl lactate. In some embodiments, the one or more additional VOCs can include no ethyl lactate.

The one or more additional VOCs in a sake replica can include ethyl laurate. In some embodiments, the ethyl laurate can be present in an amount of about 0.0005 mg/L to about 0.01 mg/L (e.g., about 0.0005 to about 0.001 mg/L, about 0.001 to about 0.005 mg/L, or about 0.005 to about 0.01 mg/L). In some embodiments, about 0.0001% to about 0.007% (e.g., about 0.0001% to about 0.0005%, about 0.0005% to about 0.001%, about 0.001% to about 0.007%, about 0.001% to about 0.005%, about 0.001% to about 0.003%, about 0.003% to about 0.005%, about 0.005% to about 0.007%) by mass of the one or more additional VOCs can be ethyl laurate. In some embodiments, the one or more additional VOCs can include no ethyl laurate.

The one or more additional VOCs in a sake replica can include ethyl levulinate. In some embodiments, the ethyl levulinate can be present in an amount of about 0.07 mg/L to about 0.4 mg/L (e.g., about 0.07 to about 0.1 mg/L, about 0.1 to about 0.4 mg/L, about 0.1 to about 0.3 mg/L, or about 0.2 to about 0.4 mg/L). In some embodiments, about 0.025% to about 0.25% (e.g., about 0.025% to about 0.05%, about 0.05% to about 0.1%, about 0.1% to about 0.2%, or about 0.10% to about 0.25%) by mass of the one or more additional VOCs can be ethyl levulinate. In some embodiments, the one or more additional VOCs can include no ethyl levulinate.

The one or more additional VOCs in a sake replica can include ethyl nonanoate. In some embodiments, the ethyl nonanoate can be present in an amount of about 0.00004 mg/L to about 0.0002 mg/L (e.g., about 0.00004 to about 0.0001 mg/L, about 0.00005 to about 0.0001 mg/L, or about 0.0001 to about 0.0002 mg/L). In some embodiments, about 0.000015% to about 0.00015% (e.g., about 0.000015% to about 0.00005%, about 0.00005% to about 0.0001%, about 0.00005% to about 0.00015%) by mass of the one or more additional VOCs can be ethyl nonanoate. In some embodiments, the one or more additional VOCs can include no ethyl nonanoate.

The one or more additional VOCs in a sake replica can include ethyl octanoate. In some embodiments, the ethyl octanoate can be present in an amount of about 0.3 mg/L to about 5.5 mg/L (e.g., about 0.3 to about 0.5 mg/L, about 0.5 to about 1 mg/L, about 1 to about 5 mg/L, about 1 to about 5.5 mg/L, about 1 to about 3 mg/L, about 3 to about 5 mg/L, about 3 to about 5.5, about 3.5 to about 5 mg/L, or about 3.5 to about 5.5 mg/L). In some embodiments, the ethyl octanoate can be present in an amount of at least about 3.4 mg/L (e.g., at least about 3.5 mg/L, 3.6 mg/L, 3.7 mg/L, 3.8 mg/L, 3.9 mg/L, 4.0 mg/L, 4.2 mg/L, 4.4 mg/L, 4.6 mg/L, 4.8 mg/L, 5.0 mg/L, 5.2 mg/L, or 5.4 mg/L). In some embodiments, about 0.1% to about 2% (e.g., about 0.1% to about 0.5%, about 0.5% to about 1%, or about 1% to about 2%) by mass of the one or more additional VOCs can be ethyl octanoate. In some embodiments, the one or more additional VOCs can include no ethyl octanoate.

The one or more additional VOCs in a sake replica can include ethyl phenylacetate. In some embodiments, the ethyl phenylacetate can be present in an amount of about 0.0002 mg/L to about 0.025 mg/L (e.g., about 0.0002 to about 0.0005 mg/L, about 0.0005 to about 0.001 mg/L, about 0.001 to about 0.005 mg/L, about 0.005 to about 0.01 mg/L, about 0.01 to about 0.02 mg/L, or about 0.010 to about 0.025 mg/L). In some embodiments, about 0.00007% to about 0.02% (e.g., about 0.00007% to about 0.0001%, about 0.0001% to about 0.0005%, about 0.0005% to about 0.001%, about 0.001% to about 0.005%, about 0.005% to about 0.01%, or about 0.01% to about 0.02%) by mass of the one or more additional VOCs can be ethyl phenylacetate. In some embodiments, the one or more additional VOCs can include no ethyl phenylacetate.

The one or more additional VOCs in a sake replica can include ethyl propionate. In some embodiments, the ethyl propionate can be present in an amount of about 0.001 mg/L to about 0.07 mg/L (e.g., about 0.001 to about 0.005 mg/L, about 0.005 to about 0.01 mg/L, about 0.01 to about 0.07 mg/L, about 0.01 to about 0.05 mg/L, about 0.01 to about 0.03 mg/L, about 0.03 to about 0.05 mg/L, or about 0.05 to about 0.07 mg/L). In some embodiments, about 0.0005% to about 0.05% (e.g., about 0.0005% to about 0.001%, about 0.001% to about 0.005%, about 0.005% to about 0.01%, or about 0.01% to about 0.05%) by mass of the one or more additional VOCs can be ethyl propionate. In some embodiments, the one or more additional VOCs can include no ethyl propionate.

The one or more additional VOCs in a sake replica can include ethyl salicylate. In some embodiments, the ethyl salicylate can be present in an amount of about 0.0001 mg/L to about 0.0006 mg/L (e.g., about 0.0001 to about 0.0005 mg/L, about 0.0001 to about 0.0003 mg/L, about 0.0003 to about 0.0005 mg/L, about 0.0002 to about 0.0004 mg/L, or about 0.0004 to about 0.0006 mg/L). In some embodiments, about 0.00005% to about 0.0005% (e.g., about 0.00005% to about 0.0001% or about 0.0001% to about 0.0005%) by mass of the one or more additional VOCs can be ethyl salicylate. In some embodiments, the one or more additional VOCs can include no ethyl salicylate.

The one or more additional VOCs in a sake replica can include ethyl trans-2-butenoate. In some embodiments, the ethyl trans-2-butenoate can be present in an amount of about 0.00005 mg/L to about 0.01 mg/L (e.g., about 0.00005 to about 0.0001 mg/L, about 0.0001 to about 0.0005 mg/L, about 0.0005 to about 0.001 mg/L, about 0.001 to about 0.005 mg/L, or about 0.005 to about 0.01 mg/L). In some embodiments, about 0.000015% to about 0.007% (e.g., about 0.000015% to about 0.00005%, about 0.00005% to about 0.0001%, about 0.0001% to about 0.0005%, about 0.0005% to about 0.001%, about 0.001% to about 0.005%, about 0.001% to about 0.007%, about 0.001% to about 0.003%, about 0.003% to about 0.005%, or about 0.005% to about 0.007%) by mass of the one or more additional VOCs can be ethyl trans-2-butenoate. In some embodiments, the one or more additional VOCs can include no ethyl trans-2-butenoate.

The one or more additional VOCs in a sake replica can include ethyl valerate. In some embodiments, the ethyl valerate can be present in an amount of about 0.0001 mg/L to about 0.0008 mg/L (e.g., about 0.0001 to about 0.0005 mg/L, about 0.0005 to about 0.0008 mg/L, about 0.0001 to about 0.0003 mg/L, about 0.0003 to about 0.0005 mg/L, about 0.0005 to about 0.0007 mg/L, about 0.0002 to about 0.0004 mg/L, about 0.0004 to about 0.0006 mg/L, or about 0.0006 to about 0.0008 mg/L). In some embodiments, about 0.00005% to about 0.0005% (e.g., about 0.00005% to about 0.0001% or about 0.0001% to about 0.0005%) by mass of the one or more additional VOCs can be ethyl valerate. In some embodiments, the one or more additional VOCs can include no ethyl valerate.

The one or more additional VOCs in a sake replica can include ethyl(methylthio) acetate. In some embodiments, the ethyl(methylthio) acetate can be present in an amount of about 0.00003 mg/L to about 0.0015 mg/L (e.g., about 0.00003 to about 0.00005 mg/L, about 0.00003 to about 0.0001 mg/L, about 0.00005 to about 0.0001 mg/L, about 0.0001 to about 0.0005 mg/L, about 0.0005 to about 0.001 mg/L, or about 0.0005 to about 0.0015 mg/L). In some embodiments, about 0.00001% to about 0.0008% (e.g., about 0.00001% to about 0.00005%, about 0.00005% to about 0.0001%, about 0.0001% to about 0.0008%, about 0.0001% to about 0.0005%, or about 0.0005% to about 0.0008%) by mass of the one or more additional VOCs can be ethyl(methylthio) acetate. In some embodiments, the one or more additional VOCs can include no ethyl(methylthio) acetate.

The one or more additional VOCs in a sake replica can include ethyl-trans-3-hexenoate. In some embodiments, the ethyl-trans-3-hexenoate can be present in an amount of about 0.00008 mg/L to about 0.0004 mg/L (e.g., about 0.00008 to about 0.0001 mg/L, about 0.0001 to about 0.0004 mg/L, about 0.0001 to about 0.0003 mg/L, or about 0.0002 to about 0.0004 mg/L). In some embodiments, about 0.00002% to about 0.0003% (e.g., about 0.00002% to about 0.00005%, about 0.00005% to about 0.0001%, about 0.0001% to about 0.0003%, about 0.0001% to about 0.0002%, or about 0.0002% to about 0.0003%) by mass of the one or more additional VOCs can be ethyl-trans-3-hexenoate. In some embodiments, the one or more additional VOCs can include no ethyl-trans-3-hexenoate.

The one or more additional VOCs in a sake replica can include furfural. In some embodiments, the furfural can be present in an amount of about 0.003 mg/L to about 9.5 mg/L (e.g., about 0.003 to about 0.01 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 1 to about 9 mg/L, about 1 to about 9.5 mg/L, about 5 to about 9 mg/L, about 5 to about 9.5 mg/L, about 1 to about 3 mg/L, about 3 to about 5 mg/L, about 6 to about 8 mg/L, about 5 to about 7 mg/L, about 7 to about 9 mg/L, or about 7 to about 9.5 mg/L). In some embodiments, the furfural can be present in an amount of at least about 0.45 mg/L (e.g., at least about 0.5 mg/L, 0.6 mg/L, 0.7 mg/L, 0.8 mg/L, 0.9 mg/L, 1.0 mg/L, 1.5 mg/L, 2.0 mg/L, 2.5 mg/L, 3.0 mg/L, 3.5 mg/L, 4.0 mg/L, 4.5 mg/L, 5.0 mg/L, 5.5 mg/L, 6.0 mg/L, 6.5 mg/L, 7.0 mg/L, 7.5 mg/L, 8.0 mg/L, 8.5 mg/L, or 9.0 mg/L). In some embodiments, about 0.001% to about 3.5% (e.g., about 0.001% to about 0.005%, about 0.005% to about 0.01%, about 0.01% to about 0.05%, about 0.05% to about 0.1%, about 0.1% to about 0.5%, about 0.5% to about 1%, about 1% to about 3%, about 1.0% to about 3.5%, about 1% to about 2%, about 2% to about 3%, or about 2.0% to about 3.5%) by mass of the one or more additional VOCs can be furfural. In some embodiments, at least about 0.31% (e.g., at least about 0.32%, 0.33%, 0.34%, 0.35%, 0.4%, 0.5%, 0.6%, 0.7%, 0.8%, 0.9%, 1.0%, 1.5%, 2.0%, 2.5%, or 3.0%) of the one or more additional VOCs can be furfural.

The one or more additional VOCs in a sake replica can include gamma-dodecalactone. In some embodiments, the gamma-dodecalactone can be present in an amount of about 0.0001 mg/L to about 0.0007 mg/L (e.g., about 0.0001 to about 0.0005 mg/L, about 0.0001 to about 0.0003 mg/L, about 0.0003 to about 0.0005 mg/L, or about 0.0005 to about 0.0007 mg/L). In some embodiments, about 0.00004% to about 0.0005% (e.g., about 0.00004% to about 0.0001%, about 0.00005% to about 0.0001%, or about 0.0001% to about 0.0005%) by mass of the one or more additional VOCs can be gamma-dodecalactone. In some embodiments, the one or more additional VOCs can include no gamma-dodecalactone.

The one or more additional VOCs in a sake replica can include gamma-heptalactone. In some embodiments, the gamma-heptalactone can be present in an amount of about 0.001 mg/L to about 0.08 mg/L (e.g., about 0.001 to about 0.005 mg/L, about 0.005 to about 0.01 mg/L, about 0.01 to about 0.05 mg/L, about 0.01 to about 0.08 mg/L, or about 0.05 to about 0.08 mg/L). In some embodiments, about 0.0003% to about 0.05% (e.g., about 0.0003% to about 0.0005%, about 0.0005% to about 0.001%, about 0.001% to about 0.005%, about 0.005% to about 0.01%, or about 0.01% to about 0.05%) by mass of the one or more additional VOCs can be gamma-heptalactone. In some embodiments, the one or more additional VOCs can include no gamma-heptalactone.

The one or more additional VOCs in a sake replica can include gamma-hexalactone. In some embodiments, the gamma-hexalactone can be present in an amount of about 0.0001 mg/L to about 0.08 mg/L (e.g., about 0.0001 to about 0.0005 mg/L, about 0.0005 to about 0.001 mg/L, about 0.001 to about 0.005 mg/L, about 0.005 to about 0.01 mg/L, about 0.01 to about 0.08 mg/L, about 0.01 to about 0.05 mg/L, or about 0.05 to about 0.08 mg/L). In some embodiments, about 0.00006% to about 0.06% (e.g., about 0.00006% to about 0.0001%, about 0.0001% to about 0.0005%, about 0.0005% to about 0.001%, about 0.001% to about 0.005%, about 0.005% to about 0.01%, about 0.01% to about 0.05%, about 0.01% to about 0.06%, about 0.01% to about 0.03%, about 0.03% to about 0.05%, about 0.02% to about 0.04%, or about 0.04% to about 0.06%) by mass of the one or more additional VOCs can be gamma-hexalactone. In some embodiments, the one or more additional VOCs can include no gamma-hexalactone.

The one or more additional VOCs in a sake replica can include gamma-nonalactone. In some embodiments, the gamma-nonalactone can be present in an amount of about 0.00002 mg/L to about 0.00009 mg/L (e.g., about 0.00002 to about 0.00005 mg/L, about 0.00005 to about 0.00009 mg/L, about 0.00002 to about 0.00004 mg/L, about 0.00004 to about 0.00006 mg/L, about 0.00006 to about 0.0008 mg/L, about 0.00003 to about 0.00005 mg/L, about 0.00005 to about 0.00007 mg/L, or about 0.00007 to about 0.00009 mg/L). In some embodiments, about 0.000006% to about 0.0006% (e.g., about 0.000006% to about 0.00001%, about 0.00001% to about 0.00005%, about 0.00005% to about 0.0001%, about 0.0001% to about 0.0005%, about 0.0001% to about 0.0006%, about 0.0001% to about 0.0003%, about 0.0003% to about 0.0005%, about 0.0002% to about 0.0004%, or about 0.0004% to about 0.0006%) by mass of the one or more additional VOCs can be gamma-nonalactone. In some embodiments, the one or more additional VOCs can include no gamma-nonalactone.

The one or more additional VOCs in a sake replica can include gamma-octalactone. In some embodiments, the gamma-octalactone can be present in an amount of about 0.00004 mg/L to about 0.005 mg/L (e.g., about 0.00004 to about 0.0001 mg/L, about 0.00005 to about 0.0001 mg/L, about 0.0001 to about 0.0005 mg/L, about 0.0005 to about 0.001 mg/L, or about 0.001 to about 0.005 mg/L). In some embodiments, about 0.000015% to about 0.004% (e.g., about 0.000015% to about 0.00005%, about 0.00005% to about 0.0001%, about 0.0001% to about 0.0005%, about 0.0005% to about 0.001%, about 0.001% to about 0.004%, about 0.001% to about 0.003%, or about 0.002% to about 0.004%) by mass of the one or more additional VOCs can be gamma-octalactone. In some embodiments, the one or more additional VOCs can include no gamma-octalactone.

The one or more additional VOCs in a sake replica can include geraniol. In some embodiments, the geraniol can be present in an amount of about 0.0001 mg/L to about 0.0006 mg/L (e.g., about 0.0001 to about 0.0005 mg/L, about 0.0001 to about 0.0003 mg/L, about 0.0003 to about 0.0005 mg/L, about 0.0002 to about 0.0004 mg/L, or about 0.0004 to about 0.0006 mg/L). In some embodiments, about 0.00004% to about 0.0004% (e.g., 0.00004% to about 0.0001%, about 0.00005% to about 0.0001%, about 0.0001% to about 0.0004%, about 0.0001% to about 0.0003%, or about 0.0002% to about 0.0004%) by mass of the one or more additional VOCs can be geraniol. In some embodiments, the one or more additional VOCs can include no geraniol.

The one or more additional VOCs in a sake replica can include guaiacol. In some embodiments, the guaiacol can be present in an amount of about 0.0001 mg/L to about 0.0015 mg/L (e.g., about 0.0001 to about 0.0005 mg/L, about 0.0005 to about 0.001 mg/L, or about 0.0005 to about 0.0015 mg/L). In some embodiments, about 0.00003% to about 0.0009% (e.g., about 0.00003% to about 0.00005%, about 0.00005% to about 0.0001%, about 0.0001% to about 0.0005%, about 0.0001% to about 0.0009%, or about 0.0005% to about 0.0009%) by mass of the one or more additional VOCs can be guaiacol. In some embodiments, the one or more additional VOCs can include no guaiacol.

The one or more additional VOCs in a sake replica can include heptyl acetate. In some embodiments, the heptyl acetate can be present in an amount of about 0.0003 mg/L to about 0.002 mg/L (e.g., about 0.0003 to about 0.0005 mg/L, about 0.0005 to about 0.001 mg/L, or about 0.001 to about 0.002 mg/L). In some embodiments, about 0.0001% to about 0.001% (e.g., about 0.0001% to about 0.0005% or about 0.0005% to about 0.001%) by mass of the one or more additional VOCs can be heptyl acetate. In some embodiments, the one or more additional VOCs can include no heptyl acetate.

The one or more additional VOCs in a sake replica can include hexanol. In some embodiments, the hexanol can be present in an amount of about 0.00007 mg/L to about 0.2 mg/L (e.g., about 0.00007 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.2 mg/L). In some embodiments, about 0.000025% to about 0.15% (e.g., about 0.000025% to about 0.00005%, about 0.00005% to about 0.0001%, about 0.0001% to about 0.0005%, about 0.0005% to about 0.001%, about 0.001% to about 0.005%, about 0.005% to about 0.01%, about 0.01% to about 0.05%, about 0.05% to about 0.1%, or about 0.05% to about 0.15%) by mass of the one or more additional VOCs can be hexanol. In some embodiments, the one or more additional VOCs can include no hexanol.

The one or more additional VOCs in a sake replica can include hexyl acetate. In some embodiments, the hexyl acetate can be present in an amount of about 0.0003 mg/L to about 0.0015 mg/L (e.g., about 0.0003 to about 0.0005 mg/L, about 0.0005 to about 0.001 mg/L, or about 0.0005 to about 0.0015 mg/L). In some embodiments, about 0.0001% to about 0.001% (e.g., about 0.0001% to about 0.0005% or about 0.0005% to about 0.001%) by mass of the one or more additional VOCs can be hexyl acetate. In some embodiments, the one or more additional VOCs can include no hexyl acetate.

The one or more additional VOCs in a sake replica can include indole. In some embodiments, the indole can be present in an amount of about 0.00006 mg/L to about 0.0003 mg/L (e.g., about 0.00006 to about 0.0001 mg/L, about 0.0001 to about 0.0003 mg/L, about 0.0001 to about 0.0002 mg/L, or about 0.0002 to about 0.0003 mg/L). In some embodiments, about 0.00002% to about 0.0002% (e.g., about 0.00002% to about 0.00005%, about 0.00005% to about 0.0001%, or about 0.0001% to about 0.0002%) by mass of the one or more additional VOCs can be indole. In some embodiments, the one or more additional VOCs can include no indole.

The one or more additional VOCs in a sake replica can include isoamyl acetate. In some embodiments, the isoamyl acetate can be present in an amount of about 0.2 mg/L to about 1.5 mg/L (e.g., about 0.2 to about 0.5 mg/L, about 0.5 to about 1 mg/L, or about 0.5 to about 1.5 mg/L). In some embodiments, about 0.08% to about 1% (e.g., about 0.08% to about 0.1%, about 0.1% to about 0.5%, or about 0.5% to about 1%) by mass of the one or more additional VOCs can be isoamyl acetate.

The one or more additional VOCs in a sake replica can include isoamyl hexanoate. In some embodiments, the isoamyl hexanoate can be present in an amount of about 0.0002 mg/L to about 0.01 mg/L (e.g., about 0.0002 to about 0.0005 mg/L, about 0.0005 to about 0.001 mg/L, about 0.001 to about 0.005 mg/L, or about 0.005 to about 0.01 mg/L). In some embodiments, about 0.00008% to about 0.007% (e.g., about 0.00008% to about 0.0001%, about 0.0001% to about 0.0005%, about 0.0005% to about 0.001%, about 0.001% to about 0.005%, about 0.001% to about 0.007%, about 0.001% to about 0.003%, about 0.003% to about 0.005%, or about 0.005% to about 0.007%) by mass of the one or more additional VOCs can be isoamyl hexanoate. In some embodiments, the one or more additional VOCs can include no isoamyl hexanoate.

The one or more additional VOCs in a sake replica can include isoamyl octanoate. In some embodiments, the isoamyl octanoate can be present in an amount of about 0.0008 mg/L to about 0.004 mg/L (e.g., 0.0008 to about 0.001 mg/L, about 0.001 to about 0.004 mg/L, about 0.001 to about 0.003 mg/L, or about 0.002 to about 0.004 mg/L). In some embodiments, about 0.0002% to about 0.003% (e.g., about 0.0002% to about 0.0005%, about 0.0005% to about 0.001%, about 0.001% to about 0.003%, about 0.001% to about 0.002%, or about 0.002% to about 0.003%) by mass of the one or more additional VOCs can be isoamyl octanoate. In some embodiments, the one or more additional VOCs can include no isoamyl octanoate.

The one or more additional VOCs in a sake replica can include isobutyl acetate. In some embodiments, the isobutyl acetate can be present in an amount of about 0.001 mg/L to about 0.15 mg/L (e.g., about 0.001 to about 0.005 mg/L, about 0.005 to about 0.01 mg/L, about 0.01 to about 0.05 mg/L, about 0.05 to about 0.1 mg/L, or about 0.05 to about 0.15 mg/L). In some embodiments, about 0.0003% to about 0.1% (e.g., about 0.0003% to about 0.0005%, about 0.0005% to about 0.001%, about 0.001% to about 0.005%, about 0.005% to about 0.01%, about 0.01% to about 0.05%, or about 0.05% to about 0.1%) by mass of the one or more additional VOCs can be isobutyl acetate. In some embodiments, the one or more additional VOCs can include no isobutyl acetate.

The one or more additional VOCs in a sake replica can include isobutyl propionate. In some embodiments, the isobutyl propionate can be present in an amount of about 0.0005 mg/L to about 0.002 mg/L (e.g., about 0.0005 to about 0.001 mg/L or about 0.001 to about 0.002 mg/L). In some embodiments, about 0.0001% to about 0.002% (e.g., about 0.0001% to about 0.0005%, about 0.0005% to about 0.001%, or about 0.001% to about 0.002%) by mass of the one or more additional VOCs can be isobutyl propionate. In some embodiments, the one or more additional VOCs can include no isobutyl propionate.

The one or more additional VOCs in a sake replica can include isobutyraldehyde. In some embodiments, the isobutyraldehyde can be present in an amount of about 0.0002 mg/L to about 0.05 mg/L (e.g., about 0.0002 to about 0.0005 mg/L, about 0.0005 to about 0.001 mg/L, about 0.001 to about 0.005 mg/L, about 0.005 to about 0.01 mg/L, or about 0.01 to about 0.05 mg/L). In some embodiments, about 0.00007% to about 0.03% (e.g., about 0.00007% to about 0.0001%, about 0.0001% to about 0.0005%, about 0.0005% to about 0.001%, about 0.001% to about 0.005%, about 0.005% to about 0.01%, about 0.01% to about 0.03%, about 0.01% to about 0.02%, or about 0.02% to about 0.03%) by mass of the one or more additional VOCs can be isobutyraldehyde. In some embodiments, the one or more additional VOCs can include no isobutyraldehyde.

The one or more additional VOCs in a sake replica can include isobutyric acid. In some embodiments, the isobutyric acid can be present in an amount of about 0.02 mg/L to about 0.6 mg/L (e.g., about 0.02 to about 0.05 mg/L, about 0.05 to about 0.1 mg/L, about 0.1 to about 0.6 mg/L, about 0.1 to about 0.5 mg/L, about 0.1 to about 0.3 mg/L, about 0.3 to about 0.5 mg/L, about 0.2 to about 0.4 mg/L, or about 0.4 to about 0.6 mg/L). In some embodiments, about 0.008% to about 0.5% (e.g., about 0.008% to about 0.01%, about 0.01% to about 0.05%, about 0.05% to about 0.1%, or about 0.1% to about 0.5%) by mass of the one or more additional VOCs can be isobutyric acid. In some embodiments, the one or more additional VOCs can include no isobutyric acid.

The one or more additional VOCs in a sake replica can include isovaleraldehyde. In some embodiments, the isovaleraldehyde can be present in an amount of about 0.03 mg/L to about 0.6 mg/L (e.g., about 0.03 to about 0.05 mg/L, about 0.05 to about 0.1 mg/L, about 0.1 to about 0.5 mg/L, about 0.1 to about 0.6 mg/L, about 0.1 to about 0.3 mg/L, about 0.3 to about 0.5 mg/L, about 0.2 to about 0.4 mg/L, or about 0.4 to about 0.6 mg/L). In some embodiments, about 0.01% to about 0.4% (e.g., about 0.01% to about 0.05%, about 0.05% to about 0.1%, about 0.1% to about 0.4%, about 0.1% to about 0.3%, or about 0.2% to about 0.4%) by mass of the one or more additional VOCs can be isovaleraldehyde. In some embodiments, the one or more additional VOCs can include no isovaleraldehyde.

The one or more additional VOCs in a sake replica can include isovaleric acid. In some embodiments, the isovaleric acid can be present in an amount of about 0.002 mg/L to about 0.2 mg/L (e.g., about 0.002 to about 0.005 mg/L, about 0.005 to about 0.01 mg/L, about 0.01 to about 0.05 mg/L, about 0.05 to about 0.1 mg/L, or about 0.1 to about 0.2 mg/L). In some embodiments, about 0.0007% to about 0.15% (e.g., about 0.0007% to about 0.001%, about 0.001% to about 0.005%, about 0.005% to about 0.01%, about 0.01% to about 0.05%, about 0.05% to about 0.1%, or about 0.05% to about 0.15%) by mass of the one or more additional VOCs can be isovaleric acid. In some embodiments, the one or more additional VOCs can include no isovaleric acid.

The one or more additional VOCs in a sake replica can include limonene. In some embodiments, the limonene can be present in an amount of about 0.00004 mg/L to about 0.002 mg/L (e.g., about 0.00004 to about 0.0001 mg/L, about 0.00005 to about 0.0001 mg/L, about 0.0001 to about 0.0005 mg/L, about 0.0005 to about 0.001 mg/L, or about 0.001 to about 0.002 mg/L). In some embodiments, about 0.00001% to about 0.001% (e.g., about 0.00001% to about 0.00005%, about 0.00005% to about 0.0001%, about 0.0001% to about 0.0005%, or about 0.0005% to about 0.001%) by mass of the one or more additional VOCs can be limonene. In some embodiments, the one or more additional VOCs can include no limonene.

The one or more additional VOCs in a sake replica can include methionyl acetate (also called 3-methylthio-propylacetate). In some embodiments, the methionyl acetate can be present in an amount of about 0.000002 mg/L to about 0.003 mg/L (e.g., about 0.000002 to about 0.000005 mg/L, about 0.000005 to about 0.00001 mg/L, about 0.00001 to about 0.00005 mg/L, about 0.00005 mg/L to about 0.0001 mg/L, about 0.0001 to about 0.0005 mg/L, about 0.0005 to about 0.001 mg/L, about 0.001 to about 0.003 mg/L, about 0.001 to about 0.002 mg/L, or about 0.002 to about 0.003 mg/L). In some embodiments, about 0.000001% to about 0.003% (e.g., 0.000001% to about 0.000005%, about 0.000005% to about 0.00001%, about 0.00001% to about 0.00005%, about 0.00005% to about 0.0001%, about 0.0001% to about 0.0005%, about 0.0005% to about 0.001%, about 0.001% to about 0.003%, about 0.001% to about 0.002%, or about 0.002% to about 0.003%) by mass of the one or more additional VOCs can be methionyl acetate. In some embodiments, the one or more additional VOCs can include no methionyl acetate.

The one or more additional VOCs in a sake replica can include methyl acetate. In some embodiments, the methyl acetate can be present in an amount of about 0.001 mg/L to about 0.07 mg/L (e.g., about 0.001 to about 0.005 mg/L, about 0.005 to about 0.01 mg/L, about 0.01 to about 0.05 mg/L, about 0.01 to about 0.07 mg/L, about 0.01 to about 0.03 mg/L, about 0.03 to about 0.05 mg/L, or about 0.05 to about 0.07 mg/L). In some embodiments, about 0.0003% to about 0.05% (e.g., about 0.0003% to about 0.0005%, about 0.0005% to about 0.001%, about 0.001% to about 0.005%, about 0.005% to about 0.01%, or about 0.01% to about 0.05%) by mass of the one or more additional VOCs can be methyl acetate. In some embodiments, the one or more additional VOCs can include no methyl acetate.

The one or more additional VOCs in a sake replica can include methyl hexanoate. In some embodiments, the methyl hexanoate can be present in an amount of about 0.00002 mg/L to about 0.0004 mg/L (e.g., 0.00002 to about 0.00005 mg/L, about 0.00005 to about 0.0001 mg/L, about 0.0001 to about 0.0004 mg/L, about 0.0001 to about 0.0003 mg/L, or about 0.0002 to about 0.0004 mg/L). In some embodiments, about 0.000005% to about 0.0003% (e.g., about 0.000005% to about 0.00001%, about 0.00001% to about 0.00005%, about 0.00005% to about 0.0001%, about 0.0001% to about 0.0003%, about 0.0001% to about 0.0002%, or about 0.0002% to about 0.0003%) by mass of the one or more additional VOCs can be methyl hexanoate. In some embodiments, the one or more additional VOCs can include no methyl hexanoate.

The one or more additional VOCs in a sake replica can include methyl laurate. In some embodiments, the methyl laurate can be present in an amount of about 0.0003 mg/L to about 0.0015 mg/L (e.g., about 0.0003 to about 0.0005 mg/L, about 0.0005 to about 0.001 mg/L, or about 0.0005 to about 0.0015 mg/L). In some embodiments, about 0.0001% to about 0.001% (e.g., about 0.0001% to about 0.0005% or about 0.0005% to about 0.001%) by mass of the one or more additional VOCs can be methyl laurate. In some embodiments, the one or more additional VOCs can include no methyl laurate.

The one or more additional VOCs in a sake replica can include methyl β-naphthyl ketone. In some embodiments, the methyl β-naphthyl ketone can be present in an amount of about 0.00002 mg/L to about 0.0001 mg/L (e.g., about 0.00002 to about 0.00005 mg/L or about 0.00005 to about 0.0001 mg/L). In some embodiments, about 0.000007% to about 0.00007% (e.g., about 0.000007% to about 0.00001%, about 0.00001% to about 0.00005%, about 0.00001% to about 0.00007%, about 0.00001% to about 0.00003%, about 0.00003% to about 0.00005%, or about 0.00005% to about 0.00007%) by mass of the one or more additional VOCs can be methyl β-naphthyl ketone. In some embodiments, the one or more additional VOCs can include no methyl β-naphthyl ketone.

The one or more additional VOCs in a sake replica can include methyl-2-pyrrolyl ketone. In some embodiments, the methyl-2-pyrrolyl ketone can be present in an amount of about 0.0004 mg/L to about 0.002 mg/L (e.g., about 0.0004 to about 0.001 mg/L, about 0.0005 to about 0.001 mg/L, or about 0.001 to about 0.002 mg/L). In some embodiments, about 0.0001% to about 0.0015% (e.g., about 0.0001% to about 0.0005%, about 0.0005% to about 0.001%, or about 0.0005% to about 0.0015%) by mass of the one or more additional VOCs can be methyl-2-pyrrolyl ketone. In some embodiments, the one or more additional VOCs can include no methyl-2-pyrrolyl ketone.

The one or more additional VOCs in a sake replica can include nonanal. In some embodiments, the nonanal can be present in an amount of about 0.00004 mg/L to about 0.002 mg/L (e.g., about 0.00004 to about 0.0001 mg/L, about 0.00005 to about 0.0001 mg/L, about 0.0001 to about 0.0005 mg/L, about 0.0005 to about 0.001 mg/L, or about 0.001 to about 0.002 mg/L). In some embodiments, about 0.00001% to about 0.0015% (e.g., about 0.00001% to about 0.00005%, about 0.00005% to about 0.0001%, about 0.0001% to about 0.0005%, about 0.0005% to about 0.001%, or about 0.0005% to about 0.0015%) by mass of the one or more additional VOCs can be nonanal. In some embodiments, the one or more additional VOCs can include no nonanal.

The one or more additional VOCs in a sake replica can include nonanoic acid. In some embodiments, the nonanoic acid can be present in an amount of about 0.00006 mg/L to about 0.007 mg/L (e.g., about 0.00006 to about 0.0001 mg/L, about 0.0001 to about 0.0005 mg/L, about 0.0005 to about 0.001 mg/L, about 0.001 to about 0.005 mg/L, about 0.001 to about 0.007 mg/L, about 0.001 to about 0.003 mg/L, about 0.003 to about 0.005 mg/L, or about 0.005 to about 0.007 mg/L). In some embodiments, about 0.00002% to about 0.005% (e.g., about 0.00002% to about 0.00005%, about 0.00005% to about 0.0001%, about 0.0001% to about 0.0005%, about 0.0005% to about 0.001%, or about 0.001% to about 0.005%) by mass of the one or more additional VOCs can be nonanoic acid. In some embodiments, the one or more additional VOCs can include no nonanoic acid.

The one or more additional VOCs in a sake replica can include octanal. In some embodiments, the octanal can be present in an amount of about 0.00003 mg/L to about 0.0007 mg/L (e.g., about 0.00003 to about 0.00005 mg/L, about 0.00005 to about 0.0001 mg/L, about 0.0001 to about 0.0005 mg/L, about 0.0001 to about 0.0007 mg/L, about 0.0001 to about 0.0003 mg/L, about 0.0003 to about 0.0005 mg/L, or about 0.0005 to about 0.0007 mg/L). In some embodiments, about 0.00001% to about 0.0005% (e.g., about 0.00001% to about 0.00005%, about 0.00005% to about 0.0001%, or about 0.0001% to about 0.0005%) by mass of the one or more additional VOCs can be octanal. In some embodiments, the one or more additional VOCs can include no octanal.

The one or more additional VOCs in a sake replica can include p-anisaldehyde. In some embodiments, the p-anisaldehyde can be present in an amount of about 0.0000003 mg/L to about 0.0000015 mg/L (e.g., about 0.0000003 to about 0.0000005 mg/L, about 0.0000005 to about 0.000001 mg/L, or about 0.0000005 to about 0.0000015 mg/L). In some embodiments, about 0.0000001% to about 0.000001% (e.g., about 0.0000001% to about 0.0000005% or about 0.0000005% to about 0.000001%) by mass of the one or more additional VOCs can be p-anisaldehyde. In some embodiments, the one or more additional VOCs can include no p-anisaldehyde.

The one or more additional VOCs in a sake replica can include p-cresol. In some embodiments, the p-cresol can be present in an amount of about 0.0002 mg/L to about 0.0015 mg/L (e.g., about 0.0002 to about 0.0005 mg/L, about 0.0005 to about 0.001 mg/L, or about 0.0005 to about 0.0015 mg/L). In some embodiments, about 0.00009% to about 0.0009% (e.g., about 0.00009% to about 0.0005%, about 0.0001% to about 0.0009%, about 0.0001% to about 0.0005%, or about 0.0005% to about 0.0009%) by mass of the one or more additional VOCs can be p-cresol. In some embodiments, the one or more additional VOCs can include no p-cresol.

The one or more additional VOCs in a sake replica can include phenethyl acetate. In some embodiments, the phenethyl acetate can be present in an amount of about 0.0003 mg/L to about 1 mg/L (e.g., about 0.0003 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.2 mg/L, about 0.1 to about 0.5 mg/L, or about 0.5 to about 1 mg/L). In some embodiments, about 0.0001% to about 0.7% (e.g., about 0.0001% to about 0.0005%, about 0.0005% to about 0.001%, about 0.001% to about 0.005%, about 0.005% to about 0.01%, about 0.01% to about 0.05%, about 0.01% to about 0.1%, about 0.04% to about 0.06%, about 0.05% to about 0.1%, about 0.1% to about 0.5%, about 0.1% to about 0.7%, about 0.1% to about 0.3%, about 0.3% to about 0.5%, or about 0.5% to about 0.7%) by mass of the one or more additional VOCs can be phenethyl acetate.

The one or more additional VOCs in a sake replica can include phenethyl formate. In some embodiments, the phenethyl formate can be present in an amount of about 0.04 mg/L to about 0.5 mg/L (e.g., about 0.04 to about 0.1 mg/L, about 0.05 to about 0.1 mg/L, or about 0.1 to about 0.5 mg/L). In some embodiments, about 0.015% to about 0.35% (e.g., about 0.015% to about 0.05%, about 0.05% to about 0.1%, about 0.1% to about 0.3%, about 0.10% to about 0.35%, about 0.1% to about 0.2%, about 0.2% to about 0.3%, or about 0.20% to about 0.35%) by mass of the one or more additional VOCs can be phenethyl formate. In some embodiments, the one or more additional VOCs can include no phenethyl formate.

The one or more additional VOCs in a sake replica can include phenethyl propionate. In some embodiments, the phenethyl propionate can be present in an amount of about 0.00003 mg/L to about 0.0003 mg/L (e.g., about 0.00003 to about 0.00005 mg/L, about 0.00005 to about 0.0001 mg/L, about 0.0001 to about 0.0003 mg/L, about 0.0001 to about 0.0002 mg/L, or about 0.0002 to about 0.0003 mg/L). In some embodiments, about 0.00001% to about 0.0002% (e.g., about 0.00001% to about 0.00005%, about 0.00005% to about 0.0001%, or about 0.0001% to about 0.0002%) by mass of the one or more additional VOCs can be phenethyl propionate. In some embodiments, the one or more additional VOCs can include no phenethyl propionate.

The one or more additional VOCs in a sake replica can include phenylacetaldehyde. In some embodiments, the phenylacetaldehyde can be present in an amount of about 0.0006 mg/L to about 0.15 mg/L (e.g., about 0.0006 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.05 to about 0.15 mg/L). In some embodiments, about 0.0002% to about 0.1% (e.g., about 0.0002% to about 0.0005%, about 0.0005% to about 0.001%, about 0.001% to about 0.005%, about 0.005% to about 0.01%, about 0.01% to about 0.05%, or about 0.05% to about 0.1%) by mass of the one or more additional VOCs can be phenylacetaldehyde. In some embodiments, the one or more additional VOCs can include no phenylacetaldehyde.

The one or more additional VOCs in a sake replica can include propanol. In some embodiments, the propanol can be present in an amount of about 2 mg/L to about 175 mg/L (e.g., about 2 to about 5 mg/L, about 2 to about 10 mg/L, about 5 to about 10 mg/L, about 7 to about 9 mg/L, about 10 to about 20 mg/L, about 10 to about 30 mg/L, about 10 to about 40 mg/L, about 10 to about 50 mg/L, about 20 to about 50 mg/L, about 50 to about 100 mg/L, about 100 to about 150 mg/L, about 150 to about 175 mg/L, or about 100 to about 175 mg/L). In some embodiments, the propanol can be present in an amount of less than about 39 mg/L (e.g., less than about 38 mg/L, 37 mg/L, 36 mg/L, 35 mg/L, 34 mg/L, 32 mg/L, 30 mg/L, 28 mg/L, 26 mg/L, 24 mg/L, 22 mg/L, 20 mg/L, 18 mg/L, 16 mg/L, 14 mg/L, 12 mg/L, 10 mg/L, 8 mg/L, 6 mg/L, or 4 mg/L). In some embodiments, about 1% to about 95% (e.g., about 1% to about 5%, about 2% to about 4%, about 5% to about 10%, about 1% to about 20%, about 1% to about 10%, about 1% to about 15% about 10% to about 25%, about 25% to about 50%, about 50% to about 75%, or about 75% to about 95%) by mass of the one or more additional VOCs can be propanol. In some embodiments, less than about 22.5% (e.g., less than about 22%, 21%, 20%, 18%, 16%, 14%, 12%, 10%, 8%, 6%, 4%, or 2%) of the one or more additional VOCs can be propanol.

The one or more additional VOCs in a sake replica can include propionaldehyde (also called propanal). In some embodiments, the propionaldehyde can be present in an amount of about 0.002 mg/L to about 0.09 mg/L (e.g., about 0.002 to about 0.005 mg/L, about 0.005 to about 0.01 mg/L, about 0.01 to about 0.05 mg/L, about 0.01 to about 0.09 mg/L, or about 0.05 to about 0.09 mg/L). In some embodiments, about 0.0007% to about 0.07% (e.g., about 0.0007% to about 0.001%, about 0.001% to about 0.005%, about 0.005% to about 0.01%, about 0.01% to about 0.05%, about 0.01% to about 0.07%, about 0.01% to about 0.03%, about 0.03% to about 0.05%, or about 0.05% to about 0.07%) by mass of the one or more additional VOCs can be propionaldehyde. In some embodiments, the one or more additional VOCs can include no propionaldehyde.

The one or more additional VOCs in a sake replica can include propionic acid (also called propionic acid). In some embodiments, the propionic acid can be present in an amount of about 0.2 mg/L to about 2.5 mg/L (e.g., about 0.2 to about 0.5 mg/L, about 0.5 to about 1 mg/L, about 1 to about 2 mg/L, about 1.0 to about 2.5 mg/L, or about 2.0 to about 2.5 mg/L). In some embodiments, about 0.07% to about 2% (e.g., about 0.07% to about 0.1%, about 0.1% to about 0.5%, about 0.5% to about 1%, or about 1% to about 2%) by mass of the one or more additional VOCs can be propionic acid. In some embodiments, the one or more additional VOCs can include no propionic acid.

The one or more additional VOCs in a sake replica can include propyl acetate. In some embodiments, the propyl acetate can be present in an amount of about 0.002 mg/L to about 0.2 mg/L (e.g., about 0.002 to about 0.005 mg/L, about 0.005 to about 0.01 mg/L, about 0.01 to about 0.05 mg/L, about 0.05 to about 0.1 mg/L, or about 0.1 to about 0.2 mg/L). In some embodiments, about 0.0006% to about 0.15% (e.g., about 0.0006% to about 0.001%, about 0.001% to about 0.005%, about 0.005% to about 0.01%, about 0.01% to about 0.05%, about 0.05% to about 0.1%, or about 0.05% to about 0.15%) by mass of the one or more additional VOCs can be propyl acetate. In some embodiments, the one or more additional VOCs can include no propyl acetate.

The one or more additional VOCs in a sake replica can include propyl butyrate. In some embodiments, the propyl butyrate can be present in an amount of about 0.0002 mg/L to about 0.06 mg/L (e.g., 0.0002 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.01 to about 0.06 mg/L, about 0.01 to about 0.03 mg/L, about 0.03 to about 0.05 mg/L, about 0.02 to about 0.04 mg/L, or about 0.04 to about 0.06 mg/L). In some embodiments, about 0.00008% to about 0.04% (e.g., about 0.00008% to about 0.0001%, about 0.0001% to about 0.0005%, about 0.0005% to about 0.001%, about 0.001% to about 0.005%, about 0.005% to about 0.01%, about 0.01% to about 0.04%, about 0.01% to about 0.03%, or about 0.02% to about 0.04%) by mass of the one or more additional VOCs can be propyl butyrate. In some embodiments, the one or more additional VOCs can include no propyl butyrate.

The one or more additional VOCs in a sake replica can include propyl isovalerate. In some embodiments, the propyl isovalerate can be present in an amount of about 0.0003 mg/L to about 0.002 mg/L (e.g., about 0.0003 to about 0.0005 mg/L, about 0.0005 to about 0.001 mg/L, or about 0.001 to about 0.002 mg/L). In some embodiments, about 0.0001% to about 0.001% (e.g., about 0.0001% to about 0.0005% or about 0.0005% to about 0.001%) by mass of the one or more additional VOCs can be propyl isovalerate. In some embodiments, the one or more additional VOCs can include no propyl isovalerate.

The one or more additional VOCs in a sake replica can include vanillyl ethyl ether. In some embodiments, the vanillyl ethyl ether can be present in an amount of about 0.0005 mg/L to about 0.003 mg/L (e.g., about 0.0005 to about 0.001 mg/L, about 0.001 to about 0.003 mg/L, about 0.001 to about 0.002 mg/L, or about 0.002 to about 0.003 mg/L). In some embodiments, about 0.0002% to about 0.002% (e.g., about 0.0002% to about 0.0005%, about 0.0005% to about 0.001%, or about 0.001% to about 0.002%) by mass of the one or more additional VOCs can be vanillyl ethyl ether. In some embodiments, the one or more additional VOCs can include no vanillyl ethyl ether.

The one or more additional VOCs in a sake replica can include acetaldehyde. In some embodiments, the acetaldehyde can be present in an amount of about 3 mg/L to about 35 mg/L (e.g., about 3 to about 5 mg/L, about 3 to about 10 mg/L, about 5 to about 10 mg/L, about 10 to about 20 mg/L, about 20 to about 30 mg/L, about 22 to about 26 mg/L, about 5 to about 15 mg/L, about 15 to about 25 mg/L, or about 25 to about 35 mg/L). In some embodiments, about 2.5% to about 13% (e.g., about 2.5% to about 5%, about 2.5% to about 10%, about 5% to about 10%, about 8% to about 10%, about 5% to about 13%, or about 10% to about 13%) by mass of the one or more additional VOCs can be acetaldehyde. In some embodiments, the one or more additional VOCs can include no acetaldehyde.

The one or more additional VOCs in a sake replica can include ethyl acetate. In some embodiments, the ethyl acetate can be present in an amount of about 19 mg/L to about 85 mg/L (e.g., about 19 to about 25 mg/L, about 25 to about 50 mg/L, about 50 to about 75 mg/L, about 50 to about 85 mg/L, about 20 to about 40 mg/L, about 40 to about 60 mg/L, about 60 to about 80 mg/L, about 60 to about 85 mg/L, about 30 to about 50 mg/L, about 50 to about 70 mg/L, or about 60 to about 70 mg/L). In some embodiments, about 7.5% to about 35% (e.g., about 7.5% to about 10%, about 10% to about 20%, about 20% to about 30%, about 15% to about 25%, or about 25% to about 30%) by mass of the one or more additional VOCs can be ethyl acetate. In some embodiments, the one or more additional VOCs can include no ethyl acetate.

The one or more additional VOCs in a sake replica can include isoamyl alcohol. In some embodiments, the isoamyl alcohol can be present in an amount of about 15 mg/L to about 130 mg/L (e.g., about 15 to about 25 mg/L, about 15 to about 50 mg/L, about 25 to about 50 mg/L, about 50 to about 75 mg/L, about 75 to about 100 mg/L, about 100 to about 125 mg/L, about 100 to about 125 mg/L, about 80 to about 120 mg/L, or about 90 to about 110 mg/L). In some embodiments, about 10% to about 50% (e.g., about 10% to about 20%, about 20% to about 30%, about 30% to about 40%, about 35% to about 45%, about 40% to about 50%, about 10% to about 30%, about 30% to about 50%, or about 20% to about 40%) by mass of the one or more additional VOCs can be isoamyl alcohol. In some embodiments, the one or more additional VOCs can include no isoamyl alcohol.

The one or more additional VOCs in a sake replica can include isobutyl alcohol (also called isobutanol). In some embodiments, the isobutyl alcohol can be present in an amount of about 6 mg/L to about 26 mg/L (e.g., about 6 to about 10 mg/L, about 10 to about 20 mg/L, about 10 to about 26 mg/L, about 6 to about 15 mg/L, about 15 to about 15 mg/L, about 18 to about 22 mg/L, about 19 to about 21 mg/L, or about 15 to about 26 mg/L). In some embodiments, about 2% to about 10% (e.g., about 2% to about 5%, about 5% to about 10%, about 2% to about 4%, about 4% to about 6%, about 6% to about 8%, about 8% to about 10%, about 3% to about 5%, about 5% to about 7%, or about 7% to about 9%) by mass of the one or more additional VOCs can be isobutyl alcohol. In some embodiments, the one or more additional VOCs can include no isobutyl alcohol.

The one or more additional VOCs in a sake replica can include 2-methyl-1-butanol. In some embodiments, the 2-methyl-1-butanol can be present in an amount of about 0.1 mg/L to about 20 mg/L (e.g., about 0.1 to about 0.5 mg/L, about 0.5 to about 1 mg/L, about 1 to about 5 mg/L, about 1 to about 10 mg/L, about 1 to about 20 mg/L, about 5 to about 10 mg/L, about 10 to about 20 mg/L, about 10 to about 15 mg/L, about 12 to about 16 mg/L, about 13 to about 15 mg/L, or about 15 to about 20 mg/L). In some embodiments, about 1.5% to about 7.5% (e.g., about 1.5% to about 5%, about 5% to about 7%, about 5% to about 7.5%, about 1.5% to about 3.5%, about 3.5% to about 5.5%, about 4% to about 6%, about 5.5% to about 7.5%) by mass of the one or more additional VOCs can be 2-methyl-1-butanol. In some embodiments, the one or more additional VOCs can include no 2-methyl-1-butanol.

In some embodiments, the one or more VOCs in a sake replica can include one or more compounds selected from the group consisting of 1,4-cineole, 1-decanol, 2,3-hexanedione, 2,4,6-trimethylphenol (mesitol), 2-acetyl-1-methylpyrrole, 2-ethyl-3(5 or 6)-dimethylpyrazine (e.g., 2-ethyl-3,5-dimethylpyrazine or 2-ethyl-3,6-dimethylpyrazine, or a combination thereof), 2-ethyl-3-methylpyrazine, 2-isopropyl-4-methyl thiazole, 2-methoxy-3-(1-methylpropyl) pyrazine, 2-Methoxy-4-methylphenol (creosol), 2-methoxy-4-propylphenol, 2-methoxycinnamaldehyde, 2-methyl-1-butanol, 2-methylbutyl acetate, 2-methylbutyl isovalerate, 2-nonanol, 2-octanone, 3-carene, 3-heptyl acetate, 3-methylthio hexyl acetate, 3-phenylpropanal, 4,5,6,7-tetrahydro-3,6-dimethylbenzofuran, 4-carvomenthenol (terpinen-4-ol), 4-mercapto-4-methyl-2-pentanone, 5-ethyl-3-hydroxy-4-methyl-2(5H)-furanone (maple furanone), 5-methyl-2-phenyl-2-hexenal, acetaldehyde, acetoin, a-ionone, allyl heptanoate, allyl hexanoate, alpha-pinene, amyl alcohol, amyl butyrate, anisyl acetate, anisyl alcohol, anisyl butyrate, b-caryophellene, Benzaldehyde glyceryl acetal, benzyl acetate, benzyl benzoate, benzyl butyrate, benzyl formate, benzyl propionate, beta-ionone, butyl butyryllactate, butyl formate, carvacrol, cinnamaldehyde, cis-3-hexenyl acetate, cis-3-hexenyl butyrate, cis-3-hexenyl caproate, cis-3-hexenyl valerate, cis-5-octen-1-ol, cis-6-nonen-1-ol, citral, citronellal, cuminaldehyde, D-carvone, decanal, d-fenchone, dihydrocoumarin, ethyl 2-trans-4-cis-decadienoate, ethyl acetate, ethyl acetoacetate, ethyl cinnamate, ethyl myristate, ethyl undecanoate, eucalyptol, eugenol, furfuryl thioacetate, gamma-decalactone, gamma-terpinene, gamma-undecalactone, gamma-valerolactone, geranyl acetone (6,10-dimethyl-5,9-undecadien-2-one), geranyl butyrate, geranyl propionate, hexadecanol, hexyl 3-methylbutanoate, hexyl butyrate, hexyl formate, hexyl isobutyrate, hexyl propionate, IBMP (3-Isobutyl-2-methoxypyrazine), isoamyl alcohol, isoamyl cinnamate, isoamyl isobutyrate, isoamyl isovalerate, isoamyl phenylacetate, isobutyl alcohol, isobutyl butyrate, isobutyl isobutyrate, isoeugenol, lauric aldehyde, L-carvone, linalool, linalool oxide, linalyl acetate, L-menthyl acetate, maltol, massoia lactone, methionyl butyrate, methyl anthranilate, methyl benzoate, methyl cinnamate, methyl cyclopentenolone, methyl decanoate, methyl octanoate, methyl salicylate, myrcene, nerolidol, omega-pentadecalactone, p,a-dimethylstyrene, p-cymene, perillaldehyde, phenethyl 2-methylbutyrate, phenethyl butyrate, phenethyl octanoate, phenethyl tiglate, phenylacetaldehyde dimethyl acetal, salicylaldehyde, terpinolene, tetrahydrolinalool, thymol, trans-2-hexen-1-al, valencene, valeraldehyde, vanillyl butyl ether, and whiskey lactone, in any appropriate amount.

For example, a sake replica can include one more of the following: less than about 28 mg/L of 2-phenylethanol, less than about 39 mg/L of propanol, at least about 0.17 mg/L of ethyl butanoate, at least about 3.4 mg/L of ethyl octanoate, at least about 0.45 mg/L of furfural, less than about 15.5% by mass of the additional VOCs are 2-phenylethanol, less than 22.5% by mass of the additional VOCs are propanol, at least 0.12% by mass of the additional VOCs are ethyl butanoate, and at least 0.31% of the additional VOCs are furfural.

In some embodiments, a sake replica can include non-volatile compounds.

In some embodiments, the non-volatile compounds can include one or more non-volatile compounds that are not present in a corresponding traditional sake. Non-limiting examples of such compounds can include 2,3,5-trimethylpyrazine, 2,3-dimethylpyrazine, aspartic acid, caffeic acid, camphoric acid, catechin, cinnamic acid, cysteine, cystine, ellagic acid, epicatechin, epicatechin gallate, gallic acid, hesperetin, methyl gallate, methyl-2-pyrrolyl ketone, inositol, propyl gallate, pyridine, quercetin, resveratrol, sinapinic acid, sorbic acid, syringaldehyde, and tryptamine. In some embodiments, a sake replica can include at least one compound (e.g., at least 1, at least 2, at least 3, at least 4, at least 5, 1 to 2, 1 to 3, 1 to 5, 1 to 10, 1 to 15, 1 to 20, 1 to 25, 5 to 10, 5 to 15, 5 to 20, 5 to 25, 10 to 15, 10 to 20, or 10 to 25 compounds) selected from the group consisting of 2,3,5-trimethylpyrazine, 2,3-dimethylpyrazine, aspartic acid, caffeic acid, camphoric acid, catechin, cinnamic acid, cysteine, cystine, ellagic acid, epicatechin, epicatechin gallate, gallic acid, hesperetin, methyl gallate, methyl-2-pyrrolyl ketone, inositol, propyl gallate, pyridine, quercetin, resveratrol, sinapinic acid, sorbic acid, syringaldehyde, and tryptamine. In some embodiments, the one or more non-volatile compounds can include cinnamic acid. It is surprising that the sake replicas described herein include one or more compounds not found in any tested traditional sake, as it would be expected that to create a sake replica, one would only think to use compounds found in one or more traditional sakes. By way of example only, on its own, methyl-2-pyrrolyl ketone gives a chemical (“black marker”) character, but in low concentration in a sake replica (e.g., any of the sake replicas provided herein), it can give a crisp licorice/herbaceous character that can be beneficial to the overall flavor of the sake replica. As another example, on its own, aspartic acid gives a very intense and unpleasant sweet/sourness, but in low amounts in a sake replica (e.g., any of the sake replicas provided herein), it enhances the intensity of the palet and adds a savory character that mimics some sakes with a more umami character (for example, honjozo, futsuu-shu).

In some embodiments, the non-volatile compounds can exclude one or more non-volatile compounds that are present in a corresponding traditional sake. Non-limiting examples of such compounds include 2,3,5,6-tetramethylpyrazine, 2-furoic acid, 2-isopropylmalic acid, 3,4-dihydroxybenzoic acid, 4-guanidinobutyric acid, asparagine, beta-alanine, carnitine, fucose, GABA, galactose, glucosamine, glutamine, glycine, guanine, histidine, lactic acid, leucine, mannitol, mannose, methionine, ornithine, proline, pyridoxine, pyruvic acid, quinic acid, rhamnose, salicylic acid, serine, tryptophan, tyrosine, valine, and xylose. In some embodiments, a sake replica can include at least one compound (e.g., at least 1, at least 2, at least 3, at least 4, at least 5, 1 to 2, 1 to 3, 1 to 5, 1 to 10, 1 to 15, 1 to 20, 1 to 25, 1 to 30, 5 to 10, 5 to 15, 5 to 20, 5 to 25, 5 to 30, 10 to 15, 10 to 20, 10 to 25, or 10 to 30 compounds) selected from the group consisting of 2,3,5,6-tetramethylpyrazine, 2-furoic acid, 2-isopropylmalic acid, 3,4-dihydroxybenzoic acid, 4-guanidinobutyric acid, asparagine, beta-alanine, carnitine, fucose, GABA, galactose, glucosamine, glutamine, glycine, guanine, histidine, lactic acid, leucine, mannitol, mannose, methionine, ornithine, proline, pyridoxine, pyruvic acid, quinic acid, rhamnose, salicylic acid, serine, tryptophan, tyrosine, valine, and xylose. It is surprising that the sake replicas described herein lack one or more compounds found in every tested traditional sakes, as one would believe that compounds present in every tested traditional sake to be important to sake flavor.

The non-volatile compounds present in a sake replica can include compounds that fall into any of several categories, including sugars, sugar alcohols, or a combination thereof; amino acids, amino acid derivatives, or a combination thereof; pH-modifying salts; organic acids; nucleobases, nucleotides, or a combination thereof; nitrogen-containing heterocycles; phenolic compounds. Additional categories can include lipids, vitamins, other flavorants, colors, tannin components, salt (e.g., NaCl). It will be appreciated that any of these components can be provided in any appropriate form. For example, it will be appreciated that amino acids can be provided in the form of a salt (e.g., an HCl salt). It will also be appreciated that any and all stereoisomers can be used when no stereochemistry is specified.

Amino acids or amino acid derivatives that may be present in a sake replica as provided herein include, without limitation, alanine, arginine, asparagine, aspartic acid, beta-alanine, betaine, carnitine, carnosine, citrulline, cysteine, cystine, GABA (gamma-aminobutyric acid), glutamic acid, glutamine, glycine, histidine, homoserine, isoleucine, kynurenic acid, leucine, lysine, methionine, ornithine, phenylalanine, proline, serine, threonine, trans-4-hydroxyproline, tryptamine, tryptophan, tyramine, tyrosine, valine, and any combination thereof. In some embodiments, amino acids or amino acid derivatives that may be present in a sake replica as provided herein include, without limitation, alanine, arginine, glutamic acid, lysine, phenylalanine, threonine, and any combination thereof. In some embodiments, an amino acid can be provided as the L-stereoisomer.

Examples of organic acids that can be included in a sake replica include, without limitation, 2-furoic acid, 2-isopropylmalic acid, 4-guanidinobutyric acid, adipic acid, camphoric acid, cinnamic acid, citric acid, D-glucuronic acid, fumaric acid, lactic acid, malic acid, pantothenic acid, pyruvic acid, quinic acid, sorbic acid, succinic acid, tartaric acid and any combination thereof. In some embodiments, organic acids that may be present in a sake replica as provided herein include, without limitation, cinnamic acid, citric acid, D-glucuronic acid, fumaric acid, lactic acid, malic acid, succinic acid, tartaric acid, and any combination thereof.

Sugars and sugar alcohols that can be included in a sake replica include, without limitation, arabitol, fructose, fucose, galactose, glucosamine, glucose, mannitol, mannose, inositol, rhamnose, ribose, sorbitol, xylose, and any combination thereof. In some embodiments, sugars and sugar alcohols that can be included in a sake replica include, without limitation, fructose, glucose, sorbitol, and any combination thereof.

A sake replica can include lipids such as, for example, choline (e.g., choline bitartrate) or a surfactant (e.g., a surfactant from Quillaja saponaria), or a combination thereof. In some embodiments, a sake replica can include choline bitartrate.

A sake replica can include nucleobases, nucleotides, or a combination thereof. Examples of nucleobases and nucleotides include, without limitation, adenine, cytidine, cytosine, guanine, uracil, and any combination thereof.

Nitrogen-containing heterocycles that can be included in a sake replia include, without limitation, 2,3,5,6-tetramethylpyrazine, 2,3,5-trimethylpyrazine, 2,3-dimethylpyrazine, methyl-2-pyrrolyl ketone, pipecolinic acid, piperine, pyridine, pyridoxine, and any combination thereof.

A sake replica can include phenolic compounds. Examples of phenolic compounds include, without limitation, 3,4-dihydroxybenzoic acid, acetovanillone, caffeic acid, catechin, coumaric acid, ellagic acid, epicatechin, epicatechin gallate, gallic acid, hesperetin, methyl gallate, polydatin, propyl gallate, quercetin, resveratrol, rutin, salicylic acid, sinapinic acid, syringaldehyde, syringic acid, trans-ferulic acid, vanillic acid, vanillin, and any combination thereof.

In some cases, a sake replica can include one or more vitamins (e.g., pantothenic acid (vitamin B5), pyridoxine (vitamin B6), or a combination thereof).

Flavorants that can be included in a sake replica include, without limitation, acetovanillone, carnitine, disodium 5′ ribonucleotides (e.g., 5′-guanylate and/or 5′-inosinate), monosodium glutamate (MSG), syringaldehyde, vanillin, or any combination thereof.

Colorants that may be used in the sake replicas provided herein include, without limitation, Amber, Caramel food color, Carotene, and any combination thereof. Alternatively or in addition, colorants can include natural colorants derived from fruits and vegetables such as beet, carrot, and cabbage (e.g., annatto extract, beet extract, beta carotene, caramel carmine (cochineal extract), elderberry extract, paprika, saffron, titanium dioxide, and turmeric), as well as synthetic dyes (e.g., FD+C/synthetic colors). See, e.g., www.ttb.gov/spirits/bam/chapter7.pdf

In some embodiments, the sake replicas provided herein can include one or more (e.g., one, two, three, four, five, six, seven, eight, nine, ten, 15, 20, or more than 20) non-volatile compounds that are not present in a corresponding traditional sake.

Again, non-volatile compounds can be detected in traditional sakes using any suitable method, including the LC-MS method described in Example 1 herein. A non-volatile compound that is “not present” in a reference sake is one that is not detected in the reference sake using the methods set forth in Example 1. Limits of detection for various non-volatile compounds are disclosed in TABLES 8A and 8B herein.

A sake replica can include any appropriate number of non-volatile compounds. For example, a sake replica can include 1 to 100 (e.g., at least 5, at least 10, at least 20, at least 30, at least 40, at least 50, 1 to 90, 1 to 80, 1 to 70, 1 to 60, 1 to 50, 1 to 40, 1 to 30, 1 to 20, 1 to 10, 1 to 5, 5 to 100, 5 to 90, 5 to 80, 5 to 70, 5 to 60, 5 to 40, 5 to 30, 5 to 20, 5 to 10, 10 to 100, 10 to 90, 10 to 90, 10 to 70, 10 to 60, 10 to 50, 10 to 40, 10 to 30, 10 to 20, 20 to 100, 20 to 90, 20 to 80, 20 to 70, 20 to 60, 20 to 50, 20 to 40, 20 to 30, 30 to 100,30 to 90,30 to 80,30 to 70,30 to 60,30 to 50, 30 to 40, 40 to 100, 40 to 90, 40 to 80, 40 to 70, 40 to 60, 40 to 50, 50 to 100, 50 to 90, 50 to 80, 50 to 70, or 50 to 60) non-volatile compounds. In some embodiments, a sake replica can include 1 to 100 (e.g., at least 5, at least 10, at least 20, at least 30, at least 40, at least 50, 1 to 90, 1 to 80, 1 to 70, 1 to 60, 1 to 50, 1 to 40, 1 to 30, 1 to 20, 1 to 10, 1 to 5, 5 to 100, 5 to 90, 5 to 80, 5 to 70, 5 to 60, 5 to 40, 5 to 30, 5 to 20, 5 to 10, 10 to 100, 10 to 90, 10 to 90, 10 to 70, 10 to 60, 10 to 50, 10 to 40, 10 to 30, 10 to 20, 20 to 100, 20 to 90, 20 to 80, 20 to 70, 20 to 60, 20 to 50, 20 to 40, 20 to 30, 30 to 100, 30 to 90, 30 to 80, 30 to 70, 30 to 60, 30 to 50, 30 to 40, 40 to 100, 40 to 90, 40 to 80, 40 to 70, 40 to 60, 40 to 50, 50 to 100, 50 to 90, 50 to 80, 50 to 70, or 50 to 60) compounds selected from the group consisting of 2,3,5,6-tetramethylpyrazine, 2,3,5-trimethylpyrazine, 2,3-dimethylpyrazine, 2-furoic acid, 2-isopropylmalic acid, 3,4-dihydroxybenzoic acid, 4-guanidinobutyric acid, acetovanillone, adenine, adipic acid, alanine, arabitol, arginine, asparagine, aspartic acid, beta-alanine, betaine, caffeic acid, camphoric acid, carnitine, carnosine, catechin, choline, choline bitartrate, cinnamic acid, citric acid, citrulline, coumaric acid, cysteine, cystine, cytidine, cytosine, D-glucuronic acid, ellagic acid, epicatechin, epicatechin gallate, fructose, fucose, fumaric acid, GABA, galactose, gallic acid, glucosamine, glucose, glutamic acid, glutamine, glycine, guanine, hesperetin, histidine, homoserine, isoleucine, KOH, kynurenic acid, lactic acid, leucine, lysine, malic acid, mannitol, mannose, methionine, methyl gallate, methyl-2-pyrrolyl ketone, inositol, ornithine, pantothenic acid, phenylalanine, pipecolinic acid, piperine, polydatin, proline, propyl gallate, pyridine, pyridoxine, pyruvic acid, quercetin, quinic acid, resveratrol, rhamnose, ribose, rutin, salicylic acid, serine, sinapinic acid, sorbic acid, sorbitol, succinic acid, syringaldehyde, syringic acid, tartaric acid, threonine, trans-4-hydroxyproline, trans-ferulic acid, tryptamine, tryptophan, tyramine, tyrosine, uracil, valine, vanillic acid, vanillin, and xylose. In some embodiments, a sake replica can include 1 to 100 (e.g., at least 5, at least 10, at least 20, at least 30, at least 40, at least 50, 1 to 70, 1 to 60, 1 to 50, 1 to 40, 1 to 30, 1 to 20, 1 to 10, 1 to 5, 5 to 70, 5 to 60, 5 to 40, 5 to 30, 5 to 20, 5 to 10, 10 to 70, 10 to 60, 10 to 50, 10 to 40, 10 to 30, 10 to 20, 20 to 70, 20 to 60, 20 to 50, 20 to 40, 20 to 30, 30 to 70, 30 to 60, 30 to 50, 30 to 40, 40 to 70, 40 to 60, 40 to 50, 50 to 70, or 50 to 60) compounds selected from the group consisting of 2,3,5,6-tetramethylpyrazine, 2-furoic acid, 2-isopropylmalic acid, 3,4-dihydroxybenzoic acid, 4-guanidinobutyric acid, acetovanillone, adenine, adipic acid, alanine, arabitol, arginine, asparagine, beta-alanine, betaine, carnitine, carnosine, choline, choline bitartrate, cinnamic acid, citric acid, citrulline, coumaric acid, cytidine, cytosine, D-glucuronic acid, fructose, fucose, fumaric acid, GABA, galactose, glucosamine, glucose, glutamic acid, glutamine, glycine, guanine, histidine, homoserine, isoleucine, KOH, kynurenic acid, lactic acid, leucine, lysine, malic acid, mannitol, mannose, methionine, ornithine, pantothenic acid, phenylalanine, pipecolinic acid, piperine, polydatin, proline, pyridoxine, pyruvic acid, quinic acid, rhamnose, ribose, rutin, salicylic acid, serine, sorbitol, succinic acid, syringic acid, tartaric acid, threonine, trans-4-hydroxyproline, trans-ferulic acid, tryptophan, tyramine, tyrosine, uracil, valine, vanillic acid, vanillin, and xylose. In some embodiments, a sake replica can include 1 to 24 (e.g., at least 5, at least 10, at least 15, at least 20, 1 to 5, 1 to 10, 1 to 15, 1 to 20, 5 to 10, 5 to 15, 5 to 20, 5 to 24, 10 to 15, 10 to 20, 10 to 24, 15 to 20, 15 to 24, or 20 to 24) compounds selected from the group consisting of 2,3,5,6-tetramethylpyrazine, 4-guanidinobutyric acid, alanine, arginine, choline bitartrate, cinnamic acid, citric acid, D-glucuronic acid, fructose, fumaric acid, glucose, glutamic acid, guanine, isoleucine, KOH, lactic acid, lysine, malic acid, phenylalanine, pyridoxine, salicylic acid, sorbitol, succinic acid, tartaric acid, and threonine. In some embodiments, a sake replica can include 1 to 18 (e.g., at least 5, at least 10, at least 15, at 1 to 5, 1 to 10, 1 to 15, 1 to 18, 5 to 10, 5 to 15, 5 to 18, 10 to 15, 10 to 18, or 15 to 18) selected from the group consisting of alanine, arginine, choline bitartrate, cinnamic acid, citric acid, D-glucuronic acid, fructose, fumaric acid, glucose, glutamic acid, isoleucine, KOH, lactic acid, lysine, malic acid, phenylalanine, sorbitol, succinic acid, tartaric acid, threonine. In some embodiments, a sake replica can include alanine, arginine, choline bitartrate, cinnamic acid, citric acid, D-glucuronic acid, fructose, fumaric acid, glucose, glutamic acid, isoleucine, KOH, lactic acid, lysine, malic acid, phenylalanine, sorbitol, succinic acid, tartaric acid, threonine. In some cases, the number of non-volatile compounds in a sake replica can be less than the number of non-volatile compounds in a single corresponding reference sake.

Further, in some embodiments, the sake replicas provided herein can lack one or more (e.g., one, two, three, four, five, six, seven, eight, nine, ten, or more than ten) non-volatile compounds that are present in corresponding traditional sakes. In some cases, the overall population of non-volatile compounds in a sake replica can have less than 95% identity to the non-volatile compounds in a corresponding reference sake (e.g., in a single type of traditionally made sake corresponding to the replica). For example, the non-volatile compounds in a sake replica can have less than 90%, less than 80%, less than 70%, less than 60%, less than 50%, less than 40%, less than 30%, or less than 25% identity to the population of non-volatile compounds in a corresponding reference sake. Some sake replicas may contain at least 1 (e.g., at least 2, at least 5, at least 10, at least 15, at least 20, at least 25, or at least 30) non-volatile compounds that are not found in a single reference sake. Moreover, some sake replicas may contain no more than 50 (e.g., no more than 45, 40, 35, 30, 25, 20, 15, or 10) non-volatile compounds that are present in a single reference sake. For example, in some embodiments, a sake replica can have at least m non-volatile compounds and less than m (e.g., m−1, m−2, m−3, m−4, m−5, m−6, m−7, m−8, m−9, m−10, m−15, m−20, and the like, as applicable) of the non-volatile compounds are found in a single reference sake; in some embodiments, m can be equal to 5, 6, 7, 8, 9, 10, 11, 12, 13, 14, 15, 16, 17, 18, 19, 20, 25, 30, 35, 40, 45, 50, 55, or 60.

As noted above, the amounts of non-volatile compounds in reference sakes are measured using the LC-MS methods described herein. In some embodiments, the amount of a particular non-volatile compound in a sake replica can be an amount, based on concentration or percent composition, that is within a range 30% higher and lower than a measured amount for that non-volatile compound in a corresponding reference sake. For example, a non-volatile compound can be present in a sake replica in an amount that is 70 to 90%, 80 to 100%, 90 to 110%, 100 to 120%, 110 to 130%, 70 to 100%, 80 to 110%, 90 to 120%, or 100 to 130% of an amount measured for that non-volatile compound in a corresponding reference sake.

In some cases, the amount of any particular non-volatile compound in a sake replica may be different than the amount of that non-volatile compound in a corresponding reference sake. In some cases, the amount of a non-volatile compound in a sake replica can be 75% or less (e.g., 70% or less, 60% or less, 50% or less, 40% or less, 30% or less, 20% or less, or 10% or less), by concentration or percent mass, than the amount of the same non-volatile compound in a corresponding reference sake. In some cases, the amount of a non-volatile compound in a sake replica can be 125% or more (e.g., 150% or more, 200% or more, or 300% or more), by concentration or percent mass, than the amount of the same non-volatile compound in a corresponding reference sake.

The non-volatile compounds in a sake replica can include trans-ferulic acid. In some embodiments, the trans-ferulic acid can be present in an amount of about 0.3 mg/L to about 1.2 mg/L (e.g., about 0.3 to about 0.5 mg/L, about 0.5 to about 1 mg/L, about 0.3 to about 1 mg/L, or about 0.5 to about 1.2 mg/L). In some embodiments, the non-volatile compounds can include no trans-ferulic acid.

The non-volatile compounds in a sake replica can include coumaric acid. In some embodiments, the coumaric acid can be present in an amount of about 0.03 mg/L to about 0.07 mg/L (e.g., about 0.03 to about 0.05 mg/L or about 0.05 to about 0.07 mg/L). In some embodiments, the non-volatile compounds can include no coumaric acid.

The non-volatile compounds in a sake replica can include cinnamic acid (typically used as trans-cinnamic acid). In some embodiments, the cinnamic acid can be present in an amount of about 16 mg/L to about 31 mg/L (e.g., about 16 to about 20 mg/L, about 20 to about 30 mg/L, about 20 to about 31 mg/L, about 16 to about 25 mg/L, about 20 to about 25 mg/L, about 22 to about 26 mg/L, about 23 to about 25 mg/L, about 25 to about 30 mg/L, or about 25 to about 31 mg/L). In some embodiments, the non-volatile compounds can include no cinnamic acid.

The non-volatile compounds in a sake replica can include cytidine. In some embodiments, the cytidine can be present in an amount of about 0.7 mg/L to about 4.5 mg/L (e.g., about 0.7 to about 1 mg/L, about 1 to about 4 mg/L, about 1.0 to about 4.5 mg/L, about 1 to about 3 mg/L, about 2 to about 4 mg/L, or about 2.0 to about 4.5 mg/L). In some embodiments, the non-volatile compounds can include no cytidine.

The non-volatile compounds in a sake replica can include uracil. In some embodiments, the uracil can be present in an amount of about 0.3 mg/L to about 2.5 mg/L (e.g., about 0.3 to about 0.5 mg/L, about 0.3 to about 1 mg/L, about 0.5 to about 1 mg/L, about 1 to about 2 mg/L, or about 1.0 to about 2.5 mg/L). In some embodiments, the non-volatile compounds can include no uracil.

The non-volatile compounds in a sake replica can include phenylalanine. In some embodiments, the phenylalanine can be present in an amount of about 12 mg/L to about 85 mg/L (e.g., about 12 to about 20 mg/L, about 20 to about 40 mg/L, about 40 to about 60 mg/L, about 40 to about 80 mg/L, about 60 to about 70 mg/L, about 64 to about 68 mg/L, about 65 to about 67 mg/L, about 60 to about 80 mg/L),In some embodiments, the phenylalanine can be present in an amount of at least about 38 mg/L (e.g., at least about 39 mg/L, 40 mg/L, 42 mg/L, 44 mg/L, 46 mg/L, 48 mg/L, 50 mg/L, 55 mg/L, 60 mg/L, 65 mg/L, 70 mg/L, 75 mg/L, or 80 mg/L).

The non-volatile compounds in a sake replica can include methionine. In some embodiments, the methionine can be present in an amount of about 1 mg/L to about 6 mg/L (e.g., about 1 to about 5 mg/L, about 1 to about 3 mg/L, about 3 to about 5 mg/L, about 2 to about 4 mg/L, or about 4 to about 6 mg/L). In some embodiments, the non-volatile compounds can include no methionine.

The non-volatile compounds in a sake replica can include GABA. In some embodiments, the GABA can be present in an amount of about 2 mg/L to about 9 mg/L (e.g., about 2 to about 5 mg/L, about 5 to about 9 mg/L, about 2 to about 4 mg/L, about 4 to about 6 mg/L, about 6 to about 8 mg/L, about 3 to about 5 mg/L, about 5 to about 7 mg/L, or about 7 to about 9 mg/L). In some embodiments, the non-volatile compounds can include no GABA.

The non-volatile compounds in a sake replica can include lysine. In some embodiments, the lysine can be present in an amount of about 22 mg/L to about 45 mg/L (e.g., about 22 to about 25 mg/L, about 22 to about 30 mg/L, about 25 to about 30 mg/L, about 30 to about 40 mg/L, about 30 to about 45 mg/L, about 30 to about 34 mg/L, about 30 to about 35 mg/L, about 35 to about 40 mg/L, about 40 to about 45 mg/L, about 30 to about 35 mg/L, about 25 to about 35 mg/L, or about 35 to about 45 mg/L). In some embodiments, the non-volatile compounds can include no lysine.

The non-volatile compounds in a sake replica can include histidine. In some embodiments, the histidine can be present in an amount of about 7 mg/L to about 25 mg/L (e.g., about 7 to about 10 mg/L, about 10 to about 15 mg/L, about 15 to about 20 mg/L, about 20 to about 25 mg/L, about 10 to about 20 mg/L, about 7 to about 15 mg/L, or about 15 to about 25 mg/L). In some embodiments, the non-volatile compounds can include no histidine.

The non-volatile compounds in a sake replica can include glycine. In some embodiments, the glycine can be present in an amount of about 19 mg/L to about 40 mg/L (e.g., about 19 to about 25 mg/L, about 20 to about 25 mg/L, about 25 to about 30 mg/L, about 30 to about 35 mg/L, about 35 to about 40 mg/L, about 20 to about 30 mg/L, about 30 to about 40 mg/L, or about 25 to about 35 mg/L). In some embodiments, the non-volatile compounds can include no glycine.

The non-volatile compounds in a sake replica can include serine. In some embodiments, the serine can be present in an amount of about 14 mg/L to about 40 mg/L (e.g., about 14 to about 20 mg/L, about 15 to about 20 mg/L, about 20 to about 25 mg/L, about 25 to about 30 mg/L, about 30 to about 35 mg/L, about 35 to about 40 mg/L, about 15 to about 25 mg/L, about 25 to about 35 mg/L, about 20 to about 30 mg/L, or about 30 to about 40 mg/L). In some embodiments, the non-volatile compounds can include no serine.

The non-volatile compounds in a sake replica can include isoleucine. In some embodiments, the isoleucine can be present in an amount of about 35 mg/L to about 65 mg/L (e.g., about 35 to about 45 mg/L, about 45 to about 55 mg/L, about 55 to about 65 mg/L, about 40 to about 50 mg/L, about 50 to about 60 mg/L, or about 45 to about 55 mg/L). In some embodiments, the non-volatile compounds can include no isoleucine.

The non-volatile compounds in a sake replica can include tryptophan. In some embodiments, the tryptophan can be present in an amount of about 1 mg/L to about 22 mg/L (e.g., about 1 to about 5 mg/L, about 1 to about 10 mg/L, about 5 to about 10 mg/L, about 10 to about 15 mg/L, about 15 to about 20 mg/L, about 15 to about 22 mg/L, about 10 to about 20 mg/L, or about 10 to about 22 mg/L). In some embodiments, the non-volatile compounds can include no tryptophan.

The non-volatile compounds in a sake replica can include valine. In some embodiments, the valine can be present in an amount of about 13 mg/L to about 40 mg/L (e.g., about 13 to about 20 mg/L, about 15 to about 20 mg/L, about 20 to about 25 mg/L, about 25 to about 30 mg/L, about 30 to about 35 mg/L, about 35 to about 40 mg/L, about 15 to about 25 mg/L, about 25 to about 35 mg/L, about 20 to about 30 mg/L, or about 30 to about 40 mg/L). In some embodiments, the non-volatile compounds can include no valine.

The non-volatile compounds in a sake replica can include arginine. In some embodiments, the arginine can be present in an amount of about 200 mg/L to about 450 mg/L (e.g., about 200 to about 300 mg/L, about 300 to about 400 mg/L, about 250 to about 350 mg/L, about 350 to about 450 mg/L, about 200 to about 250 mg/L, about 250 to about 300 mg/L, about 300 to about 350 mg/L, about 350 to about 400 mg/L, or about 400 to about 450 mg/L). In some embodiments, the non-volatile compounds can include no arginine.

The non-volatile compounds in a sake replica can include ornithine. In some embodiments, the ornithine can be present in an amount of about 6 mg/L to about 16 mg/L (e.g., about 6 to about 10 mg/L, about 10 to about 15 mg/L, or about 10 to about 16 mg/L). In some embodiments, the non-volatile compounds can include no ornithine.

The non-volatile compounds in a sake replica can include threonine. In some embodiments, the threonine can be present in an amount of about 8 mg/L to about 35 mg/L (e.g., about 8 to about 10 mg/L, about 10 to about 14 mg/L, about 10 to about 15 mg/L, about 15 to about 20 mg/L, about 20 to about 25 mg/L, about 25 to about 30 mg/L, about 30 to about 35 mg/L, about 15 to about 25 mg/L, about 25 to about 35 mg/L, about 10 to about 20 mg/L, about 20 to about 30 mg/L, or about 20 to about 35 mg/L).

The non-volatile compounds in a sake replica can include glutamine. In some embodiments, the glutamine can be present in an amount of about 4 mg/L to about 40 mg/L (e.g., about 4 to about 10 mg/L, about 5 to about 10 mg/L, about 10 to about 20 mg/L, about 20 to about 30 mg/L, about 30 to about 40 mg/L, about 10 to about 15 mg/L, about 15 to about 20 mg/L, about 20 to about 25 mg/L, about 25 to about 30 mg/L, about 30 to about 35 mg/L, or about 35 to about 40 mg/L). In some embodiments, the non-volatile compounds can include no glutamine.

The non-volatile compounds in a sake replica can include asparagine. In some embodiments, the asparagine can be present in an amount of about 13 mg/L to about 35 mg/L (e.g., about 13 to about 20 mg/L, about 15 to about 20 mg/L, about 20 to about 30 mg/L, about 20 to about 35 mg/L, about 20 to about 25 mg/L, about 25 to about 30 mg/L, or about 30 to about 35 mg/L). In some embodiments, the non-volatile compounds can include no asparagine.

The non-volatile compounds in a sake replica can include glutamic acid. In some embodiments, the glutamic acid can be present in an amount of about 100 mg/L to about 200 mg/L (e.g., about 100 to about 150 mg/L, about 150 to about 200 mg/L, about 100 to about 120 mg/L, about 120 to about 140 mg/L, about 140 to about 160 mg/L, about 160 to about 180 mg/L, about 180 to about 200 mg/L, about 110 to about 130 mg/L, about 130 to about 150 mg/L, about 140 to about 150 mg/L, about 150 to about 170 mg/L, or about 170 to about 190 mg/L). In some embodiments, the non-volatile compounds can include no glutamic acid.

The non-volatile compounds in a sake replica can include ribose. In some embodiments, the ribose can be present in an amount of about 9 mg/L to about 19 mg/L (e.g., about 9 to about 15 mg/L, about 10 to about 15 mg/L, or about 15 to about 19 mg/L). In some embodiments, the non-volatile compounds can include no ribose.

The non-volatile compounds in a sake replica can include fructose. In some embodiments, the fructose can be present in an amount of about 6 mg/L to about 600 mg/L (e.g., about 6 to about 10 mg/L, about 10 to about 25 mg/L, about 25 to about 50 mg/L, about 50 to about 100 mg/L, about 100 to about 500 mg/L, about 100 to about 600 mg/L, about 100 to about 300 mg/L, about 300 to about 500 mg/L, about 200 to about 400 mg/L, about 400 to about 500 mg/L or about 400 to about 600 mg/L),In some embodiments, the fructose can be present in an amount of at least about 25 mg/L (e.g., at least about 30 mg/L, 40 mg/L, 50 mg/L, 60 mg/L, 70 mg/L, 80 mg/L, 90 mg/L, 100 mg/L, 125 mg/L, 150 mg/L, 175 mg/L, 200 mg/L, 250 mg/L, 300 mg/L, 350 mg/L, 400 mg/L, 450 mg/L, 500 mg/L, or 600 mg/L).

The non-volatile compounds in a sake replica can include mannitol. In some embodiments, the mannitol can be present in an amount of about 16 mg/L to about 34 mg/L (e.g., about 16 to about 20 mg/L, about 20 to about 25 mg/L, about 25 to about 30 mg/L, about 30 to about 34 mg/L, about 16 to about 25 mg/L, about 25 to about 34 mg/L, or about 20 to about 30 mg/L). In some embodiments, the non-volatile compounds can include no mannitol.

The non-volatile compounds in a sake replica can include rhamnose. In some embodiments, the rhamnose can be present in an amount of about 14 mg/L to about 32 mg/L (e.g., about 14 to about 20 mg/L, about 15 to about 20 mg/L, about 20 to about 25 mg/L, about 25 to about 30 mg/L, about 25 to about 32 mg/L, about 20 to about 30 mg/L, or about 20 to about 32 mg/L). In some embodiments, the non-volatile compounds can include no rhamnose.

The non-volatile compounds in a sake replica can include glucose. In some embodiments, the glucose can be present in an amount of about 25 g/L to about 50 g/L (e.g., about 25 to about 30 g/L, about 30 to about 35 g/L, about 35 to about 40 g/L, about 40 to about 45 g/L, about 45 to about 50 g/L, about 25 to about 35 g/L, about 34 to about 38 g/L, about 35 to about 37 g/L, about 35 to about 45 g/L, about 30 to about 40 g/L, or about 40 to about 50 g/L). In some embodiments, the non-volatile compounds can include no glucose.

The non-volatile compounds in a sake replica can include xylose. In some embodiments, the xylose can be present in an amount of about 1 mg/L to about 18 mg/L (e.g., about 1 to about 5 mg/L, about 1 to about 10 mg/L, about 5 to about 10 mg/L, about 10 to about 18 mg/L, about 10 to about 15 mg/L, or about 15 to about 18 mg/L). In some embodiments, the non-volatile compounds can include no xylose.

The non-volatile compounds in a sake replica can include sorbitol. In some embodiments, the sorbitol can be present in an amount of about 27 mg/L to about 52 mg/L (e.g., about 27 to about 30 mg/L, about 30 to about 35 mg/L, about 35 to about 40 mg/L, about 35 to about 45 mg/L, about 40 to about 45 mg/L, about 45 to about 50 mg/L, about 45 to about 52 mg/L, about 30 to about 40 mg/L, about 40 to about 50 mg/L, or about 40 to about 52 mg/L). In some embodiments, the non-volatile compounds can include no sorbitol.

The non-volatile compounds in a sake replica can include betaine. In some embodiments, the betaine can be present in an amount of about 1 mg/L to about 20 mg/L (e.g., about 1 to about 5 mg/L, about 1 to about 10 mg/L, about 10 to about 20 mg/L, about 10 to about 15 mg/L, or about 15 to about 20 mg/L). In some embodiments, the non-volatile compounds can include no betaine.

The non-volatile compounds in a sake replica can include trans-4-hydroxyproline. In some embodiments, the trans-4-hydroxyproline can be present in an amount of about 0.04 mg/L to about 0.3 mg/L (e.g., about 0.04 to about 0.1 mg/L, about 0.05 to about 0.1 mg/L, about 0.1 to about 0.3 mg/L, about 0.1 to about 0.2 mg/L, or about 0.2 to about 0.3 mg/L). In some embodiments, the non-volatile compounds can include no trans-4-hydroxyproline.

The non-volatile compounds in a sake replica can include carnosine. In some embodiments, the carnosine can be present in an amount of about 0.4 mg/L to about 2 mg/L (e.g., about 0.4 to about 1 mg/L, about 0.5 to about 1 mg/L, or about 1 to about 2 mg/L). In some embodiments, the non-volatile compounds can include no carnosine.

The non-volatile compounds in a sake replica can include homoserine. In some embodiments, the homoserine can be present in an amount of about 4 mg/L to about 23 mg/L (e.g., 4 to about 10 mg/L, about 5 to about 10 mg/L, about 10 to about 20 mg/L, about 10 to about 23 mg/L, about 10 to about 15 mg/L, about 15 to about 20 mg/L, or about 15 to about 23 mg/L). In some embodiments, the non-volatile compounds can include no homoserine.

The non-volatile compounds in a sake replica can include citrulline. In some embodiments, the citrulline can be present in an amount of about 0.1 mg/L to about 0.4 mg/L (e.g., about 0.1 to about 0.3 mg/L or about 0.2 to about 0.4 mg/L). In some embodiments, the non-volatile compounds can include no citrulline.

The non-volatile compounds in a sake replica can include D-glucuronic acid. In some embodiments, the D-glucuronic acid can be present in an amount of about 8 mg/L to about 45 mg/L (e.g., about 8 to about 10 mg/L, about 10 to about 20 mg/L, about 20 to about 30 mg/L, about 30 to about 40 mg/L, about 10 to about 15 mg/L, about 15 to about 20 mg/L, about 20 to about 25 mg/L, about 25 to about 30 mg/L, about 30 to about 35 mg/L, about 32 to about 36 mg/L, about 33 to about 35 mg/L, about 35 to about 40 mg/L, about 40 to about 45 mg/L, about 15 to about 25 mg/L, about 25 to about 35 mg/L, or about 35 to about 45 mg/L).

The non-volatile compounds in a sake replica can include quinic acid. In some embodiments, the quinic acid can be present in an amount of about 12 mg/L to about 26 mg/L (e.g., about 12 to about 15 mg/L, about 12 to about 20 mg/L, about 15 to about 20 mg/L, about 20 to about 25 mg/L, about 20 to about 26 mg/L, about 15 to about 25 mg/L, or about 15 to about 26 mg/L). In some embodiments, the non-volatile compounds can include no quinic acid.

The non-volatile compounds in a sake replica can include malic acid. In some embodiments, the malic acid can be present in an amount of about 330 mg/L to about 620 mg/L (e.g., about 330 to about 350 mg/L, about 330 to about 400 mg/L, about 350 to about 400 mg/L, about 400 to about 450 mg/L, about 450 to about 500 mg/L, about 500 to about 550 mg/L, about 550 to about 600 mg/L, about 550 to about 620 mg/L, about 400 to about 500 mg/L, about 500 to about 600 mg/L, or about 500 to about 620 mg/L). In some embodiments, the non-volatile compounds can include no malic acid.

The non-volatile compounds in a sake replica can include pyruvic acid. In some embodiments, the pyruvic acid can be present in an amount of about 5 mg/L to about 12 mg/L (e.g., about 5 to about 10 mg/L, about 10 to about 12 mg/L, or about 8 to about 12 mg/L). In some embodiments, the non-volatile compounds can include no pyruvic acid.

The non-volatile compounds in a sake replica can include tartaric acid. In some embodiments, the tartaric acid can be present in an amount of about 0.1 mg/L to about 0.25 mg/L (e.g., about 0.1 to about 0.2 mg/L). In some embodiments, the non-volatile compounds can include no tartaric acid.

The non-volatile compounds in a sake replica can include lactic acid. In some embodiments, the lactic acid can be present in an amount of about 0.2 to about 0.6 mL/L (e.g., about 0.3 to about 0.5 mL/L). In some embodiments, the non-volatile compounds can include no lactic acid.

The non-volatile compounds in a sake replica can include citric acid. In some embodiments, the citric acid can be present in an amount of about 36 mg/L to about 68 mg/L (e.g., about 36 to about 40 mg/L, about 40 to about 45 mg/L, about 45 to about 50 mg/L, about 50 to about 55 mg/L, about 55 to about 60 mg/L, about 60 to about 65 mg/L, about 60 to about 68 mg/L, about 40 to about 50 mg/L, about 36 to about 45 mg/L, about 45 to about 55 mg/L, about 50 to about 54 mg/L, about 51 to about 53 mg/L, to about 55 to about 65 mg/L, or about 50 to about 60 mg/L). In some embodiments, the non-volatile compounds can include no citric acid.

The non-volatile compounds in a sake replica can include fumaric acid. In some embodiments, the fumaric acid can be present in an amount of about 0.3 mg/L to about 7 mg/L (e.g., about 0.3 to about 1 mg/L, about 0.3 to about 0.5 mg/L, about 0.5 to about 1 mg/L, about 1 to about 5 mg/L, about 1 to about 7 mg/L, about 1 to about 3 mg/L, about 3 to about 5 mg/L, or about 5 to about 7 mg/L),In some embodiments, the fumaric acid can be present in an amount of less than about 1.4 mg/L (e.g., less than about 1.3 mg/L, 1.2 mg/L, 1.1 mg/L, 1.0 mg/L, 0.9 mg/L, 0.8 mg/L, 0.7 mg/L, 0.6 mg/L, 0.5 mg/L, or 0.4 mg/L).

The non-volatile compounds in a sake replica can include succinic acid. In some embodiments, the succinic acid can be present in an amount of about 200 mg/L to about 400 mg/L (e.g., about 200 to about 300 mg/L, about 300 to about 400 mg/L, about 250 to about 350 mg/L, or about 280 to about 320 mg/L). In some embodiments, the non-volatile compounds can include no succinic acid.

The non-volatile compounds in a sake replica can include 2-furoic acid. In some embodiments, the 2-furoic acid can be present in an amount of about 11 mg/L to about 22 mg/L (e.g., about 11 to about 15 mg/L, about 15 to about 20 mg/L, or about 15 to about 22 mg/L). In some embodiments, the non-volatile compounds can include no 2-furoic acid.

The non-volatile compounds in a sake replica can include 2-isopropylmalic acid. In some embodiments, the 2-isopropylmalic acid can be present in an amount of about 4 mg/L to about 21 mg/L (e.g., about 4 to about 10 mg/L, about 5 to about 10 mg/L, about 10 to about 20 mg/L, about 10 to about 21 mg/L, about 10 to about 15 mg/L, about 15 to about 20 mg/L, or about 15 to about 21 mg/L). In some embodiments, the non-volatile compounds can include no 2-isopropylmalic acid.

The non-volatile compounds in a sake replica can include alanine. In some embodiments, the alanine can be present in an amount of about 60 mg/L to about 120 mg/L (e.g., about 60 to about 80 mg/L, about 80 to about 100 mg/L, about 85 to about 95 mg/L, about 100 to about 120 mg/L, about 70 to about 90 mg/L, or about 90 to about 110 mg/L). In some embodiments, the non-volatile compounds can include no alanine.

The non-volatile compounds in a sake replica can include choline bitartrate. In some embodiments, the choline bitartrate can be present in an amount of about 400 mg/L to about 750 mg/L (e.g., about 400 to about 500 mg/L, about 500 to about 600 mg/L, about 600 to about 700, about 600 to about 750 mg/L, about 450 to about 550 mg/L, about 550 to about 600 mg/L, about 550 to about 650 mg/L, or about 650 to about 750 mg/L). In some embodiments, the non-volatile compounds can include no choline bitartrate.

The non-volatile compounds in a sake replica can include KOH. In some embodiments, the KOH can be present in an amount of about 250 mg/L to about 500 mg/L (e.g., about 250 to about 350 mg/L, about 350 to about 400 mg/L, about 350 to about 450 mg/L, 300 to about 400 mg/L, or about 400 to about 500 mg/L). In some embodiments, the non-volatile compounds can include no KOH.

In some embodiments, the non-volatile compounds in a sake replica can include one or more compounds selected from the group consisting of 2,3,5,6-tetramethylpyrazine, 2,3,5-trimethylpyrazine, 2,3-dimethylpyrazine, 3,4-dihydroxybenzoic acid, 4-guanidinobutyric acid, acetovanillone, adenine, adipic acid, arabitol, aspartic acid, beta-alanine, caffeic acid, camphoric acid, carnitine, catechin, choline, cysteine, cystine, cytosine, ellagic acid, epicatechin, epicatechin gallate, fucose, galactose, gallic acid, glucosamine, guanine, hesperetin, kynurenic acid, leucine, mannose, methyl gallate, methyl-2-pyrrolyl ketone, inositol, pantothenic acid, pipecolinic acid, piperine, polydatin, proline, propyl gallate, pyridine, pyridoxine, quercetin, resveratrol, rutin, salicylic acid, sinapinic acid, sorbic acid, syringaldehyde, syringic acid, tryptamine, tyramine, tyrosine, vanillic acid, and vanillin, in any appropriate amount.

Because of the methods by which they are made, the sake replicas provided herein typically lack contaminants and other detrimental compounds that sometimes are encountered in traditional sakes. These include, without limitation, organisms such as Escherichia. coli, Salmonella sp., Brettanomyces sp., Lactobacillales, Saccharomyces sp. (which are often used by distillers and brewers), Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, and Verticillium psalliotae (strains that have been isolated from the corks of corked wine; see, www.ncbi.nlm.nih.gov/pmc/articles/PMC134401/), as well as heavy metal, mold, mildew, rot, insects, insect eggs, insect filth, rodent filth, mammalian excreta, insect lecithins, hydrogen sulfide, hydrogen disulfide, 2,4,6-trichloranisole (which has been linked to a skunked wine smell), 2,4,6,-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, and dichloromethane.

It is noted that while sake replicas can include volatile and non-volatile compounds as listed herein, the added compounds may react with one another to generate additional compounds, or to change the effective amount of one or more of the added compounds within the sake replica formulation.

This document also provides methods for making sake replicas. Any of the sake replicas described herein can be made by methods as disclosed herein. In some embodiments, the methods provided herein can be carried out by first mixing ethanol and non-volatile ingredients, and then adding VOCs. In general, water, ethanol, organic acids, VOCs, amino acids, and certain texture and flavor modifying ingredients are all used to generate a final product having the characteristics of a traditionally-produced sake. Sake replicas can be served cold or hot.

In some embodiments, the methods provided herein can include combining water one or more organic acids, one or more sugars or sugar alcohols, a base, one or more amino acids or amino acid derivatives, ethanol, and ten or more additional VOCs. In some embodiments, the methods also can include adding a coloring agent (e.g., carotene and/or caramel), a surfactant, gum arabic, pectin, or any combination thereof.

This document also provides methods for generating concentrated versions of any sake replica, where the concentrated versions include all of the additional VOCs and non-volatile components of the final product, but without the bulk of the ethanol and water. Such concentrates can be manufactured and then shipped to a second location, where water and ethanol can be added at the appropriate ABV and volume to create a finished product.

Any suitable concentration of additional VOCs and non-volatile compounds can be used. For example, a concentrated sake replica can include additional VOCs and non-volatile components in a concentration of at least 1.1-fold (e.g., 1.2-fold, 1.3-fold, 1.5-fold, 1.6-fold, 1.7-fold, 1.8-fold, 1.9-fold, 2-fold, 3-fold, 5-fold, 8-fold, 10-fold, 15-fold, or 20-fold concentrations, as compared to their concentrations in the final product, such that they can be diluted by at least about 1.1-fold (e.g., 1.2-fold, 1.3-fold, 1.5-fold, 1.6-fold, 1.7-fold, 1.8-fold, 1.9-fold, 2-fold, 5-fold, 8-fold, 10-fold, 15-fold, or 20-fold), respectively, with water and ethanol to yield the final product. The concentrates provided herein can contain all of the formulaic flavor, acid, and other components (as well as any grain neutral spirits) that are present in the final product. In general, such concentrates can be prepared in much the same way as a non-concentrated sake replica, by combining the desired amounts of additional VOCs and non-volatile components but omitting the water and the bulk of the ethanol. It is noted that in some cases, some amount of ethanol can be included in the concentrate in order to facilitate dissolution of the additional VOCs and non-volatile compounds.

Any of the sake replicas described herein can be made as a concentrate, e.g., using the methods disclosed herein. It will be appreciated that the amount of any component (e.g., additional VOC or non-volatile) disclosed herein as an amount for a sake replica (e.g., a 1× sake replica) can be multiplied by the concentration factor (e.g., 1.1-fold, 1.2-fold, 1.3-fold, 1.5-fold, 1.6-fold, 1.7-fold, 1.8-fold, 1.9-fold 2-fold, 3-fold, 5-fold, 8-fold, 10-fold, 15-fold, or 20-fold) for the appropriate concentrated amount.

Accordingly, also provided herein are exemplary formulations. Some exemplary formulations are shown in TABLES F1 (VOCs) and F2 (non-volatiles and ethanol). For example, an exemplary sake formulation can be made by combining some (e.g., 10, 11, 12, 13) or all of the VOCs in the “Exemplary 1× Range” column of TABLE F1 and some (e.g., 15, 16, 17, 18, 19) or all of the non-volatile compounds and the ethanol in the “Exemplary 1X Range” column of TABLE F2. Similarly, a sake replica concentrate could be made by combining some (e.g., 10, 11, 12, 13) or all of the VOCs in a ‘concentrate’ column of TABLE F1 and some (e.g., 15, 16, 17, 18, 19) or all of the non-volatile compounds and the ethanol in the corresponding ‘concentrate’ column of TABLE F2.

TABLE F1
VOCs in exemplary sake formulations

| | | Exemplary | Exemplary | Exemplary |
|---|---|---|---|---|
| Compound (mg/L, | | 5X | 10X | 20X |
| unless otherwise | Exemplary | Concentrate | Concentrate | Concentrate |
| specified) | 1X Range | Range | Range | Range |
| acetaldehyde | 17-32 | 85-160 | 170-320 | 340-640 |
| butyl alcohol | 3-7 | 15-35 | 30-70 | 60-140 |
| propyl alcohol | 5-11 | 25-55 | 50-110 | 100-220 |
| ethyl acetate | 45-85 | 225-425 | 450-850 | 900-1700 |
| ethyl butanoate | 0.4-0.8 | 2-4 | 4-8 | 8-16 |
| ethyl hexanoate | 2-4 | 10-20 | 20-40 | 40-80 |
| ethyl octanoate | 2.5-5.5 | 12.5-27.5 | 25-55 | 50-110 |
| furfural | 4-10 | 20-50 | 40-100 | 80-200 |
| isoamyl acetate | 0.5-1 | 2.5-5 | 5-10 | 10-20 |
| isoamyl alcohol | 70-130 | 350-650 | 700-1300 | 1400-2600 |
| isobutyl alcohol | 14-26 | 70-130 | 140-260 | 280-520 |
| phenethyl acetate | 0.1-0.2 | 0.5-1 | 1-2 | 2-4 |
| phenethyl alcohol | 4-9 | 20-45 | 40-90 | 80-180 |
| 2-methyl-1-butanol | 10-19 | 50-95 | 100-190 | 200-380 |

TABLE F2
exemplary non-volatiles and ethanol in sake formulations

| Compound | | Exemplary | Exemplary | Exemplary |
|---|---|---|---|---|
| (mg/L, unless | | 5X | 10X | 20X |
| otherwise | Exemplary | Concentrate | Concentrate | Concentrate |
| specified) | 1X Range | Range | Range | Range |
| arginine | 225-420 | 1125-2100 | 2250-4200 | 4500-8400 |
| alanine | 60-120 | 300-600 | 600-1200 | 1200-2400 |
| choline | 400-750 | 2000-3750 | 4000-7500 | 8000-15000 |
| bitartrate | | | | |
| fructose | 300-600 | 1500-3000 | 3000-6000 | 6000-12000 |
| glucose | 25000-50000 | 125000- | 250000- | 500000- |
| | | 250000 | 500000 | 1000000 |
| D-glucuronic | 20-45 | 100-225 | 200-450 | 400-900 |
| acid | | | | |
| malic acid | 330-620 | 1650-3100 | 3300-6200 | 6600-12400 |
| sorbitol | 25-50 | 125-250 | 250-500 | 500-1000 |
| fumaric acid | 0.25-0.6 | 1.25-3 | 2.5-6 | 5-12 |
| glutamic acid | 100-200 | 500-1000 | 1000-2000 | 2000-4000 |
| citric acid | 35-70 | 175-350 | 350-700 | 700-1400 |
| isoleucine | 35-65 | 175-325 | 350-650 | 700-1300 |
| tartaric acid | 0.1-0.25 | 0.5-1.25 | 1-2.5 | 2-5 |
| lactic acid | 280-530 | 1400-2650 | 2800-5300 | 5600-10600 |
| (mL/L) | | | | |
| lysine HCl | 20-45 | 100-225 | 200-450 | 400-900 |
| phenylalanine | 40-90 | 200-450 | 400-900 | 800-1800 |
| threonine | 9-16 | 45-80 | 90-160 | 180-320 |
| cinnamic acid | 16-32 | 80-160 | 160-320 | 320-640 |
| succinic acid | 200-400 | 1000-2000 | 2000-4000 | 4000-8000 |
| KOH | 250-500 | 1250-2500 | 2500-5000 | 5000-10000 |
| 95% ethanol | 110-210 | 550-1050* | 1100-2100* | 2200-4200* |
| (mL/L) | | | | |

*A portion of the ethanol can be added as a diluent and therefore the full amount shown may not be present in a concentrate.

### EXEMPLARY EMBODIMENTS

Embodiment 1 is a sake replica comprising:
ethanol;
water; and
one or more additional volatile organic compounds (VOCs), wherein the one or more additional VOCs comprise at least one compound selected from the group consisting of 1,4-cineole, 1-decanol, 2,4,6-trimethylphenol, 2-acetyl-1-methylpyrrole, 2-ethyl-3(5 or 6)-dimethylpyrazine , 2-ethyl-3-methylpyrazine, 2-isopropyl-4-methyl thiazole, 2-methoxy-3-(1-methylpropyl) pyrazine, 2-methoxy-4-methylphenol, 2-methoxy-4-propylphenol, 2-methylbutyl acetate, 2-methylbutyl isovalerate, 2-nonanol, 3-carene, 3-methylthio hexyl acetate, 3-phenylpropanal, 4,5,6,7-tetrahydro-3,6-dimethylbenzofuran, 4-carvomenthenol, 4-mercapto-4-methyl-2-pentanone, 5-methyl-2-phenyl-2-hexenal, acetoin, a-ionone, allyl heptanoate, alpha-pinene, amyl alcohol, amyl butyrate, anisyl acetate, anisyl butyrate, b-caryophellene, benzyl acetate, benzyl benzoate, benzyl butyrate, benzyl formate, benzyl propionate, beta-ionone, butyl butyryllactate, butyl formate, carvacrol, cinnamaldehyde, cis-3-hexenyl acetate, cis-3-hexenyl butyrate, cis-3-hexenyl valerate, cis-5-octen-1-ol, cis-6-nonen-1-ol, citral, citronellal, cuminaldehyde, D-carvone, decanal, d-fenchone, ethyl 2-trans-4-cis-decadienoate, ethyl cinnamate, ethyl myristate, ethyl undecanoate, eucalyptol, eugenol, furfuryl thioacetate, gamma-decalactone, gamma-terpinene, gamma-undecalactone, gamma-valerolactone, geranyl acetone, hexadecanol, hexyl 3-methylbutanoate, hexyl isobutyrate, 3-isobutyl-2-methoxypyrazine, isoamyl cinnamate, isoamyl isobutyrate, isoamyl isovalerate, isoamyl phenylacetate, isobutyl isobutyrate, isoeugenol, L-carvone, linalool, linalool oxide, linalyl acetate, L-menthyl acetate, maltol, massoia lactone, methyl anthranilate, methyl benzoate, methyl cinnamate, methyl cyclopentenolone, methyl decanoate, methyl octanoate, methyl salicylate, myrcene, nerolidol, omega-pentadecalactone, p,a-dimethylstyrene, p-cymene, perillaldehyde, phenethyl 2-methylbutyrate, phenethyl butyrate, phenethyl octanoate, phenethyl tiglate, phenylacetaldehyde dimethyl acetal, salicylaldehyde, tetrahydrolinalool, thymol, trans-2-hexen-1-al, valencene, valeraldehyde, vanillyl butyl ether, and whiskey lactone.

Embodiment 2 is the sake replica of embodiment 1, wherein the one or more additional VOCs do not comprise at least one compound selected from the group consisting of 1-octanol, 2,3-pentadione, 2-heptanone, 2-nonanone, 5-methyl furfural, benzaldehyde, benzyl alcohol, butyl acetate, butyraldehyde, citronellol, diethyl succinate, ethyl isobutyrate, ethyl lactate, ethyl propionate, ethyl trans-2-butenoate, ethyl(methylthio) acetate, gamma-heptalactone, gamma-hexalactone, gamma-octalactone, hexanol, isoamyl hexanoate, isobutyl acetate, isobutyraldehyde, isobutyric acid, isovaleric acid, methionyl acetate, methyl acetate, nonanoic acid, phenylacetaldehyde, propionaldehyde, propionic acid, propyl acetate, and propyl butyrate.

Embodiment 3 is a sake replica comprising:
ethanol;
water; and
one or more additional VOCs, wherein the one or more additional VOCs do not comprise at least one compound selected from the group consisting of 1-octanol, 2,3-pentadione, 2-heptanone, 2-nonanone, 5-methyl furfural, benzaldehyde, benzyl alcohol, butyl acetate, butyraldehyde, citronellol, diethyl succinate, ethyl isobutyrate, ethyl lactate, ethyl propionate, ethyl trans-2-butenoate, ethyl(methylthio) acetate, gamma-heptalactone, gamma-hexalactone, gamma-octalactone, hexanol, isoamyl hexanoate, isobutyl acetate, isobutyraldehyde, isobutyric acid, isovaleric acid, methionyl acetate, methyl acetate, nonanoic acid, phenylacetaldehyde, propionaldehyde, propionic acid, propyl acetate, and propyl butyrate.

Embodiment 4 is the sake replica of embodiment 3, wherein the one or more additional VOCs comprise at least one compound selected from the group consisting of 1,4-cineole, 1-decanol, 2,4,6-trimethylphenol, 2-acetyl-1-methylpyrrole, 2-ethyl-3(5 or 6)-dimethylpyrazine , 2-ethyl-3-methylpyrazine, 2-isopropyl-4-methyl thiazole, 2-methoxy-3-(1-methylpropyl) pyrazine, 2-methoxy-4-methylphenol, 2-methoxy-4-propylphenol, 2-methylbutyl acetate, 2-methylbutyl isovalerate, 2-nonanol, 3-carene, 3-methylthio hexyl acetate, 3-phenylpropanal, 4,5,6,7-tetrahydro-3,6-dimethylbenzofuran, 4-carvomenthenol, 4-mercapto-4-methyl-2-pentanone, 5-methyl-2-phenyl-2-hexenal, acetoin, a-ionone, allyl heptanoate, alpha-pinene, amyl alcohol, amyl butyrate, anisyl acetate, anisyl butyrate, b-caryophellene, benzyl acetate, benzyl benzoate, benzyl butyrate, benzyl formate, benzyl propionate, beta-ionone, butyl butyryllactate, butyl formate, carvacrol, cinnamaldehyde, cis-3-hexenyl acetate, cis-3-hexenyl butyrate, cis-3-hexenyl valerate, cis-5-octen-1-ol, cis-6-nonen-1-ol, citral, citronellal, cuminaldehyde, D-carvone, decanal, d-fenchone, ethyl 2-trans-4-cis-decadienoate, ethyl cinnamate, ethyl myristate, ethyl undecanoate, eucalyptol, eugenol, furfuryl thioacetate, gamma-decalactone, gamma-terpinene, gamma-undecalactone, gamma-valerolactone, geranyl acetone, hexadecanol, hexyl 3-methylbutanoate, hexyl isobutyrate, 3-isobutyl-2-methoxypyrazine, isoamyl cinnamate, isoamyl isobutyrate, isoamyl isovalerate, isoamyl phenylacetate, isobutyl isobutyrate, isoeugenol, L-carvone, linalool, linalool oxide, linalyl acetate, L-menthyl acetate, maltol, massoia lactone, methyl anthranilate, methyl benzoate, methyl cinnamate, methyl cyclopentenolone, methyl decanoate, methyl octanoate, methyl salicylate, myrcene, nerolidol, omega-pentadecalactone, p,a-dimethylstyrene, p-cymene, perillaldehyde, phenethyl 2-methylbutyrate, phenethyl butyrate, phenethyl octanoate, phenethyl tiglate, phenylacetaldehyde dimethyl acetal, salicylaldehyde, tetrahydrolinalool, thymol, trans-2-hexen-1-al, valencene, valeraldehyde, vanillyl butyl ether, and whiskey lactone.

Embodiment 5 is the sake replica of any one of embodiments 1 to 4, wherein the one or more additional VOCs comprise:
an ester;
an alcohol;

an aldehyde, a ketone, or an aldehyde and a ketone;

optionally, an acid;
optionally, a terpene, an isoprenoid, or a terpene and an isoprenoid;
optionally, a phenol;
optionally, a lactone;
optionally, an amine, a pyrazine, or an amine and a pyrazine;
optionally, a thiol, a thiazole, a sulfide, or any combination thereof;
optionally, an ether;
optionally, an acetal; and
optionally, a furan.

Embodiment 6 is the sake replica of any one of embodiments 1 to 5, wherein the one or more additional VOCs comprise one or more esters.

Embodiment 7 is the sake replica of embodiment 6, wherein the one or more esters are selected from the group consisting of 2-methylbutyl acetate, 2-methylbutyl isovalerate, 3-heptyl acetate, 3-methylthio hexyl acetate, allyl heptanoate, allyl hexanoate, amyl butyrate, anisyl acetate, anisyl butyrate, benzyl acetate, benzyl benzoate, benzyl butyrate, benzyl formate, benzyl propionate, butyl acetate, butyl butyryllactate, butyl formate, cis-3-hexenyl acetate, cis-3-hexenyl butyrate, cis-3-hexenyl caproate, cis-3-hexenyl valerate, diethyl malate, diethyl succinate, ethyl 2-methylbutyrate, ethyl 2-trans-4-cis-decadienoate, ethyl 3-hydroxyhexanoate, ethyl acetate, ethyl acetoacetate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl phenylacetate, ethyl propionate, ethyl salicylate, ethyl trans-2-butenoate, ethyl undecanoate, ethyl valerate, ethyl(methylthio) acetate, ethyl-trans-3-hexenoate, geranyl butyrate, geranyl propionate, heptyl acetate, hexyl 3-methylbutanoate, hexyl acetate, hexyl butyrate, hexyl formate, hexyl isobutyrate, hexyl propionate, isoamyl acetate, isoamyl cinnamate, isoamyl hexanoate, isoamyl isobutyrate, isoamyl isovalerate, isoamyl octanoate, isoamyl phenylacetate, isobutyl acetate, isobutyl butyrate, isobutyl isobutyrate, isobutyl propionate, linalyl acetate, methionyl acetate (3-methylthio-propylacetate), methionyl butyrate, methyl acetate, methyl anthranilate, methyl benzoate, methyl cinnamate, methyl decanoate, methyl hexanoate, methyl laurate, methyl octanoate, methyl salicylate, phenethyl 2-methylbutyrate, phenethyl acetate, phenethyl butyrate, phenethyl formate, phenethyl octanoate, phenethyl propionate, phenethyl tiglate, propyl acetate, propyl butyrate, propyl isovalerate, and mixtures thereof.

Embodiment 8 is the sake replica of any one of embodiments 6-7, wherein the one or more esters are selected from the group consisting of butyl acetate, diethyl malate, diethyl succinate, ethyl 2-methylbutyrate, ethyl 3-hydroxyhexanoate, ethyl acetate, ethyl benzoate, ethyl butanoate, ethyl decanoate, ethyl heptanoate, ethyl hexanoate, ethyl isobutyrate, ethyl isovalerate, ethyl lactate, ethyl laurate, ethyl levulinate, ethyl nonanoate, ethyl octanoate, ethyl phenylacetate, ethyl propionate, ethyl salicylate, ethyl trans-2-butenoate, ethyl valerate, ethyl(methylthio) acetate, ethyl-trans-3-hexenoate, heptyl acetate, hexyl acetate, isoamyl acetate, isoamyl hexanoate, isoamyl octanoate, isobutyl acetate, isobutyl propionate, methionyl acetate, methyl acetate, methyl hexanoate, methyl laurate, phenethyl acetate, phenethyl formate, phenethyl propionate, propyl acetate, propyl butyrate, propyl isovalerate, and mixtures thereof.

Embodiment 9 is the sake replica of any one of embodiments 6-8, wherein the one or more esters are selected from the group consisting of ethyl acetate, ethyl butanoate, ethyl hexanoate, ethyl octanoate, isoamyl acetate, phenethyl acetate, and mixtures thereof.

Embodiment 10 is the sake replica of any one of embodiments 6-9, wherein the one or more esters are present in a total amount of about 6 mg/L to about 95 mg/L.

Embodiment 11 is the sake replica of any one of embodiments 6-10, wherein the one or more esters are present in an amount of at least about 41 mg/L.

Embodiment 12 is the sake replica of any one of embodiments 6-11, wherein about 2% to about 40% by mass of the one or more additional VOCs comprise the one or more esters.

Embodiment 13 is the sake replica of any one of embodiments 1-12, wherein the one or more additional VOCs comprise one or more acids.

Embodiment 14 is the sake replica of embodiment 13, wherein the one or more acids are selected from the group consisting of isobutyric acid, isovaleric acid, nonanoic acid, propionic acid, and mixtures thereof.

Embodiment 15 is the sake replica of any one of embodiments 13-14, wherein the one or more acids are present in a total amount of about 0.9 mg/L to about 3 mg/L.

Embodiment 16 is the sake replica of any one of embodiments 13-15, wherein about 0.3% to about 2% of the one or more additional VOCs comprise the one or more acids.

Embodiment 17 is the sake replica of any one of embodiments 1-16, wherein the one or more additional VOCs comprise one or more alcohols.

Embodiment 18 is the sake replica of embodiment 17, wherein the one or more alcohols are selected from the group consisting of 1-decanol, 1-octanol, 1-octen-3-ol, 2-heptanol, 2-methyl-1-butanol, 2-nonanol, 2-phenylethanol, amyl alcohol, anisyl alcohol, benzyl alcohol, butyl alcohol, cis-5 -octen-1-ol, cis-6-nonen-1-ol, DL-3-methyl-2-butanol, hexadecanol, hexanol, isoamyl alcohol, isobutyl alcohol, propanol, and mixtures thereof.

Embodiment 19 is the sake replica of any one of embodiments 17-18, wherein the one or more alcohols are selected from the group consisting of 1-octanol, 1-octen-3-ol, 2-heptanol, 2-methyl-1-butanol, 2-phenylethanol, benzyl alcohol, butyl alcohol, DL-3-methyl-2-butanol, hexanol, isoamyl alcohol, isobutyl alcohol, propanol, and mixtures thereof.

Embodiment 20 is the sake replica of any one of embodiments 17-19, wherein the one or more alcohols are selected from the group consisting of 2-methyl-1-butanol, 2-phenylethanol, butyl alcohol, isoamyl alcohol, isobutyl alcohol, propanol, and mixtures thereof.

Embodiment 21 is the sake replica of any one of embodiments 17-20, wherein the one or more alcohols are present in a total amount of about 100 mg/L to about 350 mg/L.

Embodiment 22 is the sake replica of any one of embodiments 17-21, wherein about 40% to about 95% of the one or more additional VOCs comprise the one or more alcohols.

Embodiment 23 is the sake replica of any one of embodiments 1-22, wherein the one or more additional VOCs comprise one or more aldehydes or ketones.

Embodiment 24 is the sake replica of embodiment 23, wherein the one or more aldehydes or ketones are selected from the group consisting of 3-Ethyl-2-hydroxy-2-cyclopenten-1-one, 2,3-hexanedione, 2,3-pentadione, 2-acetyl-1-methylpyrrole, 2-heptanone, 2-methoxycinnamaldehyde, 2-methylbutyraldehyde, 2-nonanone, 2-octanone, 2-undecanone, 3-phenylpropanal, 5-ethyl-3-hydroxy-4-methyl-2(5H)-furanone, 5-methyl furfural, 5-methyl-2-phenyl-2-hexenal, 6-methyl-5-hepten-2-one, acetaldehyde, acetoin, acetophenone, benzaldehyde, butyraldehyde, cinnamaldehyde, cuminaldehyde, decanal, furfural, isobutyraldehyde, isovaleraldehyde, lauric aldehyde, maltol, methyl cyclopentenolone, methyl β-naphthyl ketone, methyl-2-pyrrolyl ketone, nonanal, octanal, p-anisaldehyde, phenylacetaldehyde, propionaldehyde, salicylaldehyde, trans-2-hexen-1-al, valeraldehyde, and mixtures thereof.

Embodiment 25 is the sake replica of any one of embodiments 23-24, wherein the one or more aldehydes or ketones are selected from the group consisting of 2,3-pentadione, 2-heptanone, 2-methylbutyraldehyde, 2-nonanone, 2-undecanone, 5-ethyl-3-hydroxy-4-methyl-2(5H)-furanone, 5-methyl furfural, 6-methyl-5-hepten-2-one, acetaldehyde, acetophenone, benzaldehyde, butyraldehyde, furfural, isobutyraldehyde, isovaleraldehyde, methyl β-naphthyl ketone, methyl-2-pyrrolyl ketone, nonanal, octanal, p-anisaldehyde, phenylacetaldehyde, propionaldehyde, and mixtures thereof.

Embodiment 26 is the sake replica of any one of embodiments 23-25, wherein the one or more aldehydes or ketones are selected from the group consisting of acetaldehyde, furfural, and mixtures thereof.

Embodiment 27 is the sake replica of any one of embodiments 23-26, wherein the one or more aldehydes or ketones are present in a total amount of about 0.09 mg/L to about 40 mg/L.

Embodiment 28 is the sake replica of any one of embodiments 23-27, wherein the one or more aldehydes or ketones are present in a total amount of at least about 1.2 mg/L.

Embodiment 29 is the sake replica of any one of embodiments 23-28, wherein about 0.03% to about 16% by mass of the one or more additional VOCs comprise the one or more aldehydes or ketones.

Embodiment 30 is the sake replica of any one of embodiments 23-30, wherein at least about 0.9% by mass of the one or more additional VOCs comprise the one or more aldehydes or ketones.

Embodiment 31 is the sake replica of any one of embodiments 1-30, wherein the one or more additional VOCs comprise one or more terpenes or isoprenoids.

Embodiment 32 is the sake of embodiment 31, wherein the one or more terpenes or isoprenoids are selected from the group consisting of (1R)-(-)-myrtenal, 1,4-cineole, 3-carene, 4,5,6,7-tetrahydro-3,6-dimethylbenzofuran, 4-carvomenthenol, 4-ethyl guaiacol, a-ionone, alpha-pinene, a-terpineol, b-caryophellene, beta-damascenone, beta-ionone, beta-pinene, carvacrol, cis-rose-oxide, citral, citronellal, citronellol, D-camphor, D-carvone, d-fenchone, eucalyptol, gamma-terpinene, geraniol, geranyl acetone, L-carvone, limonene, linalool, linalool oxide, L-menthyl acetate, myrcene, nerolidol, p,a-dimethyl styrene, p-cymene, perillaldehyde, terpinolene, tetrahydrolinalool, thymol, valencene, and mixtures thereof.

Embodiment 33 is the sake replica of any one of embodiments 31-32, wherein the one or more terpenes or isoprenoids are selected from the group consisting of (1R)-(-)-myrtenal, 4-ethyl guaiacol, a-terpineol, beta-damascenone, beta-pinene, cis-rose-oxide, citronellol, D-camphor, geraniol, limonene, and mixtures thereof.

Embodiment 34 is the sake replica of any one of embodiments 31-33, wherein the one or more terpenes or isoprenoids are present in a total amount of about 0.001 mg/L to about 0.045 mg/L.

Embodiment 35 is the sake replica of any one of embodiments 31-34, wherein about 0.0003% to about 0.035% by mass of the one or more additional VOCs comprise the one or more terpenes or isoprenoids.

Embodiment 36 is the sake replica of any one of embodiments 1-35, wherein the one or more additional VOCs comprise one or more phenols.

Embodiment 37 is the sake replica of embodiment 36, wherein the one or more phenols are selected from the group consisting of 2,4,6-trimethylphenol, 2-methoxy-4-methylphenol, 2-methoxy-4-propylphenol, 4-ethyl phenol, eugenol, guaiacol, isoeugenol, p-cresol, and mixtures thereof.

Embodiment 38 is the sake replica of any one of embodiments 36-37, wherein the one or more phenols are selected from the group consisting of 4-ethyl phenol, guaiacol, p-cresol, and mixtures thereof.

Embodiment 39 is the sake replica of any one of embodiments 36-38, wherein the one or more phenols are present in a total amount of about 0.0002 mg/L to about 0.009 mg/L.

Embodiment 40 is the sake replica of any one of embodiments 36-39, wherein about 0.00009% to about 0.006% by mass of the one or more additional VOCs comprise the one or more phenols.

Embodiment 41 is the sake replica of any one of embodiments 1-40, wherein the one or more additional VOCs comprise one or more lactones.

Embodiment 42 is the sake replica of embodiment 41, wherein the one or more lactones are selected from the group consisting of delta-decalactone, delta-dodecalactone, dihydrocoumarin, gamma-decalactone, gamma-dodecalactone, gamma-heptalactone, gamma-hexalactone, gamma-nonalactone, gamma-octalactone, gamma-undecalactone, gamma-valerolactone, massoia lactone, omega-pentadecalactone, whiskey lactone, and mixtures thereof.

Embodiment 43 is the sake replica of any one of embodiments 41-42, wherein the one or more lactones are selected from the group consisting of delta-decalactone, delta-dodecalactone, gamma-dodecalactone, gamma-heptalactone, gamma-hexalactone, gamma-nonalactone, gamma-octalactone, and mixtures thereof.

Embodiment 44 is the sake replica of any one of embodiments 41-43, wherein the one or more lactones are present in a total amount of about 0.0025 mg/L to about 0.2 mg/L.

Embodiment 45 is the sake replica of any one of embodiments 41-44, wherein about 0.0009% to about 0.12% by mass of the one or more additional VOCs comprise the one or more lactones.

Embodiment 46 is the sake replica of any one of embodiments 1-45, wherein the one or more additional VOCs comprise one or more amines or pyrazines.

Embodiment 47 is the sake replica of embodiment 46, wherein the one or more amines or pyrazines are selected from the group consisting of 2-ethyl-3(5 or 6)-dimethylpyrazine, 2-ethyl-3-methylpyrazine, 2-methoxy-3-(1-methylpropyl) pyrazine, 3-Isobutyl-2-methoxypyrazine, indole, and mixtures thereof.

Embodiment 48 is the sake replica of any one of embodiments 46-47, wherein the one or more amines or pyrazines comprise indole.

Embodiment 49 is the sake replica of any one of embodiments 46-48, wherein the one or more amines or pyrazines are present in a total amount of about 0.0001 mg/L to about 0.0003 mg/L.

Embodiment 50 is the sake replica of any one of embodiments 46-49, wherein about 0.00004% to about 0.0002% by mass of the one or more additional VOCs comprise the one or more amines or pyrazines.

Embodiment 51 is the sake replica of any one of embodiments 1-50, wherein the one or more additional VOCs comprise one or more thiols, thiazoles, or sulfides.

Embodiment 52 is the sake replica of embodiment 51, wherein the one or more thiols, thiazoles, or sulfides are selected from the group consisting of 1-para-menthene-8-thiol, 2-isopropyl-4-methyl thiazole, 4-mercapto-4-methyl-2-pentanone, furfuryl thioacetate, and mixtures thereof.

Embodiment 53 is the sake replica of any one of embodiments 51-52, wherein the one or more thiols, thiazoles, or sulfides comprise 1-para-menthene-8-thiol.

Embodiment 54 is the sake replica any one of embodiments 51-53, wherein the one or more thiols, thiazoles, or sulfides are present in a total amount of about 0.0000003 mg/L to about 0.0000015 mg/L.

Embodiment 55 is the sake replica of any one of embodiments 51-54, wherein about 0.00000008% to about 0.000001% by mass of the one or more additional VOCs comprise the one or more thiols, thiazoles, or sulfides.

Embodiment 56 is the sake replica of any one of embodiments 1 to 55, wherein the one or more additional VOCs comprise one or more ethers.

Embodiment 57 is the sake replica of embodiment 56, wherein the one or more ethers comprise vanillyl ethyl ether, vanillyl butyl ether, or a combination thereof.

Embodiment 58 is the sake replica of any one of embodiments 56-57, wherein the one or more ethers comprise vanillyl ethyl ether.

Embodiment 59 is the sake replica of any one of embodiments 56-58, wherein the one or more ethers are present in a total amount of about 0.001 to about 0.003 mg/L.

Embodiment 60 is the sake replica of any one of embodiments 56-59, wherein about 0.0004% to about 0.002% by mass of the one or more additional VOCs comprise the one or more ethers.

Embodiment 61 is the sake replica of any one of embodiments 1-60, wherein the one or more additional VOCs comprise one or more acetals.

Embodiment 62 is the sake replica of embodiment 61, wherein the one or more acetals are selected from the group consisting of 2-isobutyl-4-methyl-1,3-dioxolane, benzaldehyde glyceryl acetal, phenylacetaldehyde dimethyl acetal, and mixtures thereof.

Embodiment 63 is the sake replica of any one of embodiments 61-62, wherein the one or more acetals comprise 2-isobutyl-4-methyl-1,3-dioxolane.

Embodiment 64 is the sake replica of any one of embodiments 61-63, wherein the one or more acetals are present in a total amount of about 0.001 mg/L to about 0.003 mg/L.

Embodiment 65 is the sake replica of any one of embodiments 61-64, about 0.0004% to about 0.002% by mass of the one or more additional VOCs comprise the one or more acetals.

Embodiment 66 is the sake replica of any one of embodiments 1-65, wherein the one or more additional VOCs comprise one or more furans.

Embodiment 67 is the sake replica of embodiment 66, wherein the one or more furans comprise 2-pentyl furan.

Embodiment 68 is the sake replica of any one of embodiments 66-67, wherein the one or more furans are present in a total amount of about 0.0006 mg/L to about 0.0012 mg/L.

Embodiment 69 is the sake replica of any one of embodiments 66-68, wherein about 0.0002% to about 0.0008% by mass of the one or more additional VOCs comprise the one or more furans.

Embodiment 70 is the sake replica of any one of embodiments 1-69, wherein the one or more additional VOCs comprise at least 5 compounds selected from the group consisting of (1R)-(-)-myrtenal, 3-ethyl-2-hydroxy-2-cyclopenten-1-one, 1,4-cineole, 1-decanol, 1-octanol, 1-octen-3-ol, 1-para-menthene-8-thiol, 2,3-hexanedione, 2,3-pentadione, 2,4,6-trimethylphenol, 2-acetyl-1-methylpyrrole, 2-ethyl-3(5 or 6)-dimethylpyrazine, 2-ethyl-3-methylpyrazine, 2-heptanol, 2-heptanone, 2-isobutyl-4-methyl-1,3-dioxolane, 2-isopropyl-4-methyl thiazole, 2-methoxy-3-(1-methylpropyl) pyrazine, 2-methoxy-4-methylphenol, 2-methoxy-4-propylphenol, 2-methoxycinnamaldehyde, 2-methyl-1-butanol, 2-methylbutyl acetate, 2-methylbutyl isovalerate, 2-methylbutyraldehyde, 2-nonanol, 2-nonanone, 2-octanone, 2-pentylfuran, 2-phenylethanol, 2-undecanone, 3-carene, 3-heptyl acetate, 3-methylthio hexyl acetate, 3-phenylpropanal, 4,5,6,7-tetrahydro-3,6-dimethylbenzofuran, 4-carvomenthenol, 4-ethyl guaiacol, 4-ethyl phenol, 4-mercapto-4-methyl-2-pentanone, 5-ethyl-3-hydroxy-4-methyl-2(5H)-furanone, 5-methyl furfural, 5-methyl-2-phenyl-2-hexenal, 6-methyl-5-hepten-2-one, acetaldehyde, acetoin, acetophenone, a-ionone, allyl heptanoate, allyl hexanoate, alpha-pinene, amyl alcohol, amyl butyrate, anisyl acetate, anisyl alcohol, anisyl butyrate, a-terpineol, b-caryophellene, benzaldehyde, benzaldehyde glyceryl acetal, benzyl acetate, benzyl alcohol, benzyl benzoate, benzyl butyrate, benzyl formate, benzyl propionate, beta-damascenone, beta-ionone, beta-pinene, butyl acetate, butyl alcohol, butyl butyryllactate, butyl formate, butyraldehyde, carvacrol, cinnamaldehyde, cis-3-hexenyl acetate, cis-3-hexenyl butyrate, cis-3-hexenyl caproate, cis-3-hexenyl valerate, cis-5-octen-1-ol, cis-6-nonen-1-ol, cis-rose-oxide, citral, citronellal, citronellol, cuminaldehyde, D-camphor, D-carvone, decanal, delta-decalactone, delta-dodecalactone, d-fenchone, diethyl malate, diethyl succinate, dihydrocoumarin, DL-3-methyl-2-butanol, ethyl 2-methylbutyrate, ethyl 2-trans-4-cis-decadienoate, ethyl 3-hydroxyhexanoate, ethyl acetate, ethyl acetoacetate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl phenylacetate, ethyl propionate, ethyl salicylate, ethyl trans-2-butenoate, ethyl undecanoate, ethyl valerate, ethyl(methylthio) acetate, ethyl-trans-3-hexenoate, eucalyptol, eugenol, furfural, furfuryl thioacetate, gamma-decalactone, gamma-dodecalactone, gamma-heptalactone, gamma-hexalactone, gamma-nonalactone, gamma-octalactone, gamma-terpinene, gamma-undecalactone, gamma-valerolactone, geraniol, geranyl acetone, geranyl butyrate, geranyl propionate, guaiacol, heptyl acetate, hexadecanol, hexanol, hexyl 3-methylbutanoate, hexyl acetate, hexyl butyrate, hexyl formate, hexyl isobutyrate, hexyl propionate, 3-isobutyl-2-methoxypyrazine, indole, isoamyl acetate, isoamyl alcohol, isoamyl cinnamate, isoamyl hexanoate, isoamyl isobutyrate, isoamyl isovalerate, isoamyl octanoate, isoamyl phenylacetate, isobutyl acetate, isobutyl alcohol, isobutyl butyrate, isobutyl isobutyrate, isobutyl propionate, isobutyraldehyde, isobutyric acid, isoeugenol, isovaleraldehyde, isovaleric acid, lauric aldehyde, L-carvone, limonene, linalool, linalool oxide, linalyl acetate, L-menthyl acetate, maltol, massoia lactone, methionyl acetate, methionyl butyrate, methyl acetate, methyl anthranilate, methyl benzoate, methyl cinnamate, methyl cyclopentenolone, methyl decanoate, methyl hexanoate, methyl laurate, methyl octanoate, methyl salicylate, methyl β-naphthyl ketone, methyl-2-pyrrolyl ketone, myrcene, nerolidol, nonanal, nonanoic acid, octanal, omega-pentadecalactone, p,a-dimethyl styrene, p-anisaldehyde, p-cresol, p-cymene, perillaldehyde, phenethyl 2-methylbutyrate, phenethyl acetate, phenethyl butyrate, phenethyl formate, phenethyl octanoate, phenethyl propionate, phenethyl tiglate, phenylacetaldehyde, phenylacetaldehyde dimethyl acetal, propanol, propionaldehyde, propionic acid, propyl acetate, propyl butyrate, propyl isovalerate, salicylaldehyde, terpinolene, tetrahydrolinalool, thymol, trans-2-hexen-1-al, valencene, valeraldehyde, vanillyl butyl ether, vanillyl ethyl ether, and whiskey lactone.

Embodiment 71 is the sake replica of any one of embodiments 1-70, wherein the one or more additional VOCs comprise at least 3 compounds selected from the group consisting of (1R)-(-)-myrtenal, 1-octanol, 1-octen-3-ol, 1-para-menthene-8-thiol, 2,3-pentadione, 2-heptanol, 2-heptanone, 2-isobutyl-4-methyl-1,3-dioxolane, 2-methyl-1-butanol, 2-methylbutyraldehyde, 2-nonanone, 2-pentylfuran, 2-phenylethanol, 2-undecanone, 4-ethyl guaiacol, 4-ethyl phenol, 5-ethyl-3-hydroxy-4-methyl-2(5H)-furanone, 5-methyl furfural, 6-methyl-5-hepten-2-one, acetaldehyde, acetophenone, a-terpineol, benzaldehyde, benzyl alcohol, beta-damascenone, beta-pinene, butyl acetate, butyl alcohol, butyraldehyde, cis-rose-oxide, citronellol, D-camphor, delta-decalactone, delta-dodecalactone, diethyl malate, diethyl succinate, DL-3-methyl-2-butanol, ethyl 2-methylbutyrate, ethyl 3-hydroxyhexanoate, ethyl acetate, ethyl benzoate, Ethyl butanoate, ethyl decanoate, ethyl heptanoate, ethyl hexanoate, ethyl isobutyrate, ethyl isovalerate, ethyl lactate, ethyl laurate, ethyl levulinate, ethyl nonanoate, ethyl octanoate, ethyl phenylacetate, ethyl propionate, ethyl salicylate, ethyl trans-2-butenoate, ethyl valerate, ethyl(methylthio) acetate, ethyl-trans-3-hexenoate, furfural, gamma-dodecalactone, gamma-heptalactone, gamma-hexalactone, gamma-nonalactone, gamma-octalactone, geraniol, guaiacol, heptyl acetate, hexanol, hexyl acetate, indole, isoamyl acetate, isoamyl alcohol, isoamyl hexanoate, isoamyl octanoate, isobutyl acetate, isobutyl alcohol, isobutyl propionate, isobutyraldehyde, isobutyric acid, isovaleraldehyde, isovaleric acid, limonene, methionyl acetate, methyl acetate, methyl hexanoate, methyl laurate, methyl β-naphthyl ketone, methyl-2-pyrrolyl ketone, nonanal, nonanoic acid, octanal, p-anisaldehyde, p-cresol, phenethyl acetate, phenethyl formate, phenethyl propionate, phenylacetaldehyde, propanol, propionaldehyde, propionic acid, propyl acetate, propyl butyrate, propyl isovalerate, and vanillyl ethyl ether.

Embodiment 72 is the sake replica of any one of embodiments 1-71, wherein the one or more additional VOCs comprise at least 3 compounds selected from the group consisting of 1-octanol, 2,3-pentadione, 2-heptanone, 2-methyl-1-butanol, 2-nonanone, 2-phenylethanol, 5-methyl furfural, acetaldehyde, benzaldehyde, benzyl alcohol, butyl acetate, butyl alcohol, butyraldehyde, citronellol, diethyl succinate, ethyl acetate, ethyl butanoate, ethyl hexanoate, ethyl isobutyrate, ethyl lactate, ethyl octanoate, ethyl propionate, ethyl trans-2-butenoate, ethyl(methylthio) acetate, furfural, gamma-heptalactone, gamma-hexalactone, gamma-octalactone, hexanol, isoamyl acetate, isoamyl alcohol, isoamyl hexanoate, isobutyl acetate, isobutyl alcohol, isobutyraldehyde, isobutyric acid, isovaleric acid, methionyl acetate, methyl acetate, nonanoic acid, phenethyl acetate, phenylacetaldehyde, propanol, propionaldehyde, propionic acid, propyl acetate, propyl butyrate.

Embodiment 73 is the sake replica of any one of embodiments 1-72, wherein the one or more additional VOCs comprise at least 3 compounds selected from the group consisting of 2-methyl-1-butanol, 2-phenylethanol, acetaldehyde, butyl alcohol, ethyl acetate, ethyl butanoate, ethyl hexanoate, ethyl octanoate, furfural, isoamyl acetate, isoamyl alcohol, isobutyl alcohol, phenethyl acetate, and propanol.

Embodiment 74 is the sake replica of any one of embodiments 1-73, wherein the sake replica comprises 2-phenylethanol in an amount of less than about 28 mg/L.

Embodiment 75 is the sake replica of any one of embodiments 1-74, wherein the sake replica comprises propanol in an amount of less than about 39 mg/L.

Embodiment 76 is the sake replica of any one of embodiments 1-75, wherein the sake replica comprises ethyl butanoate in an amount of at least about 0.17 mg/L.

Embodiment 77 is the sake replica of any one of embodiments 1-76, wherein the sake replica comprises ethyl octanoate in an amount of at least about 3.4 mg/L.

Embodiment 78 is the sake replica of any one of embodiments 1-77, wherein the sake replica comprises furfural in an amount of at least about 0.45 mg/L.

Embodiment 79 is the sake replica of any one of embodiments 1-78, wherein less than about 15.5% by mass of the one or more additional VOCs comprise 2-phenylethanol.

Embodiment 80 is the sake replica of any one of embodiments 1-79, wherein less than about 22.5% by mass of the one or more additional VOCs comprise propanol.

Embodiment 81 is the sake replica of any one of embodiments 1-80, wherein at least about 0.12% by mass of the one or more additional VOCs comprise ethyl butanoate.

Embodiment 82 is the sake replica of any one of embodiments 1-81, wherein at least about 0.31% by mass of the one or more additional VOCs comprise furfural.

Embodiment 83 is the sake replica of any one of embodiments 1-82, wherein the one or more additional VOCs comprise one or more of butyl formate, ethyl octanoate, ethyl propionate, ethyl-2-methylbutyrate, isoamyl acetate, isoamyl alcohol, and isobutanol.

Embodiment 84 is the sake replica of any one of embodiments 1-82, wherein the one or more additional VOCs comprise two or more of butyl formate, ethyl octanoate, ethyl propionate, ethyl-2-methylbutyrate, isoamyl acetate, isoamyl alcohol, and isobutanol.

Embodiment 85 is the sake replica of any one of embodiments 1-82, wherein the one or more additional VOCs comprise three or more of butyl formate, ethyl octanoate, ethyl propionate, ethyl-2-methylbutyrate, isoamyl acetate, isoamyl alcohol, and isobutanol.

Embodiment 86 is the sake replica of any one of embodiments 1-82, wherein the one or more additional VOCs comprise four or more of butyl formate, ethyl octanoate, ethyl propionate, ethyl-2-methylbutyrate, isoamyl acetate, isoamyl alcohol, and isobutanol.

Embodiment 87 is the sake replica of any one of embodiments 1-82, wherein the one or more additional VOCs comprise five or more of butyl formate, ethyl octanoate, ethyl propionate, ethyl-2-methylbutyrate, isoamyl acetate, isoamyl alcohol, and isobutanol.

Embodiment 88 is the sake replica of any one of embodiments 1-82, wherein the one or more additional VOCs comprise six or more of butyl formate, ethyl octanoate, ethyl propionate, ethyl-2-methylbutyrate, isoamyl acetate, isoamyl alcohol, and isobutanol.

Embodiment 89 is the sake replica of any one of embodiments 1-82, wherein the one or more additional VOCs comprise butyl formate, ethyl octanoate, ethyl propionate, ethyl-2-methylbutyrate, isoamyl acetate, isoamyl alcohol, and isobutanol.

Embodiment 90 is the sake replica of any one of embodiments 1-82, wherein the one or more additional VOCs comprise no more than 6 of butyl formate, ethyl octanoate, ethyl propionate, ethyl-2-methylbutyrate, isoamyl acetate, isoamyl alcohol, and isobutanol.

Embodiment 91 is the sake replica of any one of embodiments 1-82, wherein the one or more additional VOCs comprise no more than 5 of butyl formate, ethyl octanoate, ethyl propionate, ethyl-2-methylbutyrate, isoamyl acetate, isoamyl alcohol, and isobutanol.

Embodiment 92 is the sake replica of any one of embodiments 1-82, wherein the one or more additional VOCs comprise no more than 4 of butyl formate, ethyl octanoate, ethyl propionate, ethyl-2-methylbutyrate, isoamyl acetate, isoamyl alcohol, and isobutanol.

Embodiment 93 is the sake replica of any one of embodiments 1-92, wherein the additional VOCs have less than 90% identity to the VOCs in a single reference sake.

Embodiment 94 is the sake replica of any one of embodiments 1-92, wherein the additional VOCs have less than 70% identity to the VOCs in a single reference sake.

Embodiment 95 is the sake replica of any one of embodiments 1-92, wherein the additional VOCs have less than 50% identity to the VOCs in a single reference sake.

Embodiment 96 is the sake replica of any one of embodiments 1-92, wherein the additional VOCs have less than 30% identity to the VOCs in a single reference sake.

Embodiment 97 is the sake replica of any one of embodiments 1-92, wherein the additional VOCs have less than 20% identity to the VOCs in a single reference sake.

Embodiment 98 is the sake replica of any one of embodiments 1-97, wherein the sake replica comprises at least 7 additional VOCs and wherein no more than 6 of the additional VOCs are found in a single reference sake.

Embodiment 99 is the sake replica of any one of embodiments 1-97, wherein the sake replica comprises at least 8 additional VOCs and wherein no more than 7 of the additional VOCs are found in a single reference sake.

Embodiment 100 is the sake replica of any one of embodiments 1-97, wherein the sake replica comprises at least 9 additional VOCs and wherein no more than 8 of the additional VOCs are found in a single reference sake.

Embodiment 101 is the sake replica of any one of embodiments 1-97, wherein the sake replica comprises at least 10 additional VOCs and wherein no more than 9 of the additional VOCs are found in a single reference sake.

Embodiment 102 is the sake replica of any one of embodiments 1-101, wherein the sake replica comprises one or more additional VOCs that are not present in a corresponding traditional sake.

Embodiment 103 is the sake replica of any one of embodiments 1-102, wherein the sake replica does not comprise one or more additional VOCs that are present in a corresponding traditional sake.

Embodiment 104 is the sake replica of any one of embodiments 1-103, further comprising one or more non-volatile compounds.

Embodiment 105 is the sake replica of embodiment 104, wherein the one or more non-volatile compounds comprise one or more non-volatile compounds that are not present in a corresponding traditional sake.

Embodiment 106 is the sake replica of embodiment 105, wherein the one or more non-volatile compounds that are not present in a traditional sake are selected from the group consisting of 2,3,5-trimethylpyrazine, 2,3-dimethylpyrazine, aspartic acid, caffeic acid, camphoric acid, catechin, cinnamic acid, cysteine, cystine, ellagic acid, epicatechin, epicatechin gallate, gallic acid, hesperetin, methyl gallate, methyl-2-pyrrolyl ketone, inositol, propyl gallate, pyridine, quercetin, resveratrol, sinapinic acid, sorbic acid, syringaldehyde, and tryptamine.

Embodiment 107 is the sake replica of any one of embodiments 104-106, wherein the one or more non-volatile compounds do not comprise one or more non-volatile compounds that are present in a corresponding traditional sake.

Embodiment 108 is the sake replica of embodiment 107, wherein the one or more non-volatile compounds that are present in a corresponding traditional sake are selected from the group consisting of 2,3,5,6-tetramethylpyrazine, 2-furoic acid, 2-isopropylmalic acid, 3,4-dihydroxybenzoic acid, 4-guanidinobutyric acid, asparagine, beta-alanine, carnitine, fucose, gamma-aminobutyric acid (GABA), galactose, glucosamine, glutamine, glycine, guanine, histidine, lactic acid, leucine, mannitol, mannose, methionine, ornithine, proline, pyridoxine, pyruvic acid, quinic acid, rhamnose, salicylic acid, serine, tryptophan, tyrosine, valine, and xylose.

Embodiment 109 is the sake replica of any one of embodiments 104-108, wherein the one or more non-volatile compounds comprise:
a sugar, a sugar alcohol, or a combination thereof;
an amino acid, an amino acid derivative, or a combination thereof;
a pH-modifying salt;
an organic acid;
optionally, a nucleobase, a nucleotide, or a combination thereof;
optionally, a nitrogen-containing heterocycle; and
optionally, a phenolic compound.

Embodiment 110. The sake replica of any one of embodiments 104-109, wherein the one or more non-volatile compounds comprise a sugar, a sugar alcohol, or a combination thereof.

Embodiment 111 is the sake replica of embodiment 110, wherein the sugar, sugar alcohol, or combination thereof is selected from the group consisting of arabitol, fructose, fucose, galactose, glucosamine, glucose, mannitol, mannose, inositol, rhamnose, ribose, sorbitol, xylose, and mixtures thereof.

Embodiment 112 is the sake replica of any one of embodiments 110-111, wherein the sugar, sugar alcohol, or combination thereof is selected from the group consisting of fructose, glucose, sorbitol, fucose, galactose, glucosamine, mannitol, mannose, rhamnose, xylose, arabitol, ribose, and mixtures thereof.

Embodiment 113 is the sake replica of any one of embodiments 110-112, wherein the sugar, sugar alcohol, or combination thereof is selected from the group consisting of fructose, glucose, sorbitol, and mixtures thereof.

Embodiment 114 is the sake replica of any one of embodiments 104-113, wherein the one or more non-volatile compounds comprise an amino acid, amino acid derivative, or combination thereof.

Embodiment 115 is the sake replica of embodiment 114, wherein the amino acid, amino acid derivative, or combination thereof is selected from the group consisting of alanine, arginine, asparagine, aspartic acid, beta-alanine, betaine, carnitine, carnosine, citrulline, cysteine, cystine, GABA, glutamic acid, glutamine, glycine, histidine, homoserine, isoleucine, kynurenic acid, leucine, lysine, methionine, ornithine, phenylalanine, proline, serine, threonine, trans-4-hydroxyproline, tryptamine, tryptophan, tyramine, tyrosine, valine, and mixtures thereof.

Embodiment 116 is the sake replica of any one of embodiments 114-115, wherein the amino acid, amino acid derivative, or combination thereof is selected from the group consisting of arginine, glutamic acid, isoleucine, lysine, phenylalanine, threonine, alanine, asparagine, beta-alanine, carnitine, GABA, glutamine, glycine, histidine, leucine, methionine, ornithine, proline, serine, tryptophan, tyrosine, valine, betaine, carnosine, citrulline, homoserine, trans-4-hydroxyproline, tyramine, kynurenic acid, and mixtures thereof.

Embodiment 117 is the sake replica of any one of embodiments 114-116, wherein the amino acid, amino acid derivative, or combination thereof is selected from the group consisting of alanine, arginine, glutamic acid, isoleucine, lysine, phenylalanine, threonine, and mixtures thereof.

Embodiment 118 is the sake replica of any one of embodiments 104-117, wherein the one or more non-volatile compounds comprise a pH-modifying salt.

Embodiment 119 is the sake replica of embodiment 118, wherein the pH-modifying comprises potassium hydroxide (KOH).

Embodiment 120 is the sake replica of any one of embodiments 104-119, wherein the one or more non-volatile compounds comprise an organic acid.

Embodiment 121 is the sake replica of embodiment 120, wherein the organic acid is selected from the group consisting of 2-furoic acid, 2-isopropylmalic acid, 4-guanidinobutyric acid, adipic acid, camphoric acid, cinnamic acid, citric acid, D-glucuronic acid, fumaric acid, lactic acid, malic acid, pantothenic acid, pyruvic acid, quinic acid, sorbic acid, succinic acid, tartaric acid, and mixtures thereof.

Embodiment 122 is the sake replica of any one of embodiments 120-121, wherein the organic acid is selected from the group consisting of citric acid, D-glucuronic acid, fumaric acid, malic acid, succinic acid, tartaric acid, cinnamic acid, pantothenic acid, 2-furoic acid, 2-isopropylmalic acid, 4-guanidinobutyric acid, lactic acid, pyruvic acid, quinic acid, adipic acid, and mixtures thereof.

Embodiment 123 is the sake replica of any one of embodiments 120-122, wherein the organic acid is selected from the group consisting of cinnamic acid, citric acid, D-glucuronic acid, fumaric acid, lactic acid, malic acid, succinic acid, tartaric acid, and mixtures thereof.

Embodiment 124 is the sake replica of any one of embodiments 104-123, wherein the one or more non-volatile compounds comprise a nucleobase, nucleotide, or a combination thereof.

Embodiment 125 is the sake replica of embodiment 124, wherein the nucleobase, nucleotide, or combination thereof is selected from the group consisting of adenine, cytidine, cytosine, guanine, uracil, and mixtures thereof.

Embodiment 126 is the sake replica of any one of embodiments 104-125, wherein the one or more non-volatile compounds comprise a nitrogen-containing heterocycle.

Embodiment 127 is the sake replica of embodiment 126, wherein the nitrogen-containing heterocycle is selected from the group consisting of 2,3,5,6-tetramethylpyrazine, 2,3,5-trimethylpyrazine, 2,3-dimethylpyrazine, methyl-2-pyrrolyl ketone, pipecolinic acid, piperine, pyridine, pyridoxine, and mixtures thereof.

Embodiment 128 is the sake replica of any one of embodiments 126-127, wherein the nitrogen-containing heterocycle is selected from the group consisting of 2,3,5,6-tetramethylpyrazine, pyridoxine, pipecolinic acid, piperine, and mixtures thereof.

Embodiment 129 is the sake replica of any one of embodiments 104-128, wherein the one or more non-volatile compounds comprise a phenolic compound.

Embodiment 130 is the sake replica of embodiment 129, wherein the phenolic compound is selected from the group consisting of 3,4-dihydroxybenzoic acid, acetovanillone, caffeic acid, catechin, coumaric acid, ellagic acid, epicatechin, epicatechin gallate, gallic acid, hesperetin, methyl gallate, polydatin, propyl gallate, quercetin, resveratrol, rutin, salicylic acid, sinapinic acid, syringaldehyde, syringic acid, trans-ferulic acid, vanillic acid, vanillin, and mixtures thereof.

Embodiment 131 is the sake replica of any one of embodiments 129-130, wherein the phenolic compound is selected from the group consisting of salicylic acid, vanillin, 3,4-dihydroxybenzoic acid, trans-ferulic acid, coumaric acid, vanillic acid, rutin, acetovanillone, polydatin, syringic acid, and mixtures thereof.

Embodiment 132 is the sake of any one of embodiments 104-131, wherein the one or more non-volatile compounds comprise at least 5 compounds selected from the group consisting of 2,3,5,6-tetramethylpyrazine, 2,3,5-trimethylpyrazine, 2,3-dimethylpyrazine, 2-furoic acid, 2-isopropylmalic acid, 3,4-dihydroxybenzoic acid, 4-guanidinobutyric acid, acetovanillone, adenine, adipic acid, alanine, arabitol, arginine, asparagine, aspartic acid, beta-alanine, betaine, caffeic acid, camphoric acid, carnitine, carnosine, catechin, choline, choline bitartrate, cinnamic acid, citric acid, citrulline, coumaric acid, cysteine, cystine, cytidine, cytosine, D-glucuronic acid, ellagic acid, epicatechin, epicatechin gallate, fructose, fucose, fumaric acid, GABA, galactose, gallic acid, glucosamine, glucose, glutamic acid, glutamine, glycine, guanine, hesperetin, histidine, homoserine, isoleucine, KOH, kynurenic acid, lactic acid, leucine, lysine, malic acid, mannitol, mannose, methionine, methyl Gallate, methyl-2-pyrrolyl ketone, inositol, ornithine, pantothenic acid, phenylalanine, pipecolinic acid, piperine, polydatin, proline, propyl gallate, pyridine, pyridoxine, pyruvic acid, quercetin, quinic acid, resveratrol, rhamnose, ribose, rutin, salicylic acid, serine, sinapinic acid, sorbic acid, sorbitol, succinic acid, syringaldehyde, syringic acid, tartaric acid, threonine, trans-4-hydroxyproline, trans-ferulic acid, tryptamine, tryptophan, tyramine, tyrosine, uracil, valine, vanillic acid, vanillin, and xylose.

Embodiment 133 is the sake replica of any one of embodiments 104-131, wherein the one or more non-volatile compounds comprise at least 5 compounds selected from the group consisting of 2,3,5,6-tetramethylpyrazine, 2-furoic acid, 2-isopropylmalic acid, 3,4-dihydroxybenzoic acid, 4-guanidinobutyric acid, acetovanillone, adenine, adipic acid, alanine, arabitol, arginine, asparagine, beta-alanine, betaine, carnitine, carnosine, choline, choline bitartrate, cinnamic acid, citric acid, citrulline, coumaric acid, cytidine, cytosine, D-glucuronic acid, fructose, fucose, fumaric acid, GABA, galactose, glucosamine, glucose, glutamic acid, glutamine, glycine, guanine, histidine, homoserine, isoleucine, KOH, kynurenic acid, lactic acid, leucine, lysine, malic acid, mannitol, mannose, methionine, ornithine, pantothenic acid, phenylalanine, pipecolinic acid, piperine, polydatin, proline, pyridoxine, pyruvic acid, quinic acid, rhamnose, ribose, rutin, salicylic acid, serine, sorbitol, succinic acid, syringic acid, tartaric acid, threonine, trans-4-hydroxyproline, trans-ferulic acid, tryptophan, tyramine, tyrosine, uracil, valine, vanillic acid, vanillin, and xylose.

Embodiment 134 is the sake replica of any one of embodiments 104-131, wherein the one or more non-volatile compounds comprise at least 5 compounds selected from the group consisting of 2,3,5,6-tetramethylpyrazine, 4-guanidinobutyric acid, alanine, arginine, choline bitartrate, cinnamic acid, citric acid, D-glucuronic acid, fructose, fumaric acid, glucose, glutamic acid, guanine, isoleucine, KOH, lysine, lactic acid malic acid, phenylalanine, pyridoxine, salicylic acid, sorbitol, succinic acid, tartaric acid, and threonine.

Embodiment 135 is the sake replica of any one of embodiments 104-131, wherein the one or more non-volatile compounds comprise at least 5 compounds selected from the group consisting of alanine, arginine, choline bitartrate, cinnamic acid, citric acid, D-glucuronic acid, fructose, fumaric acid, glucose, glutamic acid, isoleucine, KOH, lysine, lactic acid, malic acid, phenylalanine, sorbitol, succinic acid, tartaric acid, threonine.

Embodiment 136 is the sake replica of any one of embodiments 104-135, wherein the sake replica comprises less than about 1.4 mg/L of fumaric acid.

Embodiment 137 is the sake replica of any one of embodiments 104-136, wherein the sake replica comprises at least about 38 mg/L of phenylalanine.

Embodiment 138 is the sake replica of any one of embodiments 104-137, wherein the sake replica comprises at least about 25 mg/L of fructose.

Embodiment 139 is the sake replica of any one of embodiments 104-138, wherein the one or more non-volatile compounds have less than 90% identity to the non-volatile compounds in a single reference sake.

Embodiment 140 is the sake replica of any one of embodiments 104-138, wherein the one or more non-volatile compounds have less than 70% identity to the non-volatile compounds in a single reference sake.

Embodiment 141 is the sake replica of any one of embodiments 104-138, wherein the one or more non-volatile compounds have less than 50% identity to the non-volatile compounds in a single reference sake.

Embodiment 142 is the sake replica of any one of embodiments 104-138, wherein the one or more non-volatile compounds have less than 30% identity to the non-volatile compounds in a single reference sake.

Embodiment 143 is the sake replica of any one of embodiments 104-142, wherein the sake replica comprises at least 16 additional non-volatile compounds and wherein no more than 15 of the additional non-volatile compounds are found in a single reference sake.

Embodiment 144 is the sake replica of any one of embodiments 104-142, wherein the sake replica comprises at least 18 additional non-volatile compounds and wherein no more than 15 of the additional non-volatile compounds are found in a single reference sake.

Embodiment 145 is the sake replica of any one of embodiments 104-142, wherein the sake replica comprises at least 20 additional non-volatile compounds and wherein no more than 15 of the additional non-volatile compounds are found in a single reference sake.

Embodiment 146 is the sake replica of any one of embodiments 1-145, wherein the sake replica does not comprise one or more of Escherichia coli, Salmonella sp., Brettanomyces sp., Lactobacillales, Saccharomyces sp., Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, Verticillium psalliotae, mold, mildew, rot, insects, insect eggs, insect filth, rodent filth, mammalian excreta, insect lecithins, hydrogen sulfide, hydrogen disulfide, 2,4,6-trichloranisole, 2,4,6,-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, and dichloromethane.

Embodiment 147 is a sake replica comprising:
ethanol;
water; and
one or more non-volatile compounds, wherein the one or more non-volatile compounds comprise at least one compound selected from the group consisting of 2,3,5-trimethylpyrazine, 2,3-dimethylpyrazine, aspartic acid, caffeic acid, camphoric acid, catechin, cinnamic acid, cysteine, cystine, ellagic acid, epicatechin, epicatechin gallate, gallic acid, hesperetin, methyl gallate, methyl-2-pyrrolyl ketone, inositol, propyl gallate, pyridine, quercetin, resveratrol, sinapinic acid, sorbic acid, syringaldehyde, and tryptamine.

Embodiment 148 is the sake replica of embodiment 147, wherein the one or more non-volatile compounds do not comprise at least one compound selected from the group consisting of 2,3,5,6-tetramethylpyrazine, 2-furoic acid, 2-isopropylmalic acid, 3,4-dihydroxybenzoic acid, 4-guanidinobutyric acid, asparagine, beta-alanine, carnitine, fucose, GABA, galactose, glucosamine, glutamine, glycine, guanine, histidine, lactic acid, leucine, mannitol, mannose, methionine, ornithine, proline, pyridoxine, pyruvic acid, quinic acid, rhamnose, salicylic acid, serine, tryptophan, tyrosine, valine, and xylose.

Embodiment 149 is a sake replica comprising:
ethanol;
water; and
one or more non-volatile compounds, wherein the one or more non-volatile compounds do not comprise at least one compound selected from the group consisting of 2,3,5,6-tetramethylpyrazine, 2-furoic acid, 2-isopropylmalic acid, 3,4-dihydroxybenzoic acid, 4-guanidinobutyric acid, asparagine, beta-alanine, carnitine, fucose, GABA, galactose, glucosamine, glutamine, glycine, guanine, histidine, lactic acid, leucine, mannitol, mannose, methionine, ornithine, proline, pyridoxine, pyruvic acid, quinic acid, rhamnose, salicylic acid, serine, tryptophan, tyrosine, valine, and xylose.

Embodiment 150 is the sake replica of embodiment 149, wherein the one or more non-volatile compounds comprise at least one compound selected from the group consisting of 2,3,5-trimethylpyrazine, 2,3-dimethylpyrazine, aspartic acid, caffeic acid, camphoric acid, catechin, cinnamic acid, cysteine, cystine, ellagic acid, epicatechin, epicatechin gallate, gallic acid, hesperetin, methyl gallate, methyl-2-pyrrolyl ketone, inositol, propyl gallate, pyridine, quercetin, resveratrol, sinapinic acid, sorbic acid, syringaldehyde, and tryptamine.

Embodiment 151 is the sake replica of any one of embodiments 147-150, wherein the one or more non-volatile compounds comprise:
a sugar, a sugar alcohol, or a combination thereof;
an amino acid, an amino acid derivative, or a combination thereof;
a pH-modifying salt;
an organic acid;
optionally, a nucleobase, a nucleotide, or a combination thereof;
optionally, a nitrogen-containing heterocycle; and
optionally, a phenolic compound.

Embodiment 152. The sake replica of any one of embodiments 147-151, wherein the one or more non-volatile compounds comprise a sugar, a sugar alcohol, or a combination thereof.

Embodiment 153 is the sake replica of embodiment 152, wherein the sugar, sugar alcohol, or combination thereof is selected from the group consisting of arabitol, fructose, fucose, galactose, glucosamine, glucose, mannitol, mannose, inositol, rhamnose, ribose, sorbitol, xylose, and mixtures thereof.

Embodiment 154 is the sake replica of any one of embodiments 152-153, wherein the sugar, sugar alcohol, or combination thereof is selected from the group consisting of fructose, glucose, sorbitol, fucose, galactose, glucosamine, mannitol, mannose, rhamnose, xylose, arabitol, ribose, and mixtures thereof.

Embodiment 155 is the sake replica of any one of embodiments 152-115412, wherein the sugar, sugar alcohol, or combination thereof is selected from the group consisting of fructose, glucose, sorbitol, and mixtures thereof.

Embodiment 156 is the sake replica of any one of embodiments 147-155, wherein the one or more non-volatile compounds comprise an amino acid, amino acid derivative, or combination thereof.

Embodiment 157 is the sake replica of embodiment 156, wherein the amino acid, amino acid derivative, or combination thereof is selected from the group consisting of alanine, arginine, asparagine, aspartic acid, beta-alanine, betaine, carnitine, carnosine, citrulline, cysteine, cystine, GABA, glutamic acid, glutamine, glycine, histidine, homoserine, isoleucine, kynurenic acid, leucine, lysine, methionine, ornithine, phenylalanine, proline, serine, threonine, trans-4-hydroxyproline, tryptamine, tryptophan, tyramine, tyrosine, valine, and mixtures thereof.

Embodiment 158 is the sake replica of any one of embodiments 156-157, wherein the amino acid, amino acid derivative, or combination thereof is selected from the group consisting of arginine, glutamic acid, isoleucine, lysine, phenylalanine, threonine, alanine, asparagine, beta-alanine, carnitine, GABA, glutamine, glycine, histidine, leucine, methionine, ornithine, proline, serine, tryptophan, tyrosine, valine, betaine, carnosine, citrulline, homoserine, trans-4-hydroxyproline, tyramine, kynurenic acid, and mixtures thereof.

Embodiment 159 is the sake replica of any one of embodiments 156-158, wherein the amino acid, amino acid derivative, or combination thereof is selected from the group consisting of alanine, arginine, glutamic acid, isoleucine, lysine, phenylalanine, threonine, and mixtures thereof.

Embodiment 160 is the sake replica of any one of embodiments 147-159, wherein the one or more non-volatile compounds comprise a pH-modifying salt.

Embodiment 161 is the sake replica of embodiment 160, wherein the pH-modifying comprises potassium hydroxide (KOH).

Embodiment 162 is the sake replica of any one of embodiments 147-161, wherein the one or more non-volatile compounds comprise an organic acid.

Embodiment 163 is the sake replica of embodiment 162, wherein the organic acid is selected from the group consisting of 2-furoic acid, 2-isopropylmalic acid, 4-guanidinobutyric acid, adipic acid, camphoric acid, cinnamic acid, citric acid, D-glucuronic acid, fumaric acid, lactic acid, malic acid, pantothenic acid, pyruvic acid, quinic acid, sorbic acid, succinic acid, tartaric acid, and mixtures thereof.

Embodiment 164 is the sake replica of any one of embodiments 162-163, wherein the organic acid is selected from the group consisting of citric acid, D-glucuronic acid, fumaric acid, lactic acid, malic acid, succinic acid, tartaric acid, cinnamic acid, pantothenic acid, 2-furoic acid, 2-isopropylmalic acid, 4-guanidinobutyric acid, lactic acid, pyruvic acid, quinic acid, adipic acid, and mixtures thereof.

Embodiment 165 is the sake replica of any one of embodiments 162-164, wherein the organic acid is selected from the group consisting of cinnamic acid, citric acid, D-glucuronic acid, fumaric acid, lactic acid, malic acid, succinic acid, tartaric acid, and mixtures thereof.

Embodiment 166 is the sake replica of any one of embodiments 147-165, wherein the one or more non-volatile compounds comprise a nucleobase, nucleotide, or a combination thereof.

Embodiment 167 is the sake replica of embodiment 166, wherein the nucleobase, nucleotide, or combination thereof is selected from the group consisting of adenine, cytidine, cytosine, guanine, uracil, and mixtures thereof.

Embodiment 168 is the sake replica of any one of embodiments 147-167, wherein the one or more non-volatile compounds comprise a nitrogen-containing heterocycle.

Embodiment 169 is the sake replica of embodiment 168, wherein the nitrogen-containing heterocycle is selected from the group consisting of 2,3,5,6-tetramethylpyrazine, 2,3,5-trimethylpyrazine, 2,3-dimethylpyrazine, methyl-2-pyrrolyl ketone, pipecolinic acid, piperine, pyridine, pyridoxine, and mixtures thereof.

Embodiment 170 is the sake replica of any one of embodiments 168-169, wherein the nitrogen-containing heterocycle is selected from the group consisting of 2,3,5,6-tetramethylpyrazine, pyridoxine, pipecolinic acid, piperine, and mixtures thereof.

Embodiment 171 is the sake replica of any one of embodiments 147-170, wherein the one or more non-volatile compounds comprise a phenolic compound.

Embodiment 172 is the sake replica of embodiment 171, wherein the phenolic compound is selected from the group consisting of 3,4-dihydroxybenzoic acid, acetovanillone, caffeic acid, catechin, coumaric acid, ellagic acid, epicatechin, epicatechin gallate, gallic acid, hesperetin, methyl gallate, polydatin, propyl gallate, quercetin, resveratrol, rutin, salicylic acid, sinapinic acid, syringaldehyde, syringic acid, trans-ferulic acid, vanillic acid, vanillin, and mixtures thereof.

Embodiment 173 is the sake replica of any one of embodiments 171-172, wherein the phenolic compound is selected from the group consisting of salicylic acid, vanillin, 3,4-dihydroxybenzoic acid, trans-ferulic acid, coumaric acid, vanillic acid, rutin, acetovanillone, polydatin, syringic acid, and mixtures thereof.

Embodiment 174 is the sake of any one of embodiments 147-173, wherein the one or more non-volatile compounds comprise at least 5 compounds selected from the group consisting of 2,3,5,6-tetramethylpyrazine, 2,3,5-trimethylpyrazine, 2,3-dimethylpyrazine, 2-furoic acid, 2-isopropylmalic acid, 3,4-dihydroxybenzoic acid, 4-guanidinobutyric acid, acetovanillone, adenine, adipic acid, alanine, arabitol, arginine, asparagine, aspartic acid, beta-alanine, betaine, caffeic acid, camphoric acid, carnitine, carnosine, catechin, choline, choline bitartrate, cinnamic acid, citric acid, citrulline, coumaric acid, cysteine, cystine, cytidine, cytosine, D-glucuronic acid, ellagic acid, epicatechin, epicatechin gallate, fructose, fucose, fumaric acid, GABA, galactose, gallic acid, glucosamine, glucose, glutamic acid, glutamine, glycine, guanine, hesperetin, histidine, homoserine, isoleucine, KOH, kynurenic acid, lactic acid, leucine, lysine, malic acid, mannitol, mannose, methionine, methyl Gallate, methyl-2-pyrrolyl ketone, inositol, ornithine, pantothenic acid, phenylalanine, pipecolinic acid, piperine, polydatin, proline, propyl gallate, pyridine, pyridoxine, pyruvic acid, quercetin, quinic acid, resveratrol, rhamnose, ribose, rutin, salicylic acid, serine, sinapinic acid, sorbic acid, sorbitol, succinic acid, syringaldehyde, syringic acid, tartaric acid, threonine, trans-4-hydroxyproline, trans-ferulic acid, tryptamine, tryptophan, tyramine, tyrosine, uracil, valine, vanillic acid, vanillin, and xylose.

Embodiment 175 is the sake replica of any one of embodiments 147-173, wherein the one or more non-volatile compounds comprise at least 5 compound selected from the group consisting of 2,3,5,6-tetramethylpyrazine, 2-furoic acid, 2-isopropylmalic acid, 3,4-dihydroxybenzoic acid, 4-guanidinobutyric acid, acetovanillone, adenine, adipic acid, alanine, arabitol, arginine, asparagine, beta-alanine, betaine, carnitine, carnosine, choline, choline bitartrate, cinnamic acid, citric acid, citrulline, coumaric acid, cytidine, cytosine, D-glucuronic acid, fructose, fucose, fumaric acid, GABA, galactose, glucosamine, glucose, glutamic acid, glutamine, glycine, guanine, histidine, homoserine, isoleucine, KOH, kynurenic acid, lactic acid, leucine, lysine, malic acid, mannitol, mannose, methionine, ornithine, pantothenic acid, phenylalanine, pipecolinic acid, piperine, polydatin, proline, pyridoxine, pyruvic acid, quinic acid, rhamnose, ribose, rutin, salicylic acid, serine, sorbitol, succinic acid, syringic acid, tartaric acid, threonine, trans-4-hydroxyproline, trans-ferulic acid, tryptophan, tyramine, tyrosine, uracil, valine, vanillic acid, vanillin, and xylose.

Embodiment 176 is the sake replica of any one of embodiments 147-173, wherein the one or more non-volatile compounds comprise at least 5 compounds selected from the group consisting of 2,3,5,6-tetramethylpyrazine, 4-guanidinobutyric acid, alanine, arginine, choline bitartrate, cinnamic acid, citric acid, D-glucuronic acid, fructose, fumaric acid, glucose, glutamic acid, guanine, isoleucine, KOH, lysine, lactic acid, malic acid, phenylalanine, pyridoxine, salicylic acid, sorbitol, succinic acid, tartaric acid, and threonine.

Embodiment 177 is the sake replica of any one of embodiments 147-173, wherein the one or more non-volatile compounds comprise at least 5 compounds selected from the group consisting of alanine, arginine, choline bitartrate, cinnamic acid, citric acid, D-glucuronic acid, fructose, fumaric acid, glucose, glutamic acid, isoleucine, KOH, lactic acid, lysine, malic acid, phenylalanine, sorbitol, succinic acid, tartaric acid, threonine.

Embodiment 178 is the sake replica of any one of embodiments 147-177, wherein the sake replica comprises less than about 1.4 mg/L of fumaric acid.

Embodiment 179 is the sake replica of any one of embodiments 147-178, wherein the sake replica comprises at least about 38 mg/L of phenylalanine.

Embodiment 180 is the sake replica of any one of embodiments 147-179, wherein the sake replica comprises at least about 25 mg/L of fructose.

Embodiment 181 is the sake replica of any one of embodiments 104-180, wherein the one or more non-volatile compounds have less than 90% identity to the non-volatile compounds in a single reference sake.

Embodiment 182 is the sake replica of any one of embodiments 104-180, wherein the one or more non-volatile compounds have less than 70% identity to the non-volatile compounds in a single reference sake.

Embodiment 183 is the sake replica of any one of embodiments 104-180, wherein the one or more non-volatile compounds have less than 50% identity to the non-volatile compounds in a single reference sake.

Embodiment 184 is the sake replica of any one of embodiments 104-180, wherein the one or more non-volatile compounds have less than 30% identity to the non-volatile compounds in a single reference sake.

Embodiment 185 is the sake replica of any one of embodiments 147-184, wherein the sake replica comprises at least 16 additional non-volatile compounds and wherein no more than 15 of the additional non-volatile compounds are found in a single reference sake.

Embodiment 186 is the sake replica of any one of embodiments 147-184, wherein the sake replica comprises at least 18 additional non-volatile compounds and wherein no more than 15 of the additional non-volatile compounds are found in a single reference sake.

Embodiment 187 is the sake replica of any one of embodiments 147-142, wherein the sake replica comprises at least 20 additional non-volatile compounds and wherein no more than 15 of the additional non-volatile compounds are found in a single reference sake.

Embodiment 188 is the sake replica of any one of embodiments 147-187, wherein the sake replica comprises one or more additional VOCs that are not present in a corresponding traditional sake.

Embodiment 189 is the sake replica of any one of embodiments 147-187, wherein the sake replica does not comprise one or more additional VOCs that are present in a corresponding traditional sake.

Embodiment 190 is the sake replica of any one of embodiments 147-189, further comprising one or more additional VOCs.

Embodiment 191 is the sake replica of embodiment 190, wherein the one or more additional VOCs comprise one or more additional VOCs that are not present in a corresponding traditional sake.

Embodiment 192 is the sake replica of embodiment 191, wherein the one or more additional VOCs that are not present in a traditional sake are selected from the group consisting of 1,4-cineole, 1-decanol, 2,4,6-trimethylphenol, 2-acetyl-1-methylpyrrole, 2-ethyl-3(5 or 6)-dimethylpyrazine , 2-ethyl-3-methylpyrazine, 2-isopropyl-4-methyl thiazole, 2-methoxy-3-(1-methylpropyl) pyrazine, 2-methoxy-4-methylphenol, 2-methoxy-4-propylphenol, 2-methylbutyl acetate, 2-methylbutyl isovalerate, 2-nonanol, 3-carene, 3-methylthio hexyl acetate, 3-phenylpropanal, 4,5,6,7-tetrahydro-3,6-dimethylbenzofuran, 4-carvomenthenol, 4-mercapto-4-methyl-2-pentanone, 5-methyl-2-phenyl-2-hexenal, acetoin, a-ionone, allyl heptanoate, alpha-pinene, amyl alcohol, amyl butyrate, anisyl acetate, anisyl butyrate, b-caryophellene, benzyl acetate, benzyl benzoate, benzyl butyrate, benzyl formate, benzyl propionate, beta-ionone, butyl butyryllactate, butyl formate, carvacrol, cinnamaldehyde, cis-3-hexenyl acetate, cis-3-hexenyl butyrate, cis-3-hexenyl valerate, cis-5-octen-1-ol, cis-6-nonen-1-ol, citral, citronellal, cuminaldehyde, D-carvone, decanal, d-fenchone, ethyl 2-trans-4-cis-decadienoate, ethyl cinnamate, ethyl myristate, ethyl undecanoate, eucalyptol, eugenol, furfuryl thioacetate, gamma-decalactone, gamma-terpinene, gamma-undecalactone, gamma-valerolactone, geranyl acetone, hexadecanol, hexyl 3-methylbutanoate, hexyl isobutyrate, 3-isobutyl-2-methoxypyrazine, isoamyl cinnamate, isoamyl isobutyrate, isoamyl isovalerate, isoamyl phenylacetate, isobutyl isobutyrate, isoeugenol, L-carvone, linalool, linalool oxide, linalyl acetate, L-menthyl acetate, maltol, massoia lactone, methyl anthranilate, methyl benzoate, methyl cinnamate, methyl cyclopentenolone, methyl decanoate, methyl octanoate, methyl salicylate, myrcene, nerolidol, omega-pentadecalactone, p,a-dimethylstyrene, p-cymene, perillaldehyde, phenethyl 2-methylbutyrate, phenethyl butyrate, phenethyl octanoate, phenethyl tiglate, phenylacetaldehyde dimethyl acetal, salicylaldehyde, tetrahydrolinalool, thymol, trans-2-hexen-1-al, valencene, valeraldehyde, vanillyl butyl ether, and whiskey lactone.

Embodiment 193 is the sake replica of any one of embodiments 190-192, wherein the one or more additional VOCs do not comprise one or more additional VOCs that are present in a corresponding traditional sake.

Embodiment 194 is the sake replica of embodiment 193, wherein the one or more additional VOCs that are present in a traditional sake are selected from the group consisting of 1-octanol, 2,3-pentadione, 2-heptanone, 2-nonanone, 5-methyl furfural, benzaldehyde, benzyl alcohol, butyl acetate, butyraldehyde, citronellol, diethyl succinate, ethyl isobutyrate, ethyl lactate, ethyl propionate, ethyl trans-2-butenoate, ethyl(methylthio) acetate, gamma-heptalactone, gamma-hexalactone, gamma-octalactone, hexanol, isoamyl hexanoate, isobutyl acetate, isobutyraldehyde, isobutyric acid, isovaleric acid, methionyl acetate, methyl acetate, nonanoic acid, phenylacetaldehyde, propionaldehyde, propionic acid, propyl acetate, and propyl butyrate.

Embodiment 195 is the sake replica of any one of embodiments 190-194, wherein the one or more additional VOCs comprise:
an ester;
an alcohol;

an aldehyde, a ketone, or an aldehyde and a ketone;

optionally, an acid;
optionally, a terpene, an isoprenoid, or a terpene and an isoprenoid;
optionally, a phenol;
optionally, a lactone;
optionally, an amine, a pyrazine, or an amine and a pyrazine;
optionally, a thiol, a thiazole, a sulfide, or any combination thereof;
optionally, an ether;
optionally, an acetal; and
optionally, a furan.

Embodiment 196 is the sake replica of any one of embodiments 190-195, wherein the one or more additional VOCs comprise one or more esters.

Embodiment 197 is the sake replica of embodiment 196, wherein the one or more esters are selected from the group consisting of 2-methylbutyl acetate, 2-methylbutyl isovalerate, 3-heptyl acetate, 3-methylthio hexyl acetate, allyl heptanoate, allyl hexanoate, amyl butyrate, anisyl acetate, anisyl butyrate, benzyl acetate, benzyl benzoate, benzyl butyrate, benzyl formate, benzyl propionate, butyl acetate, butyl butyryllactate, butyl formate, cis-3-hexenyl acetate, cis-3-hexenyl butyrate, cis-3-hexenyl caproate, cis-3-hexenyl valerate, diethyl malate, diethyl succinate, ethyl 2-methylbutyrate, ethyl 2-trans-4-cis-decadienoate, ethyl 3-hydroxyhexanoate, ethyl acetate, ethyl acetoacetate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl phenylacetate, ethyl propionate, ethyl salicylate, ethyl trans-2-butenoate, ethyl undecanoate, ethyl valerate, ethyl(methylthio) acetate, ethyl-trans-3-hexenoate, geranyl butyrate, geranyl propionate, heptyl acetate, hexyl 3-methylbutanoate, hexyl acetate, hexyl butyrate, hexyl formate, hexyl isobutyrate, hexyl propionate, isoamyl acetate, isoamyl cinnamate, isoamyl hexanoate, isoamyl isobutyrate, isoamyl isovalerate, isoamyl octanoate, isoamyl phenylacetate, isobutyl acetate, isobutyl butyrate, isobutyl isobutyrate, isobutyl propionate, linalyl acetate, methionyl acetate (3-methylthio-propylacetate), methionyl butyrate, methyl acetate, methyl anthranilate, methyl benzoate, methyl cinnamate, methyl decanoate, methyl hexanoate, methyl laurate, methyl octanoate, methyl salicylate, phenethyl 2-methylbutyrate, phenethyl acetate, phenethyl butyrate, phenethyl formate, phenethyl octanoate, phenethyl propionate, phenethyl tiglate, propyl acetate, propyl butyrate, propyl isovalerate, and mixtures thereof.

Embodiment 198 is the sake replica of any one of embodiments 196-197, wherein the one or more esters are selected from the group consisting of butyl acetate, diethyl malate, diethyl succinate, ethyl 2-methylbutyrate, ethyl 3-hydroxyhexanoate, ethyl acetate, ethyl benzoate, ethyl butanoate, ethyl decanoate, ethyl heptanoate, ethyl hexanoate, ethyl isobutyrate, ethyl isovalerate, ethyl lactate, ethyl laurate, ethyl levulinate, ethyl nonanoate, ethyl octanoate, ethyl phenylacetate, ethyl propionate, ethyl salicylate, ethyl trans-2-butenoate, ethyl valerate, ethyl(methylthio) acetate, ethyl-trans-3-hexenoate, heptyl acetate, hexyl acetate, isoamyl acetate, isoamyl hexanoate, isoamyl octanoate, isobutyl acetate, isobutyl propionate, methionyl acetate, methyl acetate, methyl hexanoate, methyl laurate, phenethyl acetate, phenethyl formate, phenethyl propionate, propyl acetate, propyl butyrate, propyl isovalerate, and mixtures thereof.

Embodiment 199 is the sake replica of any one of embodiments 196-198, wherein the one or more esters are selected from the group consisting of ethyl acetate, ethyl butanoate, ethyl hexanoate, ethyl octanoate, isoamyl acetate, and phenethyl acetate.

Embodiment 200 is the sake replica of any one of embodiments 196-199, wherein the one or more esters are present in a total amount of about 6 mg/L to about 95 mg/L.

Embodiment 201 is the sake replica of any one of embodiments 196-200, wherein the one or more esters are present in an amount of at least about 41 mg/L.

Embodiment 202 is the sake replica of any one of embodiments 196-201, wherein about 2% to about 40% by mass of the one or more additional VOCs comprise the one or more esters.

Embodiment 203 is the sake replica of any one of embodiments 190-202, wherein the one or more additional VOCs comprise one or more acids.

Embodiment 204 is the sake replica of embodiment 203, wherein the one or more acids are selected from the group consisting of isobutyric acid, isovaleric acid, nonanoic acid, propionic acid, and mixtures thereof.

Embodiment 205 is the sake replica of any one of embodiments 203-204, wherein the one or more acids are present in a total amount of about 0.9 mg/L to about 3 mg/L.

Embodiment 206 is the sake replica of any one of embodiments 203-205, wherein about 0.3% to about 2% of the one or more additional VOCs comprise the one or more acids.

Embodiment 207 is the sake replica of any one of embodiments 190-206, wherein the one or more additional VOCs comprise one or more alcohols.

Embodiment 208 is the sake replica of embodiment 207, wherein the one or more alcohols are selected from the group consisting of 1-decanol, 1-octanol, 1-octen-3-ol, 2-heptanol, 2-methyl-1-butanol, 2-nonanol, 2-phenylethanol, amyl alcohol, anisyl alcohol, benzyl alcohol, butyl alcohol, cis-5-octen-1-ol, cis-6-nonen-1-ol, DL-3-methyl-2-butanol, hexadecanol, hexanol, isoamyl alcohol, isobutyl alcohol, propanol, and mixtures thereof.

Embodiment 209 is the sake replica of any one of embodiments 207-208, wherein the one or more alcohols are selected from the group consisting of 1-octanol, 1-octen-3-ol, 2-heptanol, 2-methyl-1-butanol, 2-phenylethanol, benzyl alcohol, butyl alcohol, DL-3-methyl-2-butanol, hexanol, isoamyl alcohol, isobutyl alcohol, propanol, and mixtures thereof.

Embodiment 210 is the sake replica of any one of embodiments 207-209, wherein the one or more alcohols are selected from the group consisting of 2-methyl-1-butanol, 2-phenylethanol, butyl alcohol, isoamyl alcohol, isobutyl alcohol, propanol, and mixtures thereof.

Embodiment 211 is the sake replica of any one of embodiments 207-210, wherein the one or more alcohols are present in a total amount of about 100 mg/L to about 350 mg/L.

Embodiment 212 is the sake replica of any one of embodiments 207-210, wherein about 40% to about 95% of the one or more additional VOCs comprise the one or more alcohols.

Embodiment 213 is the sake replica of any one of embodiments 190-212, wherein the one or more additional VOCs comprise one or more aldehydes or ketones.

Embodiment 214 is the sake replica of embodiment 213, wherein the one or more aldehydes or ketones are selected from the group consisting of 2,3-hexanedione, 2,3-pentadione, 2-acetyl-1-methylpyrrole, 2-heptanone, 2-methoxycinnamaldehyde, 2-methylbutyraldehyde, 2-nonanone, 2-octanone, 2-undecanone, 3-phenylpropanal, 5-ethyl-3-hydroxy-4-methyl-2(5H)-furanone, 5-methyl furfural, 5-methyl-2-phenyl-2-hexenal, 6-methyl-5-hepten-2-one, acetaldehyde, acetoin, acetophenone, benzaldehyde, butyraldehyde, cinnamaldehyde, cuminaldehyde, decanal, furfural, isobutyraldehyde, isovaleraldehyde, lauric aldehyde, maltol, methyl cyclopentenolone, methyl β-naphthyl ketone, methyl-2-pyrrolyl ketone, nonanal, octanal, p-anisaldehyde, phenylacetaldehyde, propionaldehyde, salicylaldehyde, trans-2-hexen-1-al, valeraldehyde, and mixtures thereof.

Embodiment 215 is the sake replica of any one of embodiments 213-214, wherein the one or more aldehydes or ketones are selected from the group consisting of 2,3-pentadione, 2-heptanone, 2-methylbutyraldehyde, 2-nonanone, 2-undecanone, 5-ethyl-3-hydroxy-4-methyl-2(5H)-furanone, 5-methyl furfural, 6-methyl-5-hepten-2-one, acetaldehyde, acetophenone, benzaldehyde, butyraldehyde, furfural, isobutyraldehyde, isovaleraldehyde, methyl β-naphthyl ketone, methyl-2-pyrrolyl ketone, nonanal, octanal, p-anisaldehyde, phenylacetaldehyde, propionaldehyde, and mixtures thereof.

Embodiment 216 is the sake replica of any one of embodiments 213-215, wherein the one or more aldehydes or ketones are selected from the group consisting of acetaldehyde, furfural, and mixtures thereof.

Embodiment 217 is the sake replica of any one of embodiments 213-216, wherein the one or more aldehydes or ketones are present in a total amount of about 0.09 mg/L to about 40 mg/L.

Embodiment 218 is the sake replica of any one of embodiments 213-217, wherein the one or more aldehydes or ketones are present in a total amount of at least about 1.2 mg/L.

Embodiment 219 is the sake replica of any one of embodiments 213-218, wherein about 0.03% to about 16% by mass of the one or more additional VOCs comprise the one or more aldehydes or ketones.

Embodiment 220 is the sake replica of any one of embodiments 213-219, wherein at least about 0.9% by mass of the one or more additional VOCs comprise the one or more aldehydes or ketones.

Embodiment 221 is the sake replica of any one of embodiments 190-220, wherein the one or more additional VOCs comprise one or more terpenes or isoprenoids.

Embodiment 222 is the sake of embodiment 221, wherein the one or more terpenes or isoprenoids are selected from the group consisting of (1R)-(-)-myrtenal, 1,4-cineole, 3-carene, 4,5,6,7-tetrahydro-3,6-dimethylbenzofuran, 4-carvomenthenol, 4-ethyl guaiacol, a-ionone, alpha-pinene, a-terpineol, b-caryophellene, beta-damascenone, beta-ionone, beta-pinene, carvacrol, cis-rose-oxide, citral, citronellal, citronellol, D-camphor, D-carvone, d-fenchone, eucalyptol, gamma-terpinene, geraniol, geranyl acetone, L-carvone, limonene, linalool, linalool oxide, L-menthyl acetate, myrcene, nerolidol, p,a-dimethyl styrene, p-cymene, perillaldehyde, terpinolene, tetrahydrolinalool, thymol, valencene, and mixtures thereof.

Embodiment 223 is the sake replica of any one of embodiments 221-222, wherein the one or more terpenes or isoprenoids are selected from the group consisting of (1R)-(-)-myrtenal, 4-ethyl guaiacol, a-terpineol, beta-damascenone, beta-pinene, cis-rose-oxide, citronellol, D-camphor, geraniol, limonene, and mixtures thereof.

Embodiment 224 is the sake replica of any one of embodiments 221-223, wherein the one or more terpenes or isoprenoids are present in a total amount of about 0.001 mg/L to about 0.045 mg/L.

Embodiment 225 is the sake replica of any one of embodiments 221-224, wherein about 0.0003% to about 0.035% by mass of the one or more additional VOCs comprise the one or more terpenes or isoprenoids.

Embodiment 226 is the sake replica of any one of embodiments 190-225, wherein the one or more additional VOCs comprise one or more phenols.

Embodiment 227 is the sake replica of embodiment 226, wherein the one or more phenols are selected from the group consisting of 2,4,6-trimethylphenol, 2-methoxy-4-methylphenol, 2-methoxy-4-propylphenol, 4-ethyl phenol, eugenol, guaiacol, isoeugenol, p-cresol, and mixtures thereof.

Embodiment 228 is the sake replica of any one of embodiments 226-227, wherein the one or more phenols are selected from the group consisting of 4-ethyl phenol, guaiacol, p-cresol, and mixtures thereof.

Embodiment 229 is the sake replica of any one of embodiments 226-228, wherein the one or more phenols are present in a total amount of about 0.0002 mg/L to about 0.009 mg/L.

Embodiment 230 is the sake replica of any one of embodiments 226-229, wherein about 0.00009% to about 0.006% by mass of the one or more additional VOCs comprise the one or more phenols.

Embodiment 231 is the sake replica of any one of embodiments 190-230, wherein the one or more additional VOCs comprise one or more lactones.

Embodiment 232 is the sake replica of embodiment 231, wherein the one or more lactones are selected from the group consisting of delta-decalactone, delta-dodecalactone, dihydrocoumarin, gamma-decalactone, gamma-dodecalactone, gamma-heptalactone, gamma-hexalactone, gamma-nonalactone, gamma-octalactone, gamma-undecalactone, gamma-valerolactone, massoia lactone, omega-pentadecalactone, whiskey lactone, and mixtures thereof.

Embodiment 233 is the sake replica of any one of embodiments 231-42, wherein the one or more lactones are selected from the group consisting of delta-decalactone, delta-dodecalactone, gamma-dodecalactone, gamma-heptalactone, gamma-hexalactone, gamma-nonalactone, gamma-octalactone, and mixtures thereof.

Embodiment 234 is the sake replica of any one of embodiments 231-233, wherein the one or more lactones are present in a total amount of about 0.0025 mg/L to about 0.2 mg/L.

Embodiment 235 is the sake replica of any one of embodiments 231-234, wherein about 0.0009% to about 0.12% by mass of the one or more additional VOCs comprise the one or more lactones.

Embodiment 236 is the sake replica of any one of embodiments 190-235, wherein the one or more additional VOCs comprise one or more amines or pyrazines.

Embodiment 237 is the sake replica of embodiment 236, wherein the one or more amines or pyrazines are selected from the group consisting of 2-ethyl-3(5 or 6)-dimethylpyrazine, 2-ethyl-3-methylpyrazine, 2-methoxy-3-(1-methylpropyl) pyrazine, 3-Isobutyl-2-methoxypyrazine, indole, and mixtures thereof.

Embodiment 238 is the sake replica of any one of embodiments 236-237, wherein the one or more amines or pyrazines comprise indole.

Embodiment 239 is the sake replica of any one of embodiments 236-238, wherein the one or more amines or pyrazines are present in a total amount of about 0.0001 mg/L to about 0.0003 mg/L.

Embodiment 240 is the sake replica of any one of embodiments 236-239, wherein about 0.00004% to about 0.0002% by mass of the one or more additional VOCs comprise the one or more amines or pyrazines.

Embodiment 241 is the sake replica of any one of embodiments 190-240, wherein the one or more additional VOCs comprise one or more thiols, thiazoles, or sulfides.

Embodiment 242 is the sake replica of embodiment 241, wherein the one or more thiols, thiazoles, or sulfides are selected from the group consisting of 1-para-menthene-8-thiol, 2-isopropyl-4-methyl thiazole, 4-mercapto-4-methyl-2-pentanone, furfuryl thioacetate, and mixtures thereof.

Embodiment 243 is the sake replica of any one of embodiments 241-242, wherein the one or more thiols, thiazoles, or sulfides comprise 1-para-menthene-8-thiol.

Embodiment 244 is the sake replica any one of embodiments 241-243, wherein the one or more thiols, thiazoles, or sulfides are present in a total amount of about 0.0000003 mg/L to about 0.0000015 mg/L.

Embodiment 245 is the sake replica of any one of embodiments 241-244, wherein about 0.00000008% to about 0.000001% by mass of the one or more additional VOCs comprise the one or more thiols, thiazoles, or sulfides.

Embodiment 246 is the sake replica of any one of embodiments 190-245, wherein the one or more additional VOCs comprise one or more ethers.

Embodiment 247 is the sake replica of embodiment 246, wherein the one or more ethers comprise vanillyl ethyl ether, vanillyl butyl ether, or a combination thereof.

Embodiment 248 is the sake replica of any one of embodiments 246-247, wherein the one or more ethers comprise vanillyl ethyl ether.

Embodiment 249 is the sake replica of any one of embodiments 246-248, wherein the one or more ethers are present in a total amount of about 0.001 to about 0.003 mg/L.

Embodiment 250 is the sake replica of any one of embodiments 246-249, wherein about 0.0004% to about 0.002% by mass of the one or more additional VOCs comprise the one or more ethers.

Embodiment 251 is the sake replica of any one of embodiments 190-250, wherein the one or more additional VOCs comprise one or more acetals.

Embodiment 252 is the sake replica of embodiment 251, wherein the one or more acetals are selected from the group consisting of 2-isobutyl-4-methyl-1,3-dioxolane, benzaldehyde glyceryl acetal, phenylacetaldehyde dimethyl acetal, and mixtures thereof.

Embodiment 253 is the sake replica of any one of embodiments 251-252, wherein the one or more acetals comprise 2-isobutyl-4-methyl-1,3-dioxolane.

Embodiment 254 is the sake replica of any one of embodiments 251-253, wherein the one or more acetals are present in a total amount of about 0.001 mg/L to about 0.003 mg/L.

Embodiment 255 is the sake replica of any one of embodiments 251-254, about 0.0004% to about 0.002% by mass of the one or more additional VOCs comprise the one or more acetals.

Embodiment 256 is the sake replica of any one of embodiments 190-255, wherein the one or more additional VOCs comprise one or more furans.

Embodiment 257 is the sake replica of embodiment 256, wherein the one or more furans comprise 2-pentyl furan.

Embodiment 258 is the sake replica of any one of embodiments 256-257, wherein the one or more furans are present in a total amount of about 0.0006 mg/L to about 0.0012 mg/L.

Embodiment 259 is the sake replica of any one of embodiments 256-258, wherein about 0.0002% to about 0.0008% by mass of the one or more additional VOCs comprise the one or more furans.

Embodiment 260 is the sake replica of any one of embodiments 190-259, wherein the one or more additional VOCs comprise at least 5 compounds selected from the group consisting of (1R)-(-)-myrtenal, 3 -ethyl-2-hydroxy-2-cyclopenten-1-one, 1,4-cineole, 1-decanol, 1-octanol, 1-octen-3-ol, 1-para-menthene-8-thiol, 2,3-hexanedione, 2,3-pentadione, 2,4,6-trimethylphenol, 2-acetyl-1-methylpyrrole, 2-ethyl-3(5 or 6)-dimethylpyrazine, 2-ethyl-3-methylpyrazine, 2-heptanol, 2-heptanone, 2-isobutyl-4-methyl-1,3-dioxolane, 2-isopropyl-4-methyl thiazole, 2-methoxy-3-(1-methylpropyl) pyrazine, 2-methoxy-4-methylphenol, 2-methoxy-4-propylphenol, 2-methoxycinnamaldehyde, 2-methyl-1-butanol, 2-methylbutyl acetate, 2-methylbutyl isovalerate, 2-methylbutyraldehyde, 2-nonanol, 2-nonanone, 2-octanone, 2-pentylfuran, 2-phenylethanol, 2-undecanone, 3-carene, 3-heptyl acetate, 3-methylthio hexyl acetate, 3-phenylpropanal, 4,5,6,7-tetrahydro-3,6-dimethylbenzofuran, 4-carvomenthenol, 4-ethyl guaiacol, 4-ethyl phenol, 4-mercapto-4-methyl-2-pentanone, 5-ethyl-3-hydroxy-4-methyl-2(5H)-furanone, 5-methyl furfural, 5-methyl-2-phenyl-2-hexenal, 6-methyl-5-hepten-2-one, acetaldehyde, acetoin, acetophenone, a-ionone, allyl heptanoate, allyl hexanoate, alpha-pinene, amyl alcohol, amyl butyrate, anisyl acetate, anisyl alcohol, anisyl butyrate, a-terpineol, b-caryophellene, benzaldehyde, benzaldehyde glyceryl acetal, benzyl acetate, benzyl alcohol, benzyl benzoate, benzyl butyrate, benzyl formate, benzyl propionate, beta-damascenone, beta-ionone, beta-pinene, butyl acetate, butyl alcohol, butyl butyryllactate, butyl formate, butyraldehyde, carvacrol, cinnamaldehyde, cis-3-hexenyl acetate, cis-3-hexenyl butyrate, cis-3-hexenyl caproate, cis-3-hexenyl valerate, cis-5-octen-1-ol, cis-6-nonen-1-ol, cis-rose-oxide, citral, citronellal, citronellol, cuminaldehyde, D-camphor, D-carvone, decanal, delta-decalactone, delta-dodecalactone, d-fenchone, diethyl malate, diethyl succinate, dihydrocoumarin, DL-3-methyl-2-butanol, ethyl 2-methylbutyrate, ethyl 2-trans-4-cis-decadienoate, ethyl 3-hydroxyhexanoate, ethyl acetate, ethyl acetoacetate, ethyl benzoate, ethyl butanoate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl phenylacetate, ethyl propionate, ethyl salicylate, ethyl trans-2-butenoate, ethyl undecanoate, ethyl valerate, ethyl(methylthio) acetate, ethyl-trans-3-hexenoate, eucalyptol, eugenol, furfural, furfuryl thioacetate, gamma-decalactone, gamma-dodecalactone, gamma-heptalactone, gamma-hexalactone, gamma-nonalactone, gamma-octalactone, gamma-terpinene, gamma-undecalactone, gamma-valerolactone, geraniol, geranyl acetone, geranyl butyrate, geranyl propionate, guaiacol, heptyl acetate, hexadecanol, hexanol, hexyl 3-methylbutanoate, hexyl acetate, hexyl butyrate, hexyl formate, hexyl isobutyrate, hexyl propionate, 3-isobutyl-2-methoxypyrazine, indole, isoamyl acetate, isoamyl alcohol, isoamyl cinnamate, isoamyl hexanoate, isoamyl isobutyrate, isoamyl isovalerate, isoamyl octanoate, isoamyl phenylacetate, isobutyl acetate, isobutyl alcohol, isobutyl butyrate, isobutyl isobutyrate, isobutyl propionate, isobutyraldehyde, isobutyric acid, isoeugenol, isovaleraldehyde, isovaleric acid, lauric aldehyde, L-carvone, limonene, linalool, linalool oxide, linalyl acetate, L-menthyl acetate, maltol, massoia lactone, methionyl acetate, methionyl butyrate, methyl acetate, methyl anthranilate, methyl benzoate, methyl cinnamate, methyl cyclopentenolone, methyl decanoate, methyl hexanoate, methyl laurate, methyl octanoate, methyl salicylate, methyl 3-naphthyl ketone, methyl-2-pyrrolyl ketone, myrcene, nerolidol, nonanal, nonanoic acid, octanal, omega-pentadecalactone, p,a-dimethyl styrene, p-anisaldehyde, p-cresol, p-cymene, perillaldehyde, phenethyl 2-methylbutyrate, phenethyl acetate, phenethyl butyrate, phenethyl formate, phenethyl octanoate, phenethyl propionate, phenethyl tiglate, phenylacetaldehyde, phenylacetaldehyde dimethyl acetal, propanol, propionaldehyde, propionic acid, propyl acetate, propyl butyrate, propyl isovalerate, salicylaldehyde, terpinolene, tetrahydrolinalool, thymol, trans-2-hexen-1-al, valencene, valeraldehyde, vanillyl butyl ether, vanillyl ethyl ether, and whiskey lactone.

Embodiment 261 is the sake replica of any one of embodiments 190-260, wherein the one or more additional VOCs comprise at least 3 compounds selected from the group consisting of (1R)-(-)-myrtenal, 1-octanol, 1-octen-3-ol, 1-para-menthene-8-thiol, 2,3-pentadione, 2-heptanol, 2-heptanone, 2-isobutyl-4-methyl-1,3-dioxolane, 2-methyl-1-butanol, 2-methylbutyraldehyde, 2-nonanone, 2-pentylfuran, 2-phenylethanol, 2-undecanone, 4-ethyl guaiacol, 4-ethyl phenol, 5-ethyl-3-hydroxy-4-methyl-2(5H)-furanone, 5-methyl furfural, 6-methyl-5-hepten-2-one, acetaldehyde, acetophenone, a-terpineol, benzaldehyde, benzyl alcohol, beta-damascenone, beta-pinene, butyl acetate, butyl alcohol, butyraldehyde, cis-rose-oxide, citronellol, D-camphor, delta-decalactone, delta-dodecalactone, diethyl malate, diethyl succinate, DL-3-methyl-2-butanol, ethyl 2-methylbutyrate, ethyl 3-hydroxyhexanoate, ethyl acetate, ethyl benzoate, Ethyl butanoate, ethyl decanoate, ethyl heptanoate, ethyl hexanoate, ethyl isobutyrate, ethyl isovalerate, ethyl lactate, ethyl laurate, ethyl levulinate, ethyl nonanoate, ethyl octanoate, ethyl phenylacetate, ethyl propionate, ethyl salicylate, ethyl trans-2-butenoate, ethyl valerate, ethyl(methylthio) acetate, ethyl-trans-3-hexenoate, furfural, gamma-dodecalactone, gamma-heptalactone, gamma-hexalactone, gamma-nonalactone, gamma-octalactone, geraniol, guaiacol, heptyl acetate, hexanol, hexyl acetate, indole, isoamyl acetate, isoamyl alcohol, isoamyl hexanoate, isoamyl octanoate, isobutyl acetate, isobutyl alcohol, isobutyl propionate, isobutyraldehyde, isobutyric acid, isovaleraldehyde, isovaleric acid, limonene, methionyl acetate, methyl acetate, methyl hexanoate, methyl laurate, methyl β-naphthyl ketone, methyl-2-pyrrolyl ketone, nonanal, nonanoic acid, octanal, p-anisaldehyde, p-cresol, phenethyl acetate, phenethyl formate, phenethyl propionate, phenylacetaldehyde, propanol, propionaldehyde, propionic acid, propyl acetate, propyl butyrate, propyl isovalerate, and vanillyl ethyl ether.

Embodiment 262 is the sake replica of any one of embodiments 190-261, wherein the one or more additional VOCs comprise at least 3 compounds selected from the group consisting of 1-octanol, 2,3-pentadione, 2-heptanone, 2-methyl-1-butanol, 2-nonanone, 2-phenylethanol, 5-methyl furfural, acetaldehyde, benzaldehyde, benzyl alcohol, butyl acetate, butyl alcohol, butyraldehyde, citronellol, diethyl succinate, ethyl acetate, ethyl butanoate, ethyl hexanoate, ethyl isobutyrate, ethyl lactate, ethyl octanoate, ethyl propionate, ethyl trans-2-butenoate, ethyl(methylthio) acetate, furfural, gamma-heptalactone, gamma-hexalactone, gamma-octalactone, hexanol, isoamyl acetate, isoamyl alcohol, isoamyl hexanoate, isobutyl acetate, isobutyl alcohol, isobutyraldehyde, isobutyric acid, isovaleric acid, methionyl acetate, methyl acetate, nonanoic acid, phenethyl acetate, phenylacetaldehyde, propanol, propionaldehyde, propionic acid, propyl acetate, propyl butyrate.

Embodiment 263 is the sake replica of any one of embodiments 190-262, wherein the one or more additional VOCs comprise at least 3 compounds selected from the group consisting of 2-methyl-1-butanol, 2-phenylethanol, acetaldehyde, butyl alcohol, ethyl acetate, ethyl butanoate, ethyl hexanoate, ethyl octanoate, furfural, isoamyl acetate, isoamyl alcohol, isobutyl alcohol, phenethyl acetate, and propanol.

Embodiment 264 is the sake replica of any one of embodiments 190-263, wherein the sake replica comprises 2-phenylethanol in an amount of less than about 28 mg/L.

Embodiment 265 is the sake replica of any one of embodiments 190-264, wherein the sake replica comprises propanol in an amount of less than about 39 mg/L.

Embodiment 266 is the sake replica of any one of embodiments 190-265, wherein the sake replica comprises ethyl butanoate in an amount of at least about 0.17 mg/L.

Embodiment 267 is the sake replica of any one of embodiments 190-266, wherein the sake replica comprises ethyl octanoate in an amount of at least about 3.4 mg/L.

Embodiment 268 is the sake replica of any one of embodiments 190-267, wherein the sake replica comprises furfural in an amount of at least about 0.45 mg/L.

Embodiment 269 is the sake replica of any one of embodiments 190-268, wherein less than about 15.5% by mass of the one or more additional VOCs comprise 2-phenylethanol.

Embodiment 270 is the sake replica of any one of embodiments 190-269, wherein less than about 22.5% by mass of the one or more additional VOCs comprise propanol.

Embodiment 271 is the sake replica of any one of embodiments 190-270, wherein at least about 0.12% by mass of the one or more additional VOCs comprise ethyl butanoate.

Embodiment 272 is the sake replica of any one of embodiments 190-271, wherein at least about 0.31% by mass of the one or more additional VOCs comprise furfural.

Embodiment 273 is the sake replica of any one of embodiments 190-272, wherein the one or more additional VOCs comprise one or more of butyl formate, ethyl octanoate, ethyl propionate, ethyl-2-methylbutyrate, isoamyl acetate, isoamyl alcohol, and isobutanol.

Embodiment 274 is the sake replica of any one of embodiments 190-272, wherein the one or more additional VOCs comprise two or more of butyl formate, ethyl octanoate, ethyl propionate, ethyl-2-methylbutyrate, isoamyl acetate, isoamyl alcohol, and isobutanol.

Embodiment 275 is the sake replica of any one of embodiments 190-272, wherein the one or more additional VOCs comprise three or more of butyl formate, ethyl octanoate, ethyl propionate, ethyl-2-methylbutyrate, isoamyl acetate, isoamyl alcohol, and isobutanol.

Embodiment 276 is the sake replica of any one of embodiments 190-272, wherein the one or more additional VOCs comprise four or more of butyl formate, ethyl octanoate, ethyl propionate, ethyl-2-methylbutyrate, isoamyl acetate, isoamyl alcohol, and isobutanol.

Embodiment 277 is the sake replica of any one of embodiments 190-272, wherein the one or more additional VOCs comprise five or more of butyl formate, ethyl octanoate, ethyl propionate, ethyl-2-methylbutyrate, isoamyl acetate, isoamyl alcohol, and isobutanol.

Embodiment 278 is the sake replica of any one of embodiments 190-272, wherein the one or more additional VOCs comprise six or more of butyl formate, ethyl octanoate, ethyl propionate, ethyl-2-methylbutyrate, isoamyl acetate, isoamyl alcohol, and isobutanol.

Embodiment 279 is the sake replica of any one of embodiments 190-272, wherein the one or more additional VOCs comprise butyl formate, ethyl octanoate, ethyl propionate, ethyl-2-methylbutyrate, isoamyl acetate, isoamyl alcohol, and isobutanol.

Embodiment 280 is the sake replica of any one of embodiments 190-272, wherein the one or more additional VOCs comprise no more than 6 of butyl formate, ethyl octanoate, ethyl propionate, ethyl-2-methylbutyrate, isoamyl acetate, isoamyl alcohol, and isobutanol.

Embodiment 281 is the sake replica of any one of embodiments 190-272, wherein the one or more additional VOCs comprise no more than 5 of butyl formate, ethyl octanoate, ethyl propionate, ethyl-2-methylbutyrate, isoamyl acetate, isoamyl alcohol, and isobutanol.

Embodiment 282 is the sake replica of any one of embodiments 190-272, wherein the one or more additional VOCs comprise no more than 4 of butyl formate, ethyl octanoate, ethyl propionate, ethyl-2-methylbutyrate, isoamyl acetate, isoamyl alcohol, and isobutanol.

Embodiment 283 is the sake replica of any one of embodiments 190-282, wherein the additional VOCs have less than 90% identity to the VOCs in a single reference sake.

Embodiment 284 is the sake replica of any one of embodiments 190-282, wherein the additional VOCs have less than 70% identity to the VOCs in a single reference sake.

Embodiment 285 is the sake replica of any one of embodiments 190-282, wherein the additional VOCs have less than 50% identity to the VOCs in a single reference sake.

Embodiment 286 is the sake replica of any one of embodiments 190-282, wherein the additional VOCs have less than 30% identity to the VOCs in a single reference sake.

Embodiment 287 is the sake replica of any one of embodiments 190-282, wherein the additional VOCs have less than 20% identity to the VOCs in a single reference sake.

Embodiment 288 is the sake replica of any one of embodiments 190-287, wherein the sake replica comprises at least 7 additional VOCs and wherein no more than 6 of the additional VOCs are found in a single reference sake.

Embodiment 289 is the sake replica of any one of embodiments 190-287, wherein the sake replica comprises at least 8 additional VOCs and wherein no more than 7 of the additional VOCs are found in a single reference sake.

Embodiment 290 is the sake replica of any one of embodiments 190-287, wherein the sake replica comprises at least 9 additional VOCs and wherein no more than 8 of the additional VOCs are found in a single reference sake.

Embodiment 291 is the sake replica of any one of embodiments 190-287, wherein the sake replica comprises at least 10 additional VOCs and wherein no more than 9 of the additional VOCs are found in a single reference sake.

Embodiment 292 is the sake replica of any one of embodiments 190-291, wherein the sake replica does not comprise one or more of Escherichia coli, Salmonella sp., Brettanomyces sp., Lactobacillales, Saccharomyces sp., Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, Verticillium psalliotae, mold, mildew, rot, insects, insect eggs, insect filth, rodent filth, mammalian excreta, insect lecithins, hydrogen sulfide, hydrogen disulfide, 2,4,6-trichloranisole, 2,4,6,-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, and dichloromethane.

Embodiment 293 is a sake replica comprising:
ethanol;
water; and
one or more additional VOCs, wherein the additional VOCs comprise 2-methyl-1-butanol, 2-phenylethanol, acetaldehyde, butyl alcohol, ethyl acetate, ethyl butanoate, ethyl hexanoate, ethyl octanoate, furfural, isoamyl acetate, isoamyl alcohol, isobutyl alcohol, phenethyl acetate, and propanol.

Embodiment 294 is the sake replica of embodiment 293, further comprising one or more non-volatile compounds, wherein the non-volatile compounds comprise alanine, arginine, choline bitartrate, cinnamic acid, citric acid, D-glucuronic acid, fructose, fumaric acid, glucose, glutamic acid, isoleucine, KOH, lactic acid, lysine, malic acid, phenylalanine, sorbitol, succinic acid, tartaric acid, and threonine.

Embodiment 295 is a sake replica comprising:
ethanol;
water; and
one or more non-volatile compounds, wherein the non-volatile compounds comprise alanine, arginine, choline bitartrate, cinnamic acid, citric acid, D-glucuronic acid, fructose, fumaric acid, glucose, glutamic acid, isoleucine, KOH, lactic acid lysine, malic acid, phenylalanine, sorbitol, succinic acid, tartaric acid, and threonine.

Embodiment 296 is the sake replica of embodiment 295, further comprising one or more additional VOCs, wherein the additional VOCs comprise 2-methyl-1-butanol, 2-phenylethanol, acetaldehyde, butyl alcohol, ethyl acetate, ethyl butanoate, ethyl hexanoate, ethyl octanoate, furfural, isoamyl acetate, isoamyl alcohol, isobutyl alcohol, phenethyl acetate, and propanol.

Embodiment 297 is a method of making a sake replica, the method comprising:
combining ingredients comprising:
   water;
   ethanol;
   five or more additional VOCs, wherein at least five of the five or more additional VOCs are provided as separate ingredients; and
five or more non-volatile compounds, wherein at least five of the five or more non-volatile compounds are provided as separate ingredients.

Embodiment 298 is the method of embodiment 297, comprising 10 or more additional VOCs, wherein at least 10 of the 10 or more additional VOCs are provided as separate ingredients.

Embodiment 299 is the method of any one of embodiments 297-298, comprising 10 or more non-volatile compounds, wherein at least 10 of the 10 or more non-volatile compounds are provided as separate ingredients.

Embodiment 300 is the method of any one of embodiments 297-299, wherein the additional VOCs comprise one or more VOCs that are not present in a corresponding traditional sake.

Embodiment 301 is the method of embodiment 300, wherein the one or more VOCs that are not present in a corresponding traditional sake are selected from the group consisting of 1,4-cineole, 1-decanol, 2,4,6-trimethylphenol, 2-acetyl-1-methylpyrrole, 2-ethyl-3(5 or 6)-dimethylpyrazine , 2-ethyl-3-methylpyrazine, 2-isopropyl-4-methyl thiazole, 2-methoxy-3-(1-methylpropyl) pyrazine, 2-methoxy-4-methylphenol, 2-methoxy-4-propylphenol, 2-methylbutyl acetate, 2-methylbutyl isovalerate, 2-nonanol, 3-carene, 3-methylthio hexyl acetate, 3-phenylpropanal, 4,5,6,7-tetrahydro-3,6-dimethylbenzofuran, 4-carvomenthenol, 4-mercapto-4-methyl-2-pentanone, 5-methyl-2-phenyl-2-hexenal, acetoin, a-ionone, allyl heptanoate, alpha-pinene, amyl alcohol, amyl butyrate, anisyl acetate, anisyl butyrate, b-caryophellene, benzyl acetate, benzyl benzoate, benzyl butyrate, benzyl formate, benzyl propionate, beta-ionone, butyl butyryllactate, butyl formate, carvacrol, cinnamaldehyde, cis-3-hexenyl acetate, cis-3-hexenyl butyrate, cis-3-hexenyl valerate, cis-5-octen-1-ol, cis-6-nonen-1-ol, citral, citronellal, cuminaldehyde, D-carvone, decanal, d-fenchone, ethyl 2-trans-4-cis-decadienoate, ethyl cinnamate, ethyl myristate, ethyl undecanoate, eucalyptol, eugenol, furfuryl thioacetate, gamma-decalactone, gamma-terpinene, gamma-undecalactone, gamma-valerolactone, geranyl acetone, hexadecanol, hexyl 3-methylbutanoate, hexyl isobutyrate, 3-isobutyl-2-methoxypyrazine, isoamyl cinnamate, isoamyl isobutyrate, isoamyl isovalerate, isoamyl phenylacetate, isobutyl isobutyrate, isoeugenol, L-carvone, linalool, linalool oxide, linalyl acetate, L-menthyl acetate, maltol, massoia lactone, methyl anthranilate, methyl benzoate, methyl cinnamate, methyl cyclopentenolone, methyl decanoate, methyl octanoate, methyl salicylate, myrcene, nerolidol, omega-pentadecalactone, p,a-dimethylstyrene, p-cymene, perillaldehyde, phenethyl 2-methylbutyrate, phenethyl butyrate, phenethyl octanoate, phenethyl tiglate, phenylacetaldehyde dimethyl acetal, salicylaldehyde, tetrahydrolinalool, thymol, trans-2-hexen-1-al, valencene, valeraldehyde, vanillyl butyl ether, and whiskey lactone.

Embodiment 302 is the method of any one of embodiments 297-301, wherein the additional VOCs do not comprise one or more VOCs that are present in a corresponding traditional sake.

Embodiment 303 is the method of embodiment 302, wherein the one or more VOCs that are present in a corresponding traditional sake are selected from the group consisting of 1-octanol, 2,3-pentadione, 2-heptanone, 2-nonanone, 5-methyl furfural, benzaldehyde, benzyl alcohol, butyl acetate, butyraldehyde, citronellol, diethyl succinate, ethyl isobutyrate, ethyl lactate, ethyl propionate, ethyl trans-2-butenoate, ethyl(methylthio) acetate, gamma-heptalactone, gamma-hexalactone, gamma-octalactone, hexanol, isoamyl hexanoate, isobutyl acetate, isobutyraldehyde, isobutyric acid, isovaleric acid, methionyl acetate, methyl acetate, nonanoic acid, phenylacetaldehyde, propionaldehyde, propionic acid, propyl acetate, and propyl butyrate.

Embodiment 304 is the method of any one of embodiments 297-303, wherein the non-volatile compounds comprise one or more non-volatile compounds that are not present in a corresponding traditional sake.

Embodiment 305 is the method of embodiment 304, wherein the one or more non-volatile compounds that are not present in a corresponding traditional sake are selected from the group consisting of 2,3,5-trimethylpyrazine, 2,3-dimethylpyrazine, aspartic acid, caffeic acid, camphoric acid, catechin, cinnamic acid, cysteine, cystine, ellagic acid, epicatechin, epicatechin gallate, gallic acid, hesperetin, methyl gallate, methyl-2-pyrrolyl ketone, inositol, propyl gallate, pyridine, quercetin, resveratrol, sinapinic acid, sorbic acid, syringaldehyde, and tryptamine.

Embodiment 306 is the method of any one of embodiments 297-307, wherein the non-volatile compounds do not comprise one or more non-volatile compounds that are present in a corresponding traditional sake.

Embodiment 307 is the method of embodiment 306, wherein the one or more non-volatile compounds that are present in a corresponding traditional sake are selected from the group consisting of 2,3,5,6-tetramethylpyrazine, 2-furoic acid, 2-isopropylmalic acid, 3,4-dihydroxybenzoic acid, 4-guanidinobutyric acid, asparagine, beta-alanine, carnitine, fucose, GABA, galactose, glucosamine, glutamine, glycine, guanine, histidine, lactic acid, leucine, mannitol, mannose, methionine, ornithine, proline, pyridoxine, pyruvic acid, quinic acid, rhamnose, salicylic acid, serine, tryptophan, tyrosine, valine, and xylose.

Embodiment 308 is the method of any one of embodiments 297-307, wherein the additional VOCs comprise2-methyl-1-butanol, 2-phenylethanol, acetaldehyde, butyl alcohol, ethyl acetate, ethyl butanoate, ethyl hexanoate, ethyl octanoate, furfural, isoamyl acetate, isoamyl alcohol, isobutyl alcohol, phenethyl acetate, and propanol.

Embodiment 309 is the method of any one of embodiments 297-308, wherein the non-volatile compounds comprise alanine, arginine, choline bitartrate, cinnamic acid, citric acid, D-glucuronic acid, fructose, fumaric acid, glucose, glutamic acid, isoleucine, KOH, lysine, malic acid, phenylalanine, sorbitol, succinic acid, tartaric acid, and threonine.

Embodiment 310 is a sake replica produced by the method of any one of embodiments 297-309.

Embodiment 311 is the sake replica of embodiment 310, wherein the sake replica is the sake replica of any one of embodiments 1-296.

Embodiment 312 is a method of sake replica concentrate, the method comprising combining:
ethanol;
water; and
one or more additional VOCs, wherein at least one of the one or more additional VOCs is present in a concentration of at least about 2-fold the concentration of the same VOC in a corresponding traditional sake.

Embodiment 313 is the method of embodiment 312, comprising 5 or more additional VOCs, wherein at least 5 of the 5 or more additional VOCs are provided as separate ingredients.

Embodiment 314. The method of embodiment 312, comprising 10 or more additional VOCs, wherein at least 10 of the 10 or more additional VOCs are provided as separate ingredients.

Embodiment 315 is the method of any one of embodiments 312-314, wherein the additional VOCs comprise one or more VOCs that are not present in a corresponding traditional sake.

Embodiment 316 is the method of embodiment 315, wherein the one or more VOCs that are not present in a corresponding traditional sake are selected from the group consisting of 1,4-cineole, 1-decanol, 2,4,6-trimethylphenol, 2-acetyl-1-methylpyrrole, 2-ethyl-3(5 or 6)-dimethylpyrazine , 2-ethyl-3-methylpyrazine, 2-isopropyl-4-methyl thiazole, 2-methoxy-3-(1-methylpropyl) pyrazine, 2-methoxy-4-methylphenol, 2-methoxy-4-propylphenol, 2-methylbutyl acetate, 2-methylbutyl isovalerate, 2-nonanol, 3-carene, 3-methylthio hexyl acetate, 3-phenylpropanal, 4,5,6,7-tetrahydro-3,6-dimethylbenzofuran, 4-carvomenthenol, 4-mercapto-4-methyl-2-pentanone, 5-methyl-2-phenyl-2-hexenal, acetoin, a-ionone, allyl heptanoate, alpha-pinene, amyl alcohol, amyl butyrate, anisyl acetate, anisyl butyrate, b-caryophellene, benzyl acetate, benzyl benzoate, benzyl butyrate, benzyl formate, benzyl propionate, beta-ionone, butyl butyryllactate, butyl formate, carvacrol, cinnamaldehyde, cis-3-hexenyl acetate, cis-3-hexenyl butyrate, cis-3-hexenyl valerate, cis-5-octen-1-ol, cis-6-nonen-1-ol, citral, citronellal, cuminaldehyde, D-carvone, decanal, d-fenchone, ethyl 2-trans-4-cis-decadienoate, ethyl cinnamate, ethyl myristate, ethyl undecanoate, eucalyptol, eugenol, furfuryl thioacetate, gamma-decalactone, gamma-terpinene, gamma-undecalactone, gamma-valerolactone, geranyl acetone, hexadecanol, hexyl 3-methylbutanoate, hexyl isobutyrate, 3-isobutyl-2-methoxypyrazine, isoamyl cinnamate, isoamyl isobutyrate, isoamyl isovalerate, isoamyl phenylacetate, isobutyl isobutyrate, isoeugenol, L-carvone, linalool, linalool oxide, linalyl acetate, L-menthyl acetate, maltol, massoia lactone, methyl anthranilate, methyl benzoate, methyl cinnamate, methyl cyclopentenolone, methyl decanoate, methyl octanoate, methyl salicylate, myrcene, nerolidol, omega-pentadecalactone, p,a-dimethylstyrene, p-cymene, perillaldehyde, phenethyl 2-methylbutyrate, phenethyl butyrate, phenethyl octanoate, phenethyl tiglate, phenylacetaldehyde dimethyl acetal, salicylaldehyde, tetrahydrolinalool, thymol, trans-2-hexen-1-al, valencene, valeraldehyde, vanillyl butyl ether, and whiskey lactone.

Embodiment 317 is the method of any one of embodiments 312-316, wherein the additional VOCs do not comprise one or more VOCs that are present in a corresponding traditional sake.

Embodiment 318 is the method of embodiment 317, wherein the one or more VOCs that are present in a corresponding traditional sake are selected from the group consisting of 1-octanol, 2,3-pentadione, 2-heptanone, 2-nonanone, 5-methyl furfural, benzaldehyde, benzyl alcohol, butyl acetate, butyraldehyde, citronellol, diethyl succinate, ethyl isobutyrate, ethyl lactate, ethyl propionate, ethyl trans-2-butenoate, ethyl(methylthio) acetate, gamma-heptalactone, gamma-hexalactone, gamma-octalactone, hexanol, isoamyl hexanoate, isobutyl acetate, isobutyraldehyde, isobutyric acid, isovaleric acid, methionyl acetate, methyl acetate, nonanoic acid, phenylacetaldehyde, propionaldehyde, propionic acid, propyl acetate, and propyl butyrate.

Embodiment 319 is the method of any one of embodiments 312-318, wherein the additional VOCs comprise 2-methyl-1-butanol, 2-phenylethanol, acetaldehyde, butyl alcohol, ethyl acetate, ethyl butanoate, ethyl hexanoate, ethyl octanoate, furfural, isoamyl acetate, isoamyl alcohol, isobutyl alcohol, phenethyl acetate, and propanol.

Embodiment 320 is the method of any one of embodiments 312-319, further comprising one or more non-volatile compounds.

Embodiment 321 is the method of embodiment 320, comprising 5 or more non-volatile compounds, wherein at least 5 of the 5 or more non-volatile compounds are provided as separate ingredients.

Embodiment 322 is the method of any one of embodiments 320-321, comprising 10 or more non-volatile compounds, wherein at least 10 of the 10 or more non-volatile compounds are provided as separate ingredients.

Embodiment 323 is the method of any one of embodiments 320-322, wherein the non-volatile compounds comprise one or more non-volatile compounds that are not present in a corresponding traditional sake.

Embodiment 324 is the method of embodiment 323, wherein the one or more non-volatile compounds that are not present in a corresponding traditional sake are selected from the group consisting of 2,3,5-trimethylpyrazine, 2,3-dimethylpyrazine, aspartic acid, caffeic acid, camphoric acid, catechin, cinnamic acid, cysteine, cystine, ellagic acid, epicatechin, epicatechin gallate, gallic acid, hesperetin, methyl gallate, methyl-2-pyrrolyl ketone, inositol, propyl gallate, pyridine, quercetin, resveratrol, sinapinic acid, sorbic acid, syringaldehyde, and tryptamine.

Embodiment 325 is the method of any one of embodiments 320-324, wherein the non-volatile compounds do not comprise one or more non-volatile compounds that are present in a corresponding traditional sake.

Embodiment 326 is the method of embodiment 325, wherein the one or more non-volatile compounds that are present in a corresponding traditional sake are selected from the group consisting of 2,3,5,6-tetramethylpyrazine, 2-furoic acid, 2-isopropylmalic acid, 3,4-dihydroxybenzoic acid, 4-guanidinobutyric acid, asparagine, beta-alanine, carnitine, fucose, GABA, galactose, glucosamine, glutamine, glycine, guanine, histidine, lactic acid, leucine, mannitol, mannose, methionine, ornithine, proline, pyridoxine, pyruvic acid, quinic acid, rhamnose, salicylic acid, serine, tryptophan, tyrosine, valine, and xylose.

Embodiment 327 is the method of any one of embodiments 320-326, wherein the non-volatile compounds comprise alanine, arginine, choline bitartrate, cinnamic acid, citric acid, D-glucuronic acid, fructose, fumaric acid, glucose, glutamic acid, isoleucine, KOH, lysine, malic acid, phenylalanine, sorbitol, succinic acid, tartaric acid, and threonine.

Embodiment 328 is a method of making a sake replica concentrate, the method comprising combining:
ethanol;
water; and
one or more non-volatile compounds, wherein at least one of the one or more non-volatile compounds is present in a concentration of at least about 2-fold the concentration of the same non-volatile compound in a corresponding traditional sake.

Embodiment 329 is the method of 328, wherein the one or more non-volatile compounds comprise at least one non-volatile compound that is not present in a corresponding traditional sake.

Embodiment 330 is the method of embodiment 328 or embodiment 329, wherein the one or more non-volatile compounds that are not present in a corresponding traditional sake are selected from the group consisting of 2,3,5-trimethylpyrazine, 2,3-dimethylpyrazine, aspartic acid, caffeic acid, camphoric acid, catechin, cinnamic acid, cysteine, cystine, ellagic acid, epicatechin, epicatechin gallate, gallic acid, hesperetin, methyl gallate, methyl-2-pyrrolyl ketone, inositol, propyl gallate, pyridine, quercetin, resveratrol, sinapinic acid, sorbic acid, syringaldehyde, and tryptamine.

Embodiment 331 is the method of any one of embodiments 328-330, wherein the one or more non-volatile compounds do not comprise at least one non-volatile compound that is present in a corresponding traditional sake.

Embodiment 332 is the method of embodiment 331, wherein the one or more non-volatile compounds that are present in a corresponding traditional sake are selected from the group consisting of 2,3,5,6-tetramethylpyrazine, 2-furoic acid, 2-isopropylmalic acid, 3,4-dihydroxybenzoic acid, 4-guanidinobutyric acid, asparagine, beta-alanine, carnitine, fucose, GABA, galactose, glucosamine, glutamine, glycine, guanine, histidine, lactic acid, leucine, mannitol, mannose, methionine, ornithine, proline, pyridoxine, pyruvic acid, quinic acid, rhamnose, salicylic acid, serine, tryptophan, tyrosine, valine, and xylose.

Embodiment 333 is the method of any one of embodiments 328-332, wherein the non-volatile compounds comprise alanine, arginine, choline bitartrate, cinnamic acid, citric acid, D-glucuronic acid, fructose, fumaric acid, glucose, glutamic acid, isoleucine, KOH, lysine, malic acid, phenylalanine, sorbitol, succinic acid, tartaric acid, and threonine.

Embodiment 334 is the method of any one of embodiments 328-333, wherein the sake replica concentrate further comprises one or more additional VOCs, and wherein the one or more additional VOCs comprise at least one VOC that is not present in a corresponding traditional sake.

Embodiment 335 is the method of embodiment 334, wherein the one or more VOCs that are not present in a corresponding traditional sake are selected from the group consisting of 1,4-cineole, 1-decanol, 2,4,6-trimethylphenol, 2-acetyl-1-methylpyrrole, 2-ethyl-3(5 or 6)-dimethylpyrazine , 2-ethyl-3-methylpyrazine, 2-isopropyl-4-methyl thiazole, 2-methoxy-3-(1-methylpropyl) pyrazine, 2-methoxy-4-methylphenol, 2-methoxy-4-propylphenol, 2-methylbutyl acetate, 2-methylbutyl isovalerate, 2-nonanol, 3-carene, 3-methylthio hexyl acetate, 3-phenylpropanal, 4,5,6,7-tetrahydro-3,6-dimethylbenzofuran, 4-carvomenthenol, 4-mercapto-4-methyl-2-pentanone, 5-methyl-2-phenyl-2-hexenal, acetoin, a-ionone, allyl heptanoate, alpha-pinene, amyl alcohol, amyl butyrate, anisyl acetate, anisyl butyrate, b-caryophellene, benzyl acetate, benzyl benzoate, benzyl butyrate, benzyl formate, benzyl propionate, beta-ionone, butyl butyryllactate, butyl formate, carvacrol, cinnamaldehyde, cis-3-hexenyl acetate, cis-3-hexenyl butyrate, cis-3-hexenyl valerate, cis-5-octen-1-ol, cis-6-nonen-1-ol, citral, citronellal, cuminaldehyde, D-carvone, decanal, d-fenchone, ethyl 2-trans-4-cis-decadienoate, ethyl cinnamate, ethyl myristate, ethyl undecanoate, eucalyptol, eugenol, furfuryl thioacetate, gamma-decalactone, gamma-terpinene, gamma-undecalactone, gamma-valerolactone, geranyl acetone, hexadecanol, hexyl 3-methylbutanoate, hexyl isobutyrate, 3-isobutyl-2-methoxypyrazine, isoamyl cinnamate, isoamyl isobutyrate, isoamyl isovalerate, isoamyl phenylacetate, isobutyl isobutyrate, isoeugenol, L-carvone, linalool, linalool oxide, linalyl acetate, L-menthyl acetate, maltol, massoia lactone, methyl anthranilate, methyl benzoate, methyl cinnamate, methyl cyclopentenolone, methyl decanoate, methyl octanoate, methyl salicylate, myrcene, nerolidol, omega-pentadecalactone, p,a-dimethylstyrene, p-cymene, perillaldehyde, phenethyl 2-methylbutyrate, phenethyl butyrate, phenethyl octanoate, phenethyl tiglate, phenylacetaldehyde dimethyl acetal, salicylaldehyde, tetrahydrolinalool, thymol, trans-2-hexen-1-al, valencene, valeraldehyde, vanillyl butyl ether, and whiskey lactone.

Embodiment 336 is the method of any one of embodiments 328-335, wherein the sake replica concentrate further comprises one or more additional VOCs, and wherein the one or more additional VOCs do not comprise at least one VOC that is present in a corresponding traditional sake.

Embodiment 337 is the method of embodiment 336, wherein the one or more VOCs that are not present in a corresponding traditional sake are selected from the group consisting of 1,4-cineole, 1-decanol, 2,4,6-trimethylphenol, 2-acetyl-1-methylpyrrole, 2-ethyl-3(5 or 6)-dimethylpyrazine , 2-ethyl-3-methylpyrazine, 2-isopropyl-4-methyl thiazole, 2-methoxy-3-(1-methylpropyl) pyrazine, 2-methoxy-4-methylphenol, 2-methoxy-4-propylphenol, 2-methylbutyl acetate, 2-methylbutyl isovalerate, 2-nonanol, 3-carene, 3-methylthio hexyl acetate, 3-phenylpropanal, 4,5,6,7-tetrahydro-3,6-dimethylbenzofuran, 4-carvomenthenol, 4-mercapto-4-methyl-2-pentanone, 5-methyl-2-phenyl-2-hexenal, acetoin, a-ionone, allyl heptanoate, alpha-pinene, amyl alcohol, amyl butyrate, anisyl acetate, anisyl butyrate, b-caryophellene, benzyl acetate, benzyl benzoate, benzyl butyrate, benzyl formate, benzyl propionate, beta-ionone, butyl butyryllactate, butyl formate, carvacrol, cinnamaldehyde, cis-3-hexenyl acetate, cis-3-hexenyl butyrate, cis-3-hexenyl valerate, cis-5-octen-1-ol, cis-6-nonen-1-ol, citral, citronellal, cuminaldehyde, D-carvone, decanal, d-fenchone, ethyl 2-trans-4-cis-decadienoate, ethyl cinnamate, ethyl myristate, ethyl undecanoate, eucalyptol, eugenol, furfuryl thioacetate, gamma-decalactone, gamma-terpinene, gamma-undecalactone, gamma-valerolactone, geranyl acetone, hexadecanol, hexyl 3-methylbutanoate, hexyl isobutyrate, 3-isobutyl-2-methoxypyrazine, isoamyl cinnamate, isoamyl isobutyrate, isoamyl isovalerate, isoamyl phenylacetate, isobutyl isobutyrate, isoeugenol, L-carvone, linalool, linalool oxide, linalyl acetate, L-menthyl acetate, maltol, massoia lactone, methyl anthranilate, methyl benzoate, methyl cinnamate, methyl cyclopentenolone, methyl decanoate, methyl octanoate, methyl salicylate, myrcene, nerolidol, omega-pentadecalactone, p,a-dimethylstyrene, p-cymene, perillaldehyde, phenethyl 2-methylbutyrate, phenethyl butyrate, phenethyl octanoate, phenethyl tiglate, phenylacetaldehyde dimethyl acetal, salicylaldehyde, tetrahydrolinalool, thymol, trans-2-hexen-1-al, valencene, valeraldehyde, vanillyl butyl ether, and whiskey lactone.

Embodiment 338 is the method of embodiment 337, wherein the one or more VOCs that are present in a corresponding traditional sake are selected from the group consisting of 1-octanol, 2,3-pentadione, 2-heptanone, 2-nonanone, 5-methyl furfural, benzaldehyde, benzyl alcohol, butyl acetate, butyraldehyde, citronellol, diethyl succinate, ethyl isobutyrate, ethyl lactate, ethyl propionate, ethyl trans-2-butenoate, ethyl(methylthio) acetate, gamma-heptalactone, gamma-hexalactone, gamma-octalactone, hexanol, isoamyl hexanoate, isobutyl acetate, isobutyraldehyde, isobutyric acid, isovaleric acid, methionyl acetate, methyl acetate, nonanoic acid, phenylacetaldehyde, propionaldehyde, propionic acid, propyl acetate, and propyl butyrate.

Embodiment 339 is the method of any one of embodiments 334-338, wherein the additional VOCs comprise 2-methyl-1-butanol, 2-phenylethanol, acetaldehyde, butyl alcohol, ethyl acetate, ethyl butanoate, ethyl hexanoate, ethyl octanoate, furfural, isoamyl acetate, isoamyl alcohol, isobutyl alcohol, phenethyl acetate, and propanol.

Embodiment 340 is the method of any one of embodiments 328-339, wherein the one or more non-volatile compounds are present in the concentrate in a concentration of at least about 5-fold the concentration of the same non-volatile compounds in a corresponding traditional sake.

Embodiment 341 is the method of any one of embodiments 328-340, wherein the one or more non-volatile compounds are present in the concentrate in a concentration of at least about 10-fold the concentration of the same non-volatile compounds in a corresponding traditional sake.

Embodiment 342 is the method of any one of embodiments 328-341, wherein the one or more non-volatile compounds are present in the concentrate in a concentration of at least about 15-fold the concentration of the same non-volatile compounds in a corresponding traditional sake.

Embodiment 343 is the method of any one of embodiments 328-342, wherein the one or more non-volatile compounds are present in the concentrate in a concentration of at least about 20-fold the concentration of the same non-volatile compounds in a corresponding traditional sake.

Embodiment 344 is the method of any one of embodiments 328-343, wherein the concentrate comprises five or more non-volatile compounds, wherein at least five of the five or more non-volatile compounds are present in a concentration of at least about 5-fold the concentration of the same non-volatile compounds in a corresponding traditional sake.

Embodiment 345 is the method of any one of embodiments 328-344, wherein the total amount (in mg/L) of the one or more non-volatile compounds in the concentrate is greater than 5-fold the total amount of the same non-volatile compounds (in mg/L) in a corresponding traditional sake. Embodiment 346 is a sake replica concentrate produced by the method of any one of embodiments 312-345.

Embodiment 347 is the sake replica concentrate of embodiment 346, wherein the sake replica concentrate, when diluted, is the sake replica of any one of embodiments 1-296.

Embodiment 348 is a sake replica concentrate comprising:
ethanol;
water; and
one or more additional VOCs, wherein at least one of the one or more additional VOCs is present in a concentration of at least about 2-fold the concentration of the same VOC in a corresponding traditional sake.

Embodiment 349 is the sake replica concentrate of embodiment 348, wherein the one or more additional VOCs comprise at least one VOC that is not present in a corresponding traditional sake.

Embodiment 350 is the method of embodiment 349, wherein the one or more VOCs that are not present in a corresponding traditional sake are selected from the group consisting of 1,4-cineole, 1-decanol, 2,4,6-trimethylphenol, 2-acetyl-1-methylpyrrole, 2-ethyl-3(5 or 6)-dimethylpyrazine , 2-ethyl-3-methylpyrazine, 2-isopropyl-4-methyl thiazole, 2-methoxy-3-(1-methylpropyl) pyrazine, 2-methoxy-4-methylphenol, 2-methoxy-4-propylphenol, 2-methylbutyl acetate, 2-methylbutyl isovalerate, 2-nonanol, 3-carene, 3-methylthio hexyl acetate, 3-phenylpropanal, 4,5,6,7-tetrahydro-3,6-dimethylbenzofuran, 4-carvomenthenol, 4-mercapto-4-methyl-2-pentanone, 5-methyl-2-phenyl-2-hexenal, acetoin, a-ionone, ally! heptanoate, alpha-pinene, amyl alcohol, amyl butyrate, anisyl acetate, anisyl butyrate, b-caryophellene, benzyl acetate, benzyl benzoate, benzyl butyrate, benzyl formate, benzyl propionate, beta-ionone, butyl butyryllactate, butyl formate, carvacrol, cinnamaldehyde, cis-3-hexenyl acetate, cis-3-hexenyl butyrate, cis-3-hexenyl valerate, cis-5-octen-1-ol, cis-6-nonen-1-ol, citral, citronellal, cuminaldehyde, D-carvone, decanal, d-fenchone, ethyl 2-trans-4-cis-decadienoate, ethyl cinnamate, ethyl myristate, ethyl undecanoate, eucalyptol, eugenol, furfuryl thioacetate, gamma-decalactone, gamma-terpinene, gamma-undecalactone, gamma-valerolactone, geranyl acetone, hexadecanol, hexyl 3-methylbutanoate, hexyl isobutyrate, 3-isobutyl-2-methoxypyrazine, isoamyl cinnamate, isoamyl isobutyrate, isoamyl isovalerate, isoamyl phenylacetate, isobutyl isobutyrate, isoeugenol, L-carvone, linalool, linalool oxide, linalyl acetate, L-menthyl acetate, maltol, massoia lactone, methyl anthranilate, methyl benzoate, methyl cinnamate, methyl cyclopentenolone, methyl decanoate, methyl octanoate, methyl salicylate, myrcene, nerolidol, omega-pentadecalactone, p,a-dimethylstyrene, p-cymene, perillaldehyde, phenethyl 2-methylbutyrate, phenethyl butyrate, phenethyl octanoate, phenethyl tiglate, phenylacetaldehyde dimethyl acetal, salicylaldehyde, tetrahydrolinalool, thymol, trans-2-hexen-1-al, valencene, valeraldehyde, vanillyl butyl ether, and whiskey lactone.

Embodiment 351 is the sake replica concentrate of 348 or 349, wherein the one or more additional VOCs do not comprise at least one VOC that is present in a corresponding traditional sake.

Embodiment 352 is the method of embodiment 351, wherein the one or more VOCs that are present in a corresponding traditional sake are selected from the group consisting of 1-octanol, 2,3-pentadione, 2-heptanone, 2-nonanone, 5-methyl furfural, benzaldehyde, benzyl alcohol, butyl acetate, butyraldehyde, citronellol, diethyl succinate, ethyl isobutyrate, ethyl lactate, ethyl propionate, ethyl trans-2-butenoate, ethyl(methylthio) acetate, gamma-heptalactone, gamma-hexalactone, gamma-octalactone, hexanol, isoamyl hexanoate, isobutyl acetate, isobutyraldehyde, isobutyric acid, isovaleric acid, methionyl acetate, methyl acetate, nonanoic acid, phenylacetaldehyde, propionaldehyde, propionic acid, propyl acetate, and propyl butyrate.

Embodiment 353 is the method of any one of embodiments 348-352, wherein the additional VOCs comprise 2-methyl-1-butanol, 2-phenylethanol, acetaldehyde, butyl alcohol, ethyl acetate, ethyl butanoate, ethyl hexanoate, ethyl octanoate, furfural, isoamyl acetate, isoamyl alcohol, isobutyl alcohol, phenethyl acetate, and propanol.

Embodiment 354 is the sake replica concentrate of any one of embodiments 348-353, wherein the sake replica concentrate further comprises one or more non-volatile compounds, and wherein the one or more non-volatile compounds comprise at least one non-volatile compound that is not present in a corresponding traditional sake.

Embodiment 355 is the method of embodiment 354, wherein the one or more non-volatile compounds that is not present in a corresponding traditional sake are selected from the group consisting of 2,3,5-trimethylpyrazine, 2,3-dimethylpyrazine, aspartic acid, caffeic acid, camphoric acid, catechin, cinnamic acid, cysteine, cystine, ellagic acid, epicatechin, epicatechin gallate, gallic acid, hesperetin, methyl gallate, methyl-2-pyrrolyl ketone, inositol, propyl gallate, pyridine, quercetin, resveratrol, sinapinic acid, sorbic acid, syringaldehyde, and tryptamine.

Embodiment 356 is the sake replica concentrate of any one of embodiments 348-355, wherein the sake replica concentrate further comprises one or more non-volatile compounds, and wherein the one or more non-volatile compounds do not comprise at least one non-volatile compound that is present in a corresponding traditional sake.

Embodiment 357 is the method of embodiment 356, wherein the one or more non-volatile compounds that are present in a corresponding traditional sake are selected from the group consisting of 2,3,5,6-tetramethylpyrazine, 2-furoic acid, 2-isopropylmalic acid, 3,4-dihydroxybenzoic acid, 4-guanidinobutyric acid, asparagine, beta-alanine, carnitine, fucose, GABA, galactose, glucosamine, glutamine, glycine, guanine, histidine, lactic acid, leucine, mannitol, mannose, methionine, ornithine, proline, pyridoxine, pyruvic acid, quinic acid, rhamnose, salicylic acid, serine, tryptophan, tyrosine, valine, and xylose.

Embodiment 358 is the method of any one of embodiments 354-357, wherein the non-volatile compounds comprise alanine, arginine, choline bitartrate, cinnamic acid, citric acid, D-glucuronic acid, fructose, fumaric acid, glucose, glutamic acid, isoleucine, KOH, lysine, malic acid, phenylalanine, sorbitol, succinic acid, tartaric acid, and threonine.

Embodiment 359 is the sake replica concentrate of any one of embodiments 348-358, wherein the one or more additional VOCs are present in the concentrate in a concentration of at least about 5-fold the concentration of the same VOCs in a corresponding traditional sake.

Embodiment 360 is the sake replica concentrate of any one of embodiments 348-359, wherein the one or more additional VOCs are present in the concentrate in a concentration of at least about 10-fold the concentration of the same VOCs in a corresponding traditional sake.

Embodiment 361 is the sake replica concentrate of any one of embodiments 348-360, wherein the one or more additional VOCs are present in the concentrate in a concentration of at least about 15-fold the concentration of the same VOCs in a corresponding traditional sake.

Embodiment 362 is the sake replica concentrate of any one of embodiments 348-361, wherein the one or more additional VOCs are present in the concentrate in a concentration of at least about 20-fold the concentration of the same VOCs in a corresponding traditional sake.

Embodiment 363 is the sake replica concentrate of any one of embodiments 348-362, wherein the concentrate comprises five or more additional VOCs, wherein at least five of the five or more additional VOCs are present in a concentration of at least about 5-fold the concentration of the same VOCs in a corresponding traditional sake.

Embodiment 364 is the sake replica concentrate of any one of embodiments 348-363, wherein the total amount (in mg/L) of the one or more additional VOCs in the concentrate is greater than 5-fold the total amount of the same VOCs (in mg/L) in a corresponding traditional sake.

Embodiment 365 is the sake replica of any one of embodiments 348-364, wherein upon dilution of the sake replica concentrate to a sake replica, the sake replica is the sake replica of any one of embodiments 1-296.

Embodiment 366 is a sake replica concentrate comprising:
ethanol;
water; and
one or more non-volatile compounds, wherein at least one of the one or more non-volatile compounds is present in a concentration of at least about 2-fold the concentration of the same non-volatile compound in a corresponding traditional sake.

Embodiment 367 is the sake replica concentrate of embodiment 366, wherein the one or more non-volatile compounds comprise at least one non-volatile compound that is not present in a corresponding traditional sake.

Embodiment 368 is the method of embodiment 367, wherein the one or more non-volatile compounds that are not present in a corresponding traditional sake are selected from the group consisting of 2,3,5-trimethylpyrazine, 2,3-dimethylpyrazine, aspartic acid, caffeic acid, camphoric acid, catechin, cinnamic acid, cysteine, cystine, ellagic acid, epicatechin, epicatechin gallate, gallic acid, hesperetin, methyl gallate, methyl-2-pyrrolyl ketone, inositol, propyl gallate, pyridine, quercetin, resveratrol, sinapinic acid, sorbic acid, syringaldehyde, and tryptamine.

Embodiment 369 is the sake replica concentrate of any one of embodiments 366-368, wherein the one or more non-volatile compounds do not comprise at least one non-volatile compound that is present in a corresponding traditional sake.

Embodiment 370 is the method of embodiment 369, wherein the one or more non-volatile compounds that are present in a corresponding traditional sake are selected from the group consisting of 2,3,5,6-tetramethylpyrazine, 2-furoic acid, 2-isopropylmalic acid, 3,4-dihydroxybenzoic acid, 4-guanidinobutyric acid, asparagine, beta-alanine, carnitine, fucose, GABA, galactose, glucosamine, glutamine, glycine, guanine, histidine, lactic acid, leucine, mannitol, mannose, methionine, ornithine, proline, pyridoxine, pyruvic acid, quinic acid, rhamnose, salicylic acid, serine, tryptophan, tyrosine, valine, and xylose.

Embodiment 371 is the method of any one of embodiments 366-370, wherein the non-volatile compounds comprise alanine, arginine, choline bitartrate, cinnamic acid, citric acid, D-glucuronic acid, fructose, fumaric acid, glucose, glutamic acid, isoleucine, KOH, lysine, malic acid, phenylalanine, sorbitol, succinic acid, tartaric acid, and threonine.

Embodiment 372 is the sake replica concentrate of any one of embodiments 366-371, wherein the sake replica concentrate further comprises one or more additional VOCs, and wherein the one or more additional VOCs comprise at least one VOC that is not present in a corresponding traditional sake.

Embodiment 373 is the method of embodiment 372, wherein the one or more VOCs that are not present in a corresponding traditional sake are selected from the group consisting of 1,4-cineole, 1-decanol, 2,4,6-trimethylphenol, 2-acetyl-1-methylpyrrole, 2-ethyl-3(5 or 6)-dimethylpyrazine , 2-ethyl-3-methylpyrazine, 2-isopropyl-4-methyl thiazole, 2-methoxy-3-(1-methylpropyl) pyrazine, 2-methoxy-4-methylphenol, 2-methoxy-4-propylphenol, 2-methylbutyl acetate, 2-methylbutyl isovalerate, 2-nonanol, 3-carene, 3-methylthio hexyl acetate, 3-phenylpropanal, 4,5,6,7-tetrahydro-3,6-dimethylbenzofuran, 4-carvomenthenol, 4-mercapto-4-methyl-2-pentanone, 5-methyl-2-phenyl-2-hexenal, acetoin, a-ionone, allyl heptanoate, alpha-pinene, amyl alcohol, amyl butyrate, anisyl acetate, anisyl butyrate, b-caryophellene, benzyl acetate, benzyl benzoate, benzyl butyrate, benzyl formate, benzyl propionate, beta-ionone, butyl butyryllactate, butyl formate, carvacrol, cinnamaldehyde, cis-3-hexenyl acetate, cis-3-hexenyl butyrate, cis-3-hexenyl valerate, cis-5-octen-1-ol, cis-6-nonen-1-ol, citral, citronellal, cuminaldehyde, D-carvone, decanal, d-fenchone, ethyl 2-trans-4-cis-decadienoate, ethyl cinnamate, ethyl myristate, ethyl undecanoate, eucalyptol, eugenol, furfuryl thioacetate, gamma-decalactone, gamma-terpinene, gamma-undecalactone, gamma-valerolactone, geranyl acetone, hexadecanol, hexyl 3-methylbutanoate, hexyl isobutyrate, 3-isobutyl-2-methoxypyrazine , isoamyl cinnamate, isoamyl isobutyrate, isoamyl isovalerate, isoamyl phenylacetate, isobutyl isobutyrate, isoeugenol, L-carvone, linalool, linalool oxide, linalyl acetate, L-menthyl acetate, maltol, massoia lactone, methyl anthranilate, methyl benzoate, methyl cinnamate, methyl cyclopentenolone, methyl decanoate, methyl octanoate, methyl salicylate, myrcene, nerolidol, omega-pentadecalactone, p,a-dimethylstyrene, p-cymene, perillaldehyde, phenethyl 2-methylbutyrate, phenethyl butyrate, phenethyl octanoate, phenethyl tiglate, phenylacetaldehyde dimethyl acetal, salicylaldehyde, tetrahydrolinalool, thymol, trans-2-hexen-1-al, valencene, valeraldehyde, vanillyl butyl ether, and whiskey lactone.

Embodiment 374 is the sake replica concentrate of any one of embodiments 366-373, wherein the sake replica concentrate further comprises one or more additional VOCs, and wherein the one or more additional VOCs do not comprise at least one VOC that is present in a corresponding traditional sake.

Embodiment 375 is the method of embodiment 374, wherein the one or more VOCs that are present in a corresponding traditional sake are selected from the group consisting of 1-octanol, 2,3-pentadione, 2-heptanone, 2-nonanone, 5-methyl furfural, benzaldehyde, benzyl alcohol, butyl acetate, butyraldehyde, citronellol, diethyl succinate, ethyl isobutyrate, ethyl lactate, ethyl propionate, ethyl trans-2-butenoate, ethyl(methylthio) acetate, gamma-heptalactone, gamma-hexalactone, gamma-octalactone, hexanol, isoamyl hexanoate, isobutyl acetate, isobutyraldehyde, isobutyric acid, isovaleric acid, methionyl acetate, methyl acetate, nonanoic acid, phenylacetaldehyde, propionaldehyde, propionic acid, propyl acetate, and propyl butyrate.

Embodiment 376 is the method of any one of embodiments 372-375, wherein the additional VOCs comprise 2-methyl-1-butanol, 2-phenylethanol, acetaldehyde, butyl alcohol, ethyl acetate, ethyl butanoate, ethyl hexanoate, ethyl octanoate, furfural, isoamyl acetate, isoamyl alcohol, isobutyl alcohol, phenethyl acetate, and propanol.

Embodiment 377 is the sake replica concentrate of any one of embodiments 366-376, wherein the one or more non-volatile compounds is present in the concentrate in a concentration of at least about 5-fold the concentration of the same non-volatile compound in a corresponding traditional sake.

Embodiment 378 is the sake replica concentrate of any one of embodiments 366-377, wherein the one or more non-volatile compounds is present in the concentrate in a concentration of at least about 10-fold the concentration of the same non-volatile compound in a corresponding traditional sake.

Embodiment 379 is the sake replica concentrate of any one of embodiments 366-378, wherein the one or more non-volatile compounds is present in the concentrate in a concentration of at least about 15-fold the concentration of the same non-volatile compound in a corresponding traditional sake.

Embodiment 380 is the sake replica concentrate of any one of embodiments 366-379, wherein the one or more non-volatile compounds is present in the concentrate in a concentration of at least about 20-fold the concentration of the same non-volatile compound in a corresponding traditional sake.

Embodiment 381 is the sake replica concentrate of any one of embodiments 366-380, wherein the concentrate comprises five or more non-volatile compounds, wherein at least five of the five or more additional non-volatile compounds are present in a concentration of at least about 5-fold the concentration of the same non-volatile compounds in a corresponding traditional sake.

Embodiment 382 is the sake replica concentrate of any one of embodiments 366-381, wherein the total amount (in mg/L) of the one or more non-volatile compounds in the concentrate is greater than 5-fold the total amount of the same non-volatile compounds (in mg/L) in a corresponding traditional sake.

Embodiment 383 is the sake replica of any one of embodiments 366-382, wherein upon dilution of the sake replica concentrate to a sake replica, the sake replica is the sake replica of any one of embodiments 1-296.

Embodiment 384 is a sake replica comprising:
ethanol;
water;
additional volatile organic compounds (VOCs); and
non-volatile compounds,
wherein the additional VOCs comprise:

| Compound (mg/L, | |
|---|---|
| unless otherwise | |
| specified) | |
| acetaldehyde | 17-32 |
| butyl alcohol | 3-7 |
| propyl alcohol | 5-11 |
| ethyl acetate | 45-85 |
| ethyl butanoate | 0.4-0.8 |
| ethyl hexanoate | 2-4 |
| ethyl octanoate | 2.5-5.5 |
| furfural | 4-10 |
| isoamyl acetate | 0.5-1 |
| isoamyl alcohol | 70-130 |
| isobutyl alcohol | 14-26 |
| phenethyl acetate | 0.1-0.2 |
| phenethyl alcohol | 4-9 |
| 2-methyl-1-butanol | 10-19 |

and wherein the non-volatile compounds comprise:

| Compound (mg/L, | |
|---|---|
| unless otherwise | |
| specified) | |
| arginine | 225-420 |
| alanine | 60-120 |
| choline bitartrate | 400-750 |
| fructose | 300-600 |
| glucose | 25000-50000 |
| D-glucuronic acid | 20-45 |
| malic acid | 330-620 |
| sorbitol | 25-50 |
| fumaric acid | 0.25-0.6 |
| glutamic acid | 100-200 |
| citric acid | 35-70 |
| isoleucine | 35-65 |
| tartaric acid | 0.1-0.25 |
| lactic acid (mL/L) | 280-530 |
| lysine HCl | 20-45 |
| phenylalanine | 40-90 |
| threonine | 9-16 |
| cinnamic acid | 16-32 |
| succinic acid | 200-400 |
| KOH | 250-500 |

Embodiment 385 is a sake replica concentrate comprising:
ethanol;
water;
additional volatile organic compounds (VOCs); and
non-volatile compounds,

wherein the additional VOCs comprise:

| Compound (mg/L, | |
|---|---|
| unless otherwise | |
| specified) | |
| acetaldehyde | 85-160 |
| butyl alcohol | 15-35 |
| propyl alcohol | 25-55 |
| ethyl acetate | 225-425 |
| ethyl butanoate | 2-4 |
| ethyl hexanoate | 10-20 |
| ethyl octanoate | 12.5-27.5 |
| furfural | 20-50 |
| isoamyl acetate | 2.5-5 |
| isoamyl alcohol | 350-650 |
| isobutyl alcohol | 70-130 |
| phenethyl acetate | 0.5-1 |
| phenethyl alcohol | 20-45 |
| 2-methyl-1-butanol | 50-95 |

and wherein the non-volatile compounds comprise:

| Compound (mg/L, | |
|---|---|
| unless otherwise | |
| specified) | |
| arginine | 1125-2100 |
| alanine | 300-600 |
| choline bitartrate | 2000-3750 |
| fructose | 1500-3000 |
| glucose | 125000- |
| | 250000 |
| D-glucuronic acid | 100-225 |
| malic acid | 1650-3100 |
| sorbitol | 125-250 |
| fumaric acid | 1.25-3 |
| glutamic acid | 500-1000 |
| citric acid | 175-350 |
| isoleucine | 175-325 |
| tartaric acid | 0.5-1.25 |
| lactic acid (mL/L) | 1400-2650 |
| lysine HCl | 100-225 |
| phenylalanine | 200-450 |
| threonine | 45-80 |
| cinnamic acid | 80-160 |
| succinic acid | 1000-2000 |
| KOH | 1250-2500 |

Embodiment 386 is a sake replica concentrate comprising:
ethanol;
water;
additional volatile organic compounds (VOCs); and
non-volatile compounds,
wherein the additional VOCs comprise:

| Compound (mg/L, | |
|---|---|
| unless otherwise | |
| specified) | |
| acetaldehyde | 170-320 |
| Butyl Alcohol | 30-70 |
| Propyl Alcohol | 50-110 |
| ethyl acetate | 450-850 |
| ethyl butanoate | 4-8 |
| ethyl hexanoate | 20-40 |
| ethyl octanoate | 25-55 |
| furfural | 40-100 |
| isoamyl acetate | 5-10 |
| isoamyl alcohol | 700-1300 |
| Isobutyl Alcohol | 140-260 |
| phenethyl acetate | 1-2 |
| phenethyl alcohol | 40-90 |
| 2-methyl-1-butanol | 100-190 |

and wherein the non-volatile compounds comprise:

| Compound (mg/L, | |
|---|---|
| unless otherwise | |
| specified) | |
| arginine | 2250-4200 |
| alanine | 600-1200 |
| choline bitartrate | 4000-7500 |
| fructose | 3000-6000 |
| glucose | 250000- |
| | 500000 |
| D-glucuronic acid | 200-450 |
| malic acid | 3300-6200 |
| sorbitol | 250-500 |
| fumaric acid | 2.5-6 |
| glutamic acid | 1000-2000 |
| citric acid | 350-700 |
| isoleucine | 350-650 |
| tartaric acid | 1-2.5 |
| lactic acid (mL/L) | 2800-5300 |
| lysine HCl | 200-450 |
| phenylalanine | 400-900 |
| threonine | 90-160 |
| cinnamic acid | 160-320 |
| succinic acid | 2000-4000 |
| KOH | 2500-5000 |

Embodiment 387 is a sake replica concentrate comprising:
ethanol;
water;
additional volatile organic compounds (VOCs); and
non-volatile compounds,
wherein the additional VOCs comprise:

| Compound (mg/L, | |
|---|---|
| unless otherwise | |
| specified) | |
| acetaldehyde | 340-640 |
| butyl alcohol | 60-140 |
| propyl alcohol | 100-220 |
| ethyl acetate | 900-1700 |
| ethyl butanoate | 8-16 |
| ethyl hexanoate | 40-80 |
| ethyl octanoate | 50-110 |
| furfural | 80-200 |
| isoamyl acetate | 10-20 |
| isoamyl alcohol | 1400-2600 |
| isobutyl alcohol | 280-520 |
| phenethyl acetate | 2-4 |
| phenethyl alcohol | 80-180 |
| 2-methyl-1-butanol | 200-380 |

and wherein the non-volatile compounds comprise:

| Compound (mg/L, | |
|---|---|
| unless otherwise | |
| specified) | |
| arginine | 4500-8400 |
| alanine | 1200-2400 |
| choline bitartrate | 8000-15000 |
| fructose | 6000-12000 |
| glucose | 500000- |
| | 1000000 |
| D-glucuronic acid | 400-900 |
| malic acid | 6600-12400 |
| sorbitol | 500-1000 |
| fumaric acid | 5-12 |
| glutamic acid | 2000-4000 |
| citric acid | 700-1400 |
| isoleucine | 700-1300 |
| tartaric acid | 2-5 |
| lactic acid (mL/L) | 5600-10600 |
| lysine HCl | 400-900 |
| phenylalanine | 800-1800 |
| threonine | 180-320 |
| cinnamic acid | 320-640 |
| succinic acid | 4000-8000 |
| KOH | 5000-10000 |

### EXAMPLES

### Example 1—Methods for Detecting VOCs and Non-Volatile Compounds

GC-MS/MS was used to assess the amounts of various VOCs in several traditional sakes.

GC-MS/MS Conditions: All analyses were performed using an Agilent 7890B GC interfaced with a 7000D Triple Quadrupole mass spectrometer, and equipped with a PAL RSI 85 autosampler with HS-SPME attachment. For Headspace (HS) Solid Phase Microextraction (SPME) experiments, the SPME fiber was a 1 cm, 50/30 μm DVB/CAR/PDMS fiber (Supelco; Bellefonte, Pa.). HS-SPME autosampler conditions were as follows: pre-incubation time of 5 minutes, incubation temperature of 60° C., extraction time of 15 minutes, and desorption time 2 minutes. Post-desorption fiber conditioning time was 30 minutes. For liquid injection experiments, the injection volume was 0.5 μL. Both liquid and SPME injections had a split ratio of 1:20, with a desorption temperature of 250° C. The column was a 30 m×0.25 mm×0.25 Agilent HP-5ms or DB-WAX (ultra inert). Helium was used as the carrier gas at a constant flow rate of 1 mL/min. The MS ion source temperature and interface temperature were 250° C. The temperature program was as follows: initial temperature 40° C., held for 5 minutes, then increased to 180° C. at a rate of 4° C/min, and then increased to 240° C. at a rate of 45° C/min, and held for 10 minutes, for a total run time of 52 minutes.

Selection of target compounds and MRM method development: An outline of the general workflow for GC-MS analyses is as follows. Real samples were first analyzed by HS-SPME-GC/MS in full scan mode (m/z 40-200) to identify potential target compounds. Collected data were analyzed manually using Agilent MassHunter Qualitative Analysis Version B.07.00, or using Agilent MassHunter Unknowns Analysis Version B.08.00. Additional compounds may have been targeted based on literature research. Multiple Reaction Monitoring (MRM) optimization was performed for commercially available standards. First, full scan experiments were repeated with liquid injection (5mg/L in pure EtOH) to verify retention time and potential precursor ions. Product ion scans were performed using liquid injection and varying collision energies across a range of 5-35 V. Optimized MRM transitions and collision energies were selected, and are displayed in TABLES 1A, 1B, and 1D. A dynamic MRM (dMRM) method was developed for the generation of calibration curves, as described below.

Preparation of calibration curves: All calibration solutions were prepared as 10 mL of 10% EtOH in milliQ water in 20-mL amber vials, with 3g of salt added to enhance volatility. This concentration of EtOH minimized swelling of the SPME fiber to maximize signal despite the dilution factor. The concentration range was varied by compound, based on the expected range in real samples.

Quantification in real samples: All samples (reference samples and replica samples) were prepared as 10 mL in 20-mL amber vials with 3g of salt, and were diluted in milliQ water to achieve a final concentration of 10% EtOH. Concentrations were later corrected to account for the dilution factor of the sample. All data were collected in triplicate, and were analyzed using Agilent Quantitative Analysis (for QQQ). Values reported as not detected (ND or NF, zero) may be considered to be below the limits of detection (LODs) listed in TABLES 1A, 1B, 1C, and 1D. LODs were approximated based on S/N ratios as generated by the MassHunter software.

Various reference sake samples were assayed by GC-MS, and the levels of VOCs therein are shown in TABLE 2. In these tables, Sake 1 is a Daiginjo sake, Sake 2 is a Futsuu sake, and Sake 3 is a Nama sake.

TABLE 1A
Method A Transitions and Figures of Merit

| Compound Method | | | | Qualifier 1 Method | | | |
|---|---|---|---|---|---|---|---|
| | | | Collision | | Collision | Calibration | |
| Name | RT (min) | Transition | Energy | Transition | Energy | Range (mg/L) | LOD (mg/L) |
| propanol | 1.96 | 59.0 → 31.0 | 10 | 42.0 → 39.0 | 35 | 1-200 | 0.5 |
| ethyl acetate | 2.30 | 61.0 → 43.0 | 15 | 45.0 → 43.0 | 35 | 1-200 | 1 |
| isobutanol | 2.40 | 43.0 → 39.0 | 35 | 74.0 → 41.0 | 25 | 1-200 | 0.5 |
| isovaleraldehyde | 2.68 | 44.0 → 43.0 | 10 | 41.0 → 39.0 | 10 | 0.001-0.05 | 0.001 |
| butanol | 2.79 | 56.0 → 41.0 | 10 | 56.0 → 39.0 | 15 | 0.02-1 | 0.01 |
| 1,1-diethoxyethane | 3.91 | 73.0 → 45.0 | 10 | 103.0 → 47.0 | 10 | 0.05-2.5 | N/A |
| isoamyl alcohol | 4.03 | 70.0 → 55.0 | 15 | 55.0 → 39.0 | 15 | 15-750 | N/A |
| 2-methyl-1-butanol | 4.04 | 70.0 → 41.0 | 25 | 55.0 → 40.0 | 25 | 1-200 | 0.5 |
| ethyl isobutyrate | 4.66 | 43.0 → 27.0 | 20 | 71.0 → 43.0 | 10 | 0.001-0.05 | 0.0005 |
| isobutyl acetate | 5.11 | 73.0 → 43.0 | 5 | 56.0 → 41.0 | 15 | 0.001-0.05 | 0.001 |
| ethyl butyrate | 6.05 | 71.0 → 43.0 | 10 | 88.0 → 61.0 | 10 | 0.001-.2 | 0.0001 |
| ethyl lactate | 6.57 | 45.0 → 29.0 | 15 | 45.0 → 27.0 | 15 | 0.5-25 | 0.5 |
| ethyl-2-methylbutyrate | 7.97 | 102.0 → 74.0 | 10 | 85.0 → 57.0 | 5 | 0.001-0.05 | 0.0005 |
| ethyl isovalerate | 8.12 | 70.0 → 55.0 | 5 | 88.0 → 61.0 | 5 | 0.001-0.2 | 0.0001 |
| isoamyl acetate | 8.77 | 70.0 → 55.0 | 10 | 55.0 → 29.0 | 10 | 0.02-1 | 0.001 |
| hexanol | 9.09 | 69.0 → 41.0 | 15 | 56.0 → 41.0 | 15 | 0.001-0.05 | 0.001 |
| benzaldehyde | 12.50 | 105.0 → 51.0 | 35 | 106.0 → 77.0 | 35 | 0.001-0.05 | 0.001 |
| (−)-beta-pinene | 13.12 | 93.0 → 77.0 | 15 | 93.0 → 51.0 | 25 | 0.001-0.01 | 0.0001 |
| ethyl hexanoate | 14.31 | 88.0 → 61.0 | 5 | 99.0 → 43.0 | 5 | 0.005-1 | 0.001 |
| linalool oxide | 17.18 | 59.0 → 31.0 | 18 | 94.0 → 79.0 | 10 | 0.001-0.2 | 0.0005 |
| guaiacol | 17.85 | 109.0 → 81.0 | 15 | 124.0 → 109.0 | 15 | 0.001-0.2 | 0.0005 |
| linalool | 18.29 | 71.0 → 43.0 | 15 | 55.0 → 39.0 | 25 | 0.001-0.2 | 0.0001 |
| 2-phenylethanol | 18.77 | 122.0 → 91.0 | 15 | 92.0 → 65.0 | 25 | 0.2-10 | 0.05 |
| myrtenol | 18.77 | 79.0 → 51.0 | 35 | 91.0 → 65.0 | 35 | 0.001-0.05 | 0.001 |
| alpha-terpineol | 21.69 | 93.0 → 51.0 | 25 | 121.0 → 77.0 | 25 | 0.001-0.05 | 0.0001 |
| ethyl octanoate | 22.01 | 88.0 → 43.0 | 25 | 101.0 → 55.0 | 25 | 0.05-2.5 | 0.001 |
| citronellol | 23.10 | 69.0 → 41.0 | 10 | 41.0 → 39.0 | 10 | 0.001-0.2 | 0.0001 |
| linalyl acetate | 24.07 | 93.0 → 77.0 | 15 | 121.0 → 105.0 | 10 | 0.001-0.2 | 0.0001 |
| 4-ethyl guaiacol | 24.86 | 152.0 → 94.0 | 35 | 137.0 → 66.0 | 35 | 0.01-1 | 0.005 |
| ethyl nonanoate | 25.48 | 88.0 → 61.0 | 10 | 101.0 → 73.0 | 10 | 0.001-0.05 | 0.0001 |
| cis-whiskey lactone | 26.37 | 99.0 → 43.0 | 10 | 99.0 → 41.0 | 20 | 0.01-0.1 | 0.005 |
| eugenol | 27.51 | 164.0 →149.0 | 10 | 164.0 → 104.0 | 15 | 0.05-2.5 | 0.005 |
| damascenone | 28.41 | 69.0 → 41.0 | 20 | 121.0 → 77.0 | 20 | 0.001-0.05 | 0.0005 |
| ethyl decanoate | 28.75 | 88.0 → 43.0 | 20 | 61.0 → 43.0 | 20 | 0.05-2.5 | 0.005 |
| ethyl cinnamate | 30.93 | 131.0 → 103.0 | 10 | 131.0 → 77.0 | 25 | 0.0004-0.004 | 0.0001 |
| beta-ionone | 31.59 | 177.0 → 147.0 | 35 | 135.0 → 43.0 | 35 | 0.001-0.05 | 0.0001 |
| ethyl laurate | 34.75 | 88.0 → 61.0 | 15 | 101.0 → 55.0 | 25 | 0.001-0.05 | 0.0001 |

TABLE 1B
Method B Transitions and Figures of Merit

| Compound Method | | | | Qualifier 1 Method | | | |
|---|---|---|---|---|---|---|---|
| | | | Collision | | Collision | Calibration | |
| Name | RT (min) | Transition | Energy | Transition | Energy | Range (mg/L) | LOD (mg/L) |
| 2-methylbutyraldehyde | 2.79 | 57.0 → 39.0 | 25 | 58.0 → 31.0 | 25 | 0.005-0.05 | 0.001 |
| 2,3-pentadione | 3.20 | 100.0 → 57.0 | 5 | 57.0 → 42.0 | 30 | 0.005-0.05 | 0.001 |
| ethyl propionate | 3.52 | 102.0 → 46.0 | 35 | 75.0 → 57.0 | 35 | 0.005-0.05 | 0.005 |
| butyl formate | 3.75 | 73.0 → 45.0 | 15 | 56.0 → 41.0 | 15 | 0.005-0.05 | N/A |
| amyl alcohol | 4.92 | 70.0 → 55.0 | 5 | 55.0 → 53.0 | 35 | 0.005-0.05 | 0.005 |
| butyl acetate | 6.53 | 56.0 → 41.0 | 15 | 73.0 → 43.0 | 5 | 0.005-0.05 | N/A |
| furfural | 7.30 | 95.0 → 53.0 | 35 | 96.0 → 95.0 | 25 | 0.005-0.05 | 0.005 |
| 3-methyl-1-pentanol | 7.78 | 69.0 → 41.0 | 20 | 56.0 → 39.0 | 20 | 0.005-0.05 | 0.001 |
| ethyl valerate | 10.10 | 57.0 → 41.0 | 10 | 88.0 → 61.0 | 10 | 0.005-0.05 | 0.001 |
| 1-octen-3-ol | 13.42 | 57.0 → 31.0 | 25 | 72.0 → 43.0 | 15 | 0.005-0.05 | 0.001 |
| 3-(methylthio)-1-propanol | 13.50 | 106.0 → 58.0 | 10 | 88.0 → 73.0 | 10 | 0.005-0.05 | 0.005 |
| p-cymene | 15.20 | 134.0 → 91.0 | 35 | 119.0 → 77.0 | 35 | 0.005-0.05 | 0.001 |
| limonene | 15.34 | 93.0 → 77.0 | 15 | 68.0 → 53.0 | 15 | 0.005-0.05 | 0.001 |
| butyl isovalerate | 16.22 | 85.0 → 41.0 | 15 | 57.0 → 41.0 | 15 | 0.005-0.05 | 0.0005 |
| gamma-terpinene | 16.62 | 93.0 → 51.0 | 35 | 136.0 → 77.0 | 25 | 0.005-0.05 | 0.0005 |
| p-cresol | 17.39 | 108.0 → 107.0 | 0 | 107.0 → 77.0 | 0 | 0.005-0.05 | 0.001 |
| propyl hexanoate | 17.66 | 99.0 → 43.0 | 10 | 117.0 → 43.0 | 15 | 0.005-0.05 | 0.005 |
| 2-nonanone | 18.00 | 58.0 → 43.0 | 15 | 71.0 → 43.0 | 15 | 0.005-0.05 | 0.0001 |
| amyl butyrate | 18.10 | 71.0 → 43.0 | 10 | 89.0 → 43.0 | 15 | 0.005-0.05 | 0.0001 |
| ethyl heptanoate | 18.36 | 113.0 → 57.0 | 10 | 88.0 → 61.0 | 15 | 0.005-0.05 | N/A |
| nonanal | 18.47 | 98.0 → 56.0 | 5 | 57.0 → 39.0 | 15 | 0.005-0.05 | 0.0005 |
| 4-ethylphenol | 20.86 | 108.0 → 78.0 | 25 | 121.0 → 77.0 | 25 | 0.005-0.05 | 0.005 |
| isoamyl hexanoate | 23.57 | 70.0 → 55.0 | 10 | 99.0 → 43.0 | 10 | 0.005-0.05 | N/A |
| ethyl phenyl acetate | 23.69 | 91.0 → 65.0 | 35 | 164.0 → 91.0 | 10 | 0.005-0.05 | 0.0001 |
| phenylethyl acetate | 24.10 | 91.0 → 65.0 | 35 | 104.0 → 78.0 | 25 | 0.005-0.05 | 0.005 |
| cinnamaldehyde | 24.54 | 131.0 → 77.0 | 35 | 103.0 → 77.0 | 25 | 0.005-0.05 | 0.001 |
| 1-decanol | 24.63 | 70.0 → 55.0 | 15 | 55.0 → 51.0 | 40 | 0.005-0.05 | 0.0005 |
| gamma-nonalactone | 27.66 | 85.0 → 57.0 | 25 | 114.0 → 70.0 | 25 | 0.005-0.05 | 0.005 |
| damascone | 29.37 | 123.0 → 41.0 | 25 | 69.0 → 41.0 | 25 | 0.005-0.05 | 0.0005 |
| gamma-decalactone | 31.00 | 99.0 → 43.0 | 25 | 71.0 → 41.0 | 25 | 0.005-0.05 | 0.005 |
| ethyl myristate | 40.20 | 101.0 → 73.0 | 5 | 88.0 → 61.0 | 5 | 0.005-0.05 | 0.0005 |
| ethyl palmitate | 42.26 | 101.0 → 73.0 | 5 | 88.0 → 61.0 | 5 | 0.005-0.05 | 0.0005 |

TABLE 1C
Additional LODs in GCMS assays

| Compound | LOD (mg/L) | Compound | LOD (mg/L) |
|---|---|---|---|
| (−)cis-rose oxide | <0.001 | ethyl undecanoate | <0.0005 |
| 1-octanol | <0.0005 | ethyl(methylthio) acetate | <0.0025 |
| 2-heptanone | <0.0025 | eucalyptol | <0.00025 |
| 2-methoxy-4-propylphenol | <0.0001 | farnesol | <0.0025 |
| 2-methylbutyl acetate | <0.01 | geraniol | <0.005 |
| 2-methylbutyl isovalerate | <0.005 | geranyl acetone | <0.005 |
| 2-nonanol | 0.0025 | heptyl acetate | <0.0025 |
| 2-undecanone | <0.0001 | isoamyl isobutyrate | <0.0025 |
| 3-carene | <0.0025 | isoamyl isovalerate | <0.0025 |
| 4-carvomenthenol | <0.0025 | isoamyl octanoate | <0.0005 |
| acetophenone | <0.0025 | isobutyl isobutyrate | <0.0025 |
| alpha ionone | <0.0005 | isobutyraldehyde | 0.0025 |
| a-pinene | <0.005 | isobutyric acid | 0.05 |
| benzyl acetate | <0.0025 | methyl acetate | <0.5 |
| butyric acid | 0.01 | methyl hexanoate | <0.0025 |
| carvone | 0.05 | methyl laurate | <0.0005 |
| cis-3-hexen-1-ol | <0.02 | methyl octanoate | <0.0005 |
| cis-3-hexenyl acetate | <0.00025 | methyl salicylate | <0.0025 |
| decanoic acid | <0.01 | myrcene | <0.0025 |
| delta-decalactone | <1 | octanoic acid | <0.1 |
| diethyl malate | 0.0025 (on wax); | p-anisaldehyde | 0.00025 |
| | 0.25 (on DB5 column) | | |
| diethyl succinate | <1 | Phenethyl Butyrate | <0.0001 |
| ethyl 3-hydroxyhexanoate | <0.005 | phenethyl formate | 0.005 |
| ethyl benzoate | <0.0005 | phenethyl octanoate | <0.0005 |
| ethyl levulinate | <0.0025 | phenethyl propionate | <0.0001 |
| ethyl salicylate | <0.001 | propyl acetate | <0.0025 |
| ethyl trans-2-butenoate | <0.0025 | salicylaldehyde | <0.0025 |
| ethyl trans-3-hexenoate | <0.02 | vanillyl ethyl ether | 0.0025 |
| 2-methoxy-4-methylphenol | 0.001 | beta-damascenone | 0.003 |
| (creosol) | | | |
| citronellal | 5 | gamma-valerolactone | 0.5 |
| massoia lactone | 0.001 | phenylacetaldehyde | 0.001 |
| | | dimethyl acetal | |

TABLE 1D
Additional LODs in GCMS assays

| | | | | | | Calibration | |
|---|---|---|---|---|---|---|---|
| Compound | RT | Quantifier | CE | Qualifier | CE | Range (mg/L) | LOD (mg/L) |
| propanal | 4.834 | 58 → 57 | 5 | 57 → 29 | 10 | 0.05-0.2 | 0.05 |
| myrcene | 8.804 | 69.0 → 41.0 | 10 | 93.0 → 77.0 | 25 | 0.05-0.2 | 0.0005 |
| heptyl acetate | 11.39 | 56.0 → 41.0 | 15 | 70.0 → 55.0 | 15 | 0.05-0.2 | 0.0002 |
| methyl octanoate | 11.509 | 74.0 → 43.0 | 15 | 87.0 → 55.0 | 15 | 0.05-0.2 | 0.00005 |
| isobutyric acid | 13.503 | 88 → 73 | 5 | 73 → 55 | 20 | 0.05-0.2 | 0.1 |
| phenethyl propionate | 17.094 | 104.0 → 78.0 | 25 | 57.0 → 42.0 | 25 | 0.01-0.04 | 0.0001 |
| phenethyl octanoate | 22.009 | 104.0 → 78.0 | 15 | 127.0 → 57.0 | 5 | 0.05-0.2 | 0.00005 |
| isobutyraldehyde | 4.911 | 72.0 → 43.0 | 5 | 72.0 → 57.0 | 5 | 0.05-0.2 | 0.001 |
| eucalyptol | 9.424 | 108.0 → 77.0 | 15 | 81.0 → 53.0 | 35 | 0.05-0.2 | 0.005 |
| isoamyl isobutyrate | 10.095 | 70.0 → 55.0 | 10 | 115.0 → 71.0 | 5 | 0.05-0.2 | 0.005 |
| acetoin | 10.468 | 88 → 45 | 5 | 45 → 29.27 | 20 | 0.05-0.2 | 0.05 |
| methyl laurate | 16.12 | 74.0 → 43.0 | 15 | 87.0 → 55.0 | 15 | 0.05-0.2 | 0.0001 |
| phenethyl butyrate | 17.85 | 104.0 → 78.0 | 25 | 71.0 → 41.0 | 10 | 0.01-0.04 | 0.0001 |
| p-anisaldehyde | 18.566 | 135 → 77 | 25 | 77 → 51 | 25 | 0.05-0.2 | 0.01 |
| methyl acetate | 5.072 | 74.0 → 43.0 | 5 | 74.0 → 59.0 | 5 | 0.05-0.2 | 0.005 |
| propyl acetate | 6.385 | 73.0 → 43.0 | 5 | 73.0 → 55.0 | 15 | 0.05-0.2 | 0.001 |
| isobutyl isobutyrate | 8.02 | 71.0 → 43.0 | 10 | 89.0 → 43.0 | 15 | 0.05-0.2 | 0.0005 |
| methyl hexanoate | 9.136 | 74.0 → 43.0 | 15 | 87.0 → 55.0 | 15 | 0.05-0.2 | 0.0004 |
| methyl decanoate | 13.96 | 74.0 → 43.0 | 25 | 87.0 → 55.0 | 25 | 0.05-0.2 | 0.00005 |
| isoamyl octanoate | 14.655 | 70.0 → 55.0 | 15 | 127.0 → 57.0 | 5 | 0.005-0.02 | 0.00005 |
| D-carvone | 15.68 | 82 → 54 | 15 | 54 → 39 | 15 | 0.005-0.02 | 0.0001 |
| methyl salicylate | 16.181 | 92.0 → 63.0 | 25 | 120.0 → 64.0 | 15 | 0.005-0.02 | 0.0005 |
| maltol | 17.956 | 126 → 71 | 20 | 71 → 43 | 10 | 0.05-0.2 | 0.05 |
| Butyraldehyde | 5.441 | 72 → 57 | 10 | 72 → 29 | 20 | 0.05-0.2 | 0.01 |
| isoamyl isovalerate | 10.454 | 85.0 → 57.0 | 5 | 115.0 → 73.0 | 10 | 0.05-0.2 | <0.00001 |
| salicylaldehyde | 15.112 | 122 → 121 | 15 | 121 → 65 | 15 | 0.05-0.2 | 0.005 |
| ethyl undecanoate | 15.53 | 101.0 → 73.0 | 5 | 88.0 → 61.0 | 5 | 0.05-0.2 | 0.0001 |
| geraniol | 16.504 | 69.0 → 41.0 | 30 | 93.0 → 51.0 | 15 | 0.05-0.2 | 0.1 |
| vanillyl ethyl ether | 21.382 | 137.0 → 94.0 | 20 | 182.0 → 138.0 | 5 | 0.05-0.2 | 0.001 |
| phenethyl formate | 16.094 | 104.0 → 78.0 | 15 | 91.0 → 65.0 | 15 | 0.1-0.4 | 0.1 |
| hexanoic acid | 16.408 | 73 → 55 | 25 | 60 → 42 | 25 | 0.5-2 | 0.01 |
| farnesol | 21.08 | 93.0 → 77.0 | 15 | 107.0 → 91.0 | 15 | 0.1-0.4 | 0.01 |
| linalyl butyrate | 14.887 | 93 → 77 | 10 | 80 → 79 | 15 | 0.11-0.44 | 0.0001 |
| nerol | 15.932 | 93 → 51 | 25 | 69 → 53 | 25 | 0.055-0.22 | 0.05 |
| acetaldehyde, diethyl acetal | 5.43 | 73 → 45 | 10 | 103 → 47 | 10 | n/a | |
| 2-isopropyl-3-methoxypyrazine | n/a | 107 → 51 | 35 | 77 → 51 | 25 | NDR | |
| 3,7-dimethyl-6-octanoic acid | n/a | 69 → 41 | 15 | 95 → 55 | 25 | NDR | |
| methyl dihydrojasmonate | n/a | 83 → 55 | 40 | 153 → 83 | 25 | NDR | |
| phenethyl isobutyrate | 17.03 | 105 → 79 | 15 | 104 → 78 | 15 | NDR | |
| furfuryl mercaptan | 12.234 | 114 → 53 | 35 | 81 → 53 | 35 | NDR | |
| 3-methylthio hexyl acetate | 16.094 | 115 → 81 | 5 | 190 → 115 | 10 | NDR | |
| *ug/L | | | | | | | |
| IBMP (3-Isobutyl-2- | 13.3 | 124 → 94 | 10 | 124 → 95.81 | 20 | NDR | |
| methoxypyrazine) | | | | | | | |
| dimethyl anthranilate | 18.988 | 165 → 105 | 15 | 105 → 104 | 10 | NDR | |
| ethyl-trans-3-hexenoate | 10.51 | 69.0 → 41.0 | 10 | 42.0 → 39.0 | 25 | NDR | |
| octyl acetate | 12.546 | 70 → 55 | 15 | 83 → 55 | 15 | NDR | |
| Amyl formate | 8.08 | 73 → 55 | 15 | 45 → 27 | 15 | NDR | |
| hexyl hexanoate | 14.101 | 99 → 43 | 15 | 117 → 43 | 15 | NDR | |
| Jasmine lactone | 20.421, 20.85 | 99 → 77 | 5 | 71 → 43 | 5 | NDR | |
| trans-2-pentenal | n/a | 83 → 55 | 35 | 84 → 55 | 15 | NDR | |
| hexanal | n/a | 56 → 39 | 15 | 57 → 31 | 25 | NDR | |
| 2-(methylthio)ethanol | n/a | 92 → 61 | 5 | 61 → 45 | 35 | NDR | |
| trans-2-hexen-1-ol | n/a | 57 → 31 | 25 | 67 → 41 | 35 | NDR | |
| ethyl-2-mercaptopropionate | n/a | 61 → 46 | 35 | 88 → 59 | 15 | NDR | |
| trans-2-heptenal | n/a | 83 → 55 | 30 | 70 → 41 | 15 | NDR | |
| 2,6-dimethyl-5-heptenal | n/a | 82 → 67 | 15 | 67 → 41 | 0 | NDR | |
| 3-nonen-2-one | n/a | 55 → 39 | 35 | 125 → 55 | 15 | NDR | |
| isoborneol | n/a | 95 → 55 | 25 | 110 → 95 | 5 | NDR | |
| linalyl formate | n/a | 93 → 77 | 15 | 121 → 77 | 20 | NDR | |
| furfuryl ether | n/a | 82 → 53 | 25 | 81 → 53 | 35 | NDR | |
| citronellyl acetate | n/a | 69 → 41 | 15 | 81 → 41 | 35 | NDR | |
| geranyl acetate | n/a | 69 → 41 | 10 | 93 → 77 | 10 | NDR | |
| ethyl anthranilate | n/a | 119 → 64 | 25 | 92 → 63 | 25 | NDR | |
| methyl vanillate | n/a | 182 → 122 | 15 | 151 → 65 | 15 | NDR | |
| DL-3-methyl-2-butanol | 7.949 | 73 → 45 | 10 | 45 → 27 | 15 | 0.005-0.2 | 0.005 |
| 1,4-cineole | 8.933 | 125 → 43 | 10 | 111 → 43 | 10 | 0.005-0.2 | 0.0001 |
| 2-pentylfuran | 9.483 | 138 → 81 | 10 | 81 → 53 | 10 | 0.005-0.2 | 0.00001 |
| 2-heptanol | 10.584 | 83 → 55 | 5 | 70 → 55 | 10 | 0.005-0.2 | 0.001 |
| tetrahydrolinalool | 11.956 | 73 → 55 | 10 | 69 → 41 | 10 | 0.005-0.2 | 0.005 |
| methional | 12.42 | 104.0 → 48.0 | 15 | 104.0 → 76.0 | 15 | 0.05-0.2 | 0.05 |
| decanal | 12.954 | 82 → 67 | 15 | 57 → 41 | 25 | 0.005-0.2 | 0.001 |
| cis-5-octen-1-ol | 14.102 | 95→ 67 | 10 | 81 → 79 | 10 | 0.05-0.2 | 0.05 |
| 2-acetyl-1-methylpyrrole | 14.792 | 123 → 108 | 10 | 108 → 53 | 20 | 0.005-0.2 | 0.001 |
| cis-6-nonen-1-ol | 15.213 | 82 → 67 | 10 | 67 → 41 | 15 | 0.005-0.2 | 0.001 |
| gamma-heptalactone | 16.414 | 85 → 29 | 10 | 85 → 57 | 5 | 0.005-0.2 | 0.005 |
| gamma-octalactone | 17.5 | 100 → 43 | 15 | 85 → 29 | 15 | 0.005-0.2 | 0.001 |
| methyl-2-pyrrolyl ketone | 17.91 | 109 → 94 | 10 | 94 → 66 | 10 | 0.005-0.2 | 0.005 |
| nerolidol | 18.33 | 93 → 77 | 10 | 107 → 91 | 10 | 0.005-0.2 | 0.001 |
| thymol | 19.581 | 150 → 135 | 10 | 135 → 91 | 15 | 0.005-0.2 | 0.0001 |
| omega-pentadecalactone | 21.102 | 96 → 81 | 5 | 83 → 55 | 5 | 0.005-0.2 | 0.001 |
| gamma-dodecalactone | 22.07 | 43 → 41 | 5 | 43 → 27 | 10 | 0.005-0.2 | 0.005 |
| methyl β-naphthyl ketone | 24.612 | 170 → 155 | 10 | 155 → 127 | 10 | 0.005-0.2 | 0.001 |
| valeraldehyde | 6.5 | 58 → 57 | 10 | 57 → 29 | 5 | 0.005-0.2 | 0.005 |
| 2-isobutyl-4-methyl-1,3- | 8.668 | 87 → 59 | 5 | 87 → 31 | 15 | 0.005-0.2 | 0.005 |
| dioxolane | | | | | | | |
| hexyl acetate | 10.09 | 69.0 → 41.0 | 15 | 84.0 → 69.0 | 5 | 0.05-0.2 | 0.0005 |
| 2-ethyl-3-methylpyrazine | 11.904 | 122 → 121 | 10 | 121 → 93 | 15 | 0.005-0.2 | 0.001 |
| p,a-dimethylstyrene | 12.222 | 117 → 115 | 10 | 132 → 117 | 15 | 0.005-0.2 | 0.00001 |
| allyl heptanoate | 12.53 | 113 → 43 | 5 | 100 → 55 | 5 | 0.005-0.2 | 0.00001 |
| 4,5,6,7-tetrahydro-3,6- | 12.87 | 150 → 108 | 10 | 91 → 65 | 15 | 0.005-0.2 | 0.00001 |
| dimethylbenzofuran | | | | | | | |
| D-camphor | 13.445 | 152 → 108 | 5 | 108 → 93 | 5 | 0.005-0.2 | 0.001 |
| b-caryophellene | 14.285 | 133 → 105 | 15 | 93 → 77 | 15 | 0.005-0.2 | 0.0001 |
| phenylacetaldehyde | 14.66 | 120 → 91 | 10 | 91 → 65 | 15 | 0.005-0.2 | 0.001 |
| gamma-hexalactone | 15.389 | 85 → 29 | 15 | 86 → 29 | 15 | 0.005-0.2 | 0.001 |
| citral | 15.513 | 84 → 83 | 5 | 69 → 41 | 10 | 0.005-0.2 | 0.001 |
| cuminaldehyde | 16.182 | 148 → 119 | 10 | 148 → 133 | 10 | 0.005-0.2 | 0.0001 |
| benzyl alcohol | 16.9604 | 108 → 79 | 15 | 79 → 51 | 25 | 0.005-0.2 | 0.005 |
| 2-methoxy-4-methylphenol | 17.709 | 138 → 123 | 15 | 138 → 95 | 15 | 0.005-0.2 | 0.00001 |
| 2,4,6-trimethylphenol (mesitol) | 18.019 | 136 → 121 | 15 | ? | 0 | 0.005-0.2 | 0.00005 |
| 5-methyl-2-phenyl-2-hexenal | 18.836 | 117 → 115 | 15 | 104 → 78 | 10 | 0.005-0.2 | 0.001 |
| phenethyl tiglate | 19.971 | 104 → 78 | 15 | 83 → 55 | 5 | 0.005-0.2 | 0.00005 |
| gamma-undecalactone | 20.761 | 55 → 29 | 10 | 55 → 27 | 20 | 0.05-0.2 | 0.01 |
| hexadecanol | 21.567 | 97 → 55 | 5 | 83 → 55 | 10 | 0.005-0.2 | 0.001 |
| trans-2-hexen-1-al | 9.495 | 83 → 55 | 5 | 69 → 41 | 5 | 0.03-0.13 | 0.03 |
| octanal | 10.34 | 84 → 55 | 10 | 84 → 69 | 5 | 0.0028-0.112 | 0.002 |
| 2-isopropyl-4-methyl thiazole | 11.183 | 141 → 126 | 10 | 126 → 73 | 10 | 0.005-0.2 | 0.001 |
| 4-mercapto-4-methyl-2- | 11.552 | 132 → 89 | 5 | 99 → 43 | 5 | 0.0005-0.002 | 0.0005 |
| pentanone | | | | | | | |
| 5-methyl furfural | 13.79 | 110 → 109 | 10 | 109 → 53 | 10 | 0.005-0.2 | 0.001 |
| methionyl acetate (3-methylthio- | 14.323 | 148 → 88 | 5 | 88 → 73 | 5 | 0.005-0.2 | 0.001 |
| propylacetate) | | | | | | | |
| furfuryl thioacetate | 15.868 | 156 → 81 | 15 | 81 → 53 | 15 | 0.005-0.2 | 0.001 |
| 3-phenylpropanal | 16.075 | 134 → 92 | 10 | 91 → 65 | 15 | 0.005-0.2 | 0.001 |
| methyl cyclopentenolone | 16.45 | 112 → 84 | 5 | 112 → 56 | 10 | 0.002-0.08 | 0.005 |
| methyl cinnamate | 18.814 | 103 → 77 | 10 | 131 → 103 | 10 | 0.0004-0.015 | 0.0001 |
| carvacrol | 19.778 | 150 → 135 | 10 | 135 → 91 | 10 | 0.0038-0.153 | 0.001 |
| methyl anthranilate | 20.42 | 151 → 119 | 10 | 119 → 92 | 5 | 0.005-0.2 | 0.001 |
| 5-ethyl-3-hydroxy-4-methyl- | 20.566 | 142 → 97 | 5 | 97 → 69 | 5 | 0.05-0.2 | 0.001 |
| 2(5H)-furanone (maple | | | | | | | |
| furanone) | | | | | | | |
| isoeugenol | 21.401 | 164 → 104 | 15 | 164 → 149 | 10 | 0.005-0.2 | 0.001 |
| indole | 22.79 | 117 → 90 | 10 | 90 → 89 | 10 | 0.0009-0.034 | 0.0001 |
| benzyl benzoate | 25.85 | 105 → 77 | 15 | 91 → 65 | 15 | 0.005-0.2 | 0.0001 |
| 1-para-menthene-8-thiol | 9.173 | 68 → 67 | 5 | 93 → 77 | 10 | n/a | 1 |
| propyl butyrate | 8.131 | 89 → 43 | 10 | 71 → 43 | 5 | 0.005-0.2 | 0.001 |
| hexyl isobutyrate | 10.874 | 89 → 43 | 5 | 71 → 43 | 10 | 0.005-0.2 | 0.00005 |
| d-fenchone | 11.852 | 69 → 41 | 5 | 81 → 41 | 15 | 0.005-0.2 | 0.005 |
| cis-3-hexenyl butyrate | 12.35 | 82 → 67 | 5 | 71 → 43 | 5 | 0.005-0.2 | 0.001 |
| 2-methoxy-3-(1-methylpropyl) | 12.898 | 124 → 94 | 10 | 138 → 123 | 10 | 0.005-0.2 | 0.001 |
| pyrazine | | | | | | | |
| cis-3-hexenyl valerate | 13.493 | 85 → 57 | 5 | 82 → 67 | 10 | 0.005-0.2 | 0.0001 |
| L-menthyl acetate | 13.654 | 138 → 95 | 5 | 123 → 81 | 5 | 0.005-0.2 | 0.00001 |
| methyl benzoate | 14.351 | 105 → 77 | 5 | 136 → 105 | 5 | 0.0062-0.246 | 0.05 |
| valencene | 15.527 | 161 → 105 | 15 | 189 → 133 | 10 | 0.005-0.2 | 0.001 |
| perillaldehyde | 16.2 | 122 → 107 | 5 | 107 → 79 | 5 | 0.005-0.2 | 0.0001 |
| ethyl 2-trans-4-cis-decadienoate | 16.472 | 125 → 97 | 10 | 97 → 69 | 10 | 0.0042-0.1660 | 0.001 |
| phenethyl 2-methylbutyrate | 17.846 | 107 → 78 | 15 | 105 → 79 | 15 | 0.005-0.2 | 0.00005 |
| isoamyl phenylacetate | 18.072 | 136 → 91 | 10 | 136 → 92 | 5 | 0.005-0.2 | 0.00001 |
| anisyl acetate | 19.381 | 180 → 138 | 5 | 180 → 120 | 10 | 0.006-0.24 | 0.0005 |
| isoamyl cinnamate | 21.986 | 131 → 103 | 10 | 148 → 147 | 5 | 0.005-0.2 | 0.0001 |
| vanillyl butyl ether | 23.499 | 137 → 94 | 15 | 138 → 123 | 5 | 0.005-0.2 | 0.001 |
| isobutyl propionate | 7.619 | 57 → 29 | 5 | 56 → 41 | 10 | 0.0045-0.179 | 0.0045 |
| 2,3-hexanedione | 8.112 | 114 → 71 | 5 | 71 → 43 | 5 | 0.005-0.2 | 0.005 |
| propyl isovalerate | 8.499 | 103 → 43 | 10 | 85 → 57 | 5 | 0.005-0.2 | 0.0005 |
| isobutyl butyrate | 8.555 | 71 → 43 | 5 | 89 → 43 | 15 | 0.0042-0.168 | 0.001 |
| hexyl formate | 9.362 | 84 → 55 | 10 | 69 → 41 | 5 | 0.005-0.2 | 0.005 |
| 3-heptyl acetate | 9.601 | 101 → 43 | 10 | 129 → 43 | 10 | 0.005-0.2 | 0.0005 |
| Terpinolene | 10.238 | 121 → 93 | 5 | 136 → 121 | 10 | 0.005-0.2 | 0.0005 |
| 2-octanone | 10.321 | 136 → 121 | 10 | 121 → 93 | 5 | 0.005-0.2 | 0.005 |
| hexyl propionate | 10.823 | 84 → 69 | 5 | 75 → 57 | 10 | 0.005-0.2 | 0.001 |
| 6-methyl-5-hepten-2-one | 10.865 | 108 → 93 | 5 | 111 → 43 | 15 | 0.005-0.2 | 0.0005 |
| allyl hexanoate | 11.197 | 99 → 71 | 5 | 84 → 69 | 5 | 0.005-0.2 | 0.0001 |
| hexyl butyrate | 11.773 | 71 → 43 | 5 | 89 → 43 | 10 | 0.005-0.2 | 0.0005 |
| hexyl 3-methylbutanoate | 12.128 | 103 → 43 | 15 | 85 → 57 | 5 | 0.005-0.2 | 0.0001 |
| benzyl formate | 14.955 | 136 → 108 | 5 | 90 → 89 | 10 | 0.005-0.2 | 0.005 |
| butyl butyryllactate | 15.407 | 71 → 43 | 5 | 71 → 41 | 15 | 0.005-0.2 | 0.0001 |
| methionyl butyrate | 15.923 | 88 → 73 | 5 | 73 → 45 | 10 | 0.005-0.2 | 0.0001 |
| benzyl propionate | 16.052 | 164 → 108 | 5 | 108 → 79 | 15 | 0.005-0.2 | 0.0001 |
| geranyl propionate | 16.246 | 93 → 77 | 15 | 69 → 41 | 10 | 0.005-0.2 | 0.0001 |
| benzyl butyrate | 16.822 | 108 → 79 | 5 | 91 → 65 | 15 | 0.005-0.2 | 0.0001 |
| geranyl butyrate | 16.979 | 93 → 77 | 10 | 69 → 41 | 10 | 0.005-0.2 | 0.0001 |
| anisyl alcohol | 20.608 | 138 → 137 | 10 | 138 → 109 | 5 | 0.005-0.2 | 0.0005 |
| anisyl butyrate | 20.801 | 121 → 77 | 15 | 138 → 109 | 5 | 0.005-0.2 | 0.0005 |
| dihydrocoumarin | 20.995 | 148 → 120 | 10 | 120 → 91 | 15 | 0.005-0.2 | 0.001 |
| delta-dodecalactone | 22.632 | 99 → 71 | 5 | 99 → 43 | 10 | 0.005-0.2 | 0.001 |
| 2-methoxycinnamaldehyde | 22.756 | 162 → 131 | 5 | n/a | n/a | 0.002-0.074 | 0.001 |
| 3-mercaptohexylacetate | 15.4 | 116 → 55 | 25 | 101 → 59 | 25 | 0.01-0.04 | 0.001 |
| nonanoic acid | 19.346 | 73 → 55 | 15 | 60 → 42 | 15 | 0.05-0.2 | 0.01 |
| isovaleric acid | 14.616 | 87 → 41 | 15 | 60 → 42 | 25 | 0.05-0.2 | 0.01 |
| ethyl(methylthio) acetate | 12.391 | 134.0 → 88.0 | 5 | 88.0 → 61.0 | 5 | 0.05-0.2 | 0.01 |
| valeric acid | 15.329 | 73 → 55 | 15 | 60 → 42 | 15 | 0.05-0.2 | 0.01 |
| propanoic acid | 13.168 | 73 → 55 | 10 | 74 → 45 | 35 | 0.05-0.2 | 0.01 |
| octanoic acid | 18.434 | 73 → 55 | 25 | 60 → 42 | 25 | 0.05-0.2 | 0.01 |

NDR = no data reported
n/a = no value determined

TABLE 2
VOCs in reference sakes

| Compound | Sake l | Sake 2 | Sake 3 |
|---|---|---|---|
| isobutyraldehyde | 7.44E−03 | 7.17E−04 | 3.33E−02 |
| ethyl propionate | 3.56E−02 | 5.06E−03 | 5.34E−02 |
| ethyl butanoate | 8.04E−02 | 5.93E−03 | 7.44E−02 |
| ethyl isovalerate | 9.06E−04 | 0.00E+00 | 9.30E−03 |
| beta-pinene | 0.00E+00 | 1.98E−04 | 0.00E+00 |
| 3-carene | 0.00E+00 | 0.00E+00 | 0.00E+00 |
| myrcene | 0.00E+00 | 0.00E+00 | 0.00E+00 |
| p-cymene | 0.00E+00 | 0.00E+00 | 0.00E+00 |
| methyl octanoate | 0.00E+00 | 0.00E+00 | 0.00E+00 |
| benzaldehyde | 5.82E−02 | 1.17E−03 | 1.11E−01 |
| ethyl levulinate | 2.61E−01 | 0.00E+00 | 0.00E+00 |
| acetophenone | 0.00E+00 | 1.44E−04 | 0.00E+00 |
| salicylaldehyde | 0.00E+00 | 0.00E+00 | 0.00E+00 |
| 1-decanol | 0.00E+00 | 0.00E+00 | 0.00E+00 |
| methyl salicylate | 0.00E+00 | 0.00E+00 | 0.00E+00 |
| geraniol | 4.40E−04 | 0.00E+00 | 0.00E+00 |
| whiskey lactone | 0.00E+00 | 0.00E+00 | 0.00E+00 |
| phenethyl butyrate | 0.00E+00 | 0.00E+00 | 0.00E+00 |
| cinnamaldehyde | 0.00E+00 | 0.00E+00 | 0.00E+00 |
| ethyl myristate | 0.00E+00 | 0.00E+00 | 0.00E+00 |
| 2,3-pentadione | 1.66E−02 | 1.13E−03 | 1.73E−02 |
| butyl acetate | 2.94E−04 | 9.06E−05 | 4.04E−03 |
| ethyl valerate | 0.00E+00 | 0.00E+00 | 5.86E−04 |
| butyl alcohol | 2.16E+00 | 0.00E+00 | 8.06E+00 |
| limonene | 1.16E−03 | 1.38E−04 | 0.00E+00 |
| ethyl hexanoate | 1.78E+01 | 2.32E−03 | 4.03E+00 |
| ethyl octanoate | 1.01E+00 | 0.00E+00 | 1.66E+00 |
| isoamyl hexanoate | 6.98E−03 | 8.94E−04 | 1.44E−03 |
| linalool | 0.00E+00 | 0.00E+00 | 0.00E+00 |
| ethyl decanoate | 9.30E−02 | 0.00E+00 | 1.25E−01 |
| diethyl succinate | 7.38E−03 | 2.10E−01 | 2.50E+00 |
| a-terpineol | 0.00E+00 | 0.00E+00 | 5.32E−04 |
| phenethyl formate | 0.00E+00 | 3.61E−01 | 1.52E−01 |
| phenethyl acetate | 6.81E−01 | 1.22E−03 | 6.98E−01 |
| a-ionone | 0.00E+00 | 0.00E+00 | 0.00E+00 |
| 2-phenylethanol | 7.14E+01 | 5.76E+01 | 1.28E+02 |
| ethyl cinnamate | 0.00E+00 | 0.00E+00 | 0.00E+00 |
| vanillyl ethyl ether | 0.00E+00 | 0.00E+00 | 1.97E−03 |
| acetoin | 0.00E+00 | 0.00E+00 | 0.00E+00 |
| isobutyl acetate | 3.61E−02 | 3.68E−03 | 8.99E−02 |
| ethyl 2-methylbutyrate | 0.00E+00 | 0.00E+00 | 2.08E−03 |
| ethyl trans-2-butenoate | 6.26E−03 | 1.70E−04 | 7.34E−03 |
| 2-heptanone | 4.16E−03 | 4.80E−05 | 4.30E−03 |
| amyl alcohol | 0.00E+00 | 0.00E+00 | 0.00E+00 |
| ethyl lactate | 1.17E−01 | 8.86E+00 | 8.05E+00 |
| 1-octen-3-ol | 0.00E+00 | 0.00E+00 | 1.97E−02 |
| linalool oxide | 0.00E+00 | 0.00E+00 | 0.00E+00 |
| furfural | 3.75E−02 | 1.14E−02 | 2.13E−01 |
| linalyl acetate | 0.00E+00 | 0.00E+00 | 0.00E+00 |
| isoamyl octanoate | 2.86E−03 | 0.00E+00 | 0.00E+00 |
| ethyl 3-hydroxyhexanoate | 5.34E−03 | 0.00E+00 | 7.64E−03 |
| ethyl undecanoate | 0.00E+00 | 0.00E+00 | 0.00E+00 |
| ethyl phenyl acetate | 7.38E−04 | 0.00E+00 | 1.73E−02 |
| ethyl laurate | 7.58E−03 | 0.00E+00 | 1.75E−03 |
| guaiacol | 3.96E−04 | 0.00E+00 | 9.12E−04 |
| gamma-nonalactone | 6.60E−05 | 0.00E+00 | 0.00E+00 |
| diethyl malate | 0.00E+00 | 6.81E−04 | 1.36E−01 |
| p-cresol | 0.00E+00 | 0.00E+00 | 9.66E−04 |
| eugenol | 0.00E+00 | 0.00E+00 | 0.00E+00 |
| propionaldehyde | 2.39E−02 | 7.71E−03 | 6.77E−02 |
| ethyl isobutyrate | 6.12E−03 | 4.74E−04 | 1.56E−02 |
| isobutyl propionate | 1.67E−03 | 0.00E+00 | 0.00E+00 |
| propyl isovalerate | 0.00E+00 | 0.00E+00 | 1.18E−03 |
| eucalyptol | 0.00E+00 | 0.00E+00 | 0.00E+00 |
| isoamyl isobutyrate | 0.00E+00 | 0.00E+00 | 0.00E+00 |
| amyl butyrate | 0.00E+00 | 0.00E+00 | 0.00E+00 |
| 2-isopropyl-4-methyl | 0.00E+00 | 0.00E+00 | 0.00E+00 |
| thiazole | | | |
| d-fenchone | 0.00E+00 | 0.00E+00 | 0.00E+00 |
| ethyl(methylthio) acetate | 8.80E−04 | 1.11E−04 | 1.18E−04 |
| decanal | 0.00E+00 | 0.00E+00 | 0.00E+00 |
| D-camphor | 0.00E+00 | 4.71E−05 | 0.00E+00 |
| methyl decanoate | 0.00E+00 | 0.00E+00 | 0.00E+00 |
| methionyl acetate (3- | 2.38E−03 | 6.87E−06 | 4.20E−04 |
| methyithio-propylacetate) | | | |
| ethyl benzoate | 2.42E−03 | 0.00E+00 | 2.08E−03 |
| citral | 0.00E+00 | 0.00E+00 | 0.00E+00 |
| L-carvone | 0.00E+00 | 0.00E+00 | 0.00E+00 |
| cuminaldehyde | 0.00E+00 | 0.00E+00 | 0.00E+00 |
| beta-damascenone | 0.00E+00 | 6.90E−07 | 0.00E+00 |
| maltol | 0.00E+00 | 0.00E+00 | 0.00E+00 |
| p-anisaldehyde | 0.00E+00 | 1.14E−06 | 0.00E+00 |
| thymol | 0.00E+00 | 0.00E+00 | 0.00E+00 |
| massoia lactone | 0.00E+00 | 0.00E+00 | 0.00E+00 |
| hexadecanol | 0.00E+00 | 0.00E+00 | 0.00E+00 |
| vanillyl butyl ether | 0.00E+00 | 0.00E+00 | 0.00E+00 |
| propyl acetate | 6.09E−02 | 6.58E−03 | 1.45E−01 |
| DL-3-methyl-2-butanol | 1.21E−02 | 0.00E+00 | 0.00E+00 |
| butyl formate | 0.00E+00 | 0.00E+00 | 0.00E+00 |
| 2-pentylfuran | 8.85E−04 | 0.00E+00 | 0.00E+00 |
| octanal | 1.29E−04 | 0.00E+00 | 5.40E−04 |
| cis-3-hexenyl acetate | 0.00E+00 | 0.00E+00 | 0.00E+00 |
| heptyl acetate | 1.27E−03 | 0.00E+00 | 0.00E+00 |
| 2-ethyl-3-methylpyrazine | 0.00E+00 | 0.00E+00 | 0.00E+00 |
| 2-ethyl-3(5 or 6)- | 0.00E+00 | 0.00E+00 | 0.00E+00 |
| dimethylpyrazine | | | |
| 2-nonanol | 0.00E+00 | 0.00E+00 | 0.00E+00 |
| 1-octanol | 7.22E−03 | 5.88E−04 | INT |
| 2-undecanone | 2.42E−05 | 0.00E+00 | 0.00E+00 |
| methyl benzoate | 0.00E+00 | 0.00E+00 | 0.00E+00 |
| benzyl formate | 0.00E+00 | 0.00E+00 | 0.00E+00 |
| valencene | 0.00E+00 | 0.00E+00 | 0.00E+00 |
| furfuryl thioacetate | 0.00E+00 | 0.00E+00 | 0.00E+00 |
| perillaldehyde | 0.00E+00 | 0.00E+00 | 0.00E+00 |
| geranyl acetone (6,10- | 0.00E+00 | 0.00E+00 | 0.00E+00 |
| dimethyl-5,9-undecadien-2- | | | |
| one) | | | |
| gamma-octalactone | 2.82E−03 | 1.53E−04 | 4.00E−03 |
| 2,4,6-trimethylphenol | 0.00E+00 | 0.00E+00 | 0.00E+00 |
| (mesitol) | | | |
| methyl cinnamate | 0.00E+00 | 0.00E+00 | 0.00E+00 |
| 4-ethyl phenol | 0.00E+00 | 0.00E+00 | 4.56E−03 |
| 5-ethyl-3-hydroxy-4-methyl- | ND | 0.00E+00 | 0.00E+00 |
| 2(5H)-furanone (maple | | | |
| furanone) | | | |
| isoamyl cinnamate | 0.00E+00 | 0.00E+00 | 0.00E+00 |
| methyl β-naphthyl ketone | 0.00E+00 | 7.50E−05 | 0.00E+00 |
| methyl acetate | 1.28E−02 | 3.19E−03 | 5.48E−02 |
| valeraldehyde | 0.00E+00 | 0.00E+00 | 0.00E+00 |
| isobutyl isobutyrate | 0.00E+00 | 0.00E+00 | 0.00E+00 |
| 2-isobutyl-4-methyl-1,3- | 0.00E+00 | 0.00E+00 | 1.76E−03 |
| dioxolane | | | |
| trans-2-hexen-1-al | 0.00E+00 | 0.00E+00 | 0.00E+00 |
| isoamyl isovalerate | 0.00E+00 | 0.00E+00 | 0.00E+00 |
| ethyl heptanoate | 2.14E−03 | 0.00E+00 | 1.66E−03 |
| cis-rose-oxide | 1.14E−04 | 1.83E−05 | 0.00E+00 |
| tetrahydrolinalool | 0.00E+00 | 0.00E+00 | 0.00E+00 |
| allyl heptanoate | 0.00E+00 | 0.00E+00 | 0.00E+00 |
| propionic acid | 1.63E+00 | 1.96E+00 | 7.84E−01 |
| cis-3-hexenyl valerate | 0.00E+00 | 0.00E+00 | 0.00E+00 |
| cis-5-octen-1-ol | 0.00E+00 | 0.00E+00 | 0.00E+00 |
| isovaleric acid | 7.73E−02 | 7.82E−03 | 1.40E−01 |
| phenylacetaldehyde dimethyl | 0.00E+00 | 0.00E+00 | 0.00E+00 |
| acetal | | | |
| benzyl acetate | 0.00E+00 | 0.00E+00 | 0.00E+00 |
| benzyl propionate | 0.00E+00 | 0.00E+00 | 0.00E+00 |
| gamma-heptalactone | 5.60E−02 | 3.31E−03 | 4.27E−02 |
| benzyl butyrate | 0.00E+00 | 0.00E+00 | 0.00E+00 |
| beta-ionone | 0.00E+00 | 0.00E+00 | 0.00E+00 |
| isoamyl phenylacetate | 0.00E+00 | 0.00E+00 | 0.00E+00 |
| 5-methyl-2-phenyl-2-hexenal | 0.00E+00 | 0.00E+00 | 0.00E+00 |
| carvacrol | 0.00E+00 | 0.00E+00 | 0.00E+00 |
| gamma-undecalactone | 0.00E+00 | 0.00E+00 | 0.00E+00 |
| phenethyl octanoate | 0.00E+00 | 0.00E+00 | 0.00E+00 |
| benzyl benzoate | 0.00E+00 | 0.00E+00 | 0.00E+00 |
| butyraldehyde | 2.36E−03 | 5.79E−04 | 8.06E−03 |
| alpha-pinene | 0.00E+00 | 0.00E+00 | 0.00E+00 |
| isoamyl acetate | INT | INT | 9.93E−01 |
| 1,4-cineole | 0.00E+00 | 0.00E+00 | 0.00E+00 |
| gamma-terpinene | 0.00E+00 | 0.00E+00 | 0.00E+00 |
| 2-methylbutyl isovalerate | 0.00E+00 | 0.00E+00 | 0.00E+00 |
| 6-methyl-5-hepten-2-one | 0.00E+00 | 0.00E+00 | 2.98E−04 |
| nonanal | 0.00E+00 | 1.47E−04 | 1.46E−03 |
| hexyl 3-methylbutanoate | 0.00E+00 | 0.00E+00 | 0.00E+00 |
| citronellal | 0.00E+00 | 0.00E+00 | 0.00E+00 |
| ethyl nonanoate | 0.00E+00 | 0.00E+00 | 1.58E−04 |
| isobutyric acid | 2.28E−01 | 8.70E−02 | 4.57E−01 |
| 4-carvomenthenol (terpinen- | 0.00E+00 | 0.00E+00 | 0.00E+00 |
| 4-ol) | | | |
| (1R)-(−)-myrtenal | 0.00E+00 | 0.00E+00 | 7.34E−03 |
| cis-6-nonen-1-ol | 0.00E+00 | 0.00E+00 | 0.00E+00 |
| 3-phenylpropanal | 0.00E+00 | 0.00E+00 | 0.00E+00 |
| methyl cyclopentenolone | 0.00E+00 | 0.00E+00 | 0.00E+00 |
| benzyl alcohol | 5.18E−03 | 3.13E−01 | 2.25E−01 |
| 2-methoxy-4-methylphenol | 0.00E+00 | 0.00E+00 | 0.00E+00 |
| (creosol) | | | |
| nerolidol | 0.00E+00 | 0.00E+00 | 0.00E+00 |
| 2-methoxy-4-propylphenol | 0.00E+00 | 0.00E+00 | 0.00E+00 |
| phenethyl tiglate | 0.00E+00 | 0.00E+00 | 0.00E+00 |
| anisyl butyrate | 0.00E+00 | 0.00E+00 | 0.00E+00 |
| gamma-dodecalactone | 0.00E+00 | 0.00E+00 | 4.90E−04 |
| 2-methylbutyraldehyde | 0.00E+00 | 6.06E−04 | 2.97E−02 |
| propanol | 7.84E+01 | 1.22E+02 | 1.35E+02 |
| propyl butyrate | 4.30E−02 | 8.22E−04 | 2.51E−02 |
| methyl hexanoate | 3.24E−04 | 0.00E+00 | 6.38E−05 |
| hexyl acetate | 1.12E−03 | 0.00E+00 | 0.00E+00 |
| ethyl-trans-3-hexenoate | 2.80E−04 | 0.00E+00 | 0.00E+00 |
| hexyl isobutyrate | 0.00E+00 | 0.00E+00 | 0.00E+00 |
| 4-mercapto-4-methyl-2- | 0.00E+00 | 0.00E+00 | 0.00E+00 |
| pentanone | | | |
| p,a-dimethylstyrene | 0.00E+00 | 0.00E+00 | 0.00E+00 |
| 4,5,6,7-tetrahydro-3,6- | 0.00E+00 | 0.00E+00 | 0.00E+00 |
| dimethylbenzofuran | | | |
| IBMP (3-isobutyl-2- | 0.00E+00 | 0.00E+00 | 0.00E+00 |
| methoxypyrazine) | | | |
| L-menthyl acetate | 0.00E+00 | 0.00E+00 | 0.00E+00 |
| gamma-valerolactone | 0.00E+00 | 0.00E+00 | 0.00E+00 |
| phenylacetaldehyde | 3.39E−02 | 2.21E−03 | 1.05E−01 |
| gamma-hexalactone | 2.71E−02 | 6.30E−04 | 6.03E−02 |
| citronellol | 1.10E−02 | 1.02E−03 | 1.91E−02 |
| 3-methylthio hexyl acetate | 0.00E+00 | 0.00E+00 | 0.00E+00 |
| ethyl 2-trans-4-cis- | 0.00E+00 | 0.00E+00 | 0.00E+00 |
| decadienoate | | | |
| phenethyl propionate | 2.09E−04 | 0.00E+00 | 1.33E−04 |
| phenethyl 2-methylbutyrate | 0.00E+00 | 0.00E+00 | 0.00E+00 |
| 4-ethyl guaiacol | 0.00E+00 | 0.00E+00 | 8.14E−03 |
| nonanoic acid | 2.74E−03 | 2.19E−04 | 5.30E−03 |
| delta-decalactone | 9.64E−03 | 0.00E+00 | 7.86E−03 |
| omega-pentadecalactone | 0.00E+00 | 0.00E+00 | 0.00E+00 |
| delta-dodecalactone | 1.06E−03 | 0.00E+00 | 2.24E−03 |
| isovaleraldehyde | 4.08E−01 | 1.08E−01 | 0.00E+00 |
| 2-methylbutyl acetate | INT | INT | 0.00E+00 |
| 1-para-menthene-8-thiol | 1.00E−06 | 3.90E−07 | 0.00E+00 |
| 2-heptanol | 8.52E−04 | 0.00E+00 | 1.67E−03 |
| Hexanol | 8.05E−02 | 2.53E−04 | 1.50E−01 |
| 2-nonanone | 1.36E−03 | 7.80E−05 | 3.48E−05 |
| cis-3-hexenyl butyrate | 0.00E+00 | 0.00E+00 | 0.00E+00 |
| 2-methoxy-3-(1- | 0.00E+00 | 0.00E+00 | 0.00E+00 |
| methylpropyl) pyrazine | | | |
| 5-methyl furfural | 4.45E−04 | 8.85E−06 | 6.01E−04 |
| b-caryophellene | 0.00E+00 | 0.00E+00 | 0.00E+00 |
| 2-acetyl-1-methylpyrrole | 0.00E+00 | 0.00E+00 | 0.00E+00 |
| butyl butyryllactate | 0.00E+00 | 0.00E+00 | 0.00E+00 |
| D-carvone | 0.00E+00 | 0.00E+00 | 0.00E+00 |
| methyl laurate | 0.00E+00 | 0.00E+00 | 1.03E−03 |
| ethyl salicylate | 0.00E+00 | 0.00E+00 | 4.74E−04 |
| methyl-2-pyrrolyl ketone | 0.00E+00 | 0.00E+00 | 1.58E−03 |
| gamma-decalactone | 0.00E+00 | 0.00E+00 | 0.00E+00 |
| anisyl acetate | 0.00E+00 | 0.00E+00 | 0.00E+00 |
| methyl anthranilate | 0.00E+00 | 0.00E+00 | 0.00E+00 |
| isoeugenol | 0.00E+00 | 0.00E+00 | 0.00E+00 |
| indole | 2.12E−04 | 0.00E+00 | 0.00E+00 |

INT = interference
ND = not determined

LC-MS was used to measure the levels of various non-volatile compounds in several reference sake samples, according to the following method.

All analyses were performed on a Thermo Ultimate 3000 Ultra-Performance Liquid Chromatograph (UPLC) coupled with a Thermo Scientific Q-Exactive high resolution mass spectrometer (MS). XCalibur software was used for data acquisition, and the mass spectrometer instrument parameters were as follows for all methods:

Polarity: positive or negative mode, as indicated for each method

Resolution: 70,000

Scan range: 60-900 m/z for all methods with the exception of the lipid method, 0 which is 134-2000 m/z

Isolation window: 1.5 m/z

MS/MS collision energy: 30

Preparation of analytical standards: Stock solutions at a concentration of 1 mg/mL were made for each compound in 50% methanol. Serial dilutions were then made of each compound to create a 7-point standard curve, ranging from 10 ng/mL to 20 μg/mL. Standard curves were run in combinations of 7-12 compounds from each category per set, so long as there were no overlaps in retention time, which would have hindered quantitation.

Retention times were pre-determined for each compound by running the analytical standard at a 20 μg/mL dilution, and identifying the compound based on its accurate mass.

In all cases, five μL of each standard mix was injected through the autosampler and LC to the MS. Separation took place on a chromatographic column that was specific to each class of compounds. The conditions for each chromatographic method are described below, including the column, mobile phase and gradient used for each method.

Several types of columns were used for the different classes of compounds, as indicated in TABLE 3.

TABLE 3
List of compounds quantified by each method

| HILIC positive | HILIC negative | Omega negative | C18 positive | C18 negative |
|---|---|---|---|---|
| methionine | rhamnose | tartaric acid | quinic acid | rutin |
| histidine | glucose | citric acid | polydatin | quercetin |
| lysine | arabinose | lactic acid | acetovanillone | salicylic acid |
| serine | mannitol | 3,4-dihydroxybenzoic | epicatechin gallate | indole-3-lactic acid |
| | | acid | | |
| leucine | fructose | gallic acid | vanillic acid | sinapinic acid |
| isoleucine | ribose | glucuronic acid | syringic acid | epicatechin |
| phenylalanine | arabitol | fumaric acid | caffeic acid | catechin |
| aspartic acid | inositol | ferulic acid | coumaric acid | resveratrol |
| tyrosine | fucose | malic acid | cinnamic acid | propyl gallate |
| glycine | mannose | galacturonic acid | syringaldehyde | herperetin |
| γ-aminobutyric acid | xylose | 2-isopropylmalic acid | pantothenic acid | trans-ferulic acid |
| pyridoxine | sorbitol | 2-furoic acid | vanillin | adipic acid |
| glucosamine | galactose | pyruvic acid | trans-4-hydroxy proline | methyl gallate |
| choline | beta-alanine | succinic acid | L-citrulline | ellagic acid |
| arginine | citrulline | | tryptamine | D-glucuronic acid |
| valine | myo-inositol | | tyramine | |
| proline | | | adenine | |
| alanine | | | guanine | |
| cysteine | | | acetylcholine | |
| asparagine | | | kynurenic acid | |
| glutamic acid | | | sorbic acid | |
| tryptophan | | | lauric acid | |
| ornithine | | | palmitic acid | |
| glutamine | | | 2,3,5,6- | |
| | | | tetramethylpyrazine | |
| threonine | | | 2,3,5-trimethylpyrazine | |
| carnitine | | | 2,3-dimethylpyrazine | |
| betaine | | | camphoric acid | |
| camosine | | | methyl 2-pyrrolyl | |
| | | | ketone | |
| cystine | | | piperine | |
| homoserine | | | pyridine | |
| pipecolinic acid | | | 4-guanidinobutyric acid | |
| | | | cytosine | |
| | | | cytidine | |
| | | | uracil | |

Quantitation of Amino Acids and Similar Polar Compounds: A HILIC (hydrophilic interaction liquid chromatography) column was used to assess polar compounds that can retain a positive charge. The mobile phase used with this column included A: H₂O+5 mM Ammonium Acetate+0.1% TFA (trifluoroacetic acid), and B: 90/10 ACN (Acetonitrile)/H₂O+5 mM Ammonium Acetate+0.1% TFA. Each chromatographic run was 27.5 minutes long, and the column temperature was maintained at 40° C. The column used was a Phenomenex Luna, 3 μm NH2, 100 Å, 150×2 mm (Product #00F-4377-B0), and the guard column was a Phenomenex Security Guard Cartridges, NH2, 4×2 mm (#PRD-196870).

TABLE 4
HILIC positive mode gradient conditions

| Time | Flow Rate (mL/min) | % A | % B |
|---|---|---|---|
| 0 | 0.5 | 5 | 95 |
| 6 | 0.5 | 5 | 95 |
| 18 | 0.5 | 60 | 40 |
| 20 | 0.5 | 80 | 20 |
| 22 | 0.5 | 5 | 95 |
| 27 | 0.5 | 5 | 95 |

Quantitation of Sugars and Sugar Alcohols: The same HILIC column used for quantitation of the amino acids was used for quantitation of sugars, but the polarity of the MS was run in negative mode. While the same mobile phases were used, the gradient was slightly modified to help with retention. The temperature of the column also was held at 50° C. for better peak shape and separation of the isobaric sugars.

TABLE 5
HILIC negative mode gradient conditions

| Time | Flow Rate (mL/min) | % A | % B |
|---|---|---|---|
| 0 | 0.5 | 0 | 100 |
| 3 | 0.5 | 0 | 100 |
| 18 | 0.5 | 18 | 82 |
| 19 | 0.5 | 26 | 74 |
| 20 | 0.5 | 60 | 40 |
| 21 | 0.4 | 80 | 20 |
| 23 | 0.4 | 0 | 100 |
| 28 | 0.4 | 0 | 100 |

Quantitation of Non-Polar Compounds: A C18 column was used to assess non-polar compounds, as they are retained in the long carbon chains under polar conditions. This method was run in both positive and negative modes, depending on each compound and whether it ionizes better with a positive or negative charge, respectively. The mobile phases used for this method were A: H₂O+0.1% FA, and B: Methanol, and the temperature of the column was held at 50° C. The column used was an Agilent Poroshell 120, EC-C18 2.7 μm, 3.0×100 mm (Product #695975-302).

TABLE 6
C18 positive/negative mode gradient conditions

| Time | Flow Rate (mL/min) | % A | % B |
|---|---|---|---|
| 0 | 0.6 | 100 | 0 |
| 1.5 | 0.6 | 100 | 0 |
| 4 | 0.6 | 0 | 100 |
| 6 | 0.6 | 0 | 100 |
| 6.1 | 0.6 | 100 | 0 |
| 9 | 0.6 | 100 | 0 |

Quantitation of Organic Acids and Similarly Charged Polar Compounds: To look at organic acids, a charged C18 column was used. The gradient used for the organic method was the same as for the C18 non-polar methods, as shown in TABLE 7. There was a modification to mobile phase B for this method, in that B: ACN+0.1%FA. The column used was a Phenomenex Luna Omega, 1.6 μm, PS C18 100 Å, 100×2.1 mm (Product #00D-4752-AN).

Quantitation of Lipids: As lipids are very hydrophobic, they require stronger organic solvents in order to elute from any chromatographic column. The C18 column discussed above (Agilent Poroshell) was used to quantitate lipids, but the mobile phases that were used had a higher concentration of organic solvents. Samples were run in both positive and negative ionization modes, but the positive mode was used for quantitation of the two lipid standards. Mobile phase A: 60/40 H2O/ACN+5 mM Ammonium Acetate+0.1% FA, and B: 90/10 IPA/ACN+5 mM Ammonium Acetate+0.1% FA. The column temperature was held at 50° C.

TABLE 7
C18 Lipid positive/negative mode gradient conditions

| Time | Flow Rate (mL/min) | % A | % B |
|---|---|---|---|
| 0 | 0.6 | 80 | 20 |
| 1.5 | 0.6 | 80 | 20 |
| 4 | 0.6 | 45 | 55 |
| 10 | 0.6 | 20 | 80 |
| 11.5 | 0.6 | 0 | 100 |
| 15 | 0.6 | 0 | 100 |
| 15.5 | 0.6 | 80 | 20 |
| 17.5 | 0.6 | 80 | 20 |

Data analysis: Data analysis methods were developed with the XCalibur Processing Setup program, where methods were made for each standard cassette for each LC method. The compound mass and retention time was added for each standard, and calibration levels were applied for each standard. To calculate concentrations in samples, the samples and standards for each run were processed together using XCalibur Quan software, and concentrations calculated based on the respective compound calibration curve. Limits of detection were determined for each standard by running each standard curve at low levels until nothing was detected.

The LODs for non-volatile standard compounds are shown in TABLES 8A and 8B.

TABLE 8A
LODs for standards being quantified
(in pg/mL, ng/mL, or ug/mL)

| Cassette | Compound | LOD |
|---|---|---|
| 10 | methionine | 500 pg |
| 10 | histidine | 10 ng |
| 10 | lysine | 10 ng |
| 10 | serine | 2 ng |
| 10 | leucine | 500 pg |
| 10 | phenylalanine | 500 pg |
| 10 | aspartic acid | 5 ug |
| 10 | tyrosine | 2 ng |
| 10 | GABA | 2 ng |
| 10 | pyridoxine | 100 pg |
| 10 | glucosamine | 50 ng |
| 10 | choline | 2 ng |
| 11 | arginine | 10 ng |
| 11 | valine | 100 ng |
| 11 | proline | 2 ng |
| 11 | alanine | 10 ng |
| 11 | isoleucine | 10 ng |
| 11 | cysteine | 1 ug |
| 11 | asparagine | 10 ng |
| 11 | glutamic acid | 10 ng |
| 11 | tryptophan | 2 ng |
| 11 | ornithine | 10 ng |
| 11 | glutamine | 10 ng |
| 11 | threonine | 10 ng |
| 11 | carnitine | 500 pg |
| 12 | tartaric acid | 100 pg |
| 12 | citric acid | 10 ng |
| 12 | 2-isopropylmalic acid | 100 pg |
| 12 | lactic acid | 2 ng |
| 12 | 3,4-dihydroxybenzoic acid | 100 pg |
| 12 | gallic acid | 500 pg |
| 12 | D-glucuronic acid | 100 pg |
| 12 | fumaric acid | 500 pg |
| 12 | malic acid | 100 pg |
| 12 | galacturonic acid | 100 pg |
| 12 | 2-furoic acid | 10 ng |
| 12 | pyruvic acid | 100 pg |
| 12 | succinic acid | 500 pg |
| 13 | rhamnose | 10 ng |
| 13 | glucose | 100 ng |
| 13 | mannitol | 2 ng |
| 13 | fructose | 2 ng |
| 13 | ribose | 10 ng |
| 13 | arabitol | 2 ng |
| 14 | rutin | 1 ng |
| 14 | quercetin | 1 ng |
| 14 | salicylic acid | 200 pg |
| 14 | sinapinic acid | 200 pg |
| 14 | epicatechin | 1 ng |
| 14 | resveratrol | 4 ng |
| 14 | propyl gallate | 200 pg |
| 14 | trans-ferulic acid | 1 ng |
| 14 | hesperetin | 200 pg |
| 14 | adipic acid | 200 pg |
| 14 | methyl gallate | 200 pg |
| 14 | catechin | 1 ng |
| 14 | ellagic acid | 1 ng |
| 15 | inositol | 10 ng |
| 15 | fucose | 100 ng |
| 15 | mannose | 10 ng |
| 15 | xylose | 100 ng |
| 15 | sorbitol | 2 ng |
| 15 | galactose | 10 ng |
| 16 | quinic acid | 1 ng |
| 16 | polydatin | 4 ng |
| 16 | acetovanillone | 1 ng |
| 16 | pantothenic acid | 0.2 ng |
| 16 | vanillic acid | 10 ng |
| 16 | syringic acid | 50 ng |
| 16 | caffeic acid | 20 ng |
| 16 | epicatechin gallate | 2 ng |
| 16 | coumaric acid | 4 ng |
| 16 | cinnamic acid | 500 ng |
| 16 | syringaldehyde | 1 ng |
| 16 | vanillin | 200 pg |
| 17 | trans-4-hydroxy proline | 200 pg |
| 17 | 1-citrulline | 200 pg |
| 17 | tryptamine | 200 pg |
| 17 | tyramine | 1 ng |
| 17 | adenine | 200 pg |
| 17 | guanine | 200 pg |
| 17 | acetylcholine | 1 ng |
| 17 | kynurenic acid | 200 pg |
| 17 | sorbic acid | 100 ng |
| 17 | lauric acid | 200 pg |
| 17 | palmitic acid | 200 pg |

TABLE 8B
Additional LODs for standards being
quantified (by parts)

| Compound | LOD |
|---|---|
| 2,3,5,6-tetramethylpyrazine | <1 ppb |
| 2,3,5-trimethylpyrazine | <1 ppb |
| 2,3-dimethylpyrazine | <1 ppb |
| beta-alanine | 100 ppb |
| camphoric acid | not detected well |
| citrulline | 100 ppb |
| methyl 2-pyrrolyl ketone | <1 ppb |
| piperine | <1 ppb |
| pyridine | <1 ppb |
| 4-guanidinobutyric acid | 100 ppt |
| Betaine | <10 ppb |
| carnosine | <10 ppb |
| cystine | <100 ppb |
| cytidine | 5 ppb |
| cytosine | 100 ppt |
| D-glucuronic acid | 500 ppt |
| homoserine | <10 ppb |
| myo-inositol | 50 ppb |
| pipecolinic acid | <10 ppb |
| uracil | 5 ppb |
| glycine | 50 ppb |

The levels of the non-volatile compounds measured in some reference samples are shown in TABLE 9.

TABLE 9
LC-MS of reference sakes

| Compound | Sake 1 | Sake 1 | Sake 1 | Sake 1 | Sake 2 | Sake 2 | Sake 2 |
|---|---|---|---|---|---|---|---|
| catechin | NF | NF | NF | NF | NF | NF | NF |
| adipic acid | NF | NF | NF | NF | OC | OC | OC |
| methyl gallate | NF | NF | NF | NF | NF | NF | NF |
| epicatechin | NF | NF | NF | NF | NF | NF | NF |
| rutin | NF | OC | NF | NF | NF | OC | NF |
| trans-ferulic acid | 5.18E−01 | 5.36E−01 | 5.45E−01 | 5.61E−01 | NF | NF | NF |
| sinapinic acid | NF | NF | NF | NF | NF | NF | NF |
| resveratrol | NF | NF | NF | NF | NF | NF | NF |
| ellagic acid | NF | NF | NF | NF | NF | NF | NF |
| propyl gallate | NF | NF | NF | NF | NF | NF | NF |
| salicylic acid | OC | OC | OC | OC | OC | OC | OC |
| quercetin | NF | NF | NF | NF | NF | NF | NF |
| hesperetin | NF | NF | NF | NF | NF | NF | NF |
| pantothenic acid | OC | 0.00E+00 | OC | OC | OC | OC | OC |
| caffeic acid | NF | 0.00E+00 | NF | NF | NF | NF | NF |
| epicatechin gallate | NF | 0.00E+00 | NF | NF | NF | NF | NF |
| vanillic acid | NF | OC | NF | NF | NF | NF | NF |
| syringic acid | NF | OC | NF | NF | NF | NF | NF |
| polydatin | NF | OC | NF | NF | NF | NF | NF |
| vanillin | OC | 0.00E+00 | OC | OC | OC | OC | OC |
| syringaldehyde | NF | 0.00E+00 | NF | NF | NF | NF | NF |
| coumaric acid | OC | NF | OC | OC | OC | NF | NF |
| acetovanillone | NF | OC | NF | NF | NF | NF | NF |
| cinnamic acid | NF | NF | NF | NF | NF | NF | NF |
| cytosine | NF | OC | OC | OC | OC | OC | OC |
| adenine | NF | OC | OC | OC | OC | OC | OC |
| cytidine | NF | 2.23E+00 | 2.05E+00 | 2.04E+00 | 1.98E+00 | NF | 1.11E+00 |
| guanine | OC | OC | OC | OC | OC | OC | OC |
| 4-guanidinobutyric | OC | OC | OC | OC | OC | OC | OC |
| acid | | | | | | | |
| uracil | NF | 5.13E−01 | 4.98E−01 | 4.42E−01 | 4.64E−01 | 6.51E−01 | 7.16E−01 |
| tyramine | NF | NF | NF | NF | NF | OC | OC |
| tryptamine | NF | NF | NF | NF | NF | NF | NF |
| sorbic acid | NF | NF | NF | NF | NF | NF | NF |
| choline | NF | OC | OC | OC | OC | OC | OC |
| pyridine | NF | NF | NF | NF | NF | NF | NF |
| pyridoxine | OC | OC | OC | OC | OC | OC | OC |
| 2,3- | NF | NF | NF | NF | NF | NF | NF |
| dimethylpyrazine | | | | | | | |
| methyl2-pyrrolyl | NF | NF | NF | NF | NF | NF | NF |
| ketone | | | | | | | |
| 2,3,5- | NF | NF | NF | NF | NF | NF | NF |
| trimethylpyrazine | | | | | | | |
| 2,3,5,6- | OC | OC | OC | OC | OC | OC | OC |
| tetramethylpyrazine | | | | | | | |
| camphoric acid | NF | NF | NF | NF | NF | NF | NF |
| piperine | OC | NF | NF | NF | NF | NF | NF |
| phenylalanine | OC | OC | OC | ND | OC | 1.90E+01 | 1.76E+01 |
| leucine | OC | OC | OC | ND | OC | OC | OC |
| glucosamine | OC | OC | OC | ND | OC | OC | OC |
| methionine | 1.66E+00 | OC | OC | ND | 2.40E+00 | 1.82E+00 | 2.12E+00 |
| GABA | 4.70E+00 | 2.98E+00 | 3.76E+00 | ND | 5.16E+00 | 2.83E+00 | 3.56E+00 |
| tyrosine | OC | OC | OC | ND | OC | OC | OC |
| lysine | OC | OC | OC | ND | OC | OC | OC |
| histidine | oc | 1.57E+01 | 1.68E+01 | ND | 1.79E+01 | 1.16E+01 | 1.02E+01 |
| glycine | 2.74E+01 | OC | OC | ND | 2.92E+01 | OC | OC |
| serine | 2.30E+01 | 2.09E+01 | 2.15E+01 | ND | 2.49E+01 | 2.32E+01 | 2.09E+01 |
| aspartic acid | NF | NF | NF | ND | NF | NF | NF |
| isoleucine | OC | OC | OC | ND | OC | OC | OC |
| tryptophan | 1.65E+01 | 7.02E+00 | 1.09E+01 | ND | 4.16E+00 | 2.41E+00 | 3.56E+00 |
| valine | 2.45E+01 | 2.14E+01 | 2.24E+01 | ND | 2.48E+01 | 1.94E+01 | 2.04E+01 |
| carnitine | OC | OC | OC | ND | OC | OC | OC |
| proline | OC | OC | OC | ND | OC | OC | OC |
| arginine | OC | OC | OC | ND | OC | OC | OC |
| beta-alanine | OC | OC | OC | ND | OC | OC | OC |
| ornithine | 1.08E+01 | 8.76E+00 | 9.40E+00 | ND | 1.16E+01 | 9.99E+00 | 8.45E+00 |
| threonine | 1.75E+01 | 1.34E+01 | 1.29E+01 | ND | 1.96E+01 | 1.57E+01 | 1.30E+01 |
| glutamine | OC | 3.07E+01 | OC | ND | 8.81E+00 | 6.04E+00 | 6.41E+00 |
| asparagine | 2.62E+01 | 2.37E+01 | 2.39E+01 | ND | 2.71E+01 | 2.49E+01 | 2.26E+01 |
| cysteine | NF | NF | NF | ND | NF | NF | NF |
| glutamic acid | OC | OC | OC | ND | OC | OC | OC |
| ribose | OC | NF | OC | ND | 1.36E+01 | 1.42E+01 | 1.45E+01 |
| arabitol | OC | NF | OC | ND | OC | OC | OC |
| fructose | OC | OC | OC | ND | 1.19E+01 | 1.21E+01 | 9.92E+00 |
| mannitol | OC | OC | OC | ND | 2.54E+01 | 2.62E+01 | 2.30E+01 |
| rhamnose | OC | OC | OC | ND | 2.35E+01 | 2.46E+01 | 2.11E+01 |
| glucose | OC | OC | OC | ND | OC | OC | OC |
| xylose | 1.35E+01 | 1.26E+01 | 1.19E+01 | ND | 2.60E+00 | 3.19E+00 | 3.79E+00 |
| galactose | OC | OC | OC | ND | OC | OC | OC |
| sorbitol | OC | OC | OC | ND | OC | OC | OC |
| fucose | OC | OC | OC | ND | OC | OC | OC |
| mannose | OC | OC | OC | ND | OC | OC | OC |
| myo-inositol | NF | NF | NF | ND | NF | NF | NF |
| betaine | 1.21E+01 | 5.22E+00 | NF | ND | 4.71E+00 | 2.11E+00 | 2.98E+00 |
| pipecolinic acid | OC | OC | NF | ND | OC | OC | OC |
| trans-4- | 1.20E−01 | 7.33E−02 | NF | ND | 6.57E−02 | OC | OC |
| hydroxyproline | | | | | | | |
| kynurenic acid | NF | NF | NF | ND | OC | OC | OC |
| carnosine | 1.46E+00 | 8.12E−01 | NF | ND | 9.58E−01 | 5.93E−01 | 5.71E−01 |
| homoserine | 9.60E+00 | 7.07E+00 | NF | ND | 1.06E+01 | 8.45E+00 | 6.94E+00 |
| citrulline | 2.93E−01 | 2.33E−01 | NF | ND | 3.04E−01 | 2.41E−01 | 2.15E−01 |
| cystine | NF | NF | NF | ND | NF | NF | NF |
| D-glucuronic acid | 1.86E+01 | 1.53E+01 | 1.31E+01 | ND | 1.44E+01 | 1.26E+01 | 1.32E+01 |
| quinic acid | 1.79E+01 | 1.99E+01 | 1.88E+01 | ND | OC | OC | OC |
| malic acid | OC | OC | OC | ND | OC | OC | OC |
| pyruvic acid | 7.97E+00 | 8.88E+00 | 7.53E+00 | ND | OC | OC | OC |
| tartaric acid | OC | OC | OC | ND | OC | OC | OC |
| lactic acid | OC | OC | OC | ND | OC | OC | OC |
| citric acid | OC | OC | OC | ND | OC | OC | OC |
| fumaric acid | 5.07E+00 | 4.70E+00 | 4.44E+00 | ND | OC | OC | OC |
| succinic acid | OC | OC | OC | ND | OC | OC | OC |
| gallic acid | NF | NF | NF | ND | NF | NF | NF |
| 2-furoic acid | OC | 1.65E+01 | 1.66E+01 | ND | OC | OC | OC |
| 3,4- | OC | OC | OC | ND | OC | OC | OC |
| dihydroxybenzoic | | | | | | | |
| acid | | | | | | | |
| 2-isopropylmalic | 7.62E+00 | 7.28E+00 | 6.40E+00 | ND | 7.37E+00 | 6.80E+00 | 6.70E+00 |
| acid | | | | | | | |

| Compound | Sake 2 | Sake 3 | Sake 3 | Sake 3 | Sake 3 |
|---|---|---|---|---|---|
| catechin | NF | NF | NF | NF | NF |
| adipic acid | OC | OC | OC | OC | OC |
| methyl gallate | NF | NF | NF | NF | NF |
| epicatechin | NF | NF | NF | NF | NF |
| rutin | NF | NF | OC | NF | NF |
| trans-ferulic acid | NF | 7.31E−01 | 7.76E−01 | 8.08E−01 | 8.72E−01 |
| sinapinic acid | NF | NF | NF | NF | NF |
| resveratrol | NF | NF | NF | NF | NF |
| ellagic acid | NF | NF | NF | NF | NF |
| propyl gallate | NF | NF | NF | NF | NF |
| salicylic acid | OC | OC | OC | OC | OC |
| quercetin | NF | NF | NF | NF | NF |
| hesperetin | NF | NF | NF | NF | NF |
| pantothenic acid | OC | OC | OC | OC | OC |
| caffeic acid | NF | NF | NF | NF | NF |
| epicatechin gallate | NF | NF | NF | NF | NF |
| vanillic acid | NF | NF | OC | OC | OC |
| syringic acid | NF | NF | NF | NF | NF |
| polydatin | NF | NF | NF | NF | NF |
| vanillin | OC | OC | OC | OC | OC |
| syringaldehyde | NF | NF | NF | NF | NF |
| coumaric acid | NF | NF | 5.34E−02 | OC | OC |
| acetovanillone | NF | NF | NF | NF | NF |
| cinnamic acid | NF | NF | NF | NF | NF |
| cytosine | OC | OC | OC | OC | OC |
| adenine | OC | OC | OC | OC | OC |
| cytidine | 1.07E+00 | 1.10E+00 | 3.36E+00 | 3.11E+00 | 3.15E+00 |
| guanine | OC | OC | OC | OC | OC |
| 4-guanidinobutyric | OC | OC | OC | OC | OC |
| acid | | | | | |
| uracil | 7.39E−01 | 7.38E−01 | 1.58E+00 | 1.63E+00 | 1.70E+00 |
| tyramine | OC | OC | NF | NF | NF |
| tryptamine | NF | NF | NF | NF | NF |
| sorbic acid | NF | NF | NF | NF | NF |
| choline | OC | OC | OC | OC | OC |
| pyridine | NF | NF | NF | NF | NF |
| pyridoxine | OC | OC | OC | OC | OC |
| 2,3- | NF | NF | NF | NF | NF |
| dimethylpyrazine | | | | | |
| methy 12-pyrrolyl | NF | NF | NF | NF | NF |
| ketone | | | | | |
| 2,3,5- | NF | NF | NF | NF | NF |
| trimethylpyrazine | | | | | |
| 2,3,5,6- | OC | OC | OC | OC | OC |
| tetramethylpyrazine | | | | | |
| camphoric acid | NF | NF | NF | NF | NF |
| piperine | NF | NF | NF | NF | NF |
| phenylalanine | ND | OC | OC | OC | ND |
| leucine | ND | OC | OC | OC | ND |
| glucosamine | ND | OC | OC | OC | ND |
| methionine | ND | 4.39E+00 | 3.28E+00 | 3.92E+00 | ND |
| GABA | ND | OC | 6.70E+00 | OC | ND |
| tyrosine | ND | OC | OC | OC | ND |
| lysine | ND | OC | OC | OC | ND |
| histidine | ND | OC | OC | OC | ND |
| glycine | ND | OC | OC | OC | ND |
| serine | ND | 2.94E+01 | OC | OC | ND |
| aspartic acid | ND | NF | NF | NF | ND |
| isoleucine | ND | OC | OC | OC | ND |
| tryptophan | ND | 3.78E+00 | 2.33E+00 | 4.38E+00 | ND |
| valine | ND | OC | 3.01E+01 | OC | ND |
| carnitine | ND | OC | OC | OC | ND |
| proline | ND | OC | OC | OC | ND |
| arginine | ND | OC | OC | OC | ND |
| beta-alanine | ND | OC | OC | OC | ND |
| ornithine | ND | 1.07E+01 | 1.07E+01 | 1.18E+01 | ND |
| threonine | ND | 2.54E+01 | 2.45E+01 | 2.46E+01 | ND |
| glutamine | ND | 6.69E+00 | 6.41E+00 | 6.80E+00 | ND |
| asparagine | ND | 1.91E+01 | 2.09E+01 | 2.01E+01 | ND |
| cysteine | ND | NF | NF | NF | ND |
| glutamic acid | ND | OC | OC | OC | ND |
| ribose | ND | OC | OC | OC | ND |
| arabitol | ND | OC | OC | OC | ND |
| fructose | ND | 8.80E+00 | 1.05E+01 | 1.25E+01 | ND |
| mannitol | ND | OC | OC | OC | ND |
| rhamnose | ND | OC | OC | OC | ND |
| glucose | ND | OC | OC | OC | ND |
| xylose | ND | 7.36E+00 | 5.22E+00 | 6.70E+00 | ND |
| galactose | ND | OC | OC | OC | ND |
| sorbitol | ND | OC | OC | OC | ND |
| fucose | ND | OC | OC | OC | ND |
| mannose | ND | OC | OC | OC | ND |
| myo-inositol | ND | NF | NF | NF | ND |
| betaine | ND | 1.50E+01 | 6.05E+00 | 6.57E+00 | ND |
| pipecolinic acid | ND | OC | OC | OC | ND |
| trans-4- | ND | 2.31E−01 | 1.77E−01 | 1.74E−01 | ND |
| hydroxyproline | | | | | |
| kynurenic acid | ND | NF | NF | NF | ND |
| carnosine | ND | 1.46E+00 | 9.44E−01 | 1.09E+00 | ND |
| homoserine | ND | 1.72E+01 | 1.63E+01 | 1.64E+01 | ND |
| citrulline | ND | 2.24E−01 | 2.16E−01 | 2.35E−01 | ND |
| cystine | ND | NF | NF | NF | ND |
| D-glucuronic acid | ND | OC | OC | 1.93E+01 | ND |
| quinic acid | ND | OC | OC | OC | ND |
| malic acid | ND | OC | OC | OC | ND |
| pyruvic acid | ND | OC | OC | OC | ND |
| tartaric acid | ND | OC | OC | OC | ND |
| lactic acid | ND | OC | OC | OC | ND |
| citric acid | ND | OC | OC | OC | ND |
| fumaric acid | ND | 3.50E+00 | 3.18E+00 | 2.86E+00 | ND |
| succinic acid | ND | OC | OC | OC | ND |
| gallic acid | ND | NF | NF | NF | ND |
| 2-furoic acid | ND | OC | OC | OC | ND |
| 3,4- | ND | OC | OC | OC | ND |
| dihydroxybenzoic | | | | | |
| acid | | | | | |
| 2-isopropylmalic | ND | 1.61E+01 | 1.32E+01 | 1.20E+01 | ND |
| acid | | | | | |

NF = not present or below the limit of detection
OC = present but outside of the standard curve (e.g., below the LOQ)
ND = not determined

### Example 2—Exemplary Sake Replica

A sake replica was prepared from individual components. The ingredients included the VOCs listed in column “Exemplary 1× Range” of TABLE 10A, and the non-volatile compounds and ethanol (e.g., 95% ethanol) as listed in column “Exemplary 1× Range” of TABLE 10B. The following protocol was followed.

### Sake Base Preparation:

1) Fill a IL beaker with the total amount of ethanol needed (e.g., 159 mL) and add water (e.g., ˜250 mL).
2) Add the amino acids(e.g., alanine, arginine, glutamic acid, isoleucine, lysine, phenylalanine, and threonine) to the beaker and mix well/dissolve
   3) Add and dissolve choline bitartrate
   4) Add the acids (e.g., tartaric, malic, glucuronic, lactic, citric, fumaric, succinic, cinnamic) and dissolve
   5) Add and dissolve the sugars (e.g., fructose, glucose, sorbitol)
   6) Add KOH
   7) Add the VOCS
   8) Top up the mixture to the final volume (e.g., IL) with water
   9) Optionally, pour into a bottle and cork or cap
      Sake can be served cold or hot.

TABLES 10A and 10B also contain exemplary amounts of ingredients for sake concentrates, which can be prepared in the same manner as outlined above.

TABLE 10A
VOCs in sake formulations

| | | Exemplary | Exemplary | Exemplary |
|---|---|---|---|---|
| Compound (mg/L, | | 5X | 10X | 20X |
| unless otherwise | Exemplary | Concentrate | Concentrate | Concentrate |
| specified) | 1X Range | Range | Range | Range |
| acetaldehyde | 17-32 | 85-160 | 170-320 | 340-640 |
| butyl alcohol | 3-7 | 15-35 | 30-70 | 60-140 |
| propyl alcohol | 5-11 | 25-55 | 50-110 | 100-220 |
| ethyl acetate | 45-85 | 225-425 | 450-850 | 900-1700 |
| ethyl butanoate | 0.4-0.8 | 2-4 | 4-8 | 8-16 |
| ethyl hexanoate | 2-4 | 10-20 | 20-40 | 40-80 |
| ethyl octanoate | 2.5-5.5 | 12.5-27.5 | 25-55 | 50-110 |
| furfural | 4-10 | 20-50 | 40-100 | 80-200 |
| isoamyl acetate | 0.5-1 | 2.5-5 | 5-10 | 10-20 |
| isoamyl alcohol | 70-130 | 350-650 | 700-1300 | 1400-2600 |
| isobutyl alcohol | 14-26 | 70-130 | 140-260 | 280-520 |
| phenethyl acetate | 0.1-0.2 | 0.5-1 | 1-2 | 2-4 |
| phenethyl alcohol | 4-9 | 20-45 | 40-90 | 80-180 |
| 2-methyl-1-butanol | 10-19 | 50-95 | 100-190 | 200-380 |

TABLE 10B
non-volatiles and ethanol in sake formulations

| Compound | | Exemplary | Exemplary | Exemplary |
|---|---|---|---|---|
| (mg/L, unless | | 5X | 10X | 20X |
| otherwise | Exemplary | Concentrate | Concentrate | Concentrate |
| specified) | 1X Range | Range | Range | Range |
| arginine | 225-420 | 1125-2100 | 2250-4200 | 4500-8400 |
| alanine | 60-120 | 300-600 | 600-1200 | 1200-2400 |
| choline | 400-750 | 2000-3750 | 4000-7500 | 8000-15000 |
| bitartrate | | | | |
| fructose | 300-600 | 1500-3000 | 3000-6000 | 6000-12000 |
| glucose | 25000-50000 | 125000- | 250000- | 500000- |
| | | 250000 | 500000 | 1000000 |
| D-glucuronic | 20-45 | 100-225 | 200-450 | 400-900 |
| acid | | | | |
| malic acid | 330-620 | 1650-3100 | 3300-6200 | 6600-12400 |
| sorbitol | 25-50 | 125-250 | 250-500 | 500-1000 |
| fumaric acid | 0.25-0.6 | 1.25-3 | 2.5-6 | 5-12 |
| glutamic acid | 100-200 | 500-1000 | 1000-2000 | 2000-4000 |
| citric acid | 35-70 | 175-350 | 350-700 | 700-1400 |
| isoleucine | 35-65 | 175-325 | 350-650 | 700-1300 |
| tartaric acid | 0.1-0.25 | 0.5-1.25 | 1-2.5 | 2-5 |
| lactic acid | 280-530 | 1400-2650 | 2800-5300 | 5600-10600 |
| (mL/L) | | | | |
| lysine HCl | 20-45 | 100-225 | 200-450 | 400-900 |
| phenylalanine | 40-90 | 200-450 | 400-900 | 800-1800 |
| threonine | 9-16 | 45-80 | 90-160 | 180-320 |
| trans-cinnamic | 16-32 | 80-160 | 160-320 | 320-640 |
| acid | | | | |
| succinic acid | 200-400 | 1000-2000 | 2000-4000 | 4000-8000 |
| KOH | 250-500 | 1250-2500 | 2500-5000 | 5000-10000 |
| 95% ethanol | 110-210 | 550-1050* | 1100-2100* | 2200-4200* |
| (mL/L) | | | | |

*A portion of the ethanol can be added as a diluent and therefore the full amount shown may not be present in a concentrate.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A sake replica comprising:
ethanol;
water; and
one or more additional VOCs, wherein the one or more additional VOCs do not comprise at least one compound selected from the group consisting of 2,3-pentadione, 1-octanol, 2-heptanone, 2-nonanone, 5-methyl furfural, benzaldehyde, benzyl alcohol, butyl acetate, butyraldehyde, citronellol, diethyl succinate, ethyl isobutyrate, ethyl lactate, ethyl propionate, ethyl trans-2-butenoate, ethyl(methylthio) acetate, gamma-heptalactone, gamma-hexalactone, gamma-octalactone, hexanol, isoamyl hexanoate, isobutyl acetate, isobutyraldehyde, isobutyric acid, isovaleric acid, methionyl acetate, methyl acetate, nonanoic acid, phenylacetaldehyde, propionaldehyde, propionic acid, propyl acetate, and propyl butyrate.

2. The sake replica of claim 1, wherein the one or more additional VOCs comprise:
an ester;
an alcohol;
an aldehyde, a ketone, or an aldehyde and a ketone;
optionally, an acid;
optionally, a terpene, an isoprenoid, or a terpene and an isoprenoid;
optionally, a phenol;
optionally, a lactone;
optionally, an amine, a pyrazine, or an amine and a pyrazine;
optionally, a thiol, a thiazole, a sulfide, or any combination thereof;
optionally, an ether;
optionally, an acetal; and
optionally, a furan.

3. The sake replica of claim 2, wherein the one or more esters are selected from the group consisting of butyl acetate, diethyl malate, diethyl succinate, ethyl 2-methylbutyrate, ethyl 3-hydroxyhexanoate, ethyl acetate, ethyl benzoate, ethyl butanoate, ethyl decanoate, ethyl heptanoate, ethyl hexanoate, ethyl isobutyrate, ethyl isovalerate, ethyl lactate, ethyl laurate, ethyl levulinate, ethyl nonanoate, ethyl octanoate, ethyl phenylacetate, ethyl propionate, ethyl salicylate, ethyl trans-2-butenoate, ethyl valerate, ethyl(methylthio) acetate, ethyl-trans-3-hexenoate, heptyl acetate, hexyl acetate, isoamyl acetate, isoamyl hexanoate, isoamyl octanoate, isobutyl acetate, isobutyl propionate, methionyl acetate, methyl acetate, methyl hexanoate, methyl laurate, phenethyl acetate, phenethyl formate, phenethyl propionate, propyl acetate, propyl butyrate, propyl isovalerate, and mixtures thereof.

4. (canceled)

5. The sake replica of claim 2, wherein the one or more esters are present in an amount of at least about 41 mg/L.

6. The sake replica of claim 2, wherein the one or more alcohols are selected from the group consisting of 1-octanol, 1-octen-3-ol, 2-heptanol, 2-methyl-1-butanol, 2-phenylethanol, benzyl alcohol, butyl alcohol, DL-3-methyl-2-butanol, hexanol, isoamyl alcohol, isobutyl alcohol, propanol, and mixtures thereof.

7. (canceled)

8. The sake replica of claim 2, wherein the one or more aldehydes or ketones are selected from the group consisting of 2,3-pentadione, 2-heptanone, 2-methylbutyraldehyde, 2-nonanone, 2-undecanone, 5-ethyl-3-hydroxy-4-methyl-2(5H)-furanone, 5-methyl furfural, 6-methyl-5-hepten-2-one, acetaldehyde, acetophenone, benzaldehyde, butyraldehyde, furfural, isobutyraldehyde, isovaleraldehyde, methyl β-naphthyl ketone, methyl-2-pyrrolyl ketone, nonanal, octanal, p-anisaldehyde, phenylacetaldehyde, propionaldehyde, and mixtures thereof.

9. (canceled)

10. The sake replica of claim 2, wherein the one or more aldehydes or ketones are present in a total amount of at least about 1.2 mg/L.

11. The sake replica of claim 1, wherein the one or more additional VOCs comprise at least 3 compounds selected from the group consisting of 1-octanol, 2,3-pentadione, 2-heptanone, 2-methyl-1-butanol, 2-nonanone, 2-phenylethanol, 5-methyl furfural, acetaldehyde, benzaldehyde, benzyl alcohol, butyl acetate, butyl alcohol, butyraldehyde, citronellol, diethyl succinate, ethyl acetate, ethyl butanoate, ethyl hexanoate, ethyl isobutyrate, ethyl lactate, ethyl octanoate, ethyl propionate, ethyl trans-2-butenoate, ethyl(methylthio) acetate, furfural, gamma-heptalactone, gamma-hexalactone, gamma-octalactone, hexanol, isoamyl acetate, isoamyl alcohol, isoamyl hexanoate, isobutyl acetate, isobutyl alcohol, isobutyraldehyde, isobutyric acid, isovaleric acid, methionyl acetate, methyl acetate, nonanoic acid, phenethyl acetate, phenylacetaldehyde, propanol, propionaldehyde, propionic acid, propyl acetate, and propyl butyrate.

12. (canceled)

13. The sake replica of claim 1, wherein the sake replica further comprises 2-phenylethanol in an amount of less than about 28 mg/L.

14. The sake replica of claim 1, wherein the sake replica further comprises propanol in an amount of less than about 39 mg/L.

15. The sake replica of claim 1, wherein the sake replica further comprises ethyl butanoate in an amount of at least about 0.17 mg/L.

16. The sake replica of claim 1, wherein the sake replica further comprises ethyl octanoate in an amount of at least about 3.4 mg/L.

17. The sake replica of claim 1, wherein the sake replica further comprises furfural in an amount of at least about 0.45 mg/L.

18. The sake replica of claim 2, wherein less than about 15.5% by mass of the one or more additional VOCs comprise 2-phenylethanol.

19. The sake replica of claim 2, wherein less than about 22.5% by mass of the one or more additional VOCs comprise propanol.

20. The sake replica of claim 2, wherein at least about 0.12% by mass of the one or more additional VOCs comprise ethyl butanoate.

21. The sake replica of claim 2, wherein at least about 0.31% by mass of the one or more additional VOCs comprise furfural.

22. The sake replica of claim 1, wherein the additional VOCs have less than 90% identity to the VOCs in a single reference sake.

23. The sake replica of claim 1, wherein the sake replica comprises at least 7 additional VOCs and wherein no more than 6 of the additional VOCs are found in a single reference sake.

24. The sake replica of claim 1, further comprising one or more non-volatile compounds.

25. The sake replica of claim 24, wherein the one or more non-volatile compounds comprise one or more non-volatile compounds that are not present in a corresponding traditional sake.

26. The sake replica of claim 25, wherein the one or more non-volatile compounds that are not present in a traditional sake are selected from the group consisting of 2,3,5-trimethylpyrazine, 2,3-dimethylpyrazine, aspartic acid, caffeic acid, camphoric acid, catechin, cinnamic acid, cysteine, cystine, ellagic acid, epicatechin, epicatechin gallate, gallic acid, hesperetin, methyl gallate, methyl-2-pyrrolyl ketone, inositol, propyl gallate, pyridine, quercetin, resveratrol, sinapinic acid, sorbic acid, syringaldehyde, and tryptamine.

27. The sake replica of claim 24, wherein the one or more non-volatile compounds comprise:
a sugar, a sugar alcohol, or a combination thereof
an amino acid, an amino acid derivative, or a combination thereof;
a pH-modifying salt;
an organic acid;
optionally, a nucleobase, a nucleotide, or a combination thereof;
optionally, a nitrogen-containing heterocycle; and
optionally, a phenolic compound.

28. The sake replica of claim 27, wherein the sugar, sugar alcohol, or combination thereof is selected from the group consisting of fructose, glucose, sorbitol, fucose, galactose, glucosamine, mannitol, mannose, rhamnose, xylose, arabitol, ribose, and mixtures thereof.

29. (canceled)

30. The sake replica of claim 27, wherein the amino acid, amino acid derivative, or combination thereof is selected from the group consisting of arginine, glutamic acid, isoleucine, lysine, phenylalanine, threonine, alanine, asparagine, beta-alanine, carnitine, GABA, glutamine, glycine, histidine, leucine, methionine, ornithine, proline, serine, tryptophan, tyrosine, valine, betaine, carnosine, citrulline, homoserine, trans-4-hydroxyproline, tyramine, kynurenic acid, and mixtures thereof.

31. (canceled)

32. The sake replica of claim 27, wherein the organic acid is selected from the group consisting of citric acid, D-glucuronic acid, fumaric acid, malic acid, succinic acid, tartaric acid, cinnamic acid, pantothenic acid, 2-furoic acid, 2-isopropylmalic acid, 4-guanidinobutyric acid, lactic acid, pyruvic acid, quinic acid, adipic acid, and mixtures thereof.

33. (canceled)

34. The sake replica of claim 27, wherein the one or more non-volatile compounds comprise at least 5 compounds selected from the group consisting of 2,3,5,6-tetramethylpyrazine, 4-guanidinobutyric acid, alanine, arginine, choline bitartrate, cinnamic acid, citric acid, D-glucuronic acid, fructose, fumaric acid, glucose, glutamic acid, guanine, isoleucine, KOH, lysine, lactic acid, malic acid, phenylalanine, pyridoxine, salicylic acid, sorbitol, succinic acid, tartaric acid, and threonine.

35. (canceled)

36. The sake replica of claim 27, wherein the sake replica comprises less than about 1.4 mg/L of fumaric acid.

37. The sake replica of claim 27, wherein the sake replica comprises at least about 38 mg/L of phenylalanine.

38. The sake replica of claim 27, wherein the sake replica comprises at least about 25 mg/L of fructose.

39. A sake replica comprising:
ethanol;
water; and
one or more non-volatile compounds, wherein the one or more non-volatile compounds comprise at least one compound selected from the group consisting of cinnamic acid, 2,3,5-trimethylpyrazine, 2,3-dimethylpyrazine, aspartic acid, caffeic acid, camphoric acid, catechin, cysteine, cystine, ellagic acid, epicatechin, epicatechin gallate, gallic acid, hesperetin, methyl gallate, methyl-2-pyrrolyl ketone, inositol, propyl gallate, pyridine, quercetin, resveratrol, sinapinic acid, sorbic acid, syringaldehyde, and tryptamine.

40. A sake replica comprising:
ethanol;
water; and
one or more additional VOCs, wherein the additional VOCs comprise 2-methyl-1-butanol, 2-phenylethanol, acetaldehyde, butyl alcohol, ethyl acetate, ethyl butanoate, ethyl hexanoate, ethyl octanoate, furfural, isoamyl acetate, isoamyl alcohol, isobutyl alcohol, phenethyl acetate, and propanol.

41. The sake replica of claim 40, further comprising one or more non-volatile compounds, wherein the non-volatile compounds comprise alanine, arginine, choline bitartrate, cinnamic acid, citric acid, D-glucuronic acid, fructose, fumaric acid, glucose, glutamic acid, isoleucine, KOH, lactic acid, lysine, malic acid, phenylalanine, sorbitol, succinic acid, tartaric acid, and threonine.

42. A method of making a sake replica, the method comprising:
combining ingredients comprising:
water;
ethanol;
five or more additional VOCs, wherein at least five of the five or more additional VOCs are provided as separate ingredients; and
five or more non-volatile compounds, wherein at least five of the five or more non-volatile compounds are provided as separate ingredients.

43.-44. (canceled)

45. A sake replica comprising:
ethanol;
water;
additional volatile organic compounds (VOCs); and
non-volatile compounds,
wherein the additional VOCs comprise:

| Compound | mg/L |
|---|---|
| acetaldehyde | 17-32 |
| butyl alcohol | 3-7 |
| propyl alcohol | 5-11 |
| ethyl acetate | 45-85 |
| ethyl butanoate | 0.4-0.8 |
| ethyl hexanoate | 2-4 |
| ethyl octanoate | 2.5-5.5 |
| furfural | 4-10 |
| isoamyl acetate | 0.5-1 |
| isoamyl alcohol | 70-130 |
| isobutyl alcohol | 14-26 |
| phenethyl acetate | 0.1-0.2 |
| phenethyl alcohol | 4-9 |
| 2-methyl-1-butanol | 10-19 |

and wherein the non-volatile compounds comprise:

| Compound | mg/L |
|---|---|
| arginine | 225-420 |
| alanine | 60-120 |
| choline bitartrate | 400-750 |
| fructose | 300-600 |
| glucose | 25000-50000 |
| D-glucuronic acid | 20-45 |
| malic acid | 330-620 |
| sorbitol | 25-50 |
| fumaric acid | 0.25-0.6 |
| glutamic acid | 100-200 |
| citric acid | 35-70 |
| isoleucine | 35-65 |
| tartaric acid | 0.1-0.25 |
| lactic acid (mL/L) | 280-530 |
| lysine HCl | 20-45 |
| phenylalanine | 40-90 |
| threonine | 9-16 |
| cinnamic acid | 16-32 |
| succinic acid | 200-400 |
| KOH | 250-500 |
